(19) United States
(12) Patent Application Publication
(10) Pub. No.: US 2024/0093677 A1
(43) Pub. Date: Mar. 21, 2024

(54) ENERGY GENERATING DEVICE

(71) Applicant: Phillip Galinsky, Stonington, CT (US)

(72) Inventor: Phillip Galinsky, Stonington, CT (US)

(21) Appl. No.: 18/369,196

(22) Filed: Sep. 18, 2023

Related U.S. Application Data
(63) Continuation-in-part of application No. 18/101,126, filed on Jan. 25, 2023, now abandoned.
(60) Provisional application No. 63/376,455, filed on Sep. 21, 2022.

(51) Int. Cl. F03G 3/00; F03B 13/12

(52) U.S. Cl. CPC F03G 3/094; F03B 13/12; F05B 2220/7066; F05B 2240/50; F05B 2260/404

(57) ABSTRACT

An energy generating device may include a first body portion with at least one first force input structure coupled to the first body portion and configured to receive an external force. The energy generating device also may include a second body portion, the second body portion rotatable relative to the first body portion. Further, the energy generating device may include an electrical generator configured to use the relative motion between the first body portion and the second body portion to generate electricity. The first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion. An energy generating device may include at least one first body portion, at least one second body portion, at least one torque generator configured to cause relative rotation between the first body portion and the second body portion, and at least one electrical generator configured to use the relative motion between the first body portion and the second body portion to generate electricity, wherein the first body portion and the second body portion are configured to descend through a medium at least partially under the force of gravity or ascend through the medium at least partially by buoyant forces in such a way that the torque generator causes relative rotation between the first body portion and the second body portion.

### REFERENCE TO RELATED APPLICATIONS

This application claims priority to U.S. Provisional Patent Application No. 63/376,455, filed on Sep. 21, 2022, entitled ENERGY GENERATING DEVICE to Inventor Phillip Galinsky, the entirety of which is herein incorporated by reference. This application also claims priority to U.S. Nonprovisional patent application Ser. No. 18/101,126, filed on Jan. 25, 2023, entitled ENERGY GENERATING DEVICE to Inventor Phillip Galinsky, the entirety of which is herein incorporated by reference.

### TECHNICAL FIELD

The present disclosure relates generally to devices capable of generating electrical energy.

### BACKGROUND

It is well known that the Earth's energy resources, such as fossil fuels, are limited and may someday become scarce. Fossil fuels in particular appear to have caused substantial damage to the Earth in the form of global warming. Yet we need energy today more than ever before. Fossil fuels have also created great power instability on our planet. Nations that heavily depend upon fossil fuels for energy production find their vital systems such as food production and winter heating are threatened by geopolitical events beyond their control. Increasing amounts of energy are needed as regional water shortages create great need for region-scale desalination, putting further strain on nonrenewable fossil fuel supplies and further polluting the environment. Many people have no access to fossil fuels. Nearly a billion people have no access to electricity. Over three billion people have no access to clean energy sources for cooking, relying instead on burning dehydrated animal dung, dried brush, and wood. Moreover, as mankind searches for other homes in the Universe, reliable and repeatable energy sources will be needed. Since the same needs exist on Earth, it would be advantageous to engineer new ways to find and generate clean sources of energy.

### SUMMARY

Various disclosed exemplary embodiments include systems, devices, and methods for generating electrical energy.

In some embodiments, an energy generating device may include a first body portion with at least one first force input structure coupled to the first body portion and configured to receive an external force. In some embodiments, an energy generating device also may include a second body portion, the first body portion rotatable relative to the second body portion. Further, some embodiments of an energy generating device may include an electrical generator configured to use the relative motion between the first body portion and the second body portion to generate electricity. The first body portion and the second body portion may be configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

In accordance with various exemplary embodiments, an energy generating device may include a first body portion having a pass-through and at least one rotor structure coupled to the first body portion and configured to receive an external force. The energy generating device may also include a second body portion, the second body portion concentrically located at least partially within the pass-through of the first body portion, the first body portion rotatable relative to the second body portion and at least one helical structure, rotor or other torque generating structure coupled to the second body portion and configured to receive an external force. Further, the energy generating device may include an electrical generator configured to use the relative motion between the first body portion, having one or more conductive coils, and the second body portion, having one or more magnets, to generate electricity. Further still, the energy generating device may also include the first body portion and the second body portion may be configured to descend through a medium at least partially under the force of gravity or ascend through the medium at least partially by buoyant forces in such a way that the medium causes a force on the at least one rotor by impinging on the at least one rotor causing relative rotation between the first body portion and the second body portion.

Further, various exemplary embodiments may relate to a method of generating electricity. The method may include causing an energy generating device, having a first body portion and a second body portion configured to counter rotate with each other, to descend in a medium under the force of gravity and causing the first body portion and the second body portion to counter rotate by providing contact between the medium and a torque generator configured on both the first body portion and the second body portion. The method may also include generating electricity by providing magnets and conductive coils on the first body portion and the second body portion, the magnets causing an electrical current in the conductive coils as they bypass one another. The method further may include increasing the buoyancy of the energy generating device causing the energy generating device to ascend.

Further still, various exemplary embodiments may relate to a method of manufacturing an energy generating device. The method may include producing, from suitable materials, a first body portion. The method also may include producing, from suitable materials, at least one first force input structure. Further, the method may include coupling the at least one first force input structure to the first body portion in a configuration to receive an external force. Further still, the method may include producing, from suitable materials, a second body portion. Further still, the method may include assembling the first body portion with the second body portion in a configuration to be rotatable relative to the second body portion and assembling an electrical generator in a configuration to use the relative motion between the first body portion and the second body portion to generate electricity. The first body portion and the second body portion may be configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

In accordance with various exemplary embodiments, an energy generating device may include a first body portion, a second body portion, a torque generator, and an electrical generator configured to use the relative motion between the first body portion and the second body portion to generate electricity. The first body portion and the second body portion may be configured to descend through a medium at least partially under the force of gravity or ascend through the medium at least partially by buoyant forces in such a way that the torque generator causes relative rotation between the first body portion and the second body portion. In various exemplary embodiments the first body portion may be substantially concentric with the second body portion. In some exemplary embodiments the first body portion may include a pass through configured to receive the second body portion. In some embodiments the second body portion may be rotatably supported by at least one bearing. In various embodiments the at least one bearing may include at least one of a mechanical bearing, an air bearing, a fluid bearing, and a magnetic bearing. In various exemplary embodiments of an energy generating device the torque generator may include at least one first force input structure configured to receive an external force as the energy generating device descends or ascends through a medium causing relative rotation between the first body portion and the second body portion. In some embodiments the torque generator may include at least one first track. In some exemplary embodiments the at least one first track may be configured to prevent the rotation of the first body portion as the energy generating device descends or ascends through a medium. In some embodiments the at least one first track may be configured to steer or constrain the motion of the first body portion causing relative rotation between the first body portion and the second body portion as the energy generating device descends or ascends through a medium. In various exemplary embodiments the energy generating device may further include at least one second force input structure coupled to the second body portion. In various exemplary embodiments the torque generator may further include at least one second track. In some embodiments the at least one second track may be configured to prevent the rotation of the second body portion as the energy generating device descends or ascends through a medium. In some embodiments the at least one second track may be configured to steer or constrain the motion of the second body portion causing increased relative rotation between the first body portion and the second body portion as the energy generating device descends or ascends through a medium. In various embodiments the at least one second force input structure may be configured to cause increased relative rotation between the first body portion and the second body portion when the at least one second force input structure receives a force from the impinging medium. In some embodiments the at least one first force input structure may include a rotor and the at least one second force input structure may include a rotor. In various embodiments the at least one first force input structure may include a rotor. In some exemplary embodiments the second body portion may include at least one magnet and the first body portion may include at least one coil, the at least one magnet and the at least one coil being a portion of the electrical generator. In some embodiments the second body portion may include at least one coil and the first body portion may include at least one magnet, the at least one coil and the at least one magnet being a portion of the electrical generator. In accordance with various exemplary embodiments the energy generating device may further include at least one buoyancy modulator configured to selectively change the buoyancy of the energy generating device. In some exemplary embodiments the at least one buoyancy modulator may include at least one ballast tank. In some embodiments the at least one buoyancy modulator may include at least one inflatable member. In accordance with various exemplary embodiments the energy generating device may further include at least one pump or other gas compression member configured to fill at least one compressed gas tank. In accordance with various exemplary embodiments the energy generating device may further include at least one compressor pump configured to fill at least one compressed gas tank. In accordance with various exemplary embodiments the energy generating device may further include at least one pump or other gas compression member configured to fill at least one compressed gas tank. In accordance with some exemplary embodiments the energy generating device may further include at least one compressor pump configured to fill at least one compressed gas tank. In some embodiments the at least one second force input structure may include a helix or helical rotor. In some embodiments the at least one first force input structure may include a helix or helical rotor. In some embodiments, an energy generating device may further include at least one pump or other gas compression member configured to fill at least one compressed gas tank. In some exemplary embodiments, an energy generating device may further include at least one compressor pump configured to fill at least one compressed gas tank. In some exemplary embodiments, an energy generating device may additionally include a vessel. In some exemplary embodiments of an energy generating device the vessel may include a linear vessel. In some exemplary embodiments of an energy generating device the vessel may include a nonlinear vessel. In some embodiments the vessel is configured to contain a medium.

Further, various exemplary embodiments may relate to a method of generating electricity. The method may include causing an energy generating device, having a first body portion and a second body portion configured to counter rotate with each other, to descend in a medium under the force of gravity. The method may further include causing relative rotation between the first body portion and the second body portion by configuring the at least one track to steer or constrain the motion of one or both of the first body portion and the second body portion. Further, the method may include generating electricity by providing magnets and conductive coils on the first body portion and the second body portion, the magnets causing an electrical current in the conductive coils as they bypass one another. Further still, the method may include increasing the buoyancy of the energy generating device causing the energy generating device to ascend.

Further still, various exemplary embodiments may relate to a method of generating electricity. The method may include increasing the buoyancy of an energy generating device causing the energy generating device to ascend in a medium. The method may further include causing relative rotation between the first body portion and the second body portion by providing contact between the at least one track and one or both of the first body portion and the second body portion, thereby steering or constraining the motion of one or both of the first body portion and second body portion. Further still the method may include reversing polarity of the outputs of an electrical generator. The method may further include generating electricity by providing magnets and conductive coils on the first body portion and the second body portion, the magnets causing an electrical current in the conductive coils as they bypass one another.

Further still, various exemplary embodiments may relate to a method of manufacturing an energy generating device. The method may include producing, from suitable materials, a first body portion. The method may further include producing, from suitable materials, a second body portion. The method may further include producing, from suitable materials, at least one track. Further, the method may include coupling the at least one track to the first body portion in a configuration to steer or constrain the motion of one or both of the first body portion and second body portion. Further still, the method may include assembling the first body portion with the second body portion in a configuration to enable relative rotation between the first body portion and the second body portion. Further still, the method may include assembling an electrical generator in a configuration to use the relative motion between the first body portion and the second body portion to generate electricity. In various exemplary methods of manufacture, the first body portion and the second body portion may be configured to descend through a medium at least partially under the force of gravity or ascend through the medium at least partially by buoyant forces in such a way that the one or more track steers or constrains the motion of the one or both of the first body portion and the second body portion causing relative rotation between the first body portion and the second body portion. In accordance with various exemplary embodiments, an energy generating device may include a buoyancy modulator. In accordance with various exemplary embodiments, a buoyancy modulator may include at least one chemical converter configured to convert one or more input chemicals into one or more output chemicals. In some embodiments, the chemical converter may be configured to convert one or more chemicals to methane. In some exemplary embodiments, the buoyancy modulator may include at least one matter phase converter configured to convert a substance from one phase of matter to another. In some embodiments the matter phase converter may be configured to convert matter between a liquid phase and a gas phase. In some embodiments the matter phase converter is configured to convert matter between a solid phase and a gas phase. In some embodiments the matter phase converter is configured to convert matter between a liquid phase and a solid phase. In accordance with various exemplary embodiments, an energy generating device may additionally include at least one density modulator configured to selectively change the density of the energy. In accordance with various exemplary embodiments, an energy generating device may additionally include at least one density modulator configured to selectively change the density of the medium in which the energy generating device is located. In some embodiments the source of gravity may be a massive astronomical body. In some embodiments the source of gravity may be an artificial gravity generator. Various exemplary embodiments may relate to a method of creating energy. The method may include creating artificial gravity using an artificial gravity generator and harvesting the buoyancy potential energy of the gravity using an energy generating device. The method may include creating artificial gravity using an artificial gravity generator and harvesting the gravitational potential energy of the gravity using an energy generating device. The method may include creating artificial gravity using an artificial gravity generator and harvesting the potential energy of the gravity using an energy generating device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a schematic diagram of an exemplary embodiment of an energy generating device shown descending and ascending.

FIG. 2 is a schematic diagram of an exemplary embodiment of an energy generating device shown descending and ascending.

FIG. 3 is a schematic diagram of an exemplary embodiment of an energy generating device having a helical screw-type torque generator on the outer surface and an inner body also having a helical screw-type torque generator on its surface.

FIG. 4 is a schematic diagram of an exemplary embodiment of an energy generating device attached to a pendulum.

FIG. 5 is a schematic diagram of select components of an exemplary embodiment of an aerial energy generating device.

FIG. 6A is a schematic side view of an exemplary embodiment of an energy generating device having a dual rotor configuration.

FIG. 6B is a schematic perspective view of an exemplary embodiment of an energy generating device having a dual rotor configuration.

FIG. 6C is a schematic exploded side view of an exemplary embodiment of an energy generating device having a dual rotor configuration.

FIG. 6D is a schematic exploded rear perspective view of an exemplary embodiment of an energy generating device having a dual rotor configuration.

FIG. 6E is a schematic exploded front perspective view of an exemplary embodiment of an energy generating device having a dual rotor configuration.

FIG. 6F is a schematic perspective view of inner helical rotors and magnets of the inner body portion of an exemplary embodiment of an energy generating device.

FIG. 6G is two schematic side perspective views of an exemplary embodiment of a wireless energy generating device having a wireless docking system to send and receive energy.

FIG. 7A is a schematic side perspective view and a schematic far side view of an exemplary energy generating device having a hybrid buoyancy and lift system.

FIG. 7B is a schematic close up transparent view of an exemplary energy generating device having a hybrid buoyancy and lift system.

FIG. 7C is a schematic perspective side view of an exemplary energy generating device having a hybrid buoyancy and lift system using heated air for lift.

FIG. 7D is a schematic perspective view of an exemplary energy generating device having a hybrid buoyancy and lift system using redirected wind for lift.

FIG. 8 is a schematic diagram of an exemplary embodiment of an energy generating device having waterwheel-like rotors.

FIG. 9 is a flow diagram of an exemplary method of generating energy.

FIG. 10 is a flow diagram of an exemplary method of generating energy.

FIG. 11 is a flow diagram of an exemplary method of manufacturing an energy generating device.

FIG. 12A is a schematic side view of an exemplary embodiment of an energy generating device having a fixed track.

FIG. 12B is a schematic exploded side view of an exemplary embodiment of an energy generating device having a fixed track.

FIG. 13 is a generalized block diagram of an exemplary energy generating device system in accordance with exemplary embodiments.

FIG. 14A is a schematic of an exemplary embodiment of an energy generating device having a fixed helical outer track.

FIG. 14B is a partial cutaway perspective schematic view of an exemplary embodiment of an energy generating device having a fixed helical outer track.

FIG. 14C is a partial perspective schematic view of an exemplary embodiment of an energy generating device having a fixed helical outer track.

FIG. 14D is a partial perspective schematic view of an exemplary embodiment of an energy generating device having a fixed helical outer track and indicating a direction of rotation.

FIG. 15A is three schematic side views of a straight inner track and a twisted screw-like inner track of an exemplary embodiment of an energy generating device.

FIG. 15B is three schematic perspective views of a straight inner track and three schematic perspective views of a twisted screw-like inner track of an exemplary embodiment of an energy generating device.

FIG. 15C is a schematic perspective view of a cable bundle of an exemplary embodiment of an energy generating device.

FIG. 15D is several schematic perspective views of a straight inner track of an exemplary embodiment of an energy generating device having coiled or non-coiled conductive wires.

FIG. 16A is a schematic partial perspective extruded cutaway view of select members of an exemplary embodiment of an energy generating device

FIG. 16B is three schematic partial perspective extruded cutaway views of select members of an exemplary embodiment of an energy generating device having coiled or non-coiled conductive wires.

FIG. 16C is a schematic diagram of an exemplary embodiment of an energy generating device having non-coiled conductive wires.

FIG. 17 is a flow diagram of an exemplary method of generating energy.

FIG. 18 is a flow diagram of an exemplary method of generating energy.

FIG. 19 is a flow diagram of an exemplary method of manufacturing an energy generating device.

FIG. 20A is two schematic side views of an exemplary embodiment of an energy generating device having a torque generator including outer tracks and an inner rolling fluid turbine, shown ascending.

FIG. 20B is a schematic side view of an exemplary embodiment of an energy generating device having a torque generator including outer tracks and an inner rolling fluid turbine, shown descending.

FIG. 21A is three schematic perspective views of an exemplary embodiment of an energy generating device including a linear vessel.

FIG. 21B is a schematic view of a linear vessel of an energy generating device side by side with a schematic view of a nonlinear vessel of an energy generating device.

FIG. 22A is a schematic side perspective view of an exemplary embodiment of an energy generating device having two toroidal rotors.

FIG. 22B is another schematic perspective view of the exemplary embodiment of the energy generating device of FIG. 22A having two toroidal rotors.

FIG. 22C is a schematic perspective view of an exemplary embodiment of an energy generating device having a single toroidal rotor.

FIG. 23A is a front view schematic diagram and a side view schematic diagram of a linear generator of an exemplary embodiment of an energy generating device driven by transverse galloping and vortex shedding.

FIG. 23B is a schematic diagram of an exemplary embodiment of an energy generating device having a linear generator driven by transverse galloping and vortex shedding.

FIG. 24A is a front view schematic diagram and a side view schematic diagram of a linear generator of an exemplary embodiment of an energy generating device driven by aeroelastic fluttering.

FIG. 24B is a schematic diagram of an exemplary embodiment of an energy generating device having a linear generator driven by aeroelastic fluttering.

FIG. 24C is a schematic diagram top view of an exemplary embodiment of an energy generating device having a curvilinear track.

FIG. 24D is a schematic diagram bottom view of an exemplary embodiment of an energy generating device having a curvilinear track.

FIG. 24E is a schematic diagram side perspective view of an exemplary embodiment of an energy generating device having a curvilinear track.

FIG. 24F is a schematic diagram of an exemplary embodiment of an energy generating device having a chaotic generator.

FIG. 25A is two schematic partial perspective side views of an exemplary embodiment of an energy generating device having inner rotors and outer tracks.

FIG. 25B is a schematic perspective partial side view of an exemplary embodiment of an energy generating device having inner rotors and outer tracks.

FIG. 25C is a schematic perspective view of select members of an exemplary embodiment of an energy generating device.

FIG. 25D is a schematic perspective side view of select members of an exemplary embodiment of an energy generating device.

FIG. 25E is a schematic perspective close up view of select members of an exemplary embodiment of an energy generating device.

FIG. 25F is a schematic perspective transparent view of select members of an exemplary embodiment of an energy generating device.

FIG. 25G is a schematic bottom perspective view of an exemplary embodiment of an energy generating device having a torque generator including outer tracks and inner rotors.

FIG. 26A is a top view schematic diagram of a linear generator of an exemplary embodiment of an energy generating device and a top view schematic diagram of an exemplary embodiment of an energy generating device having a linear generator driven by rotors.

FIG. 26B is a side view schematic diagram of an exemplary embodiment of an energy generating device having a linear generator driven by rotors.

FIG. 27A is a schematic bottom perspective view of an exemplary embodiment of an energy generating device having a torque generator including inner and outer tracks.

FIG. 27B is a schematic side perspective view of an exemplary embodiment of an energy generating device having a torque generator including inner and outer tracks, and a schematic side view of an internal wireless electricity system.

FIG. 28A is a schematic side view of an exemplary embodiment of an energy generating device having a torque generator including an inner track and outer rotors

FIG. 28B is a top schematic view and a side schematic view of an exemplary embodiment of an energy generating device having a torque generator including an inner track and outer rotors

FIG. 28C is a schematic top perspective view of an exemplary embodiment of an energy generating device having a torque generator including an inner track and outer rotors.

FIG. 28D is a schematic side perspective view of an exemplary embodiment of an energy generating device having a torque generator including an inner track and outer rotors, and a schematic transparent side view of internal conductive coils and magnets.

FIG. 28E is a schematic side perspective view of an exemplary embodiment of an energy generating device having a torque generator including an inner track and outer rotors, and a schematic side view of an internal wireless electricity system.

FIG. 29A is a schematic partial near side perspective view of an exemplary embodiment of an energy generating device having an electrical connection to municipal power lines.

FIG. 29B is a schematic partial far top perspective view of an exemplary embodiment of an energy generating device having an electrical connection to municipal power lines.

FIG. 29C is a schematic far side perspective view of an exemplary embodiment of an energy generating device having an electrical connection to municipal power lines.

FIG. 29D is a schematic perspective view of an exemplary embodiment of an energy generating device having a single buoyancy modulator and several outer rotors and several inner tracks.

FIG. 30 is an exemplary embodiment of an energy generating device having a transporter.

FIG. 31A is a schematic side perspective view of an exemplary embodiment of an energy generating device having a torque generator including an outer track and inner rotors.

FIG. 31B is two schematic side perspective views of an exemplary embodiment of an energy generating device having a torque generator including an outer track and inner rotors.

FIG. 31C is a schematic side perspective view of an exemplary embodiment of an energy generating device having a torque generator including an outer track and inner rotors, and a schematic side view of an internal wireless electricity system.

FIG. 32A is a schematic perspective side view of an exemplary embodiment of an energy generating device having Tesla turbines.

FIG. 32B is a transparent schematic view and an exploded view of a Tesla turbine-driven electrical generator of an energy generating device.

FIG. 32C is a schematic perspective rear view of an exemplary embodiment of an energy generating device having Tesla turbines and a far view of an exemplary embodiment of an energy generating device docked to a seafloor buoyancy modulation and power storage system.

FIG. 32D is a schematic side view of a seafloor buoyancy modulation and power storage system including a cut away view of a seafloor compression pump.

FIG. 32E is a close up schematic side view of a seafloor buoyancy modulation and power storage system including a cut away view of a seafloor compression pump.

FIG. 32F is a schematic perspective front view of an exemplary embodiment of an energy generating device having Tesla turbines.

FIG. 32G is a schematic perspective side view of an exemplary embodiment of an energy generating device docked to a waterside buoyancy modulation and power storage system.

FIG. 32H is a schematic front perspective view of an exemplary embodiment of an energy generating device docked to a waterside buoyancy modulation and power storage system.

FIG. 33A is a schematic side perspective view of an exemplary embodiment of an energy generating device having two rotors.

FIG. 33B is a schematic transparent side view of an exemplary embodiment of an energy generating device.

FIG. 33C is several schematic views of exemplary embodiments of an energy generating device including an energy storage system such as a battery.

FIG. 33D is a schematic front perspective view of an exemplary embodiment of an energy generating device, having a USB output and a schematic front perspective view of an exemplary embodiment of an energy generating device, having an outlet output.

FIG. 33E is several schematic side views of an exemplary embodiment of an energy generating device having an aerial member depicted at several heights.

FIG. 33F is two schematic perspective views of an exemplary embodiment of an energy generating device configured to output energy to electric vehicles.

FIG. 33G is several schematic perspective views of an exemplary embodiment of an energy generating device configured to output energy to electric vehicles.

FIG. 33H is a schematic near perspective view of several exemplary embodiments of an energy generating device configured to output energy to several separate locations in a remote off grid refugee camp.

FIG. 33I is a schematic far perspective view of several exemplary embodiments of an energy generating device configured to output energy to several separate locations in a remote off grid refugee camp.

FIG. 33J is three schematic side views of three exemplary embodiments of three energy generating devices, each having two rotors.

FIG. 33K is three schematic perspective views of three exemplary embodiments of three energy generating devices.

FIG. 33L is a schematic side view of a rope of an exemplary embodiment of an energy generating device.

FIG. 33M is a schematic perspective view of an exemplary embodiment of an energy generating device having a rope and attached rechargeable battery unit.

FIG. 33N is an exemplary embodiment of an energy generating device having a gravity battery.

FIG. 33O is a schematic side perspective view of an exemplary embodiment of an energy generating device having some ground based members.

FIG. 33P is several schematic perspective views of an exemplary embodiment of a wearable energy generating device.

FIG. 33Q is a schematic perspective view of an exemplary embodiment of a wearable energy generating device depicted transparent on the right and not transparent on the left.

FIG. 33R is a schematic perspective view of a safety unit of an exemplary embodiment of an energy generating device.

FIG. 34A is two schematic far side views of an exemplary embodiment of an energy generating device, each having some members outside of an aerial member.

FIG. 34B is a schematic transparent close up side view of an exemplary embodiment of an energy generating device having an electrical generator outside of an aerial member.

FIG. 34C is two schematic far side views of an exemplary embodiment of an energy generating device, each having some members outside of a marine member.

FIG. 35A is a schematic perspective view of an exemplary embodiment of an aeronautical energy generating device having a top aeronautical member.

FIG. 35B is a schematic perspective view of an exemplary embodiment of an aeronautical energy generating device having a bottom aeronautical member.

FIG. 35C is a schematic perspective view of an exemplary embodiment of an aeronautical energy generating device with a partially cut away wall.

FIG. 35D is a schematic far side view and a schematic partially cut away close up view of an exemplary embodiment of an aeronautical energy generating device.

FIG. 35E is several schematic perspective views of an exemplary embodiment of an aeronautical energy generating device.

FIG. 35F is a schematic cut away partial perspective view of an exemplary embodiment of an aeronautical energy generating device.

FIG. 36A is three schematic views of an exemplary embodiment of an energy generating device, having a set of members to stabilize its orientation.

FIG. 36B is a schematic partial perspective view of an exemplary embodiment of an energy generating device, having a set of members to stabilize its orientation.

FIG. 36C is a schematic view of an exemplary embodiment of an energy generating device configured to generate oxygen underwater or in space, and a schematic view of a wearable embodiment of an energy generating device configured for underwater use.

FIG. 36D is a schematic view of an exemplary embodiment of an energy generating device configured to generate oxygen underwater or in space, and two schematic views of two wearable embodiments of an energy generating device configured for underwater use or use in space.

FIG. 36E is a schematic view of an exemplary embodiment of a wearable energy generating device configured for use in space or low oxygen environments.

FIG. 37A is a schematic side view of an exemplary embodiment of an orbital energy generating device or an outer space energy generating device.

FIG. 37B is a schematic perspective view of an exemplary embodiment of an orbital energy generating device or an outer space energy generating device, having a partially cut away vessel.

FIG. 37C is a schematic cross section view of an exemplary embodiment of an orbital energy generating device or an outer space energy generating device.

FIG. 37D is a schematic cross section view of an exemplary embodiment of an orbital energy generating device or an outer space energy generating device.

FIG. 37E is a schematic perspective view of an exemplary embodiment of an orbital energy generating device or an outer space energy generating device, and a schematic perspective view of an exemplary embodiment of an energy generating device having an artificial gravity generator.

FIG. 38 is three schematic perspective views of an exemplary embodiment of an energy generating device, having an artificial gravity generator.

FIG. 39 is a close-up partial cut away schematic view of a magnetic bearing and wireless electricity transfer system of an exemplary embodiment of an energy generating device.

FIG. 40 is two perspective schematic views of an exemplary embodiment of an energy generating device having a material harvesting unit and a manufacturing and assembly unit.

FIG. 41A is a perspective schematic view of an exemplary embodiment of an energy generating device including an artificial gravity generator.

FIG. 41B is a perspective schematic view of an exemplary embodiment of an energy generating device including an artificial gravity generator, as well as eight zoomed in schematic side views of various select exemplary configurations of an energy generating device.

FIG. 42A is a flow diagram of an exemplary method of harvesting the buoyancy potential energy of artificial gravity using an energy generating device.

FIG. 42B is a flow diagram of an exemplary method of harvesting the gravitational potential energy of artificial gravity using an energy generating device.

FIG. 42C is a flow diagram of an exemplary method of harvesting the potential energy of artificial gravity using an energy generating device.

### DETAILED DESCRIPTION

In the following detailed description, reference is made to the accompanying drawings, which form a part hereof. In the drawings, similar symbols typically identify similar components or members, unless context dictates otherwise. The illustrative embodiments described in the detailed description, drawings, and claims are not meant to be limiting. Other embodiments may be utilized, and other changes may be made, without departing from the spirit or scope of the subject matter presented here.

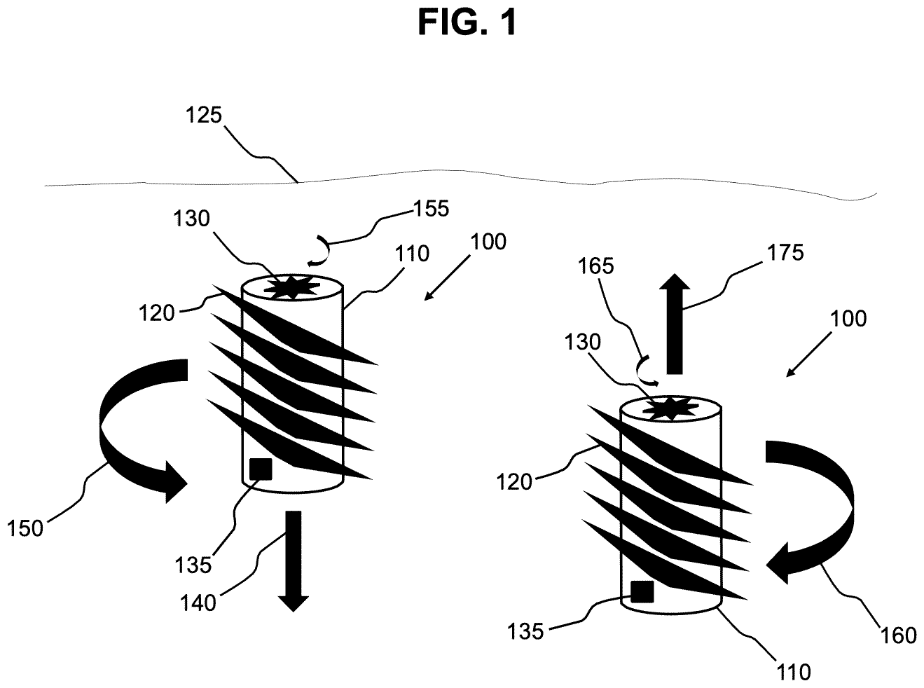

Referring now to FIG. 1, an exemplary embodiment of an energy generating device 100 having an outer first body portion 110 may include one or more first force input structure, which may be one or more torque generator, which may be helical rotor 120 or other torque generators such as but not limited to toroidal rotors, bladeless rotors, rotors, and the like. Energy generating device 100 may be used in any of a variety of fluid, semifluid or viscous medium, such as a gas or liquid medium, for example, water 125 which may be a lake or an ocean or any other body or assembly of water. As energy generating device 100 is dropped into water 125, energy generating device 100 or a buoyancy modulator coupled to outer first body portion 110 such as a ballast system 135 may be weighted with ballast such as water such that energy generating device 100 begins to descend. During descent, water may impinge on helical rotor 120, which may put a torque on outer first body portion 110. An inner second body portion 130 may be located concentrically with outer first body portion 110 and may be coupled to outer first body portion 110 by one or more bearings or other rotational members within outer first body portion 110 such that outer first body portion 110 may rotate relative to inner second body portion 130 in a direction 150, when torque is generated by helical rotor 120 as gravity pulls energy generating device 100 through water 125 in direction 140. Inner second body portion 130 may be placed in a pass through of outer first body portion 110. In some embodiments, inner second body portion 130 may also include a second force input structure such as a helical rotor or turbine or other torque generator which tends to turn inner second body portion 130 in a direction 155 as gravity pulls energy generating device 100 through water 125. An electrical generator, which may be a unidirectional rotational generator or any other generator that produces direct current, or a bidirectional rotational generator or oscillating generator or any other generator that produces alternating current, or a chaotic generator that produces chaotic current, may be configured to use the relative motion between a first body portion such as outer first body portion 110 and a second body portion such as inner second body portion 130 to generate electricity. As energy generating device 100 descends through water 125, inner second body portion 130 turns relative to outer first body portion 110. One or more magnets and conductive coils may be mounted within outer first body portion 110 and on inner second body portion 130 creating changing magnetic fields in the conductive coils generating electrical energy. In various embodiments the current may be supplied through a conducting tether, or wirelessly, or connected by other conductive member, to a storage or use facility, or stored in a battery, or supplied to on-board electrical systems.

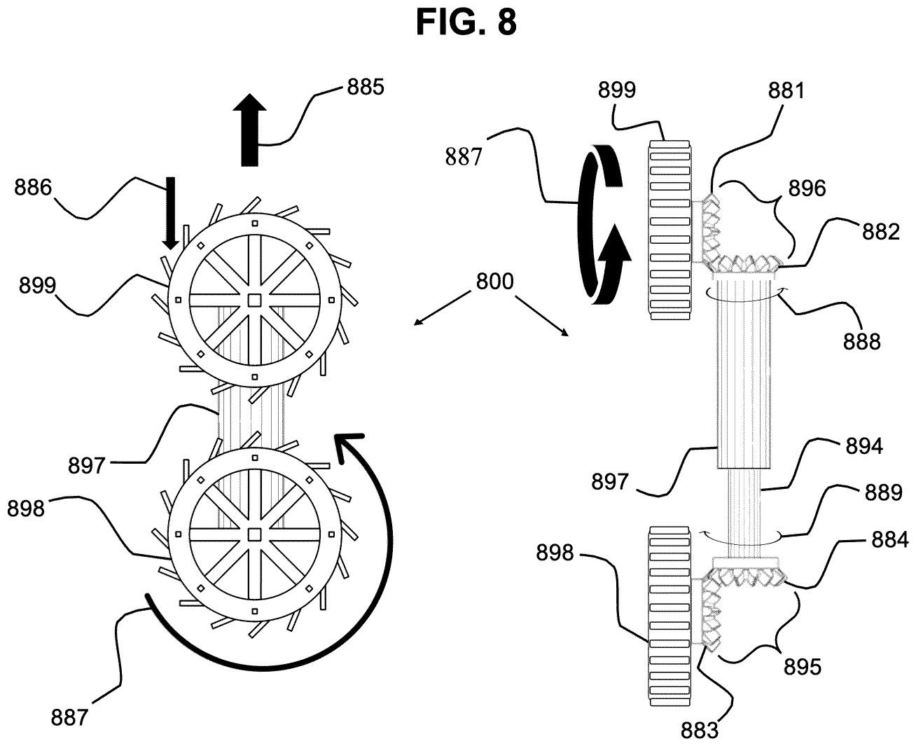

At a specified depth, compressed gas, which may be air or other compressed gas, may be expanded into a buoyancy modulator, for example, the ballast tanks of ballast system 135 on board energy generating device 100, thereby purging the ballast water. With the ballast water purged from the ballast tanks of ballast system 135, energy generating device 100 becomes buoyant and begins rising to the surface of water 125. As energy generating device 100 rises in direction 175, helical rotor 120 may begin to rotate in a direction 160 and inner second body portion 130 may begin to rotate in an opposite direction 165. As outer first body portion 110 and inner second body portion 130 rotate, electrical energy is generated. In accordance with various exemplary embodiments, as energy generating device 100 begins to ascend and the helical rotor 120 and the inner second body portion 130 begin to rotate in opposite directions, a switch unit may cause the polarity of the output to reverse, so that electrical energy is stored with the same polarity as when electrical energy generating device 100 descends. Alternatively, a rectifier may be used to ensure that the current output is the same regardless of the direction of rotation of force input structures. Alternatively, the switching of polarity can be avoided by having electrical energy generating device 100 rotate 180° end to end for the ascent. In that way, electrical energy generating device 100 is in the same orientation relative to the direction of travel during both the descent and ascent. Alternatively, as depicted in FIG. 8, a force translation mechanism such as a rotation translation mechanism may be included in addition to or in place of the polarity switching device and the 180° rotation.

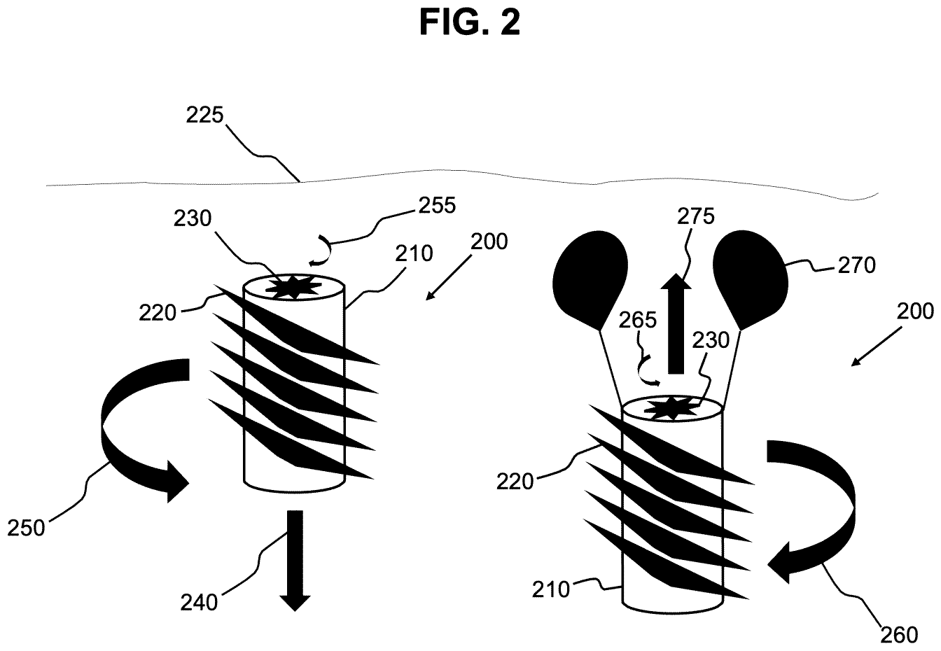

Referring now to FIG. 2, another embodiment of an energy generating device 200 having an outer first body portion 210 may include one or more first force input structures which may be helical rotor 220 or other torque generators such as but not limited to rotors and the like. Energy generating device 200 may be used in any of a variety of medium for example water 225 which may be a lake or an ocean or any other body of water or in air such as in the atmosphere or in any other fluid or semifluid or viscous medium. As energy generating device 200 is dropped into water 225 its weight may be such that energy generating device 200 begins to descend. During descent, water impinges on helical rotor 220 putting a torque on outer first body portion 210. An inner second body portion 230, which may be located within a pass through of outer first body portion 210, may contain a second force input structure such as rotors and may be located substantially concentrically with outer first body portion 210 and be coupled together by one or more bearings or other rotational member within outer first body portion 210 such that outer first body portion 210 may rotate relative to inner second body portion 230 in a direction 250, when torque is generated by helical rotor 220 as gravity pulls energy generating device 200 through water 225 substantially in direction 240. In some embodiments, inner second body portion 230 may also include a helical rotor or turbine or other torque generator which tends to turn inner second body portion 230 substantially in a direction 255 as gravity pulls energy generating device 200 through water 225 substantially in direction 240. An electrical generator may be configured to use the relative motion between the outer first body portion 210 and the inner second body portion 230 to generate electricity. As energy generating device 200 descends through water 225, inner second body portion 230 may turn relative to outer first body portion 210. Magnets and conductive coils may be mounted within outer first body portion 210 and on inner second body portion 230 creating changing magnetic fields in the conductive coils generating electrical energy. In various embodiments the current may be supplied through a conducting tether, or wirelessly, or connected by other conductive member, to a storage or use facility, or stored in a battery, or supplied to on-board electrical systems.

At a specified depth, compressed gas, which may be air or other compressed gas, is expanded into one or more buoyancy modulators such as one or more inflatable buoyancy modulator 270 which are inflated thereby. With buoyancy modulators such as one or more inflatable buoyancy modulator 270 inflated, energy generating device 200 becomes buoyant and begins rising to the surface of water 225. As energy generating device 200 rises, helical rotor 220, which may be coupled to outer first body portion 210 begins to rotate in an opposite direction 260 and inner second body portion 230 begins to rotate in an opposite direction 265. As outer first body portion 210 and inner second body portion 230 rotate, electrical energy is generated. In various other exemplary embodiments, rather than a liquid such as water, an exemplary embodiment may be configured for use in a different fluid, semifluid or viscous medium. For example, energy generating device 200 may be configured to rise to an altitude in the atmosphere during which helical rotor 220 and rotors coupled to inner second body portion 230 may be turned by impinging air or other fluid, semifluid or viscous medium. In such an embodiment, one or more buoyancy modulator such as one or more inflatable buoyancy modulator 270 may be configured as reusable balloons that help rise energy generating device 200 in a direction 275 to an altitude, before they are retracted and the gas within, which is gas lighter than the surrounding medium such as gas lighter than air (e.g., helium, or hydrogen, or the like), is recompressed into compressed gas tanks on board energy generating device 200, causing energy generating device 200 to begin to descend, during which descending, helical rotor 220 and rotors coupled to inner second body portion 230 may be turned by an impinging gas such as air.

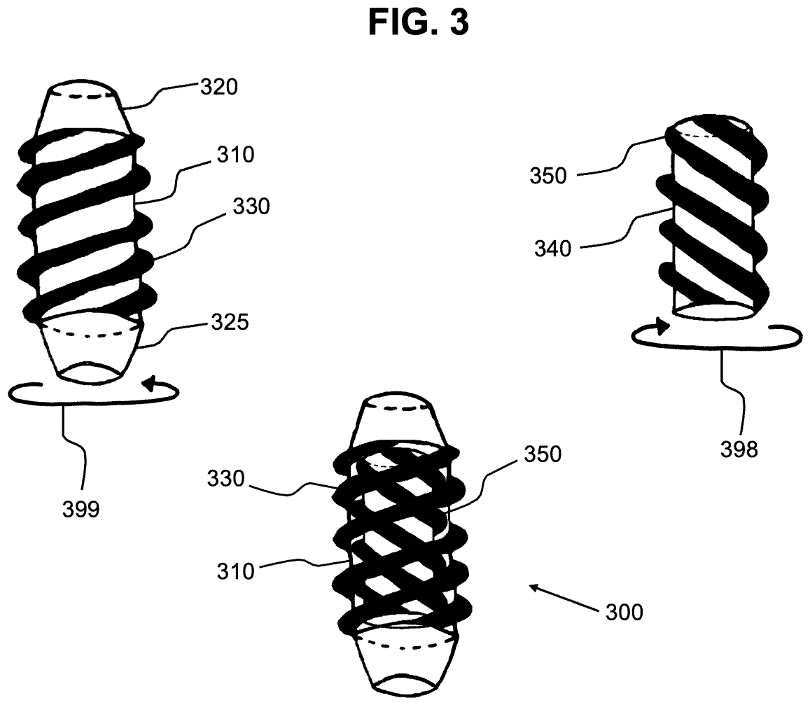

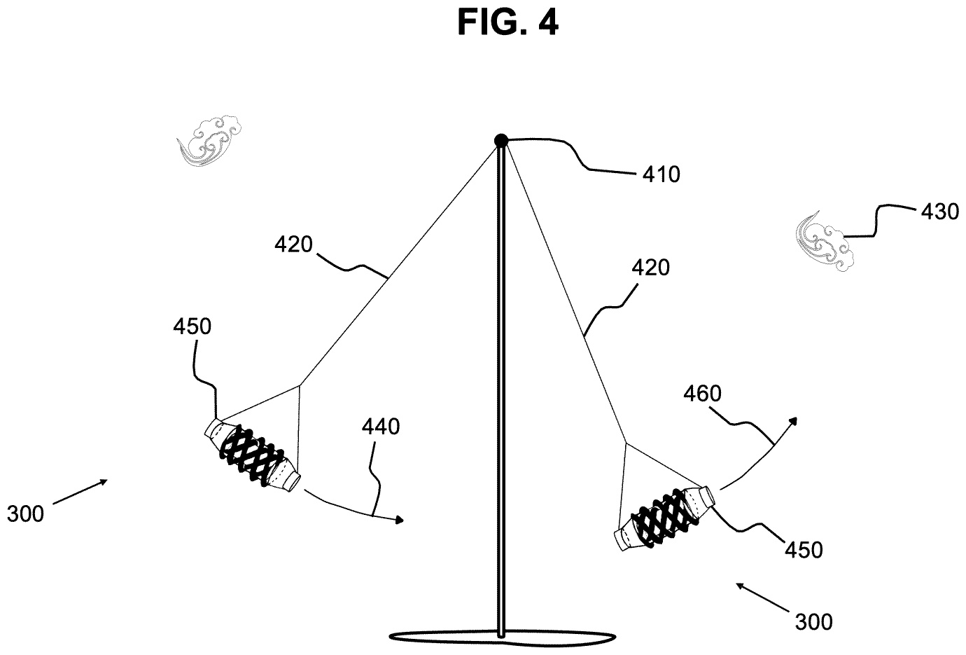

Referring now to FIG. 3 and FIG. 4, another exemplary embodiment of an energy generating device 300 is depicted. Energy generating device 300 is depicted as including a substantially cylindrical outer first body portion 310 with frustoconical shaped end 320 and frustoconical shaped end 325. Outer first body portion 310 is coupled to a first force input structure which may be a helical rotor 330 which winds around outer first body portion 310 in a screw-like manner. Within the interior of a pass through of outer first body portion 310 may be a substantially cylindrical inner second body portion 340 that may be rotatable relative to outer first body portion 310. In accordance with an exemplary embodiment, inner second body portion 340 may include a second force input structure such as helical rotor 350 that winds around inner second body portion 340 in a screw-like manner but in a direction opposite the helical rotor 330. Energy generating device 300 is shown with outer first body portion 310 and inner second body portion 340 that are rotatable relative to each other, for example, outer first body portion may rotate substantially in direction 399 while inner second body portion may rotate substantially in direction 398. As depicted in FIG. 4, an exemplary energy generating device 300 might be configured to be coupled to a pendulum 410 via one or more bearing 450 via one or more cables 420 to travel through a fluid medium such as air 430 in an arc-like downward direction at least partly under the force of gravity such as direction 440 or an arc-like upward direction at least partly under the force of buoyancy such as direction 460. Energy generating device 300 is configured to operate with similar principles to energy generating devices 100 and 200 as depicted in FIG. 1 and FIG. 2. In particular, the relative rotation between outer first body portion 310 and inner second body portion 340 enables the generation of electrical energy with an electrical generator including magnets and conductive coils and the ability to descend through a fluid medium under the influence of gravity and ascend through a fluid medium at least partly by changes in buoyancy using a buoyancy modulator.

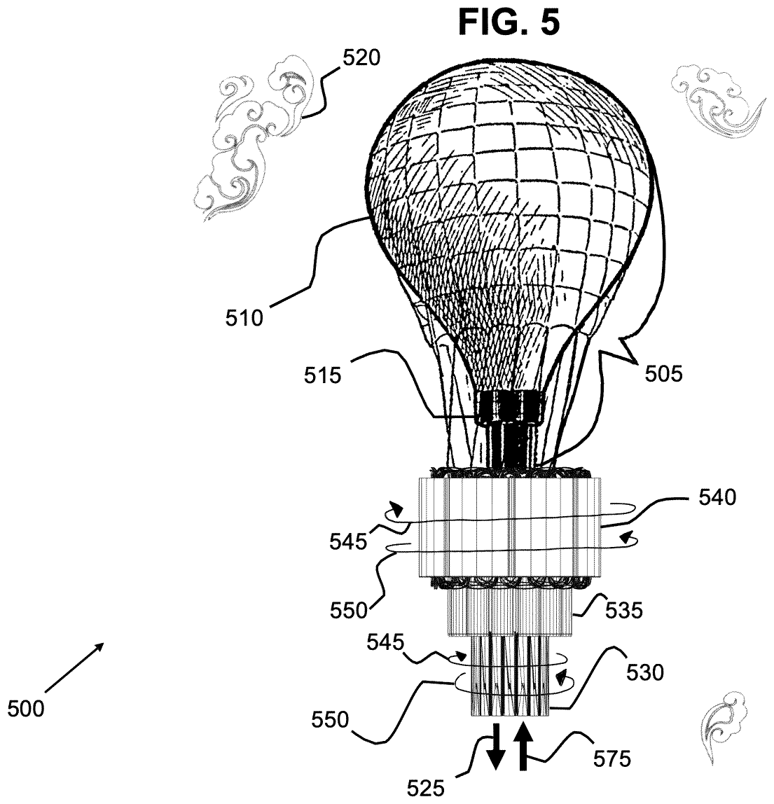

Referring now to FIG. 5, an energy generation device 500 may include a buoyancy modulator 505 that may include inflatable member 510 and a buoyancy modulator such as a chemical converter or gas compressor and gas tank 515, which may cause an energy generating device to travel through a medium 520 substantially in downward direction 525 or upward direction 575. An energy generating device may include a torque generator that causes one or more magnets 530 and one or more conductive coils 540 to rotate in opposite directions around a rotational member such as a bearing 535. For example, one or more magnets 530 may rotate substantially in direction 545 while one or more conductive coils 540 rotate around the magnets 530 substantially in direction 550. Alternatively for example, one or more magnets 530 may rotate substantially in direction 550 while one or more conductive coils 540 rotate around the one or more magnet 1610 substantially in direction 545.

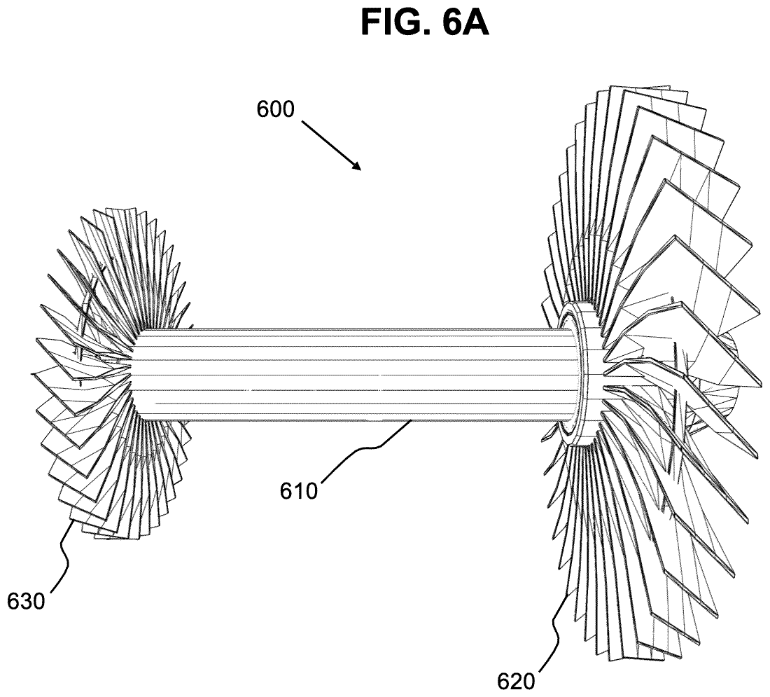

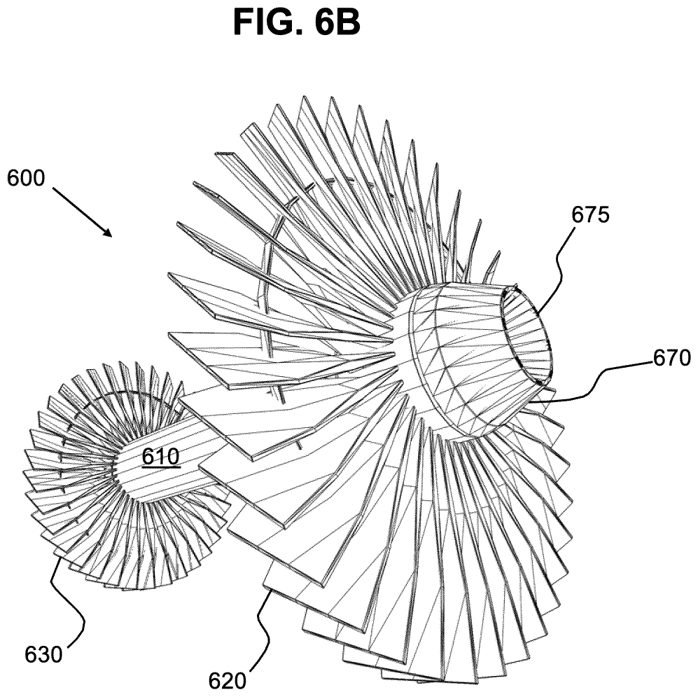

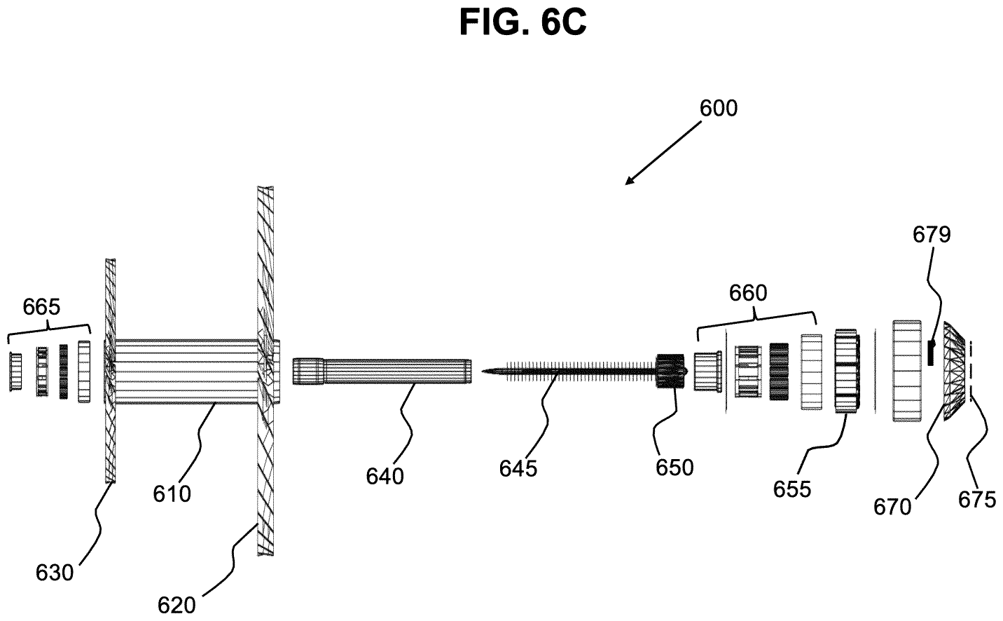

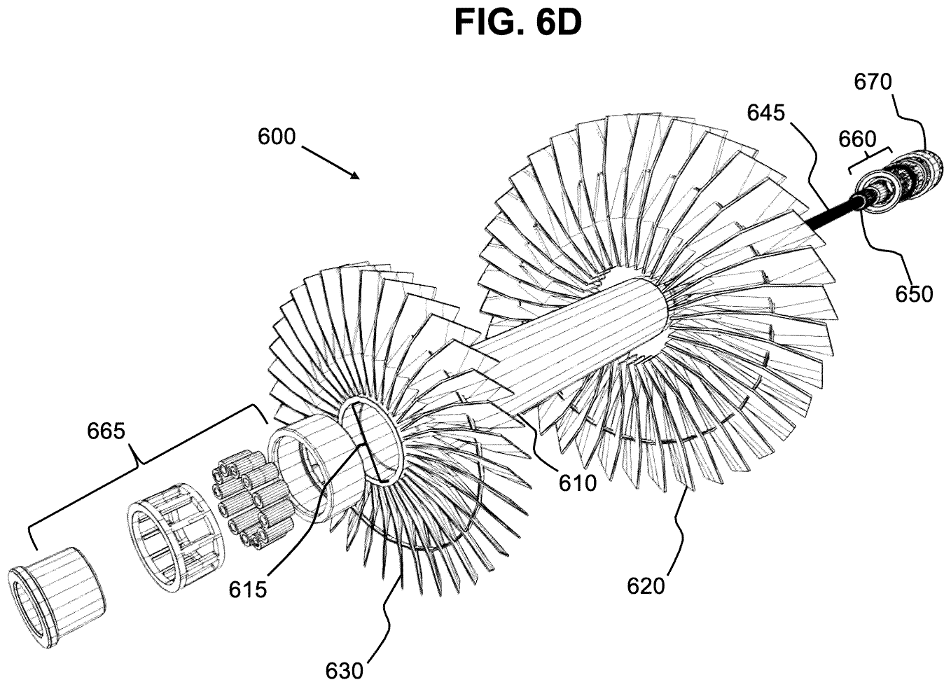

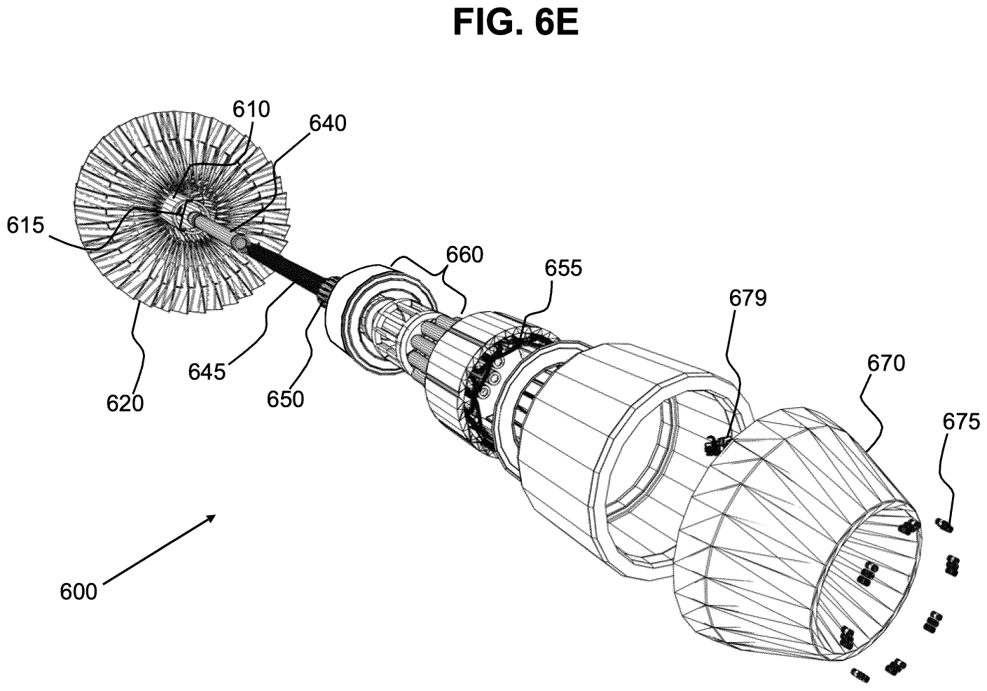

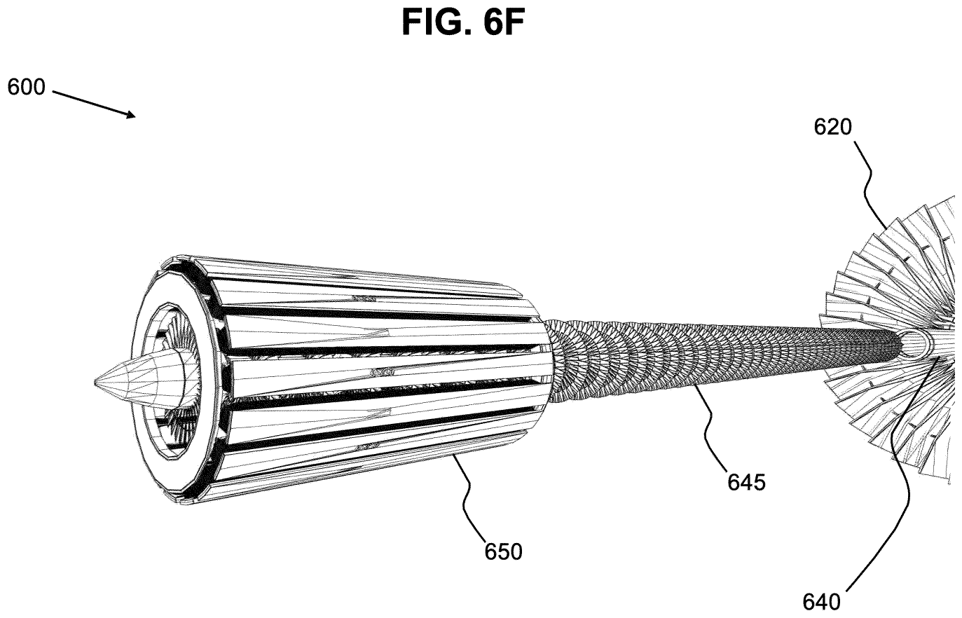

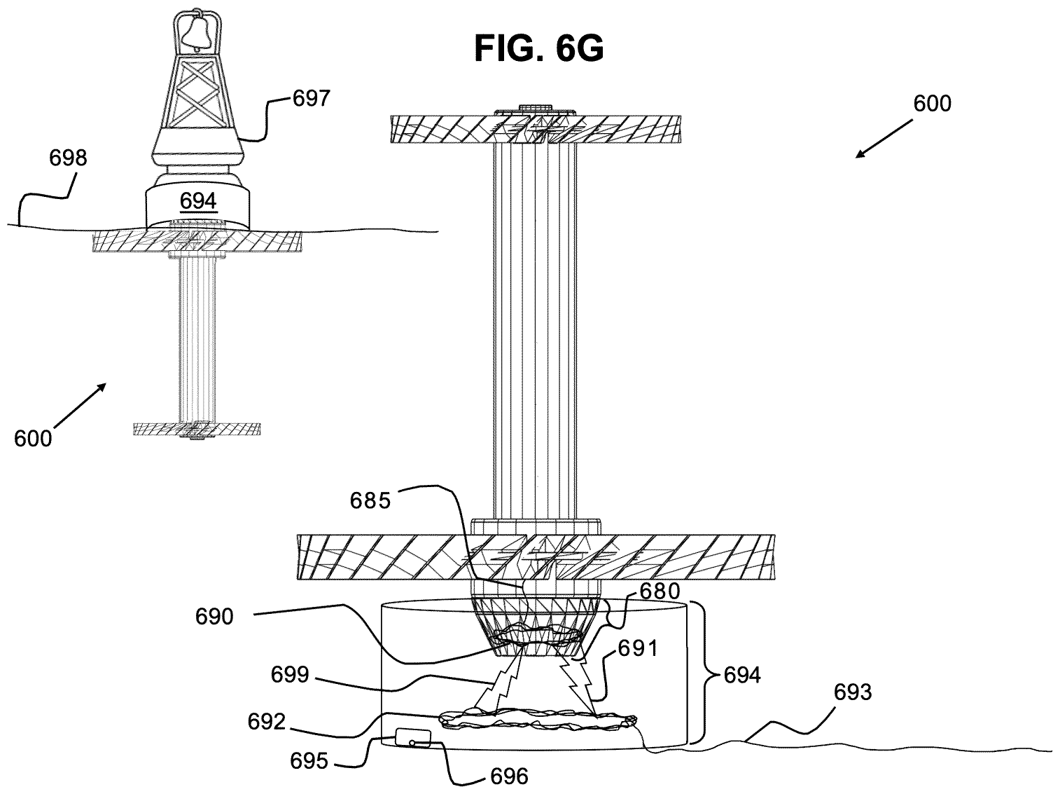

Referring now to FIGS. 6A and 6B, an exemplary embodiment of an energy generating device 600 is depicted. Energy generating device 600 is a dual rotor configuration that may include an outer first body portion 610, and a first force input structure that may include a first rotor 620, and a second rotor 630. The dual rotor configuration adds to the amount of torque created by the outer first body portion 610 as it rotates relative to an inner second body portion. As depicted, the use of a dual rotor configuration also may add to the stability of energy generating device 600 as it moves through a fluid medium.

Referring now to FIGS. 6C, 6D, and 6E, exploded views of energy generating device 600 are depicted. An inner second body portion 640 may be configured to be placed in a pass through of outer first body portion 610 and may be rotatable relative to outer first body portion 610. An inner second force input structure such as inner helix or helical rotor 645 may be coupled to inner second body portion 640 and as fluid passes over it causes one or more magnets 650 that are coupled to inner second body portion 640 to rotate relative to one or more conductive coils 655 that are coupled to outer first body portion 610. Magnets 650 may be any type of magnet, including but not limited to permanent magnets, temporary magnets, electromagnets, and superconducting magnets. One or more rotational members, which may be front bearing assembly 660 and rear bearing assembly 665, may allow relative rotation between inner second body portion 640 and outer first body portion 610 and may support inner second body portion 640 within a pass-through 615 of outer first body portion 610. Front bearing assembly 660 and rear bearing assembly 665 may be representative of any structures, such as but not limited to one or more bushings, ball bearings, roller bearings, races, or any other type of bearings or rotational members that allow inner second body portion 640 to be supported within and rotate relative to outer first body portion 610. A buoyancy modulator such as one or more ballast tank 670 may be used to take on water as ballast giving energy generating device 600 the ability to sink through the water. One or more ballast port 675 may allow fluid to move in and out of one or more ballast tank 670 via a pump or other gas compression member 679 (e.g. compressor pump).

FIG. 6F depicts some members of energy generating device 600 in a partially exploded view. Referring to FIGS. 6C, 6D and 6F, electrical energy is generated as conductive coils 655 move relative to magnets 650. In other words, an exemplary electrical generator may include magnets 650 and conductive coils 655. Inner helix or helical rotor 645 may be coupled to inner second body portion 640, which inner second body portion 640 may be configured to rotate relative to outer first body portion 610, which outer first body portion 610 may be coupled to the first rotor 620, and the second rotor 630. Front bearing assembly 660 and rear bearing assembly 665 may aid in rotatably supporting inner helix or helical rotor 645 relative to outer first body portion 610.

Referring now to FIG. 6G, an exemplary embodiment of an energy generating device is depicted. Device 600 may include a wire 685, which may be electrically coupled to one or more electrical transmitter or receiver 690, which may transmit electricity 691 to one or more electrical transmitter or receiver 692, which may be coupled to docking station 694, which may be positioned partially above the surface of a fluid such as water surface 698, for example, attached to a buoy 697, or if positioned below the surface of a fluid such as water, which may use a water discharge system such as pump 695 to pump water out of valve 696 to remove water prior to electricity transfer. One or more electrical transmitter or receiver 692 may transmit electricity to wire 693, which may transmit electrical energy to any electrical load, or a battery or other energy storage device or anywhere else electricity is needed.

When an energy generating device needs to consume energy the device may receive electricity 699 that may be transferred from any external source to electrical wire 693 to one or more electrical transmitter or receiver 692 to one or more electrical transmitter or receiver 690 to wire 685 to wherever within the device the electricity is needed. Energy generating device 600 is configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator.

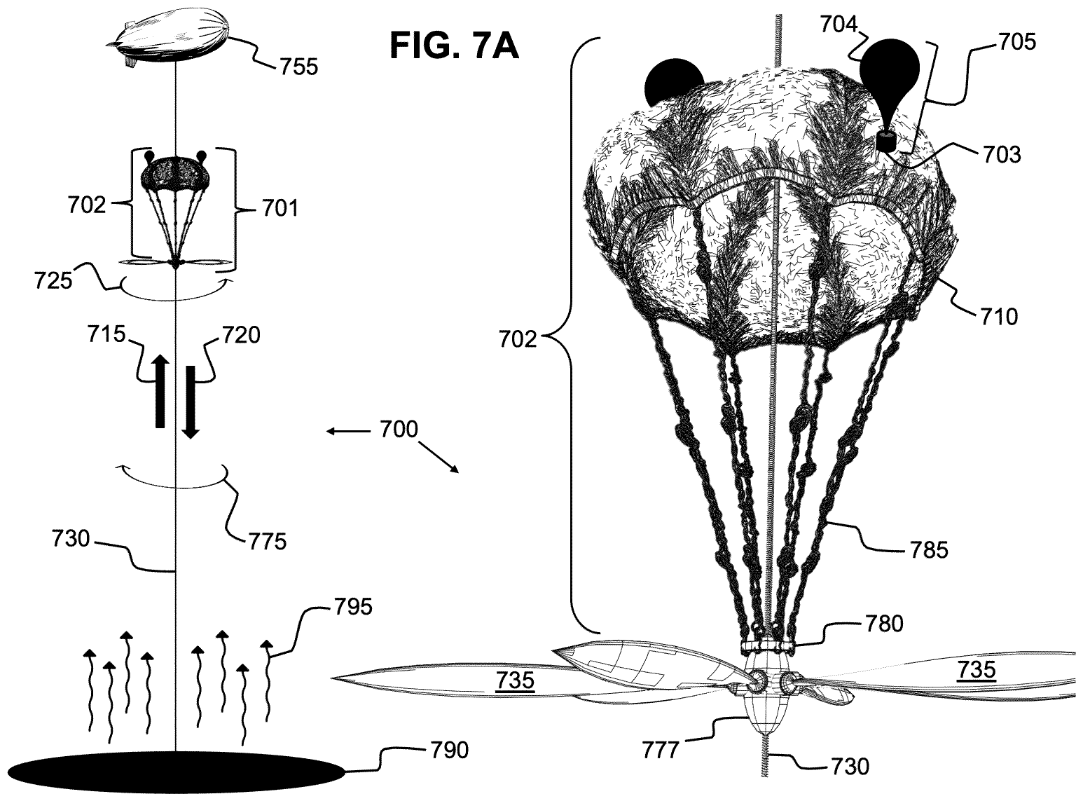

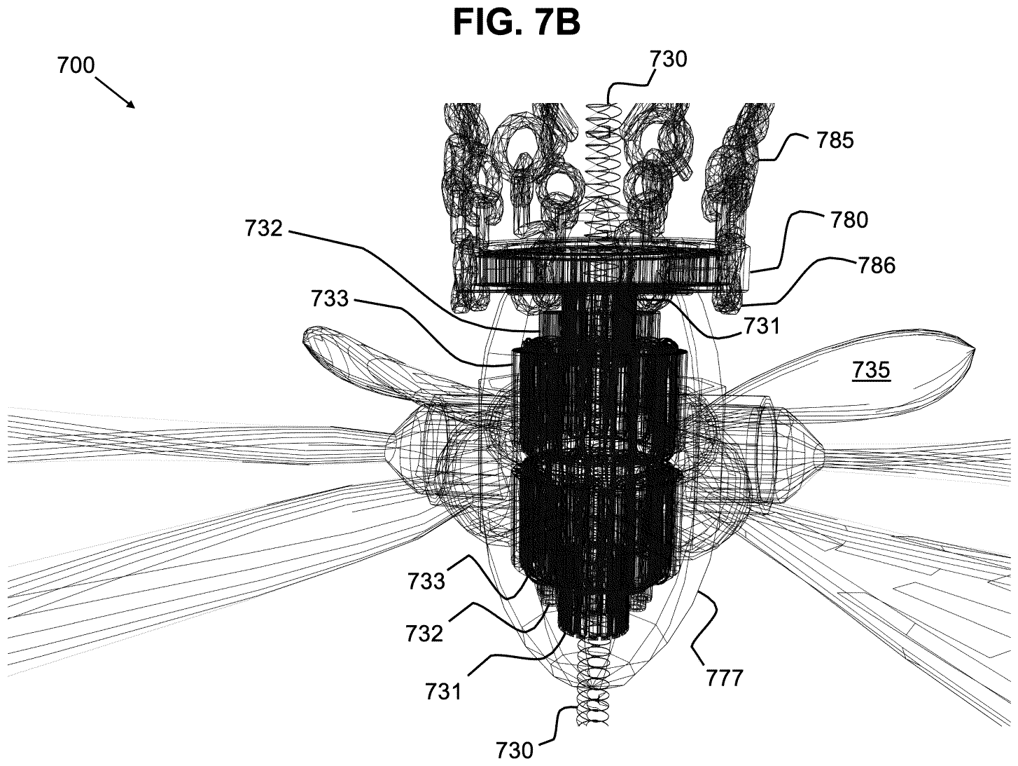

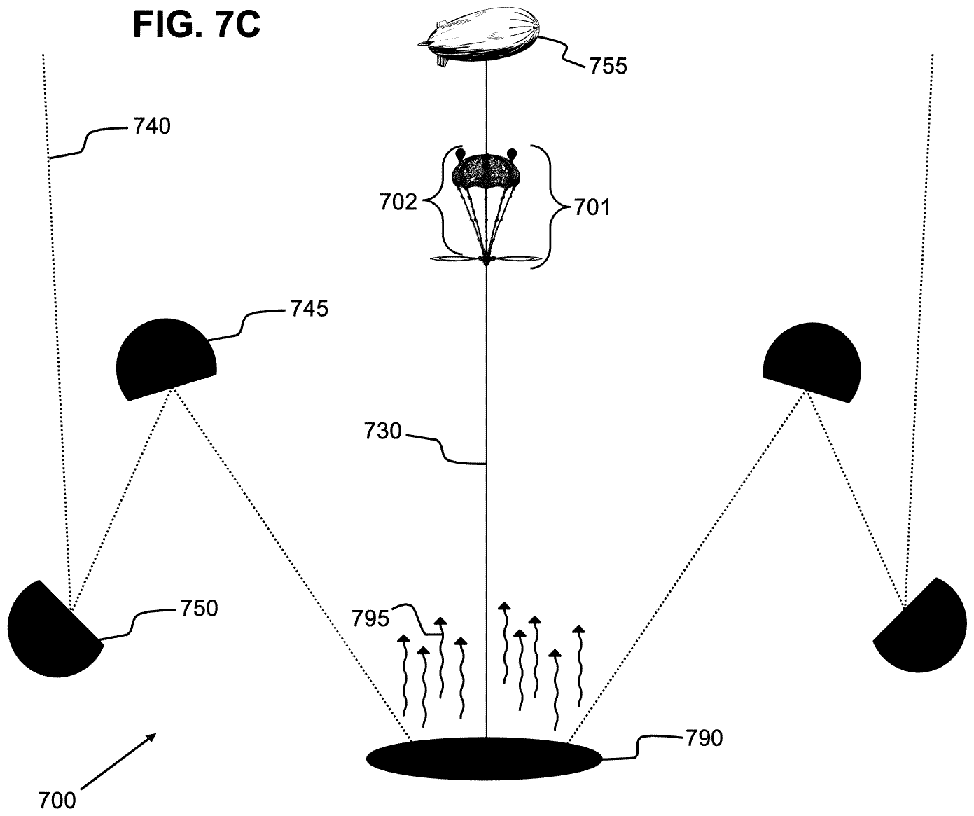

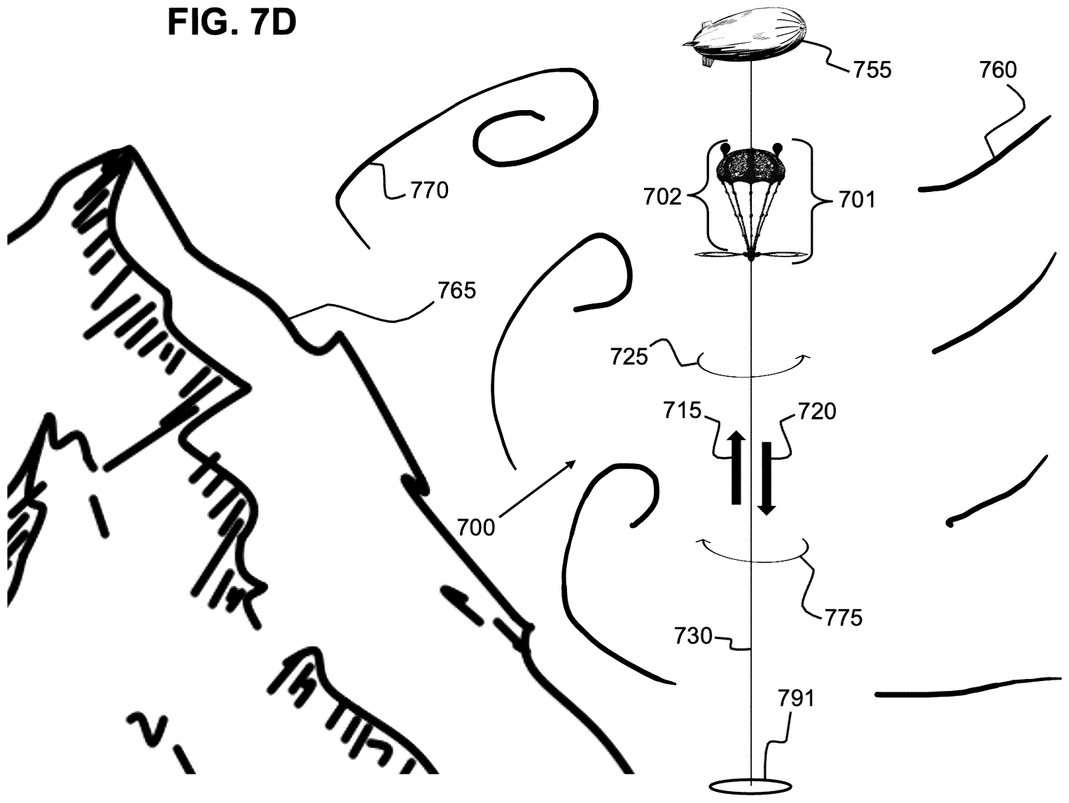

Now referring to FIGS. 7A, 7B, 7C and 7D an exemplary energy generating device 700 is depicted. One of ordinary skill in the art will recognize that any kind of buoyancy modulator can be used by an energy generating device to cause the device to ascend and descend. For example, exemplary energy generating device 700 may include a kinetic unit 701, which may include outer first body portion 777 and one or more first force input structure such as one or more rotor blade 735 and a hybrid buoyancy and lift system 702, which hybrid buoyancy and lift system 702 may include a buoyancy modulator 705 coupled to a parasail or air-catching lift member 710. Buoyancy modulator 705 may include a balloon 704 and an air compression and decompression system 703 that is coupled to and able to send gas to and receive gas from balloon 704. Parasail or air-catching lift member 710 may be coupled to a second body portion such as one or more flexible rope or cable 785, which may be configured to be placed in a pass through of outer first body portion 777. One or more flexible rope or cable 785 may be coupled to one or more bearing or other rotational member 780 by one or more rope or cable coupler 786. One or more bearing or other rotational member 780 may be rotationally coupled to outer first body portion 777. Outer first body portion 777 may be coupled to one or more rotor blade 735. Outer first body portion 777 include or contain a set of conductive coils 733, which conductive coils 733 may be rotationally coupled to one or more magnet assembly 731 by one or more bearing 732. The inner surface of one or more magnet assembly 731 may be rotationally coupled to a second force input structure such as twisted screw-like track 730. The topmost portion of twisted screw-like track 730 may be coupled to an airship 755. The bottommost portion of twisted screw-like track 730 may be coupled to heat radiating base 790. Heat radiating base 790 may radiate heat, thereby heating the air above and around it and cause the heated air 795 to rise in upward direction 715.

Exemplary device 700 may be configured to rest at or near heat radiating base 790 when one or more balloon 704 is deflated. When one or more balloon 704 is filled with a gas, such as a lighter than air gas by air compression and decompression system 703, this may cause parasail or air-catching lift member 710 to begin to rise or expand. As heated air 795 fills parasail or air-catching lift member 710, one or both of the force of buoyancy and the force of lift acting upon a buoyancy modulator such as a hybrid buoyancy and lift system 702 may cause kinetic unit 701 to ascend in substantially upward direction 715. As depicted in FIG. 7C, one or more upward-angled light concentrating unit 750 may collect sunlight or photons 740 and direct them toward one or more downward-angled light concentrating unit 745, which may direct sunlight or photons 740 to heat radiating base 790 to increase the amount of heat radiated by heat radiating base 790. Alternatively, device 700 may not use heated air at all, but rather, may include a base 791 and may be placed in a location with relatively consistent winds such as substantially horizontal wind or moving air 760 which may be caused by a mountain or other air movement director 765 to be redirected to move in a substantially upward direction 715. For example, substantially upward moving air 770 may be used rather than heated air 795 to cause lift in parasail or air-catching lift member 710, causing hybrid buoyancy and lift system 702 to cause kinetic unit 701 to rise.

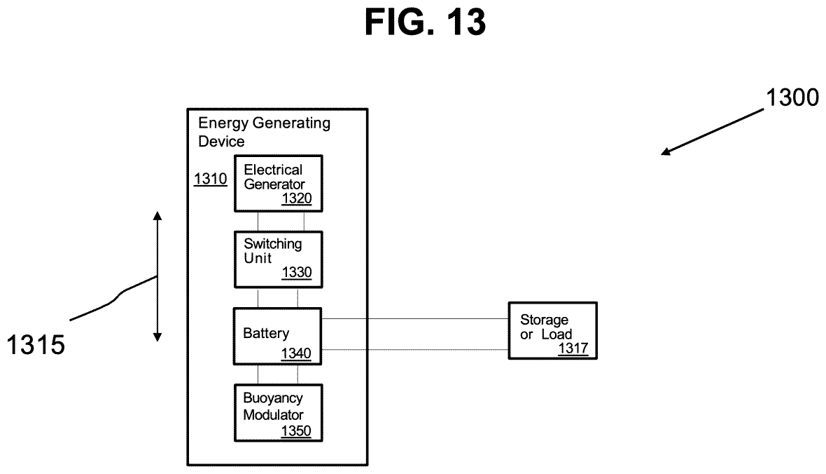

Whichever one or several of the forces of buoyancy, lift caused by heated air 795 and lift caused by substantially upward moving air 770 is used to cause kinetic unit 701 to ascend, as kinetic unit 701 ascends, a medium such as air may impinge on a torque generator, such as but not limited to one or more rotor blade 735, which may be coupled to outer first body portion 777. One or more rotor blade 735 may create a torque on outer first body portion 777 so that outer first body portion 777 may rotate substantially in rotational direction 725. Simultaneously, magnet assembly 731, which may be rotatably coupled to twisted screw-like track 730, may rotate in rotational direction 775. The relative rotation between magnet assembly 731 and conductive coils 733, which may be components of an electrical generator, may generate electricity in conductive coils 733. Lighter than air gas may be compressed by air compression and decompression system 703 causing one or more balloon 704 to be deflated or causing parasail or air-catching lift member 710 to collapse or causing hybrid buoyancy and lift system to no longer be able to lift kinetic unit 701, thereby causing kinetic unit 701 to descend. A switching unit similar in energy generating device system 1300 depicted in FIG. 13 may change polarity of the device when it reaches its highest or lowest point of travel. As kinetic unit 701 descends, air may impinge on one or more rotor blade 735, which may create a torque on outer first body portion 777 so that outer first body portion 777 may rotate substantially in rotational direction 775. Simultaneously, magnet assembly 731, may rotate in rotational direction 725. The relative rotation between magnet assembly 731 and conductive coils 733 may generate electricity in conductive coils 733.

Now referring to FIG. 8, an exemplary energy generating device 800 is depicted. One of ordinary skill in the art will recognize that any kind of rotor or any mechanism that can receive a force and translate it into rotational force can be used by an energy generating device for the torque generating function of an energy generating device. For example, as depicted in FIG. 8, an exemplary energy generating device 800 may include one or more first force input structure such as waterwheel-like rotor assembly 899 and one or more second force input structure such as waterwheel-like rotor assembly 898 that are oriented parallel to outer first body portion 897. Exemplary energy generating device 800 may include a first 90° rotation translation mechanism 896 including one or more gear 881 that is coupled to first waterwheel-like rotor assembly 899 and that is also rotatably coupled at a 90° angle to one or more gear 882, which gear 882 is coupled to outer first body portion 897, which outer first body portion 897 is coupled to internal conductive coils. Exemplary energy generating device 800 may include a second 90° rotation translation mechanism 895 including one or more gear 883 that is coupled to one or more second waterwheel-like rotor assembly 898 and that is also rotatably coupled at a 90° angle to one or more gear 884, which gear 884 is coupled to inner second body portion 894, which inner second body portion 894 may be placed in a pass through of outer first body portion 897 and which also may be coupled to internal magnets, which magnets are substantially concentric with the conductive coils, which magnets and conductive coils may be included in an electrical generator.

Exemplary device 800 can move in a substantially upward direction 885 or in a substantially downward direction 886. When an included buoyancy modulator causes exemplary device 800 moves substantially in upward direction 885 in a fluid medium such as water, the medium applies a force to first waterwheel-like rotor assembly 899 and second waterwheel-like rotor assembly 898 in downward direction 886, causing first waterwheel-like rotor assembly 899 and second waterwheel-like rotor assembly 898 to rotate in direction 887. As described in many exemplary embodiments herein, a buoyancy modulator can include a compressed air pump and a compressed air tank, or a chemical or biological reactor, or any of many kinds of buoyancy modulator. When traveling in upward direction 885, first 90° rotation translation mechanism 896 causes outer first body portion 897 to rotate in direction 888 while second 90° rotation translation mechanism 895 causes inner second body portion 894 to rotate in direction 889, thereby causing counterrotation of the conductive coils and magnets, generating electricity in the conductive coils. When exemplary device 800 moves substantially in downward direction 886 in a fluid medium such as water, the medium applies a force to first waterwheel-like rotor assembly 899 and second waterwheel-like rotor assembly 898 in upward direction 885, causing first waterwheel-like rotor assembly 899 and second waterwheel-like rotor assembly 898 to rotate in direction 887. When traveling in downward direction 886, first 90° rotation translation mechanism 896 causes outer first body portion 897 to rotate in direction 888 while second 90° rotation translation mechanism 895 causes inner second body portion 894 to rotate in direction 889, thereby causing counterrotation of the conductive coils and magnets, generating electricity in the conductive coils. An advantage of the configuration of exemplary device 800 is that it neither requires the energy generating device to turn 180° when it reaches its highest or lowest point of travel, nor does it require a switching mechanism to change polarity of the device when it reaches its highest or lowest point of travel.

Exemplary energy generating devices 600, 700 and 800 are configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator. The exemplary selection of devices depicted herein are configured to operate with several similar principles to energy generating devices 600, 700 and 800, which can harvest potential energy as electrical energy in water or any fluid.

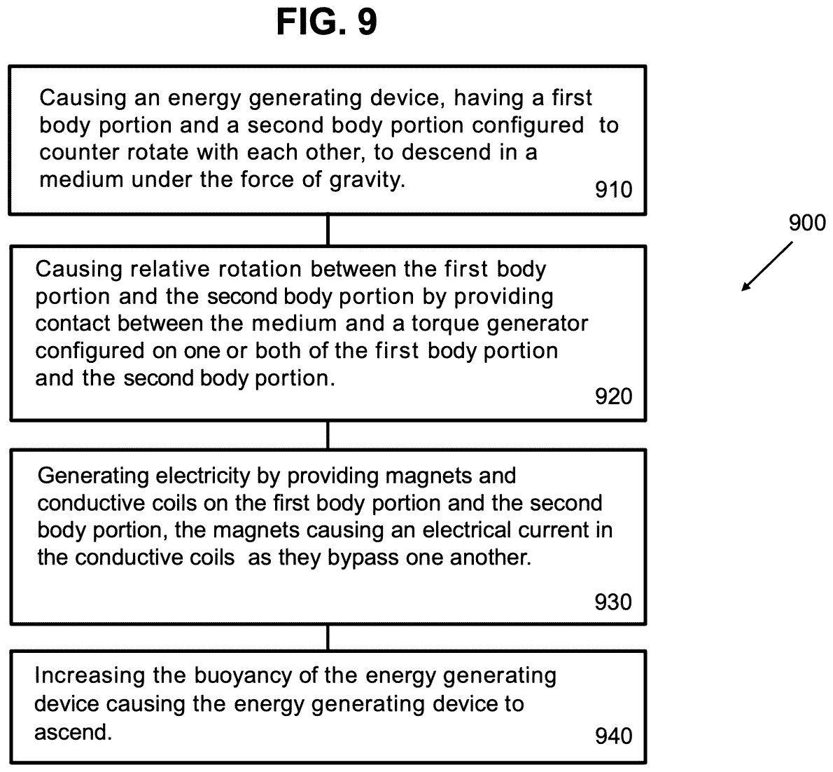

An exemplary method of operation 900 is depicted in FIG. 9. The method may include causing an energy generating device, having a first body portion and a second body portion configured to counter rotate with each other, to descend in a medium under the force of gravity (process 910). Method of operation 900 also may include causing relative rotation between the first body portion and the second body portion by providing contact between the medium and a torque generator configured on one or both of the first body portion and the second body portion (process 920). Further, the method of operation 900 may include generating electricity by providing magnets and conductive coils on the first body portion and the second body portion, the magnets causing an electrical current in the conductive coils as they bypass one another (process 930) and increasing the buoyancy of the energy generating device causing the energy generating device to ascend (process 940).

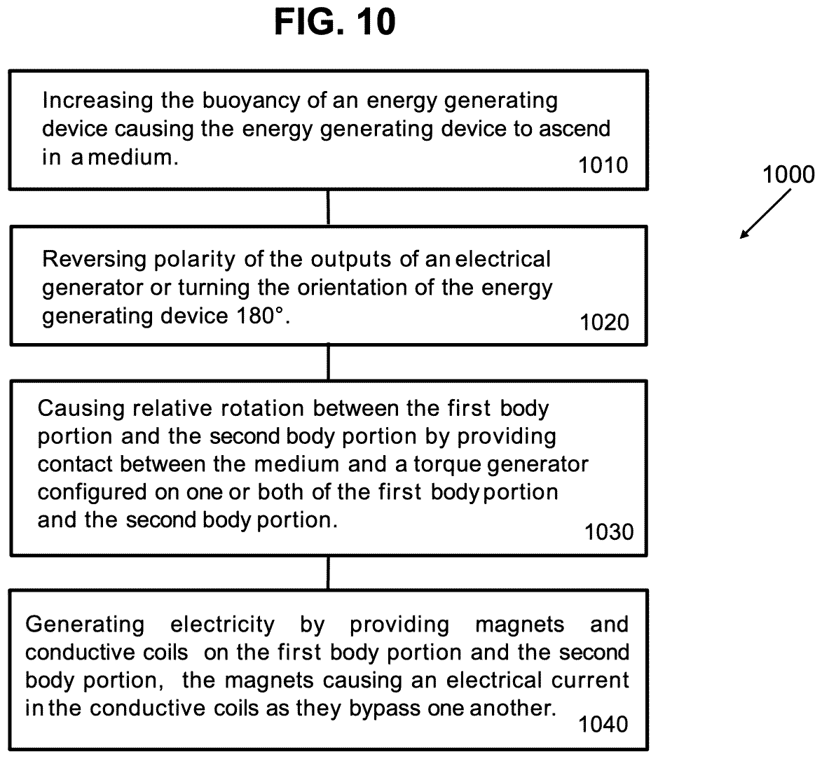

Another exemplary method of operation 1000 is depicted in FIG. 10. The method may include increasing the buoyancy of an energy generating device causing the energy generating device to ascend in a medium (process 1010). Further, the method may include reversing polarity of the outputs of an electrical generator or turning the orientation of the energy generating device 180°. (process 1020). The method also may include causing relative rotation between the first body portion and the second body portion by providing contact between the medium and a torque generator configured on one or both of the first body portion and the second body portion (process 1030). Further still, the method may include generating electricity by providing magnets and conductive coils on the first body portion and the second body portion, the magnets causing an electrical current in the conductive coils as they bypass one another (process 1040).

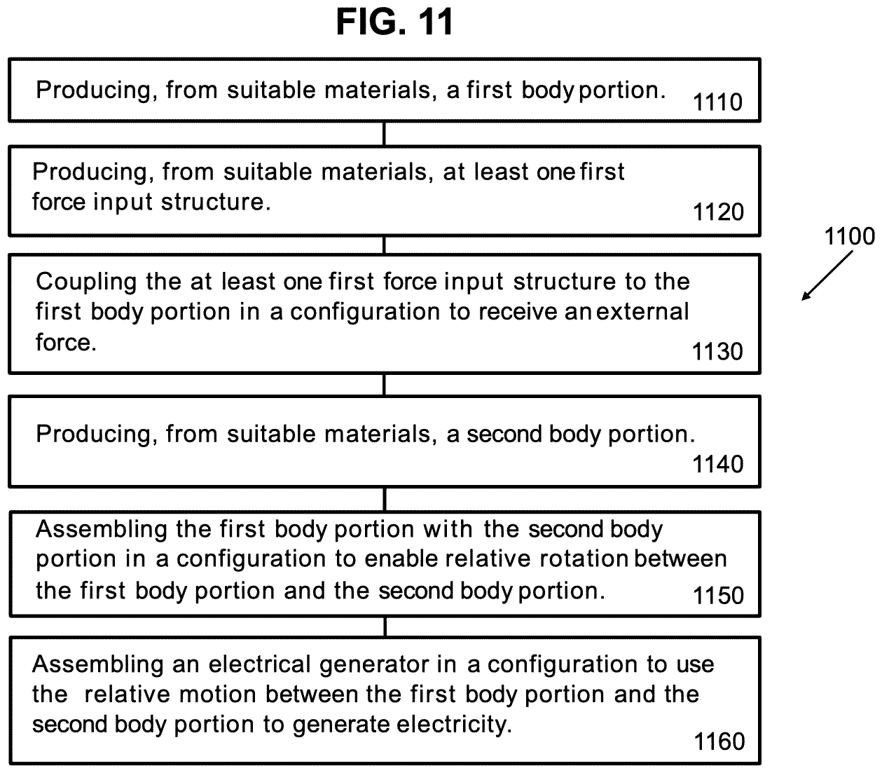

Referring now to FIG. 11, a method 1100 of manufacturing an energy generating device is depicted. The method may include producing, from suitable materials, a first body portion (process 1110). The method also may include producing, from suitable materials, at least one first force input structure (process 1120). Further, the method may include coupling the at least one first force input structure to the first body portion in a configuration to receive an external force (process 1130). Further, the method may include producing, from suitable materials, a second body portion (process 1140). Suitable materials for the various parts and portions may include but are not limited to metals, metal alloys, composites, polymers, plastics, ceramics, nanomaterials, etc. Further still, the method may include assembling the first body portion with the second body portion in a configuration to enable relative rotation between the first body portion and the second body portion (process 1150). The method may also include assembling an electrical generator in a configuration to use the relative motion between the first body portion and the second body portion to generate electricity (process 1160). The first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

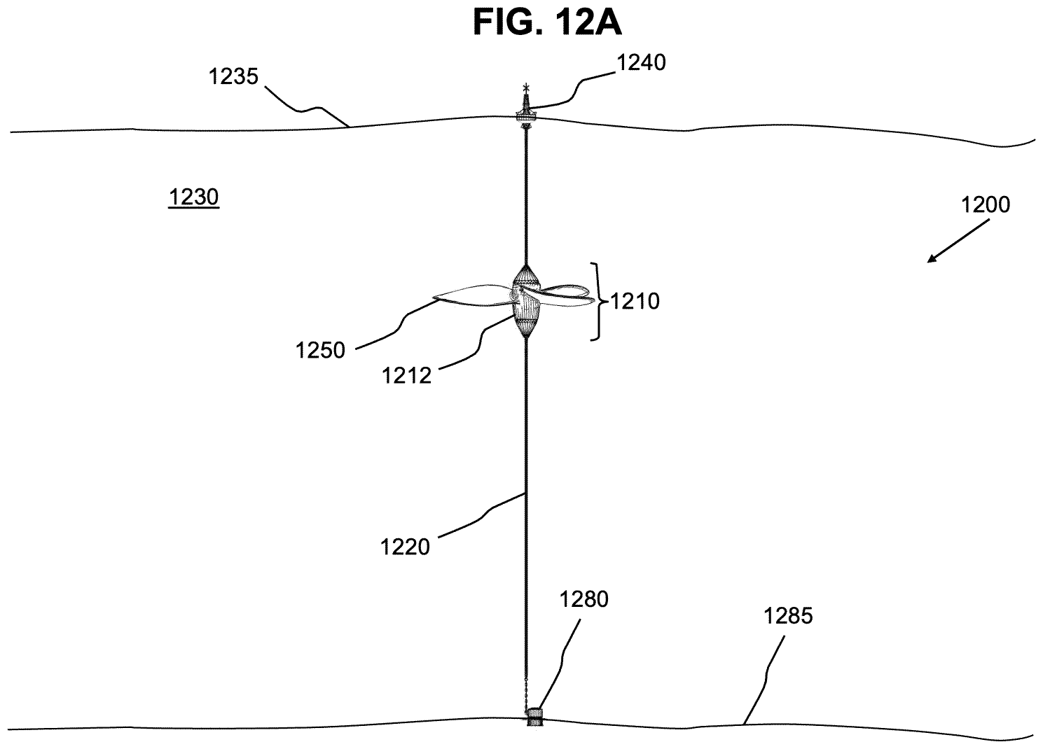

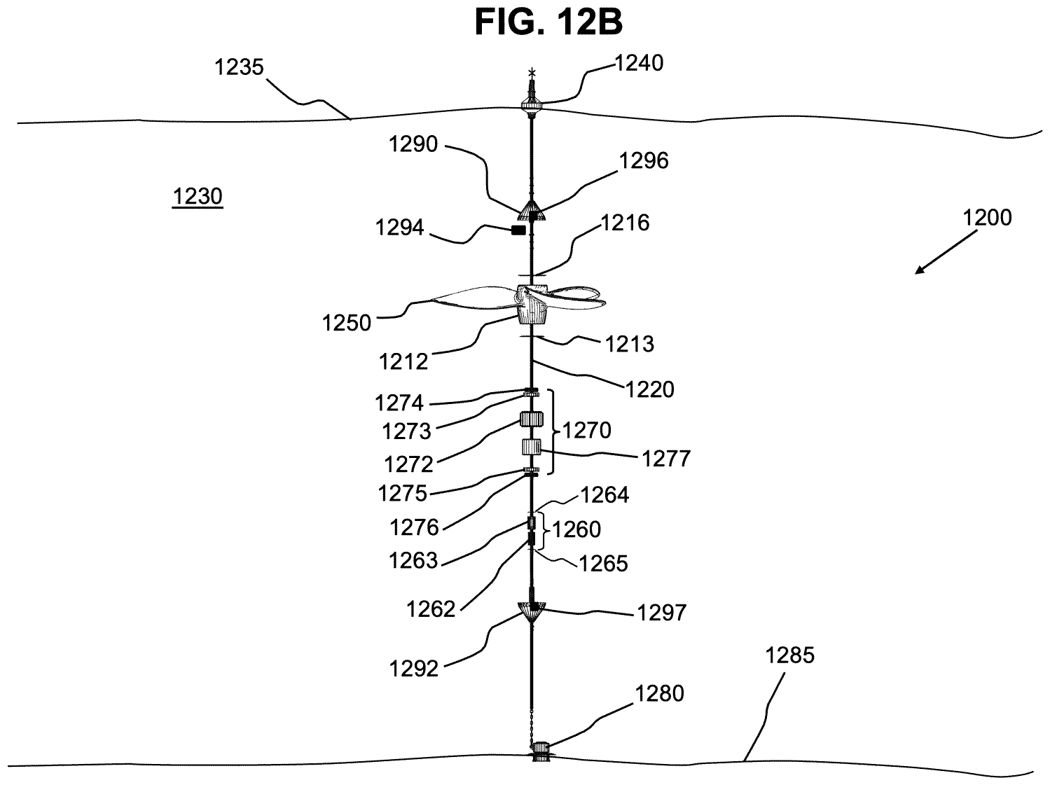

Referring now to FIGS. 12A and 12B another exemplary embodiment of an energy generating device 1200 may include a generator body 1210 that may include an outer first body portion 1212 and an inner second body portion. Generator body 1210 may be configured to move along a track 1220 which may extend in a medium (e.g. water body 1230 having a water surface 1235) from a top point, for example but not limited to a buoy 1240, which floats on water surface 1235 and maintains track 1220 in a substantially vertical orientation. A track may include one or more tracks.

In operation, generator body 1210 may be released from just below buoy 1240 and travel under the force of gravity in a downward direction along track 1220. As generator body 1210 descends, water may impinge on a first force input structure such as a torque generator, such as but not limited to one or more rotor blade 1250, which are coupled to outer first body portion 1212. One or more rotor blade 1250 may create a torque on outer first body portion 1212 so that outer first body portion 1212 may rotate relative to an inner second body portion of generator body 1210, which may be placed in a pass through of outer first body portion 1212. Inner second body portion of generator body 1210 may include a magnet assembly 1260, as depicted in FIG. 12B, which rides along track 1220 but does not rotate in the same direction as outer first body portion 1212. Track 1220 may include a second force input structure such as a twisted screwlike track that causes the inner second body portion of generator body 1210 to rotate in the opposite direction of outer first body portion 1212, or track 1220 may include a straight track that guides or constraints the inner second body portion of generator body 1210, preventing inner second body portion of generator body 1210 from rotating. Coil assembly 1270 and magnet assembly 1260 may be included in an electrical generator. The torque of one or more rotor blade 1250, may cause coil assembly 1270, which may be coupled to outer first body portion 1212, to rotate around magnet assembly 1260, which may include a magnet 1262, thereby creating an electrical current in conductive coils 1272, which is harvested as electrical energy and directed to a storage source, such as a battery or directed to a use source such as any type of electrical load.

As generator body 1210 descends, electrical energy is generated. Once generator body 1210 reaches a bottom point such as at or just above anchor point 1280, which anchor point 1280 may be any type of weighted member or any member more dense than the surrounding medium or any suction system like a suction caisson or any other anchoring structure and which anchor point 1280 is configured to maintain track 1220 at a relatively fixed position relative to a surface such as water body floor 1285, ballast tank 1290 and ballast tank 1292, which hold water or the like, are filled with air or the like by a pump or other buoyancy modulator 1294 thereby ejecting the water into water body 1230. As an alternative to using an anchor point 1280 to maintain a track 1220 in a relatively fixed position relative to a surface such as a water body floor 1285, a weight may freely hang at any depth to keep track 1220 relatively straight though it may not be fixed. Ballast tank 1290 and ballast tank 1292, when filled with air or other gas, provide buoyancy to generator body 1210 forcing generator body 1210 to move in an upward direction. As generator body 1210 moves in an upward direction, one or more rotor blade 1250 are torqued in the opposite direction of one or more rotation as rotor blade 1250 direction of rotation when generator body 1210 is traveling in the downward direction. A switching circuit or other polarity switching device changes the polarity of the output of conductive coils 1272 so that the output of the electrical generator remains the same polarity as in the downward direction. A configuration of four diodes or a rectifier can be used so that the direction of current flow of the electrical generator remains the same as in the downward direction. When the generator body reaches the top height near buoy 1240, ballast tank 1290 and ballast tank 1292 again take on water and air is compressed inside one or more compressed air tank 1296 and compressed air tank 1297.

In accordance with an exemplary embodiment, coil assembly 1270 may include any of a variety of parts including but not limited to conductive coils 1272 a top bearing outer race 1273, a top bearing inner race 1274, a bottom bearing outer race 1275, a bottom bearing inner race 1276, and an inner coil support 1277. Inner coil support 1277 may be coupled to conductive coils 1272 on its outside surface and on its inner surface to top bearing outer race 1273 and bottom bearing outer race 1275. Top bearing outer race 1273 and bottom bearing outer race 1275 are configured to rotate around top bearing inner race 1274 and bottom bearing inner race 1276 which are not configured to rotate in this exemplary embodiment but are configured to ride up and down track 1220. This configuration allows conductive coils 1272 to rotate about magnet 1262 which may be coupled to top bearing inner race 1274 and bottom bearing inner race 1276 by magnet outer housing 1263 having a magnet housing top cap 1264 and a magnet housing bottom cap 1265 that holds the magnet assembly 1260 together and helps maintain magnet assembly 1260 to ride up and down track 1220 without rotating. A generator body top cap 1216 and a generator body lower cap 1213 aid in holding together and encasing coil assembly 1270 and magnet assembly 1260. Energy generating device 1200 is configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator. The exemplary selection of devices depicted herein are configured to operate with several similar principles to energy generating device 1200, which uses a rotor and track configuration to harvest potential energy by the same principles by which energy generating device 600 is able to harvest potential energy using a configuration including two counterrotating helices or rotors without using a track.

Referring now to FIG. 13, a generalized block diagram of an energy generating device system 1300 is depicted. Energy generating device system 1300 may include an energy generating device 1310, that generates energy by moving in directions 1315, as described above, and an off-board power storage or electrical load 1317. In operation electrical energy generating device 1310 causes electrical generator 1320 to generate electricity and deliver the electricity to a switching unit 1330 with a first polarity while moving in a first direction. Battery 1340 stores electrical power delivered from switching unit 1330. When energy generating device 1310 begins moving in a second direction, electrical generator 1320 delivers electrical power to switching unit 1330 in a second polarity. Switching unit 1330 which may be any of a variety of types of switching units including but not limited to a double pole double throw (DPDT) relay, then causes delivery of electrical energy to battery 1340 in the first polarity so that battery 1340 always receives energy in the first polarity at all times. Battery 1340 may then deliver electrical energy to off-board power storage or electrical load 1317 or to the on-board buoyancy modulator 1350 such as a pump or other gas compression member or ballast system or any other buoyancy modulator 1350 or other on-board electrical systems.

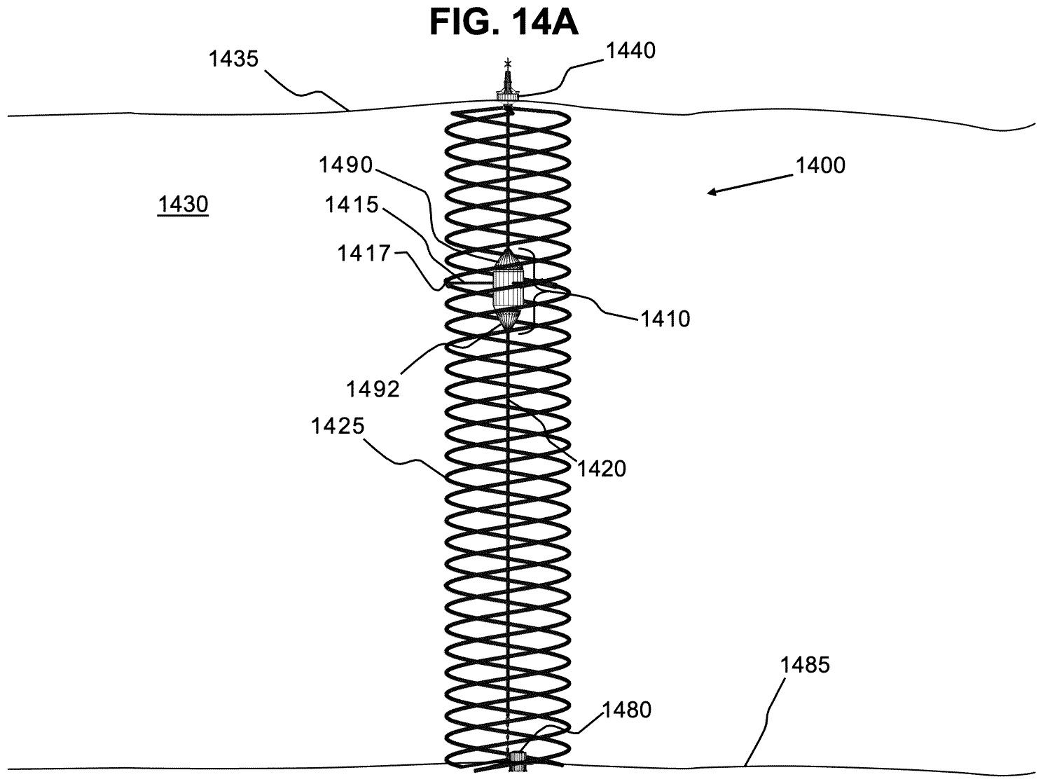

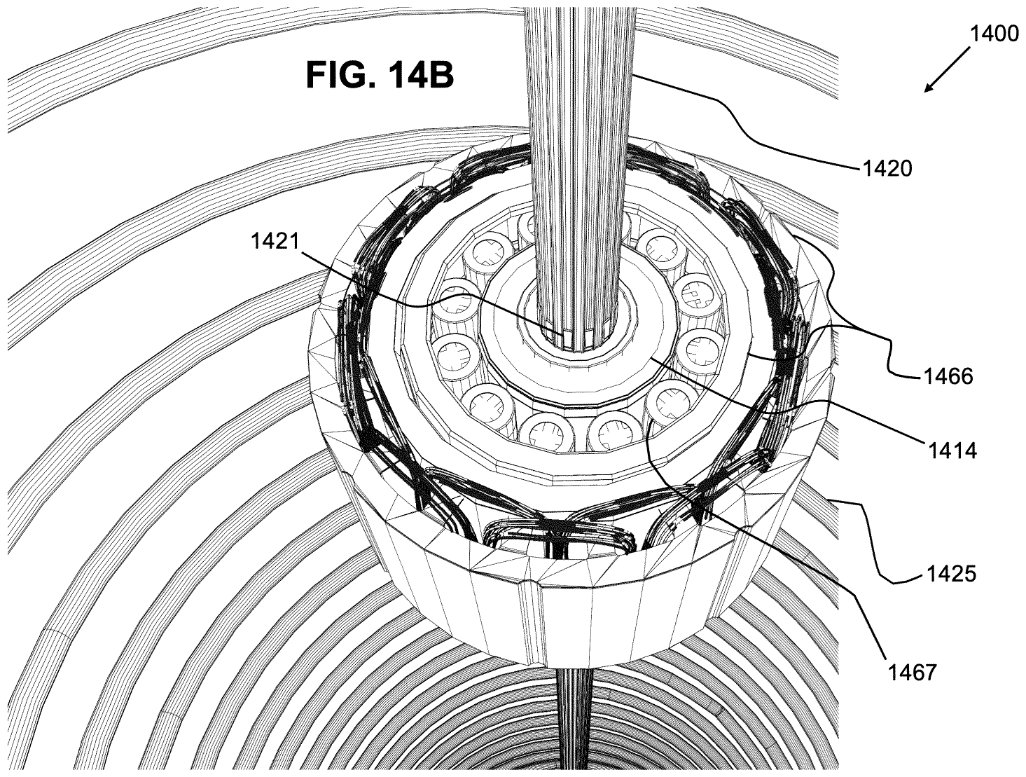

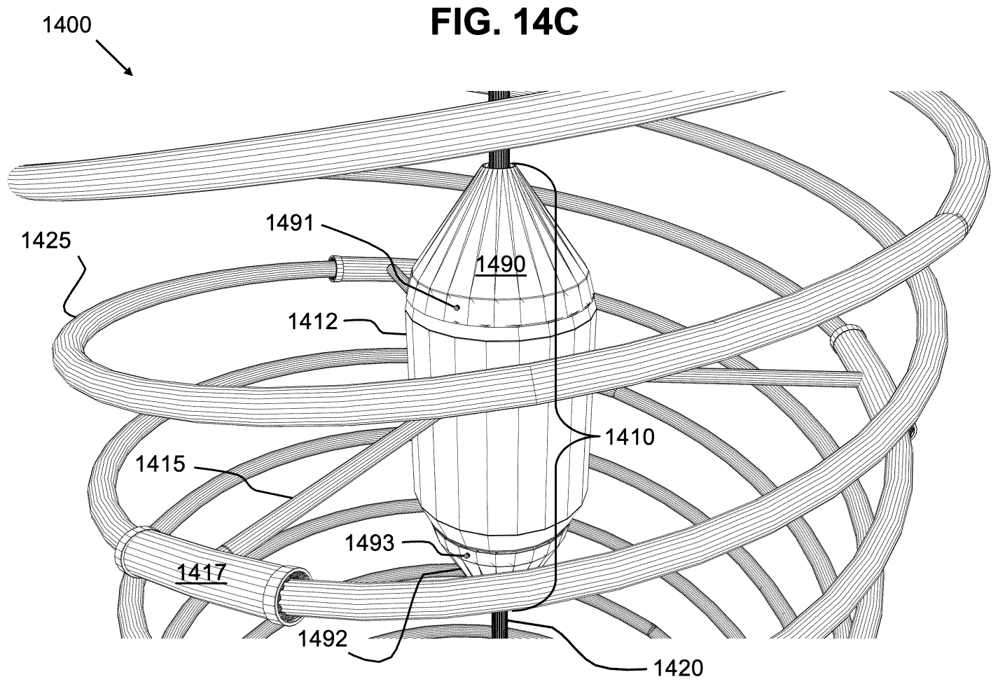

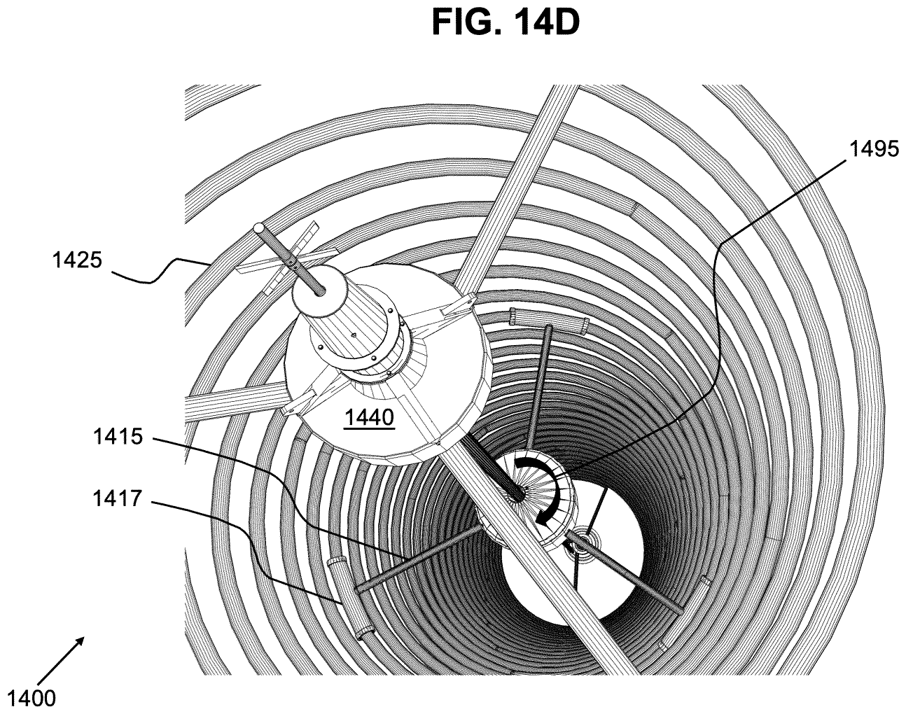

Referring now to FIGS. 14A, 14B, 14C and 14D, another embodiment of an energy generating device 1400 is depicted. Energy generating device 1400 may include a generator body 1410. Generator body 1410 may be configured to move along a track 1420, which may be included in a pass through of generator body 1410. Track 1420 may extend in a medium (e.g. water body 1430 having a water surface 1435) from a top point, for example but not limited to a buoy 1440, which may float on water surface 1435 and may maintain track 1420 in a substantially vertical orientation. Buoy 1440 and anchor 1480 are coupled to one or more outer track 1425 that runs from a location substantially near the top point at buoy 1440 to a location substantially near the bottom point at anchor 1480. In operation generator body 1410 may be released from just below buoy 1440 and travel under the force of gravity in a downward direction along track 1420. Generator body 1410 may include a first force input structure such as one or more guide arm 1415 that is movably coupled to outer track 1425 by one or more slide unit 1417. One or more slide unit 1417 may move along outer track 1425 causing an outer first body portion 1412 that is coupled to conductive coils 1466 to rotate relative to an inner second body portion 1414 in a direction such as direction 1495. In some embodiments outer first body portion 1412 may be rotatably coupled to inner second body portion 1414 using one or more roller bearing 1467 or any other kind of bearing or rotational member. Track 1420 may include a second force input structure such as a twisted screwlike track that causes inner second body portion 1414 to rotate in the opposite direction of outer first body portion 1412 or track 1420 may include a straight track that guides or constraints inner second body portion 1414, preventing inner second body portion 1414 from rotating. Conductive coils 1466 and a magnet assembly coupled to inner second body portion 1414 may be included in an electrical generator. As generator body 1410 descends under the force of gravity, the relative rotation caused between outer first body portion 1412 and inner second body portion 1414 causes relative rotation of a magnet assembly coupled to inner second body portion 1414 and conductive coils 1466 coupled to outer first body portion 1412, to create a current in conductive coils 1466 which may be used, or stored as electrical power. In an alternative embodiment the coil assembly may be coupled to inner second body portion 1414 and the magnet assembly may be coupled to outer first body portion 1412. As will be known by skilled practitioners of the art, an electrical current is generated by moving a conductive coil in a magnetic field. Therefore, as generator body 1410 descends, electrical energy is generated.

Once generator body 1410 reaches a bottom point such as at a weight or other type of anchor 1480, which may be any type of weight or anchoring structure configured to maintain track 1420 at a relatively fixed position relative to a surface, such as a fixed position on water body floor 1485, a buoyancy modulator, such as ballast tank 1490 and ballast tank 1492 which hold water or the like, may be filled with air or the like, thereby ejecting the water into water body 1430. In some embodiments, one or more ballast port 1491 and ballast port 1493 may allow fluid to pass in and out of ballast tank 1490 and ballast tank 1492. One or more ballast tank 1490 and ballast tank 1492, when filled with air or other gas, provide buoyancy to generator body 1410 forcing generator body 1410 to move in the upward direction. As generator body 1410 moves in the upward direction, one or more guide arm 1415 are torqued in a direction that is opposite the direction of rotation of movement of one or more guide arm 1415 when generator body 1410 moves in the downward direction. A switching circuit changes the polarity of the output of conductive coils 1466 so that the output of the electrical generator remains the same as in the downward direction. A configuration of four diodes or a rectifier can be used so that the direction of current flow of the electrical generator remains the same as in the downward direction. When the generator body substantially reaches the top at buoy 1440, ballast tank 1490 and ballast tank 1492 again take on water and air is compressed inside compressed air tanks. Energy generating device 1400 is configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator. The exemplary selection of devices depicted herein are configured to operate with several similar principles to energy generating device 1400, which uses a configuration including two counter rotational tracks to harvest potential energy by the same principles by which energy generating device 1200 is able to harvest potential energy using both track and rotor.

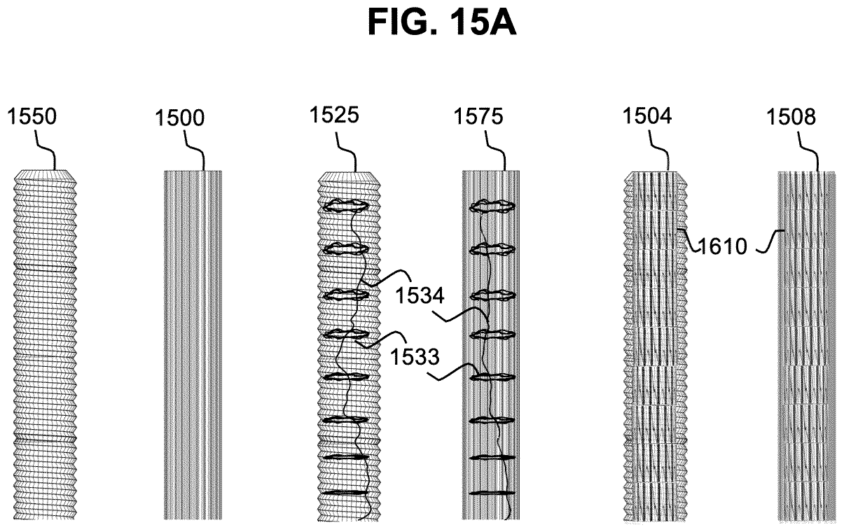

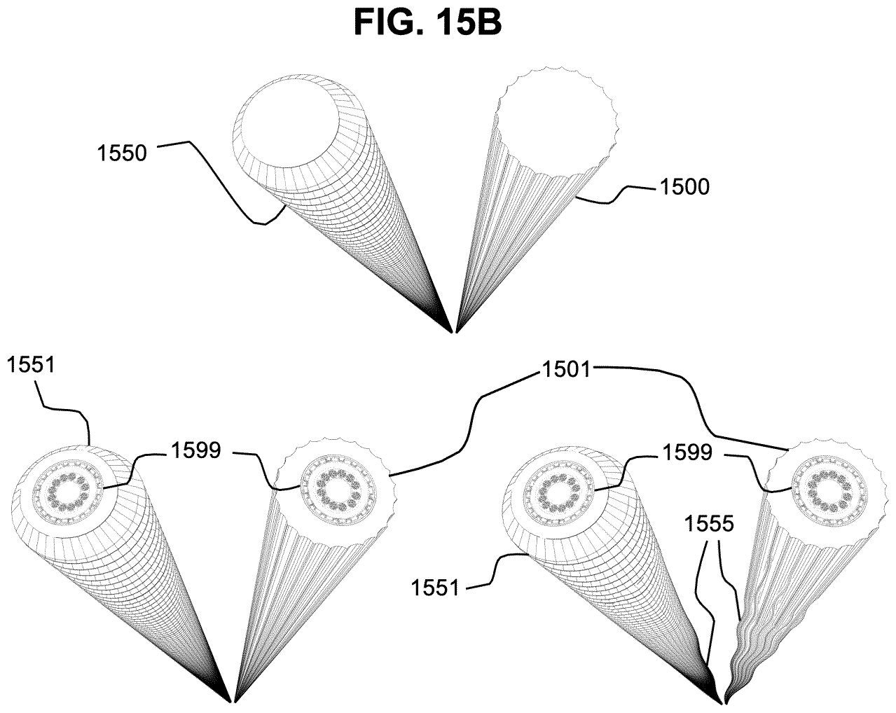

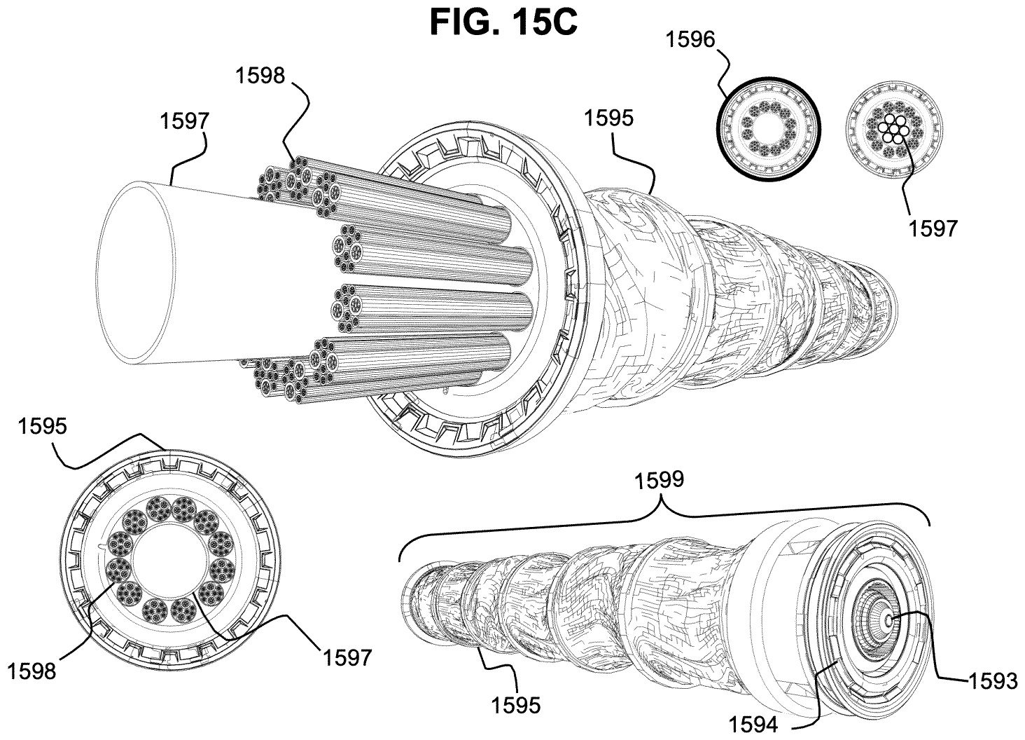

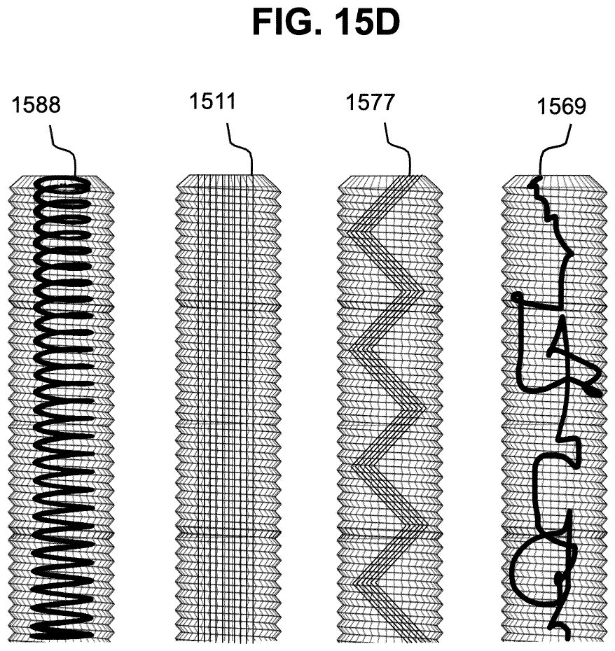

Referring now to FIGS. 14A, 14B, 14C, 14D, 15A, 15B, 15C, 15D, 16A and 16B select members of an exemplary embodiment of an energy generating device are depicted. In accordance with various exemplary embodiments, inner second body portion 1414 may be configured to slide along track 1420 similar to the exemplary embodiment depicted in FIG. 12, for example. In accordance with various exemplary embodiments, outer first body portion 1412 may be configured with multiple guide arms such as one or more guide arm 1415, such as but not limited to three guide arms which are each connected to one or more slide unit 1417. Also, in accordance with various exemplary embodiments, track 1420 may contain one or more track 1500 or track 1501 so that inner second body portion 1414 remains in a fixed vertical orientation and does not rotate, for example, as depicted in FIG. 14B, by being held in place at least partly by one or more track slider 1421, which are movably coupled to track 1420 and which are coupled to inner second body portion 1414.

Track 1501 may be comprised of rigid materials or may be comprised of flexible material 1555. Also, in accordance with various exemplary embodiments, track 1420 and other tracks of various exemplary embodiments herein may include one or more twisted screw-like track 1550 or 1551. Track 1551 may be comprised of rigid materials or may be comprised of flexible material 1555. Twisted screw-like track 1550 may cause inner second body portion 1414, which may include one or more magnet 1610, to rotate in direction 1620. Outer first body portion 1412, which may include conductive coils 1466, may rotate in direction 1640, which is substantially opposite of direction 1620, around a bearing, for example, roller bearing 1467, or a magnetic bearing or any other kind of bearing. Track 1525 and track 1504 may be subtypes of twisted screw-like track 1550 or track 1551. Track 1575 and track 1508 may be subtypes of track 1500 or track 1501.

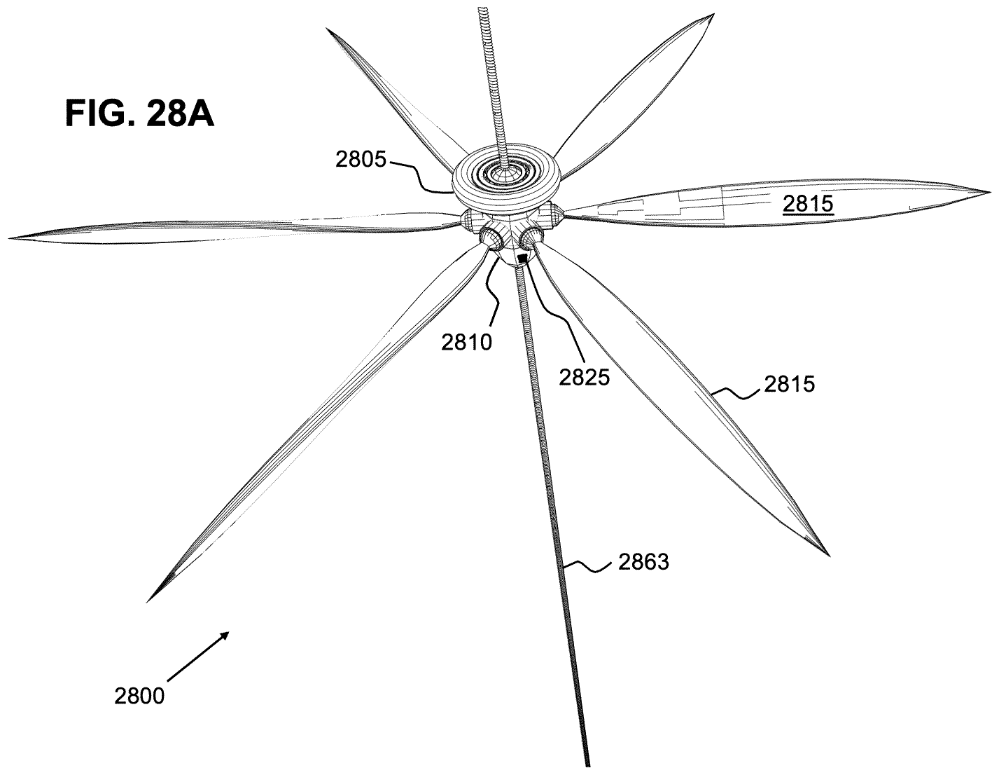

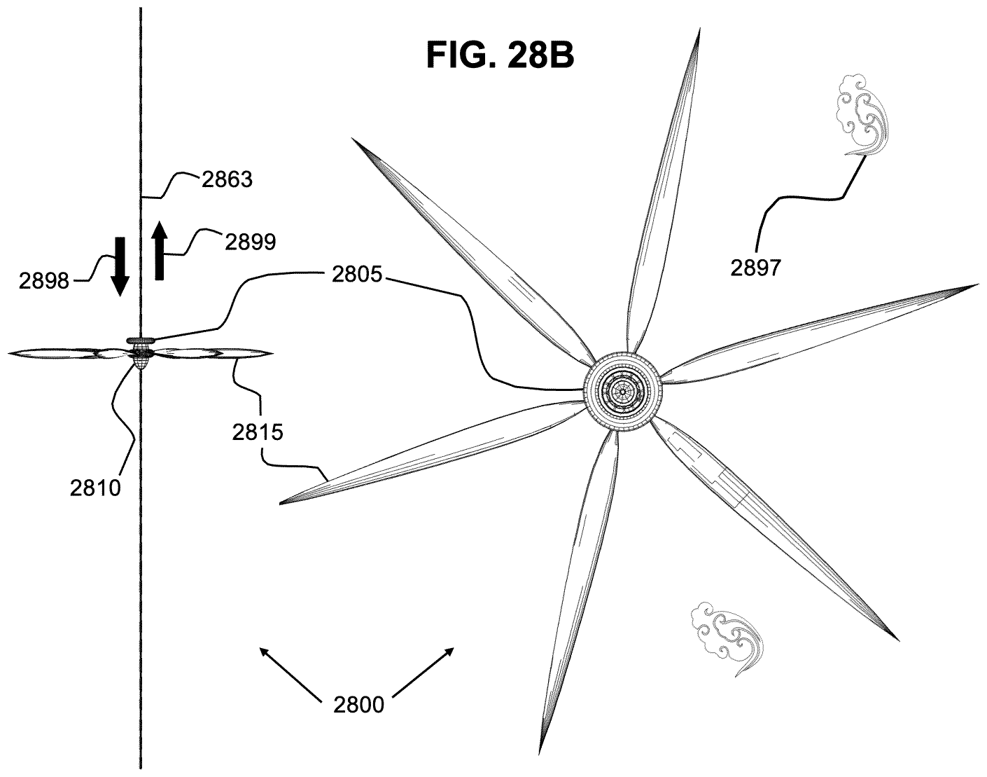

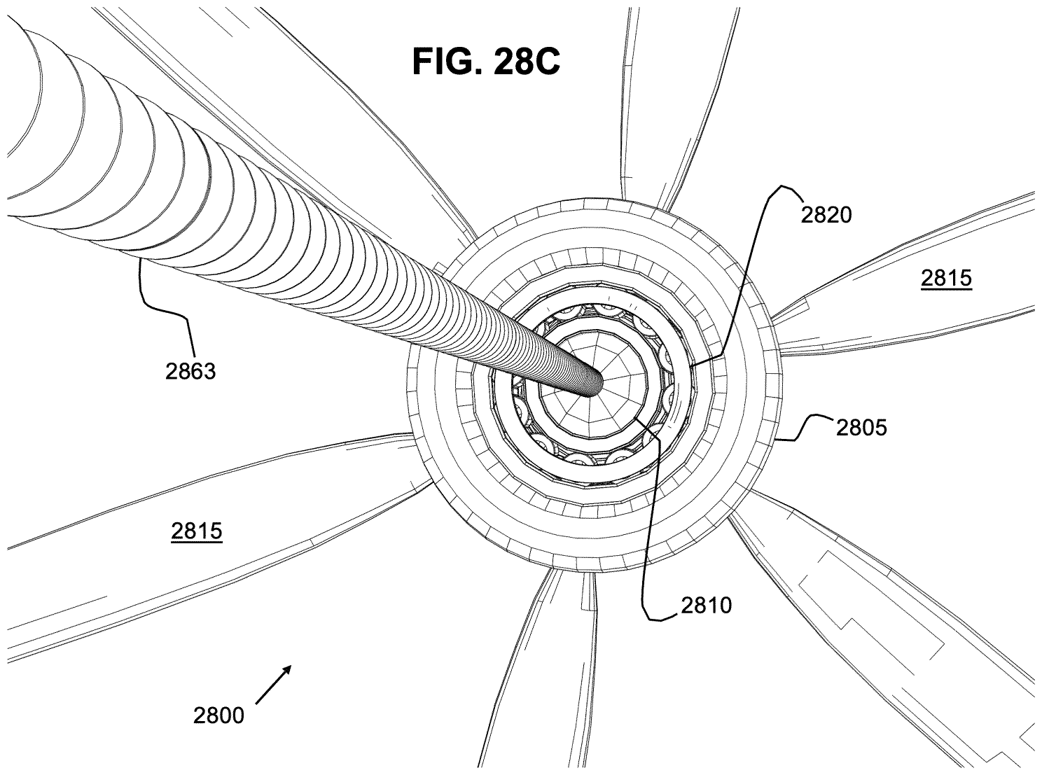

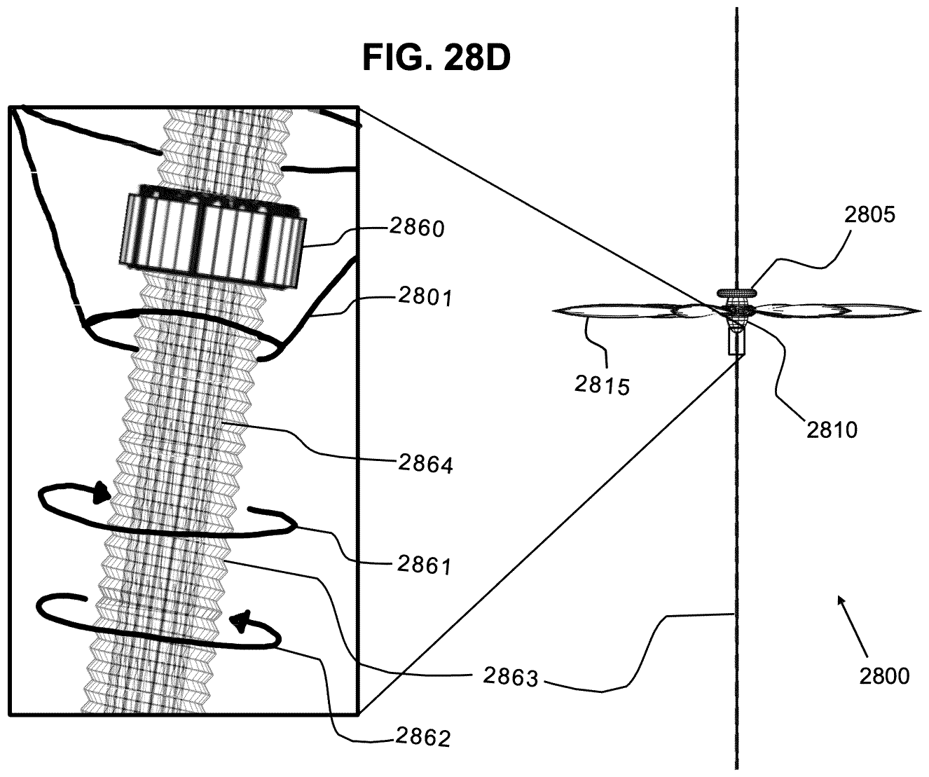

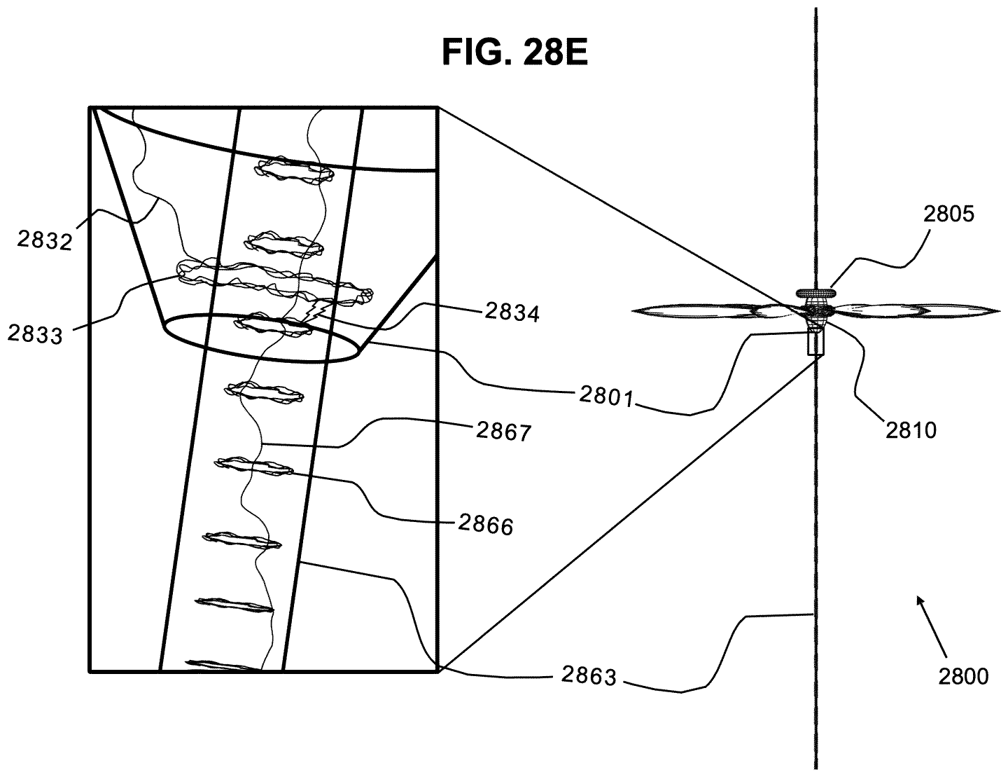

Track 1525 and track 1575 may include a wireless energy transfer system such as a wireless electricity system to, for example, transfer electricity to and from an energy generating device and to and from an external electrical load. The wireless electricity system may include wireless transmitter or receiver 1533 and electrical wire 1534. See FIG. 28E for an example configuration of an embodiment that uses a track similar to track 1525 and track 1575. Track 1504 and track 1508 may include one or more one or more magnet 1610. See FIG. 28D for an example configuration of an embodiment that uses a track similar to track 1504 and 1508.

A track 1551 may include a cable bundle 1599. A track 1501 may include a cable bundle 1599. Cable bundle 1599 may include one or more electrical cable 1598, one or more fluid transmission pipe 1597, or one or more inner or outer structural element 1596. Cable bundle 1599 may be partially contained within protective article 1595. One or more electrical cable 1598 may transfer electricity through electrical port 1594. One or more fluid transmission pipe 1597 may transfer fluid through fluid port 1593. For example, one or more fluid transmission pipe 1597 may transfer lighter than air gas from an air compressor or chemical converter to a balloon or inflatable member. An exemplary embodiment of an energy generating device 1600 may include one or more outer track 1425 and one or more inner track such as one or more track 1500, 1550, 1501, 1551, 1525, 1575, 1504 or 1508 or similar track. One of ordinary skill in the art will recognize that any kind of track or rail or the like can be used in an energy generating device without departing from the spirit or scope of this disclosure. Note that, like many exemplary embodiments depicted herein, some of the members of exemplary embodiments depicted herein, for example, some of the members of an exemplary embodiment of an energy generating device 1600 such as one or more magnet 1610 and one or more conductive coils 1466 may be depicted in an exploded, extruded or expanded view.

An energy generating device 1600 may include one or more magnet 1610 configured to rotate around a track such as track 1550, which track 1550 may include conductive wires, such as one or more alternative conductive wire assembly 1511, 1577 or 1588, or any other alternative conductive wire assembly such as alternative conductive wire assembly 1569. The rotation of one or more magnet 1610 around one or more alternative conductive wire assembly 1511, 1577 or 1588, or any other alternative conductive wire assembly such as alternative conductive wire assembly 1569 may induce current in one or more alternative conductive wire assembly 1511, 1577 or 1588, or any other alternative conductive wire assembly such as alternative conductive wire assembly 1569. Note that any reference herein to conductive coils or a conductive coil assembly should also be understood to include any alternative conductive wire assembly, regardless of whether or not the alternative wire assembly contains conductive coils or some other conductive wire configuration. Energy generating device 1600 is configured to operate with several similar principles to the exemplary selection of devices depicted herein, for example, the relative rotation between a first body portion and a second body portion enables the generation of electrical energy by an electrical generator that may include magnets and conductive wires and the ability to descend through a fluid medium at least partly under the influence of gravity and ascend through a fluid at least partly by changes in buoyancy caused by a buoyancy modulator.

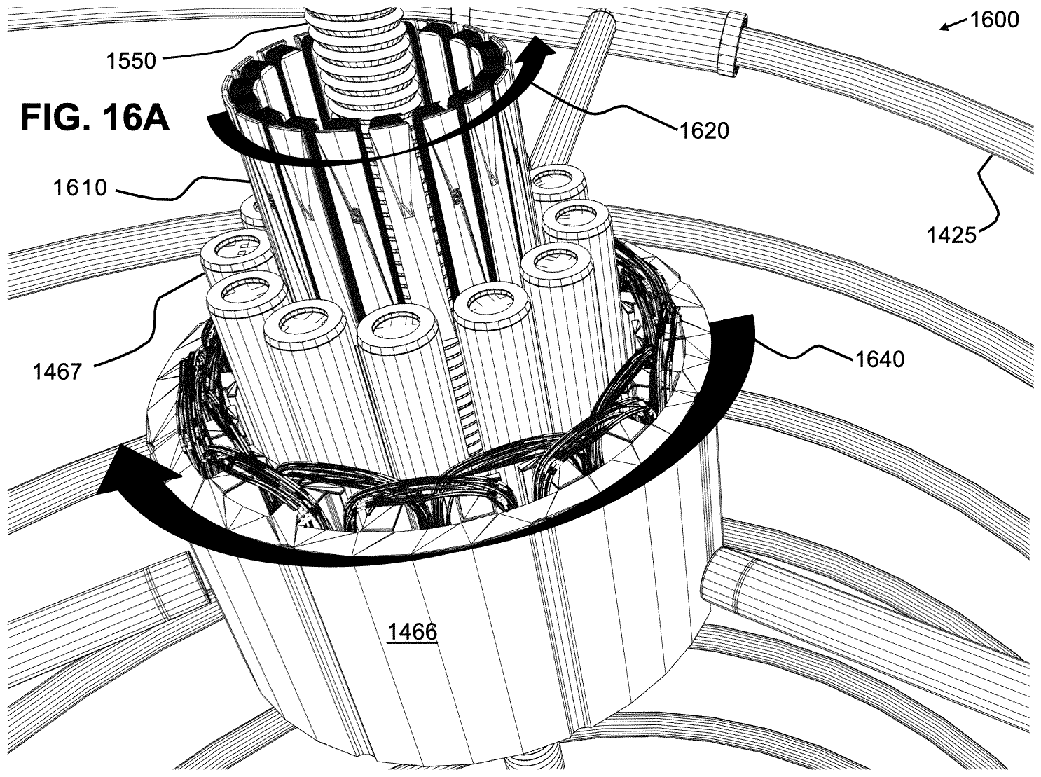

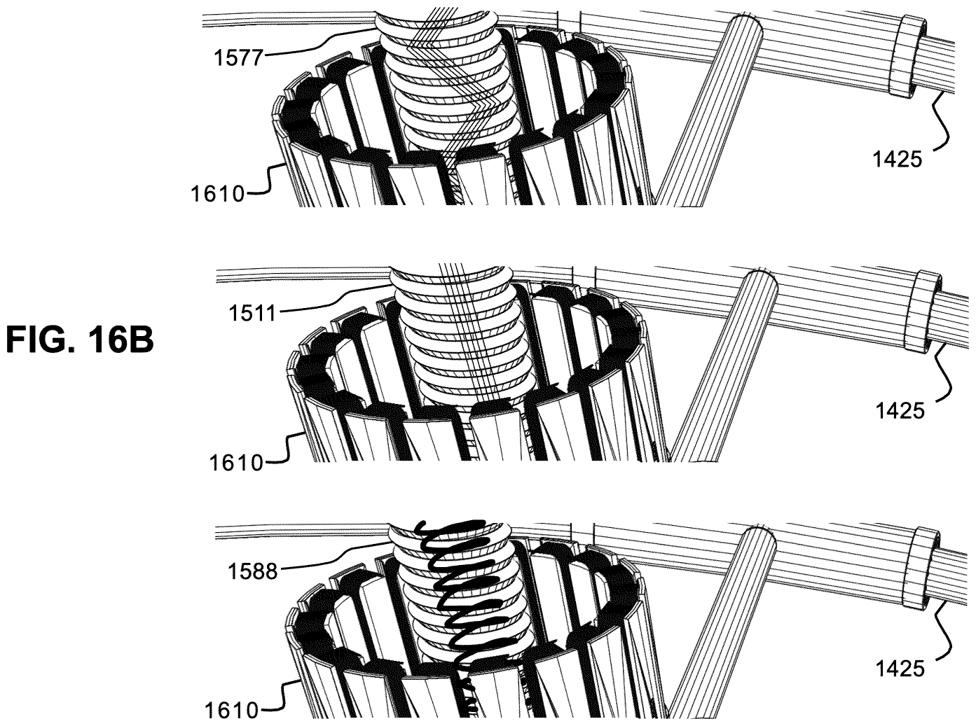

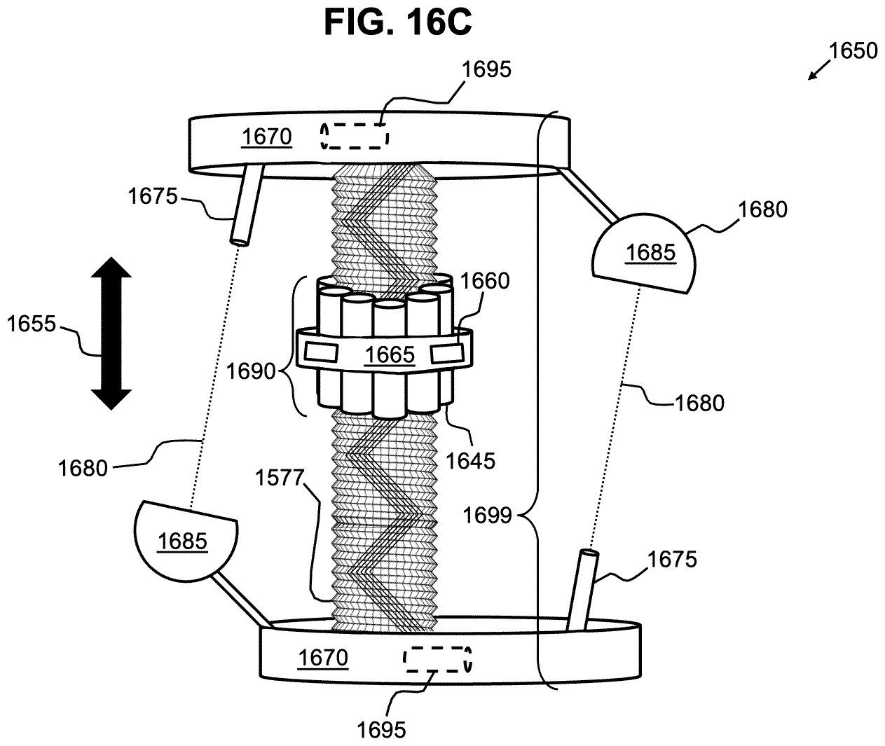

Now referring to FIG. 16C, an exemplary energy generating device 1650 is depicted. Device 1650 may include kinetic unit 1690 and one or more energy transfer system 1699. Kinetic unit 1690 may include a magnet array 1645, which may be coupled to an inflatable ring or other inflatable device 1665, which may be coupled to and provide lighter than air gas to and receive lighter than air gas from an air compressor and compressed air tank or other buoyancy modulator 1660. Magnet array 1645 may be rotatably coupled to a track containing alternative conductive wire assembly 1577, which may include or contain non-coiled conductive wires in any shape such as a zig zag shape illustrated in FIG. 16C. The wires of alternative conductive wire assembly 1577 may run from a top point electrically coupled to energy transfer system 1699 to a bottom point electrically coupled to another energy transfer system 1699. Energy transfer system 1699 may include an electronics box 1670, a neodymium-doped yttrium aluminum garnet laser 1675 or any other type of laser, a photovoltaic array 1685, and a battery 1695. An electronics box 1670 may be electronically coupled to a neodymium-doped yttrium aluminum garnet laser 1675 or any other type of laser. An electronics box 1670 may be electronically coupled to a photovoltaic array 1685 or any other type of solar power device or any other device that can receive photons and output electricity such as a thermal generator. Battery 1695 may be used to power neodymium-doped yttrium aluminum garnet laser 1675 or any other type of laser.

When buoyancy modulator 1660 increases or decreases the buoyancy of kinetic unit 1690, kinetic unit 1690 may travel in a direction 1655. As kinetic unit 1690 travels in a direction 1655, the relative movement of magnet array 1645 with alternative conductive wire assembly 1577 may cause the generation of electricity in alternative conductive wire assembly 1577. Generation of electricity in alternative conductive wire assembly 1577 may provide electrical current to neodymium-doped yttrium aluminum garnet laser 1675 (or any other type of laser), which may shoot a laser beam or photons 1680 into a photovoltaic array 1685. Photovoltaic array 1685 may convert photons received from neodymium-doped yttrium aluminum garnet laser 1675 into electricity, which may be stored in a battery 1695 or used for any purpose. Many alternatives to using a laser to send photons to a photovoltaic array exist, for example, an electromagnetic wave generator such as a microwave generator could send microwaves to a microwave receiver to complete the circuit rather than using a laser to send photons to a photovoltaic array. One of ordinary skill in the art will recognize that any energy transfer system can be used to complete the circuit of an energy generating device using a non-coiled conductive wire.

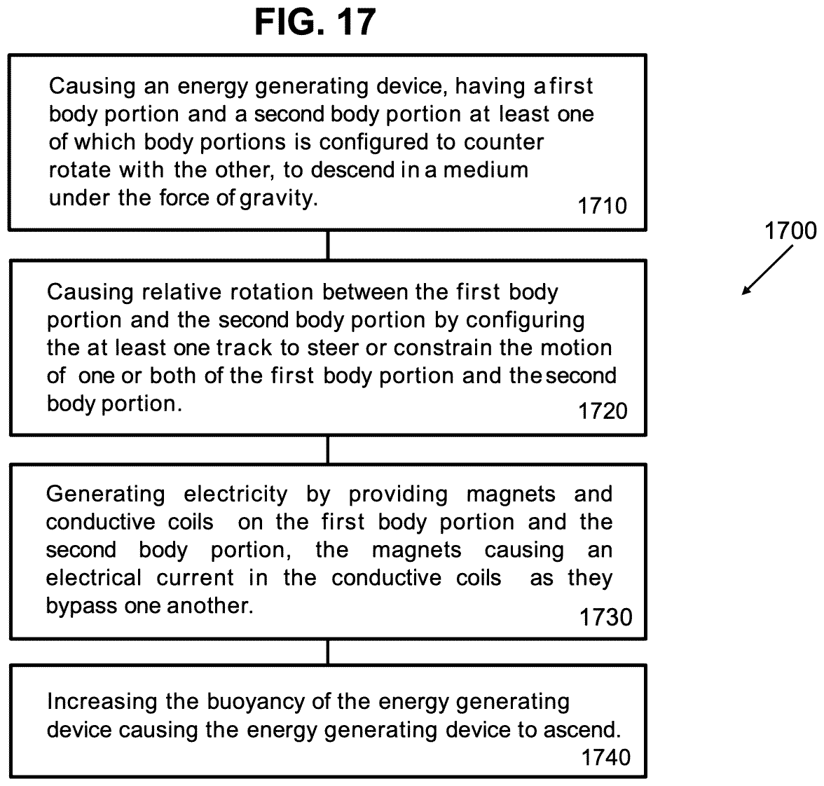

An exemplary method of operation 1700 is depicted in FIG. 17. Method of operation 1700 may include causing an energy generating device, having a first body portion and a second body portion at least one of which body portions is configured to counter rotate with the other, to descend in a medium under the force of gravity (process 1710). The method also may include causing relative rotation between the first body portion and the second body portion by configuring the at least one track to steer or constrain the motion of one or both of the first body portion and the second body portion (process 1720). The method also may include generating electricity by providing magnets and conductive coils on the first body portion and the second body portion, the magnets causing an electrical current in the conductive coils as they bypass one another (process 1730). Further still, the method may include increasing the buoyancy of the energy generating device causing the energy generating device to ascend (process 1740).

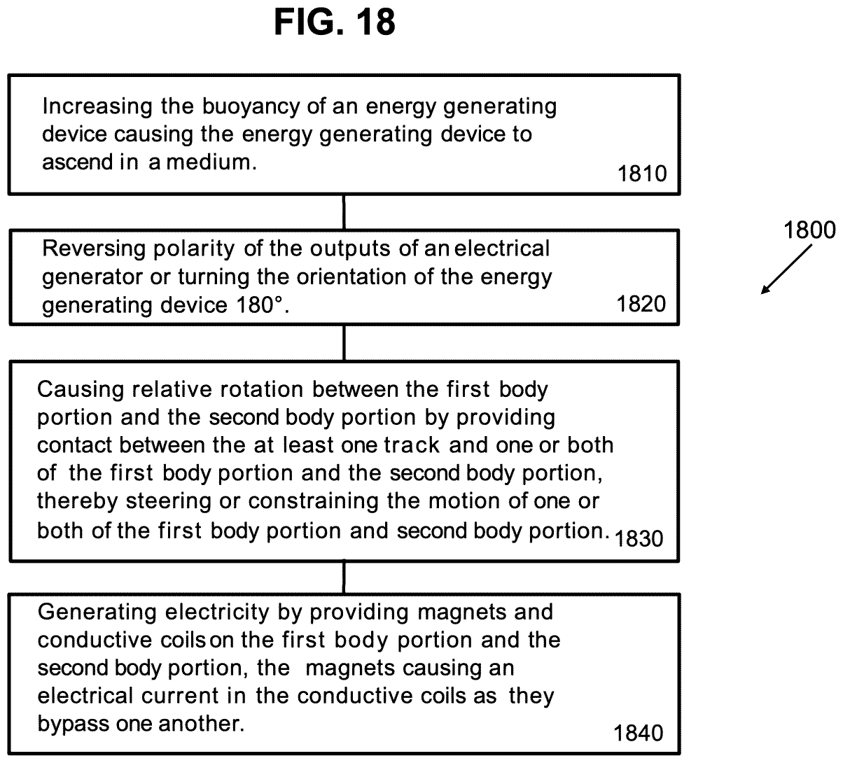

Another exemplary method of operation 1800 is depicted in FIG. 18. Method of operation 1800 may include increasing the buoyancy of an energy generating device causing the energy generating device to ascend in a medium (process 1810). The method further may include reversing polarity of the outputs of an electrical generator or turning the orientation of the energy generating device 180° (process 1820). The method also may include causing relative rotation between the first body portion and the second body portion by providing contact between the at least one track and one or both of the first body portion and the second body portion, thereby steering or constraining the motion of one or both of the first body portion and second body portion (process 1830). The method also may include generating electricity by providing magnets and conductive coils on the first body portion and the second body portion, the magnets causing an electrical current in the conductive coils as they bypass one another (process 1840).

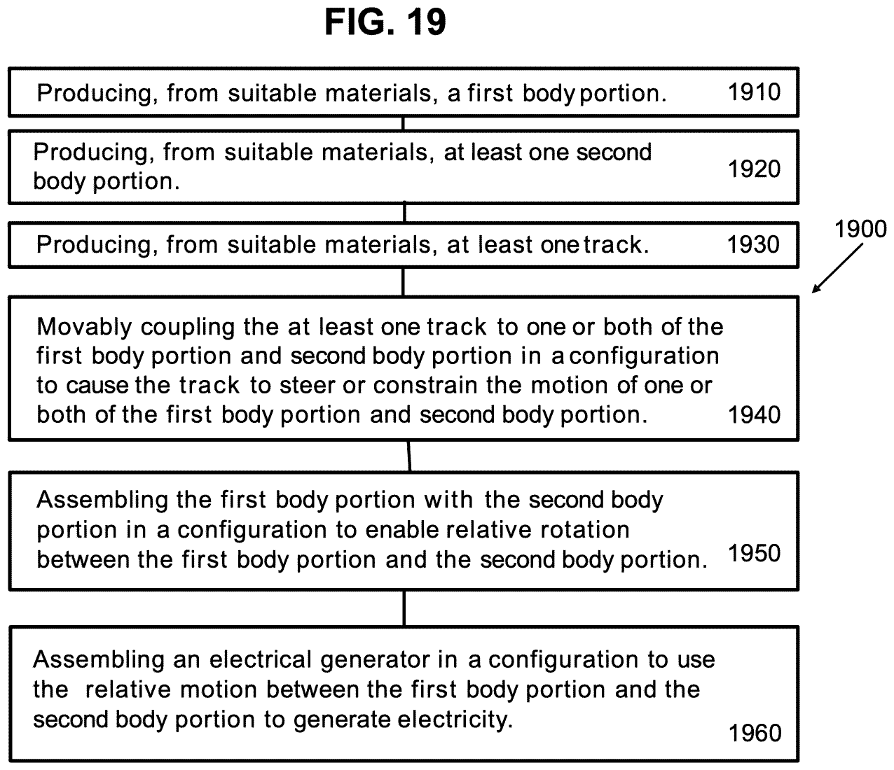

Referring now to FIG. 19, a method 1900 of manufacturing an energy generating device is depicted. The method may include producing, from suitable materials, a first body portion (process 1910). The method also may include producing, from suitable materials, at least one second body portion (process 1920). Further, the method may include producing, from suitable materials, at least one track (process 1930). Suitable materials for the various parts and portions may include but are not limited to metals, metal alloys, composites, polymers, plastics, ceramics, nanomaterials, etc. Further still, the method may include movably coupling the at least one track to one or both of the first body portion and second body portion in a configuration to cause the track to steer or constrain the motion of one or both of the first body portion and second body portion (process 1940) and assembling the first body portion with the second body portion in a configuration to enable relative rotation between the first body portion and the second body portion (process 1950). Further still, the method may include assembling an electrical generator in a configuration to use the relative motion between the first body portion and the second body portion to generate electricity (process 1960). In some exemplary embodiments the first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

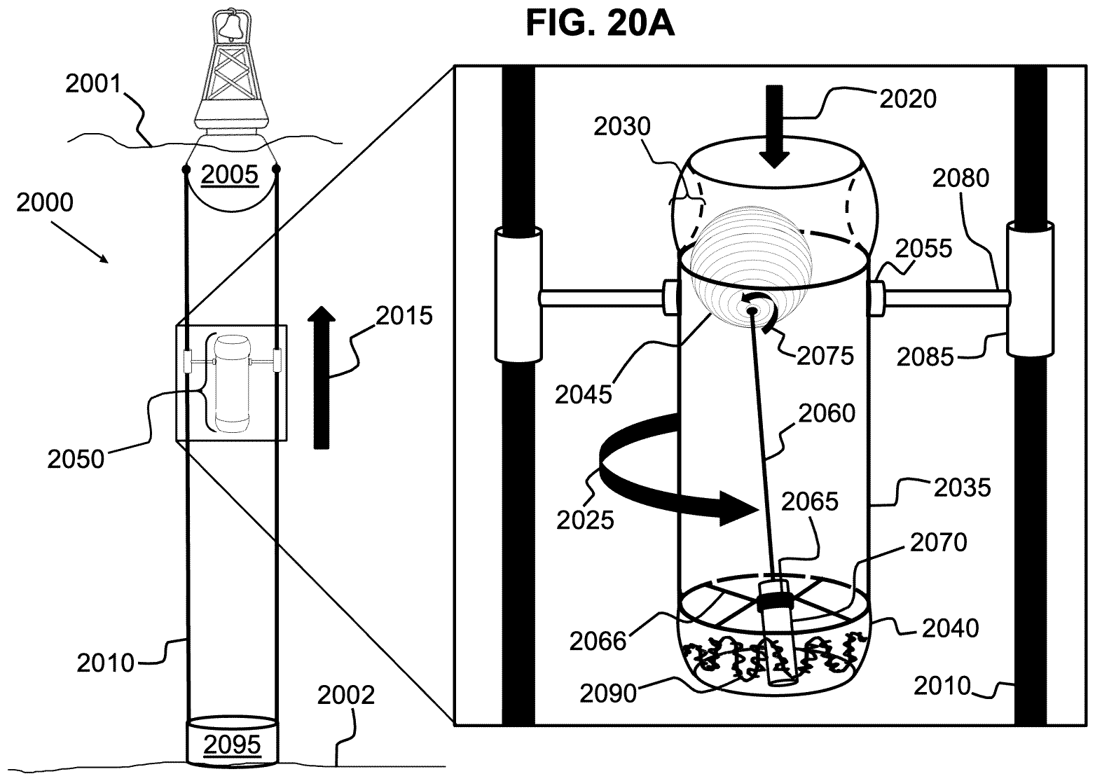

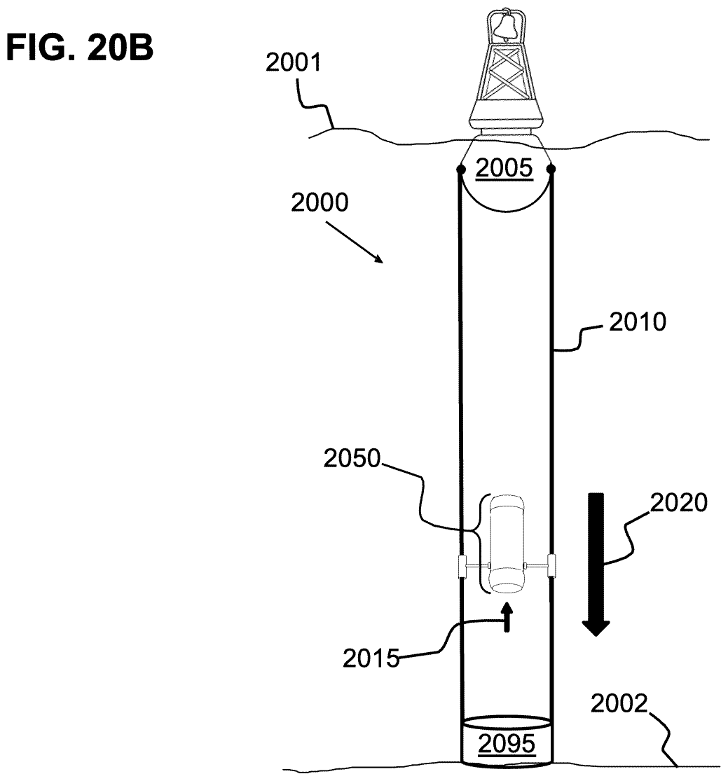

Referring now to FIGS. 20A and 20B, an exemplary embodiment of an energy generating device 2000 may include one or more top flotational member such as buoy 2005 which may be coupled to one or more track such as one or more straight track 2010, which may be coupled to one or more anchoring member 2095. Buoy 2005 may be configured to remain at or near the surface of a medium such as ocean surface 2001 while anchoring member 2095 may be configured to remain anchored to the floor of a medium such as ocean floor 2002. Buoy 2005 and anchoring member 2095 may be configured to hold and maintain one or more track 2010 in a substantially vertical orientation. A marine kinetic member 2050 make be configured to move up and down one or more track 2010. A marine member may contain a first body portion such as shaft 2060, which may be coupled to a first force input structure such as spherical or semispherical force input structure 2045. A second body portion such as marine member middle portion 2035 may be rotatably coupled to one or more guide arm 2080 by one or more rotational member such as bearing 2055. Guide arm 2080 may be coupled to one or more slide unit 2085 which slide unit 2085 may be movably coupled to one or more track 2010. Marine member middle portion 2035 may be coupled to weighted member 2040, which may include conductive coil assembly 2090. A buoyancy modulator such as ballast system 2030 may be configured to alternate between filling with a compressed gas such as air, and ballast such as water. The relation of weights of weighted member 2040 and ballast system 2030 may be such that when one or more ballast tank of ballast system 2030 fills with air, marine kinetic member 2050 ascends substantially in direction 2021 in the orientation depicted in FIG. 20A. The relation of weights of weighted member 2040 and one or more ballast tank of ballast system 2030 may be such that when one or more ballast tank of ballast system 2030 fills with water, marine kinetic member 2050 descends substantially in direction 2020 in the orientation depicted in FIG. 20B.

As marine kinetic member 2050 travels in a substantially upward direction 2021, water moves through a pass through in marine kinetic member 2050 substantially in direction 2020 relative to marine kinetic member 2050, causing a member such as spherical or semispherical force input structure 2045 to roll around the inside of marine member middle portion 2035 in direction 2025, which causes spherical or semispherical force input structure 2045 to rotate in direction 2075. Spherical or semispherical force input structure 2045 is coupled to shaft 2060, which is coupled to magnet 2070. Magnet 2070 and conductive coil assembly 2090 may be included in an electrical generator. Magnet 2070 is rotationally coupled to bearing 2065, which causes magnet 2070 to rotate in relation to conductive coil assembly 2090. The outer surface of bearing 2065 is coupled to one or more flexible arm 2066, which are coupled to marine member middle portion 2035. Like several other exemplary embodiments, exemplary embodiment 2000 has been depicted as generating electricity in a liquid medium, in this example, the ocean. Exemplary embodiment 2000 may also function in a gas medium, for example, air such as the atmosphere.

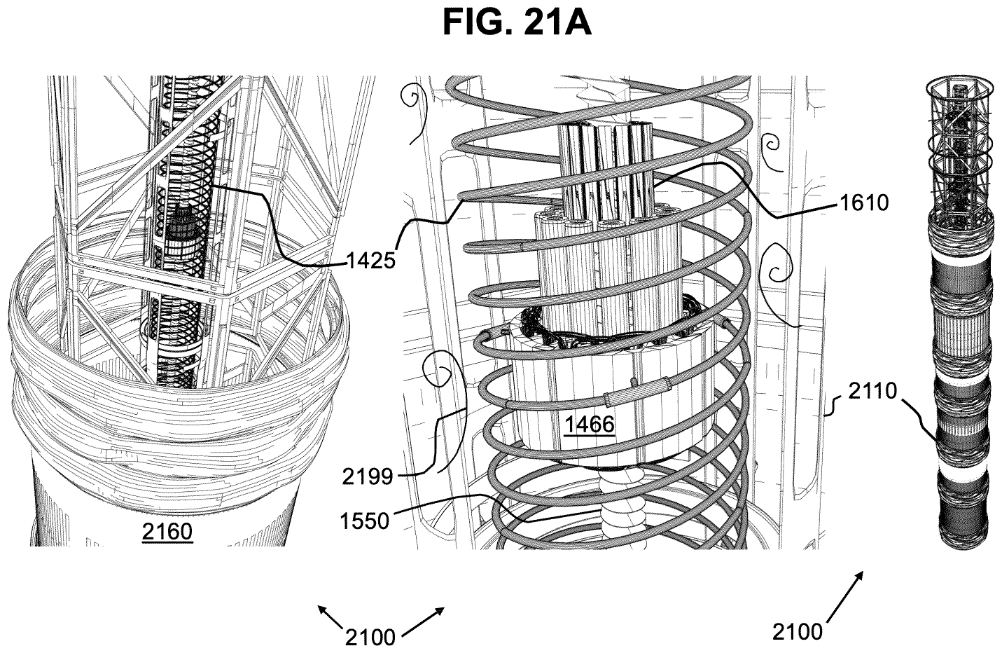

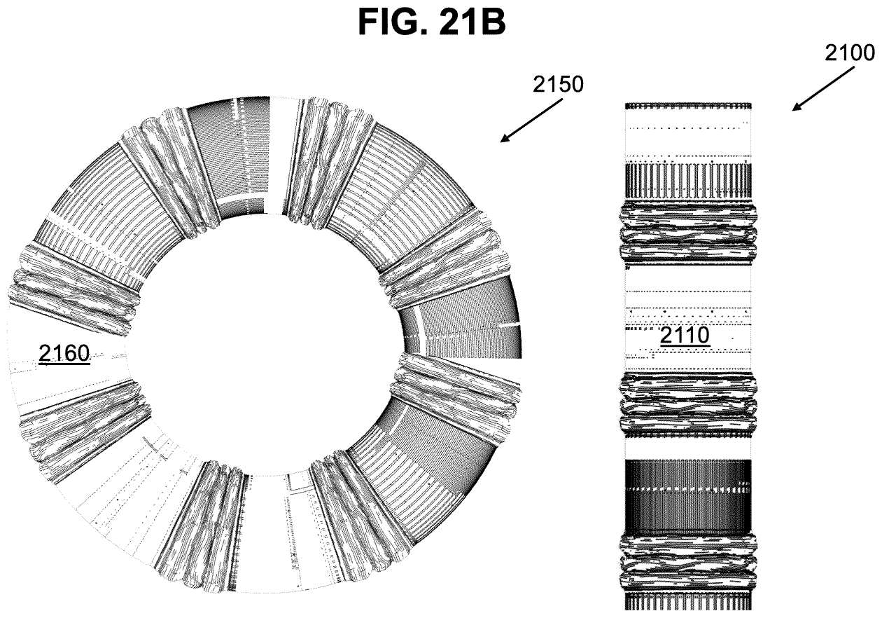

Some exemplary embodiments of an energy generating device may be located in a natural medium such as but not limited to an ocean or the open air or atmosphere, while other embodiments may be located in an artificial or contained medium. Referring now to FIGS. 21A and 21B, an exemplary embodiment of an energy generating device 2100 and an exemplary embodiment of an energy generating device 2150 may include a vessel such as but not limited to a linear vessel 2110 or a nonlinear vessel such as a circuitous vessel 2160, which contains a medium, for example, air or a gas or any fluid 2199. An exemplary embodiment of an energy generating device 2100 may include a first body portion including a first force input member such as one or more outer track 1425, a second body portion including a second force input member such as one or more inner twisted screw-like track 1550 that is located within the pass through of the first body portion, and an electrical generator that may include one or more counterrotating magnet 1610 and conductive coils 1466. Energy generating devices 2100 and 2150 are configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator.

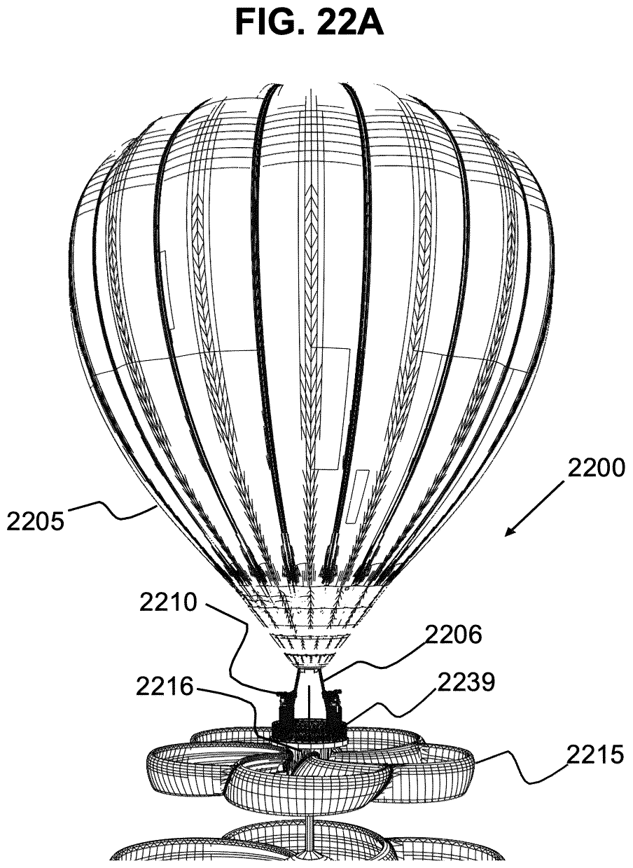

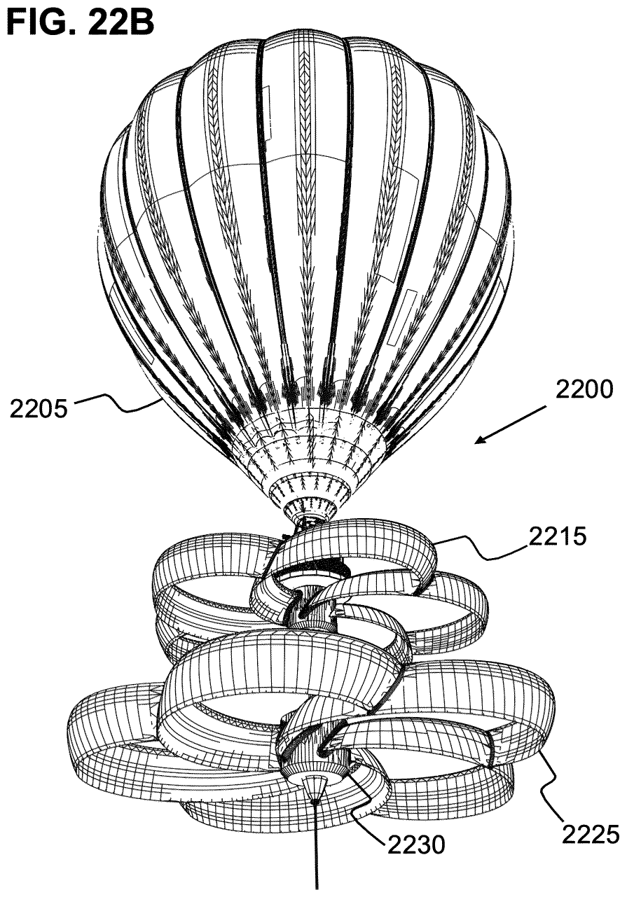

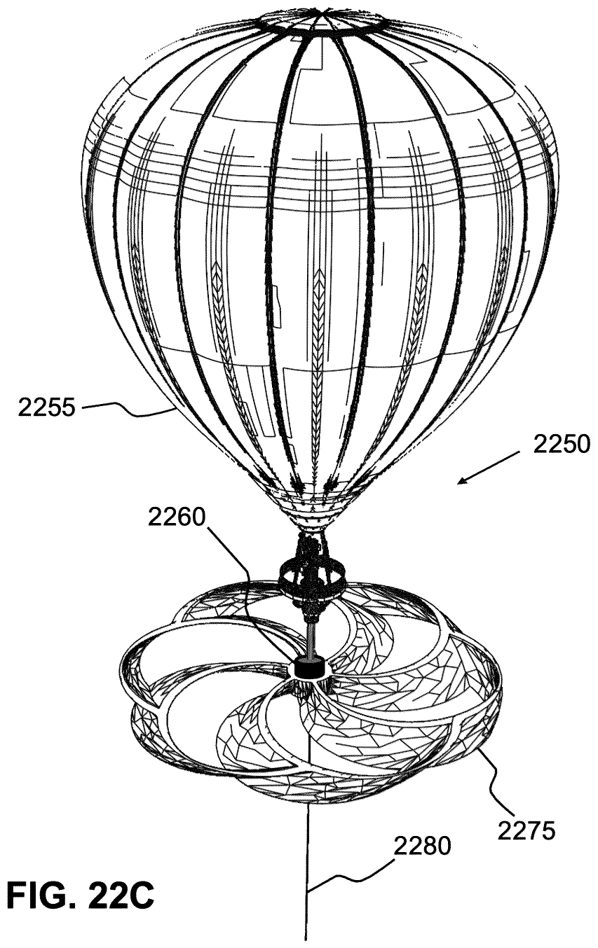

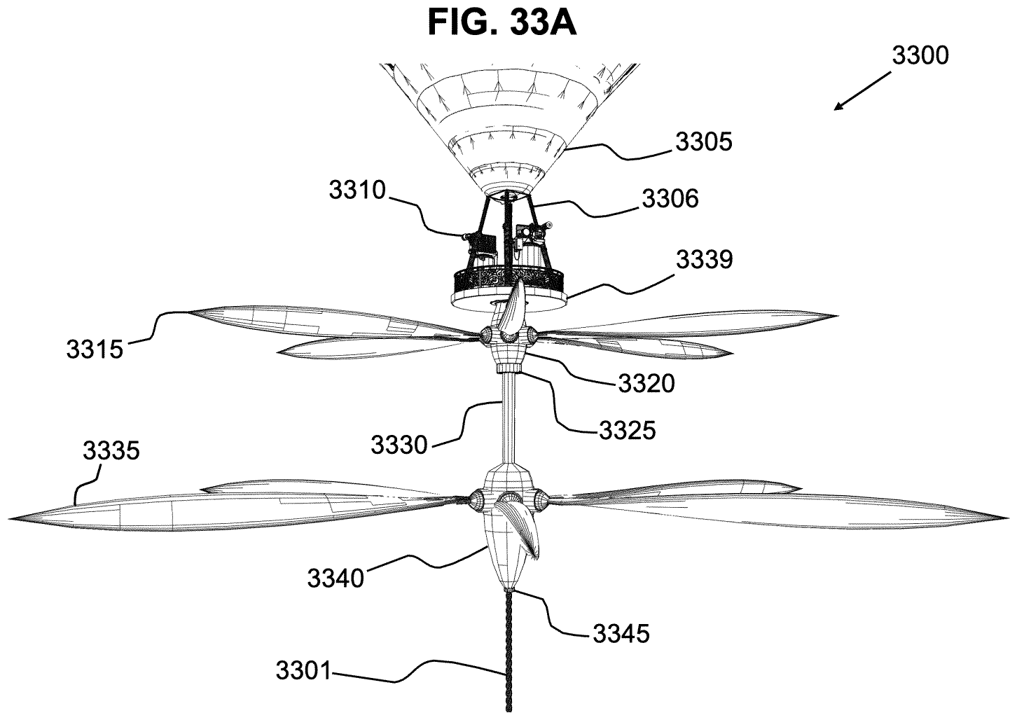

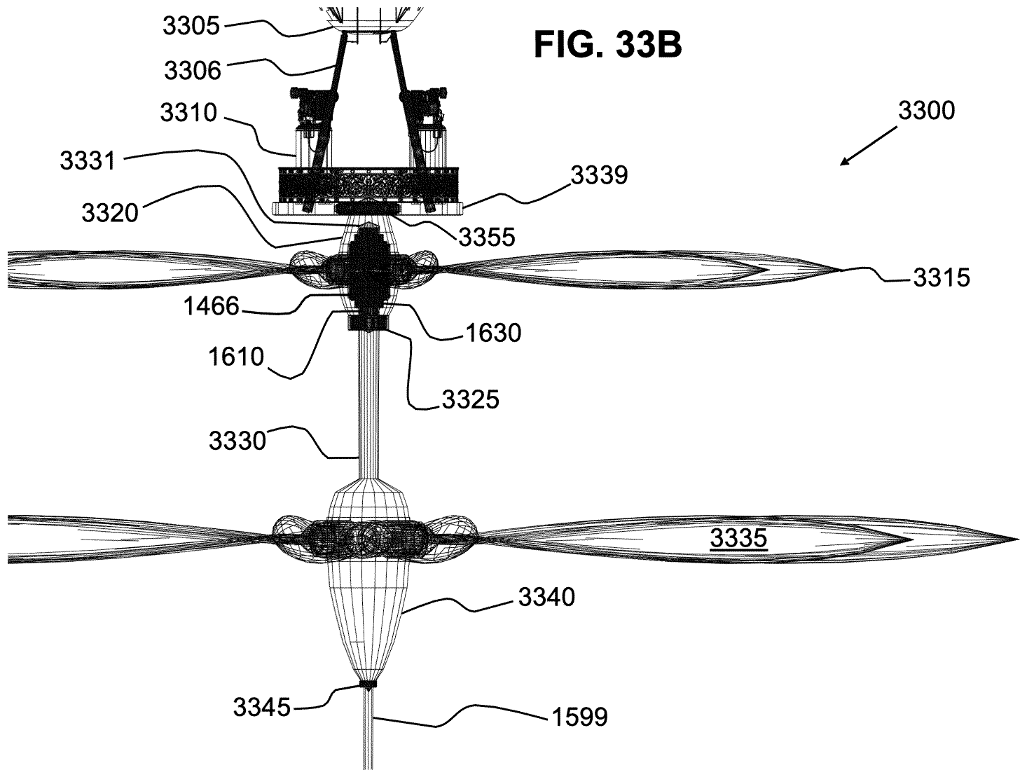

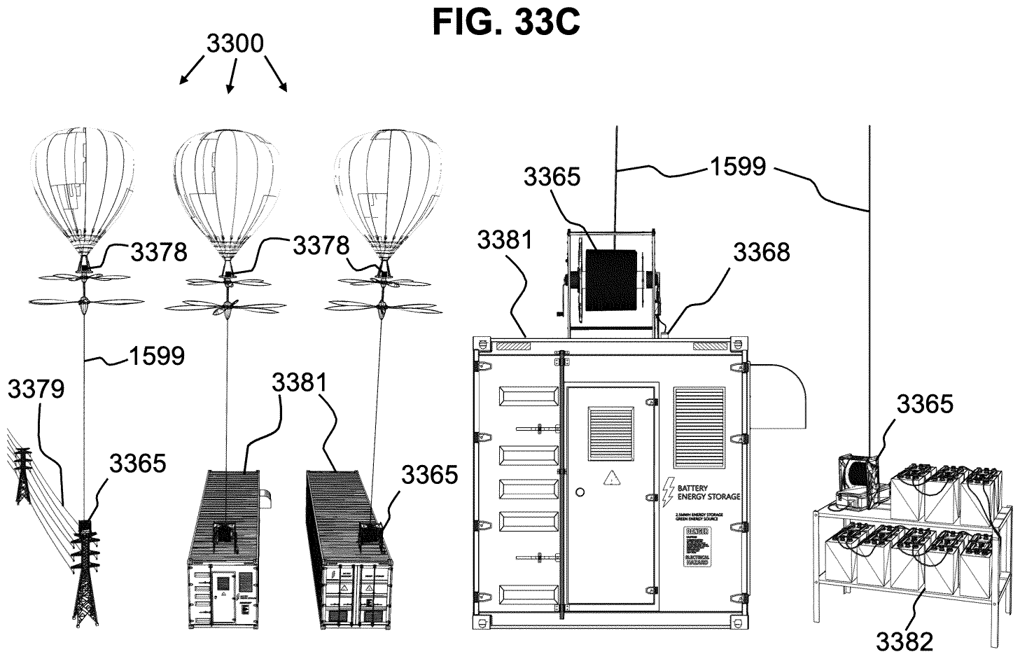

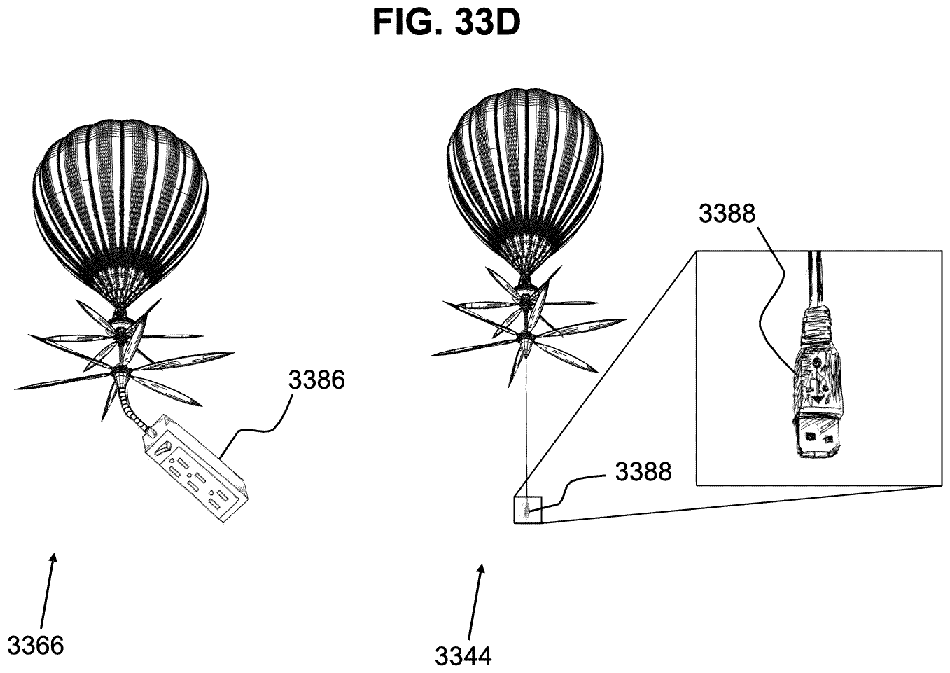

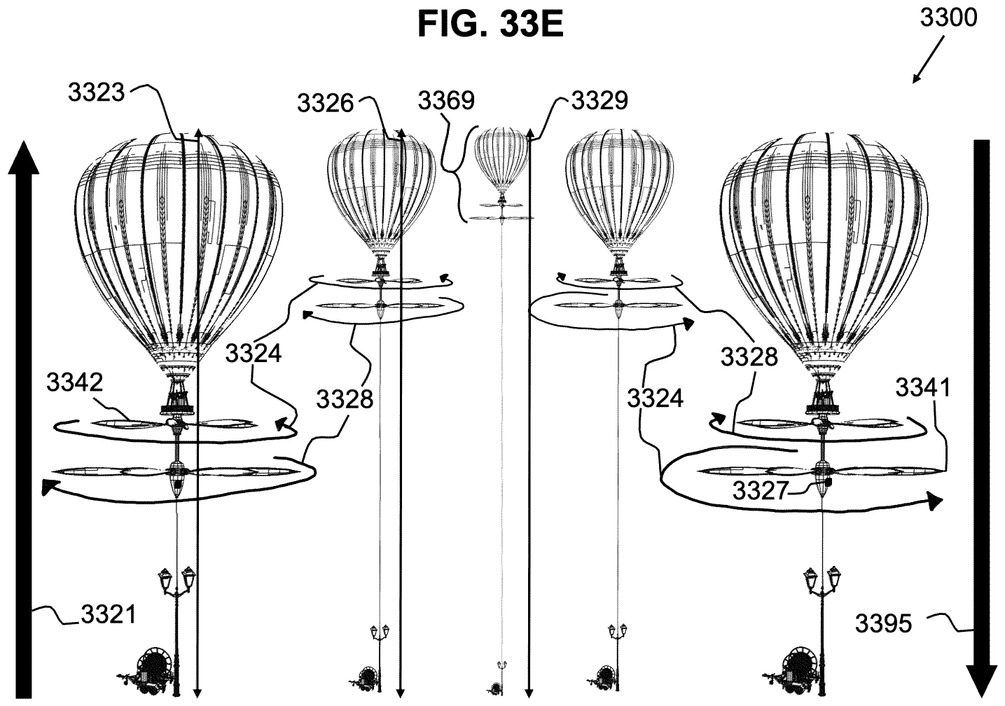

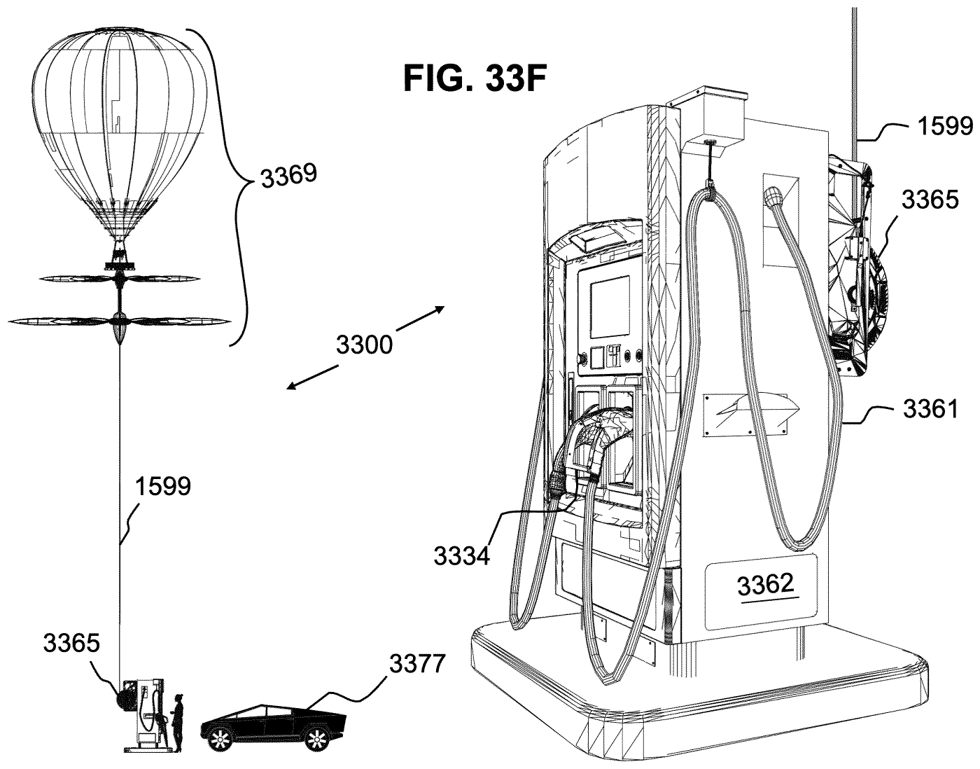

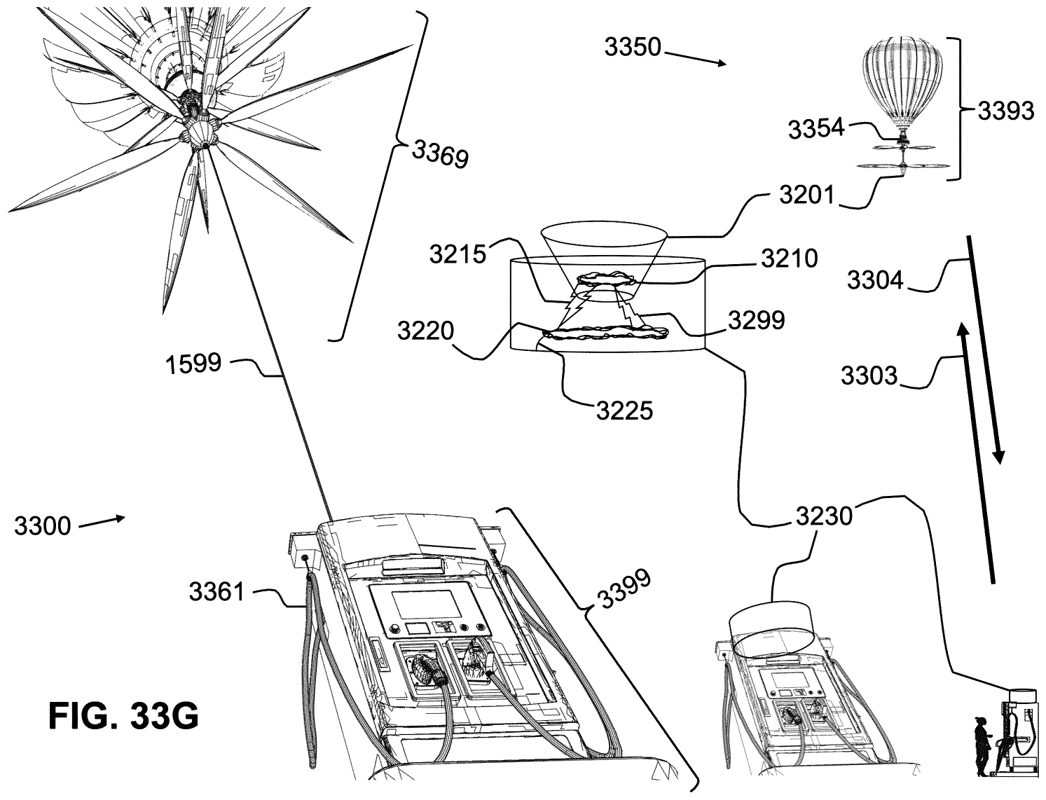

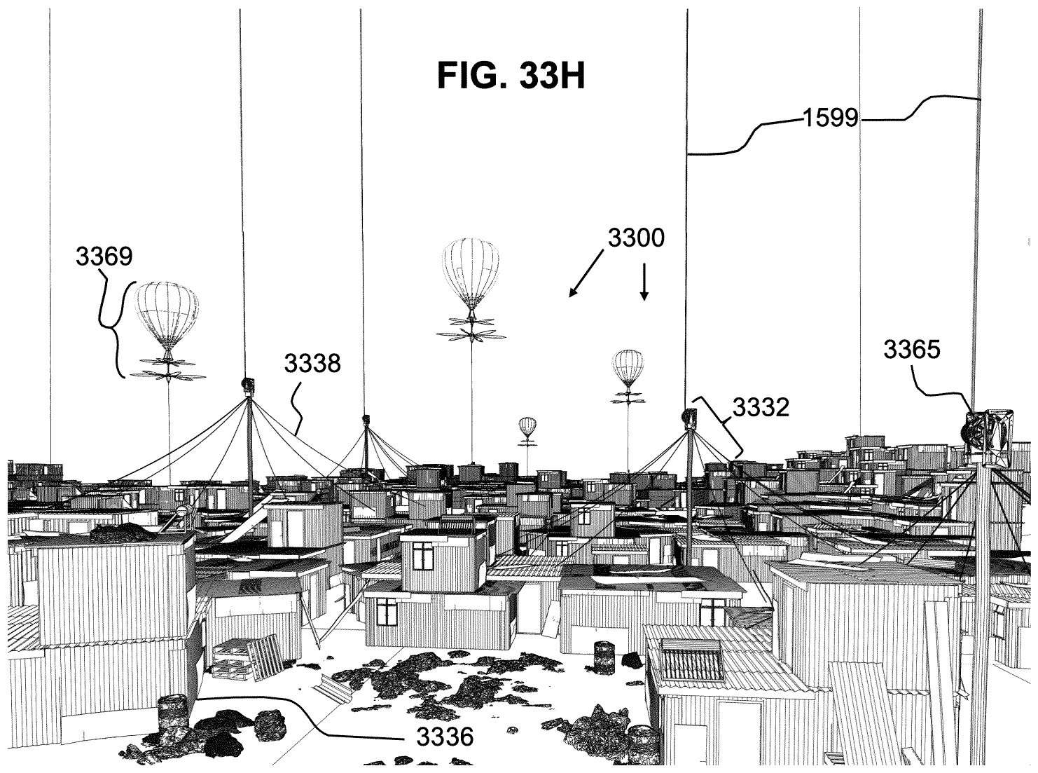

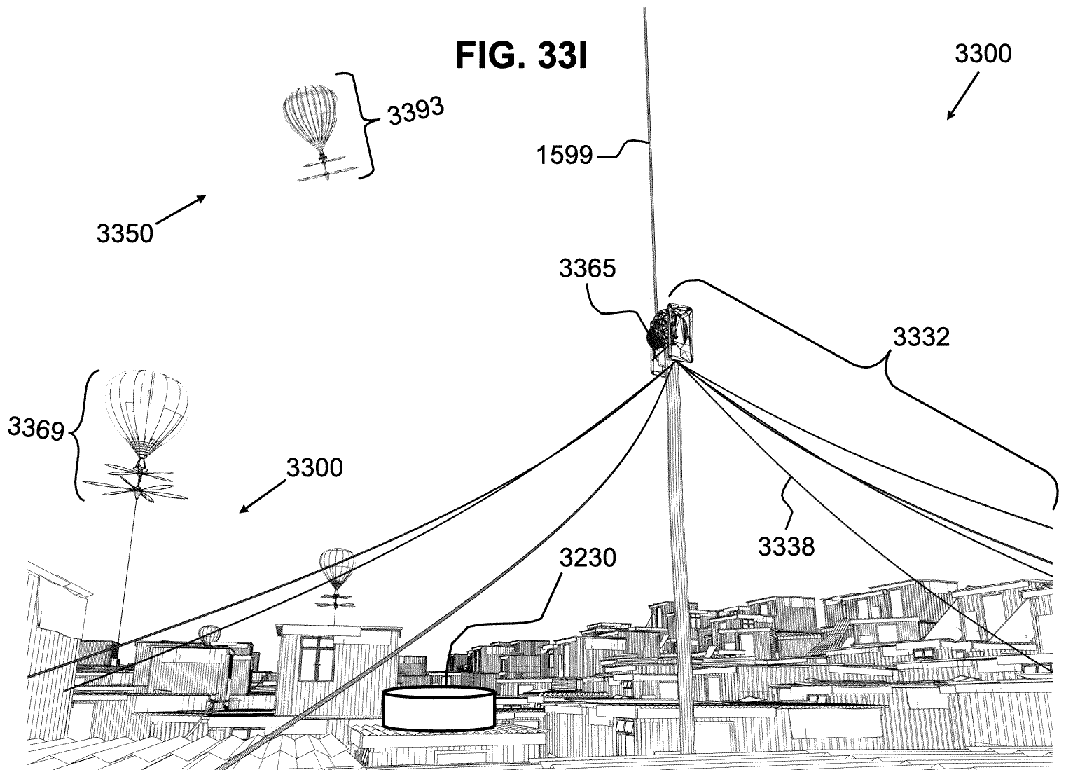

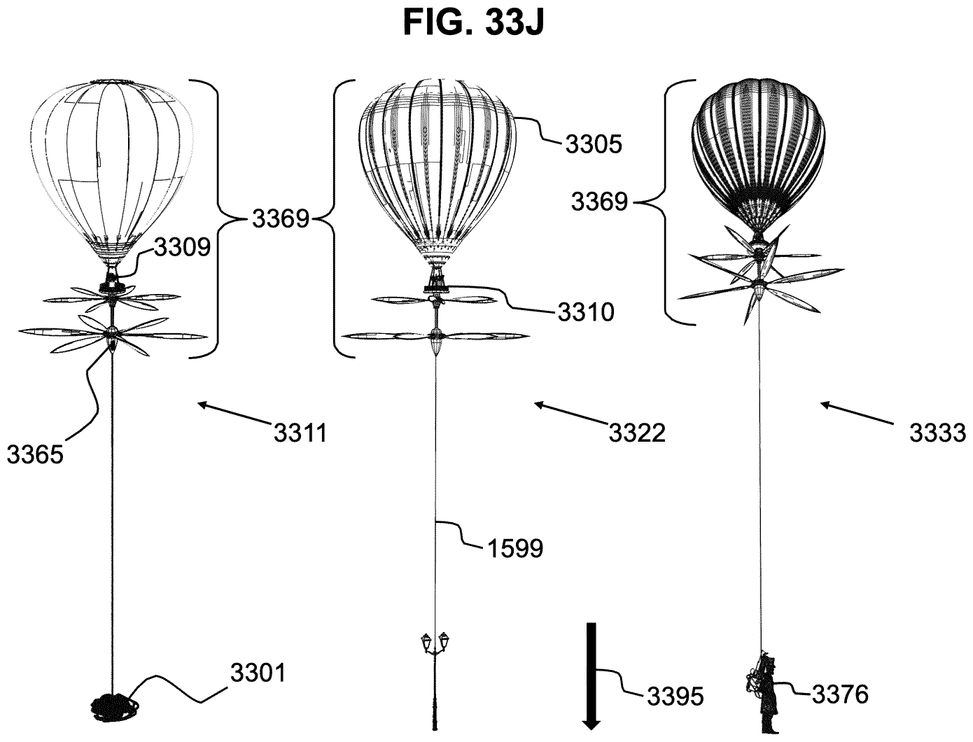

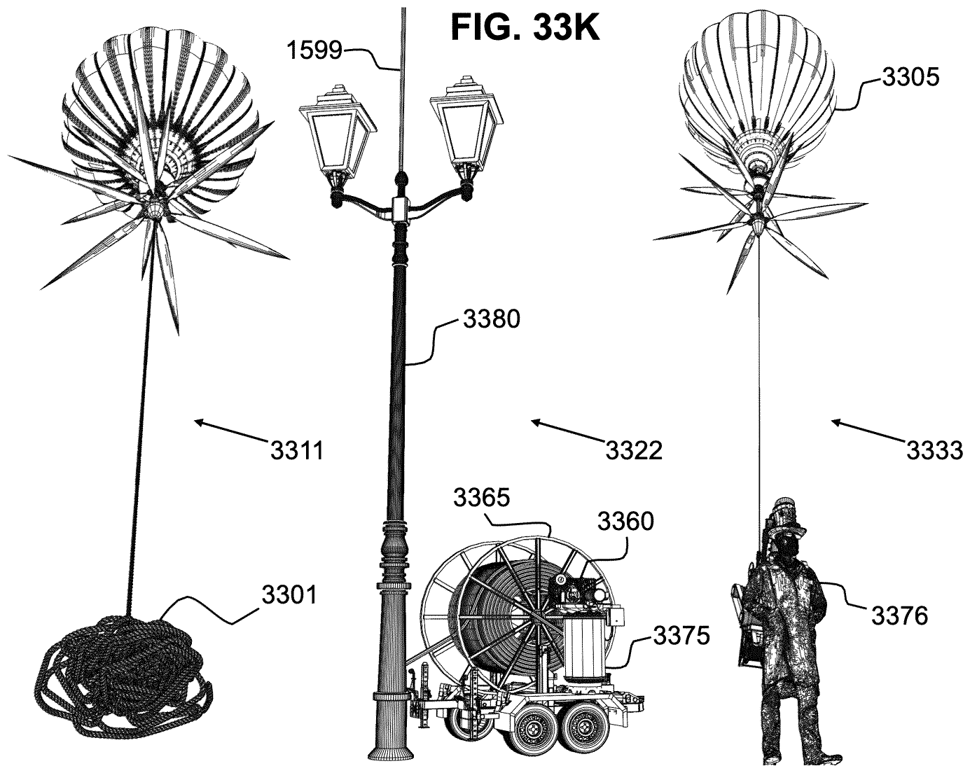

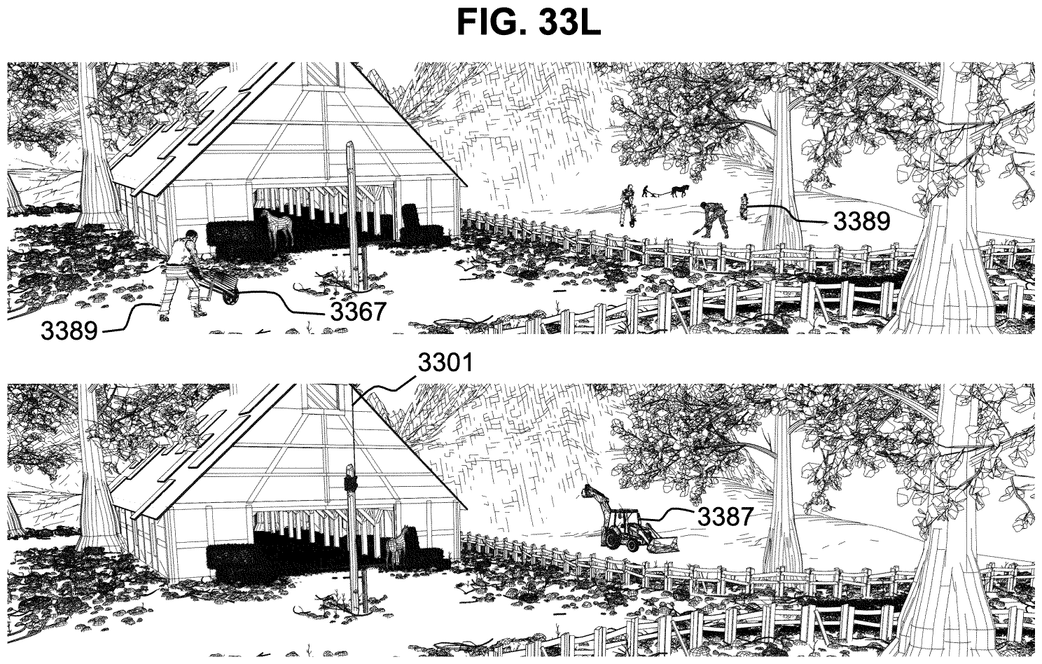

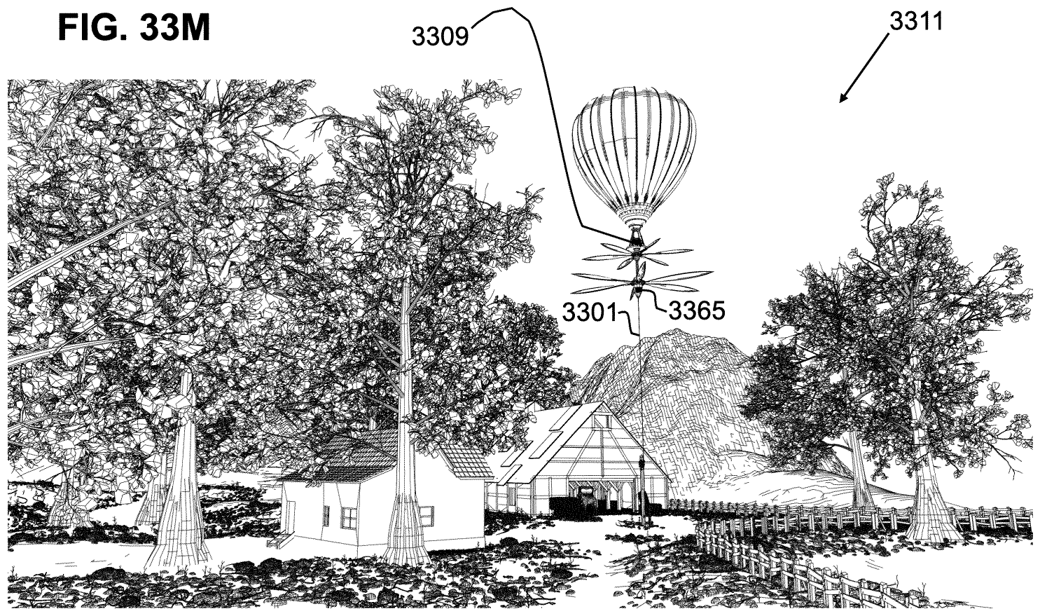

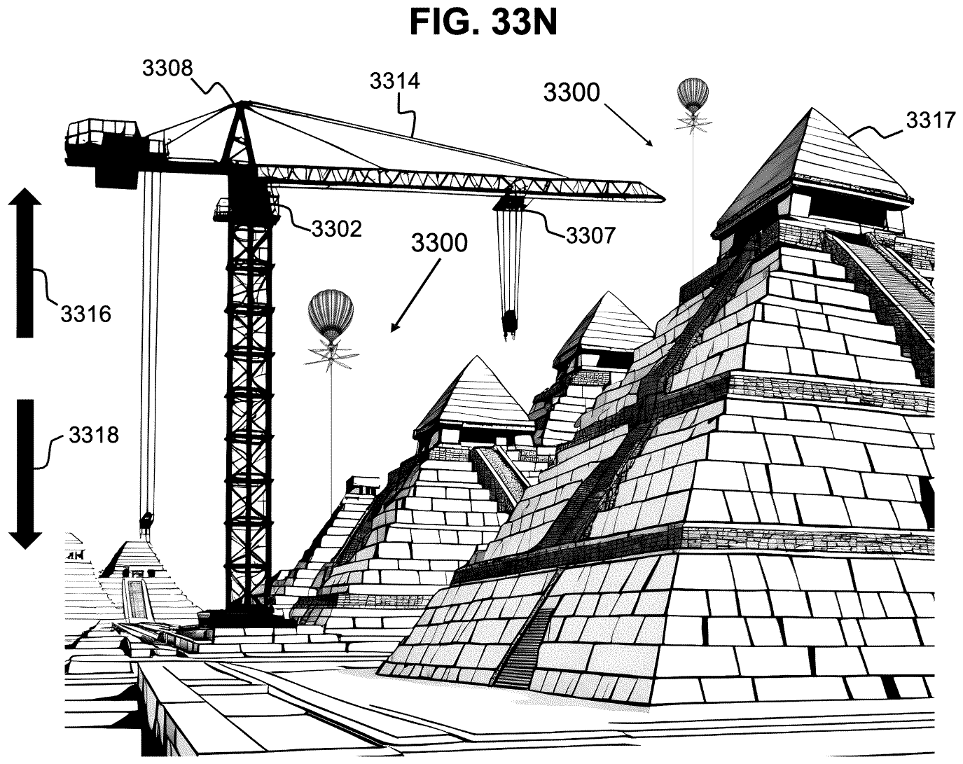

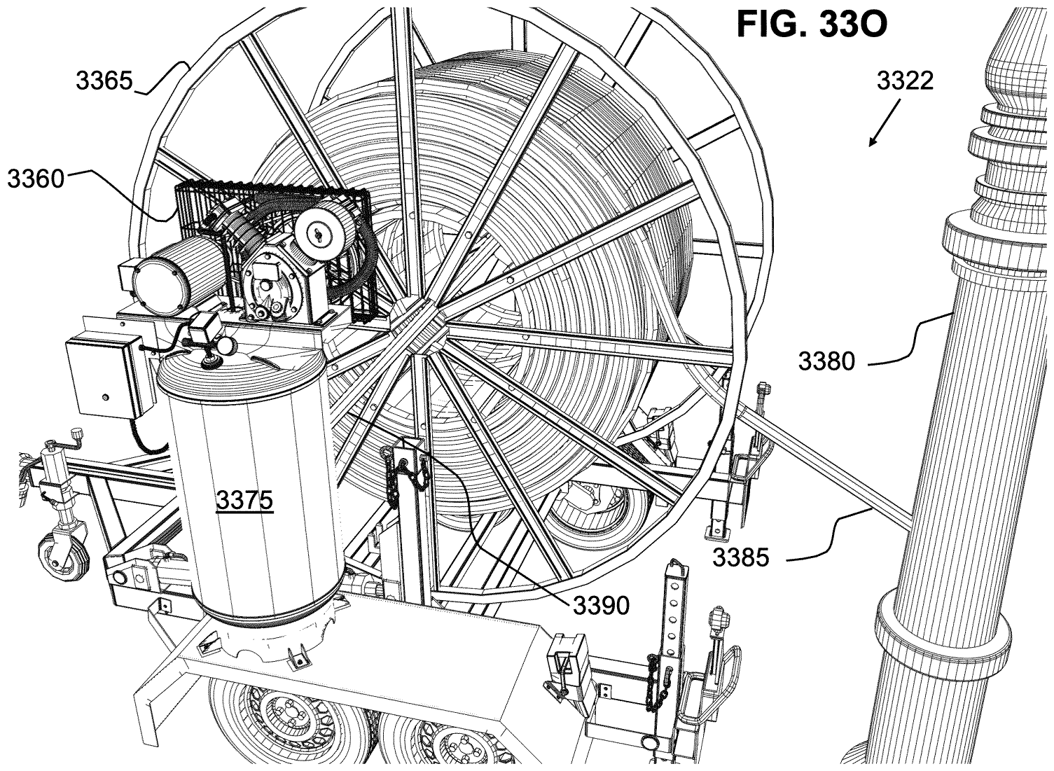

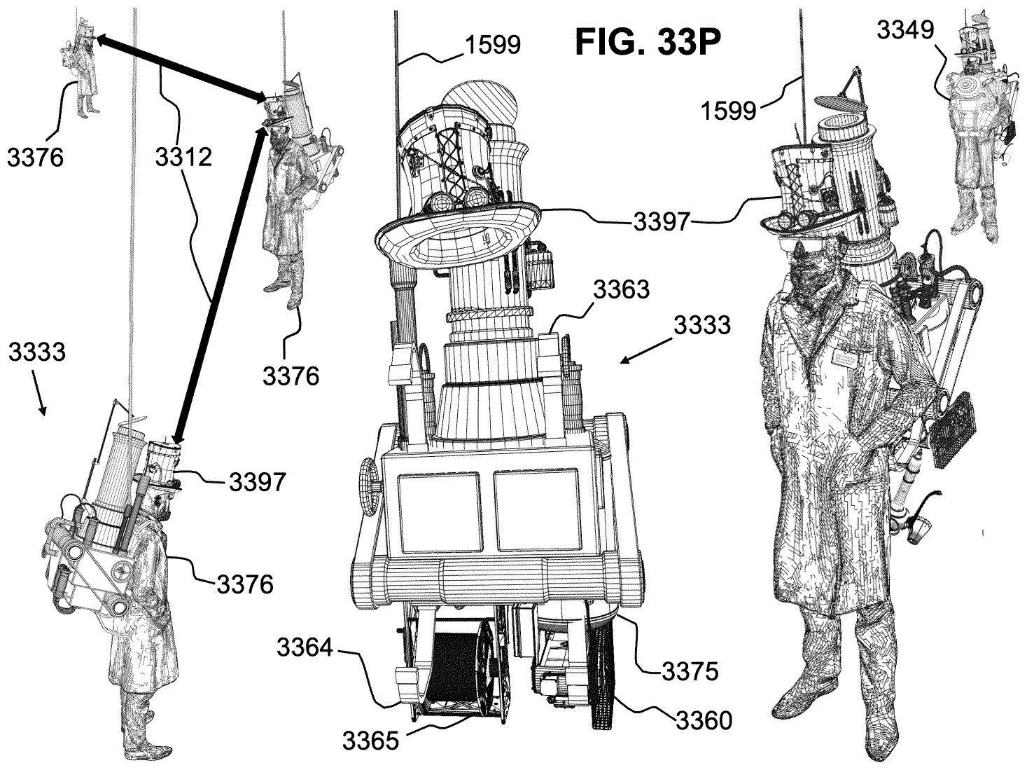

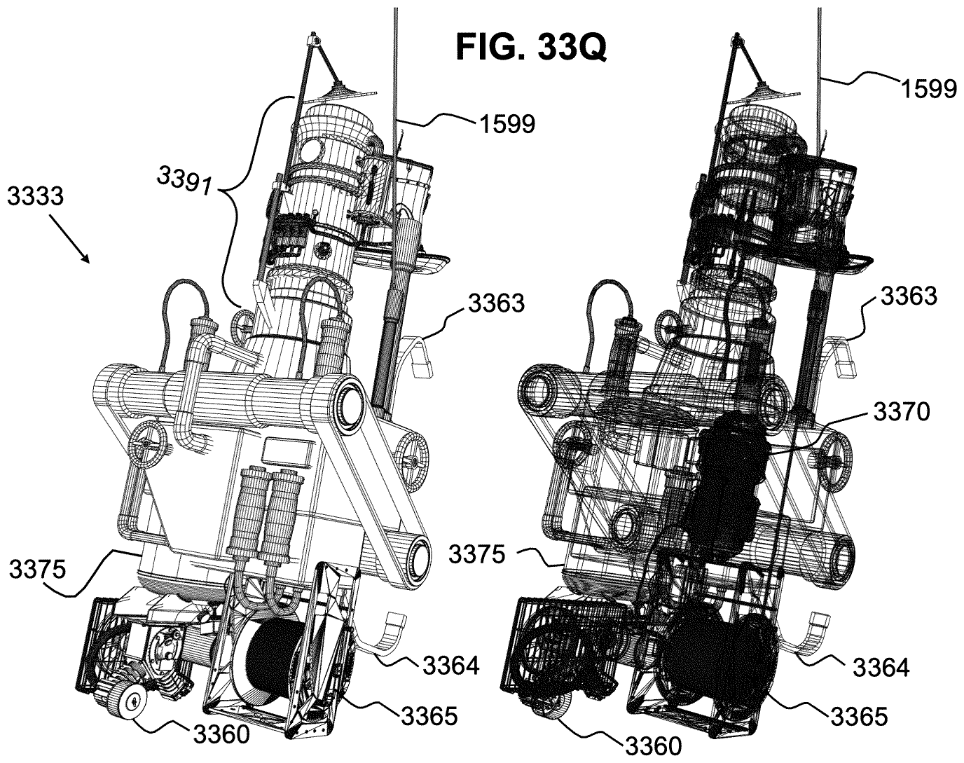

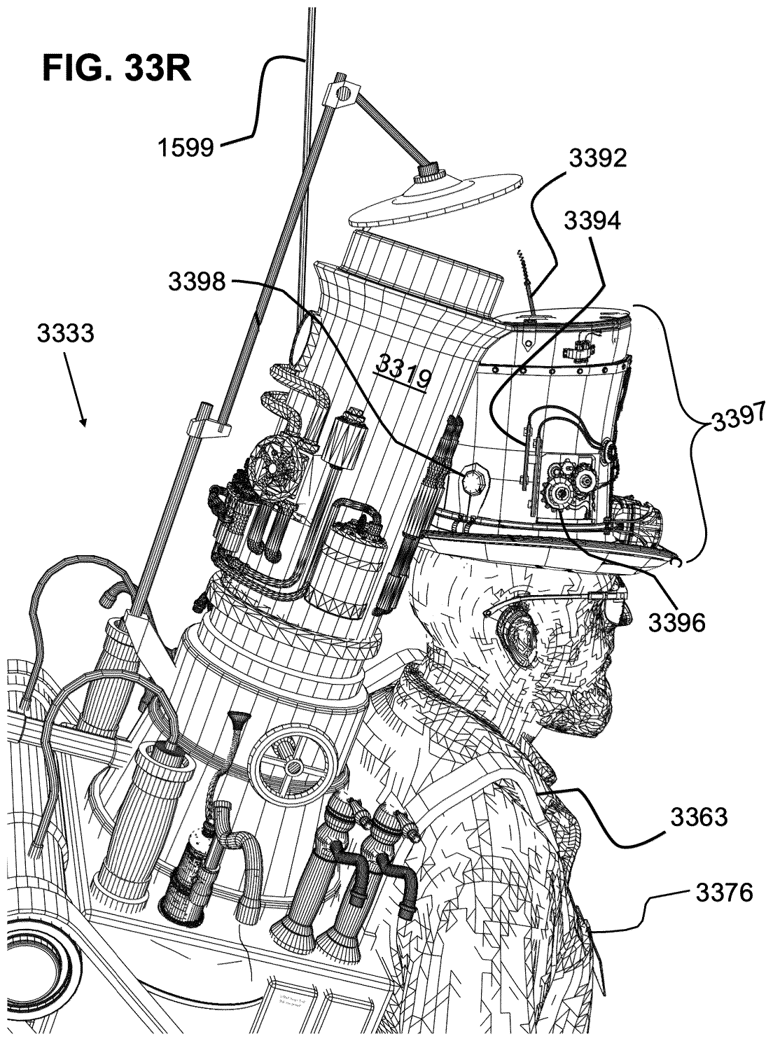

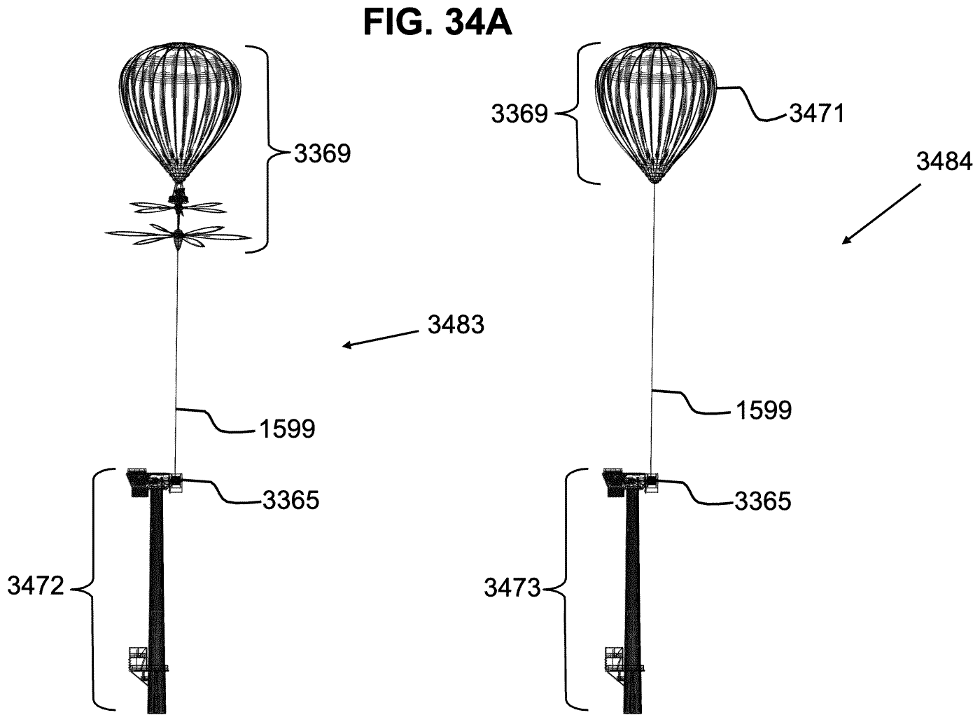

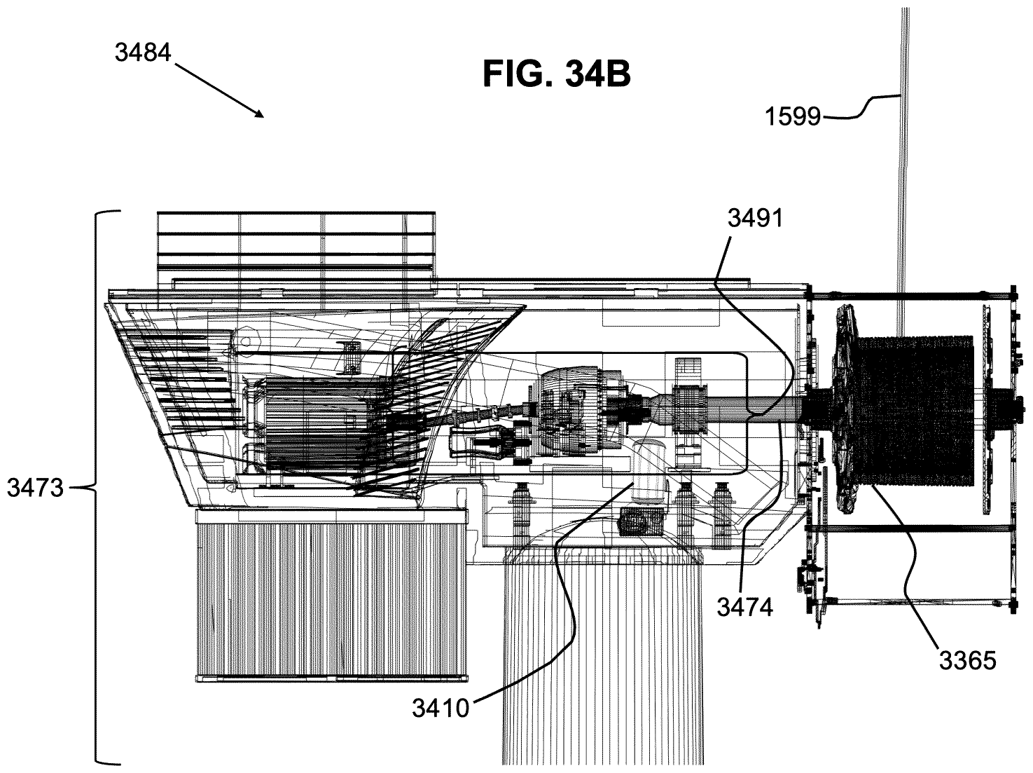

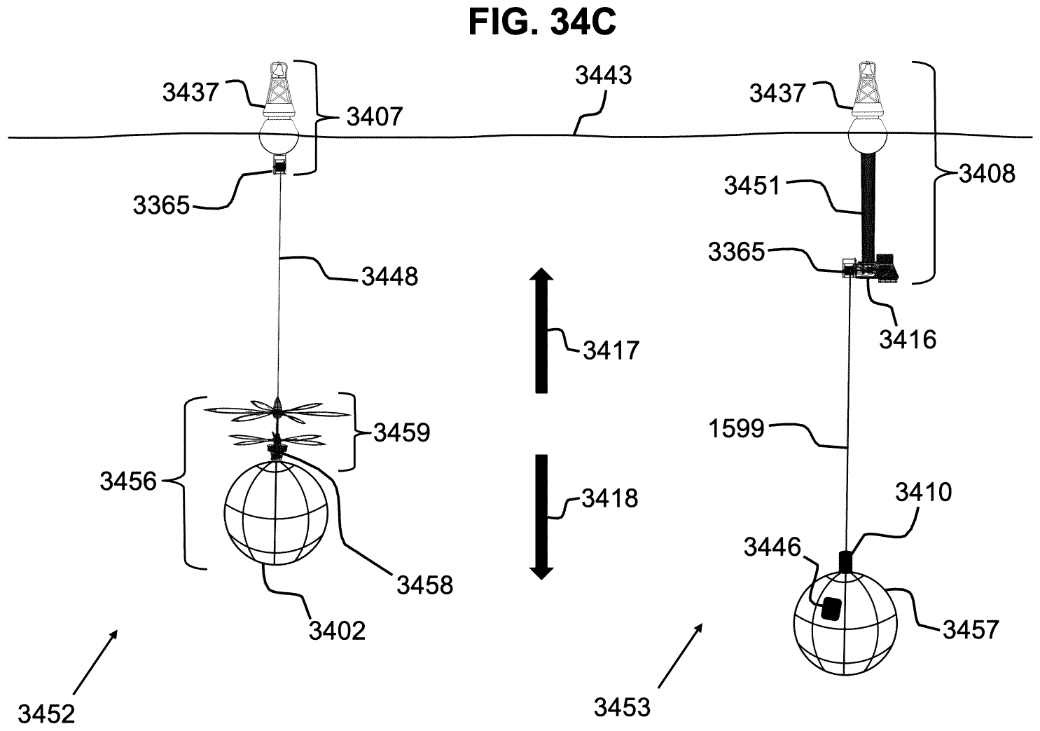

As depicted in FIGS. 22A through 22C, an exemplary embodiment of an energy generating device 2200 may include one or more balloon 2205 coupled to a platform 2239 by one or more structural member and fluid channel 2206. A buoyancy modulator such as a chemical converter or air compressor and gas tank 2210 may be coupled to platform 2239 and used to control the buoyancy of the balloon 2205 or other buoyancy device. Energy generating device 2200 is analogous to energy generating device 3300 (FIGS. 33A through 34C) except that it operates by the rotation of first force input structure toroidal rotor 2215 and second force input structure toroidal rotor 2225 (see, e.g., FIGS. 22A and 22B) instead of rotor 3315 and rotor 3335 and thus does not require further explanation as to the details of energy generating device 2200 to generate energy. One or more toroidal rotor 2215 and one or more toroidal rotor 2225 are representative of a type of propeller that are ring-shaped. Toroidal rotors are significantly quieter (especially at audible frequencies, which lie between 20 Hz and 20 kHz), and have been shown to be more efficient than traditional propellers both in air and water. Toroidal propellers are promising for their potential to reduce noise pollution through quieter aviation and maritime transport, but they have conventionally been difficult to manufacture and therefore more expensive. However, with better manufacturing techniques and for high performance needs, toroidal rotors provide significant advantages.

Referring now to FIG. 22C an alternative embodiment of an energy generating device 2250 includes one or more balloon 2255 suspended in a fluid such as air. A single toroidal rotor 2275 coupled to a buoyancy modulator 2260 may be configured to descend along a cable 2280 while harvesting rotational energy from toroidal rotor 2275 and converting the rotational energy to electrical energy analogous to the single rotor configuration of FIGS. 12A and 12B and thus does not require further explanation as to the details of energy generating device 2250 to generate energy. Energy generating devices 2200 and 2250 of FIGS. 22A, 22B and 22C, using toroidal rotor configurations may be applied to any of the applications as previously detailed throughout this application as may any force input mechanism that can be translated into a rotational force.

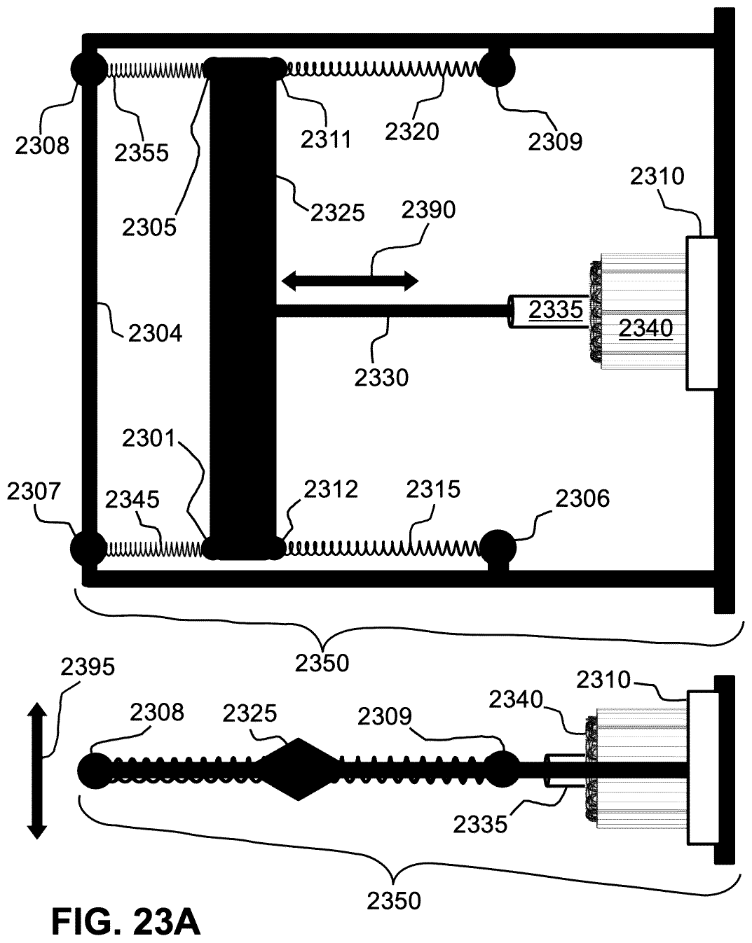

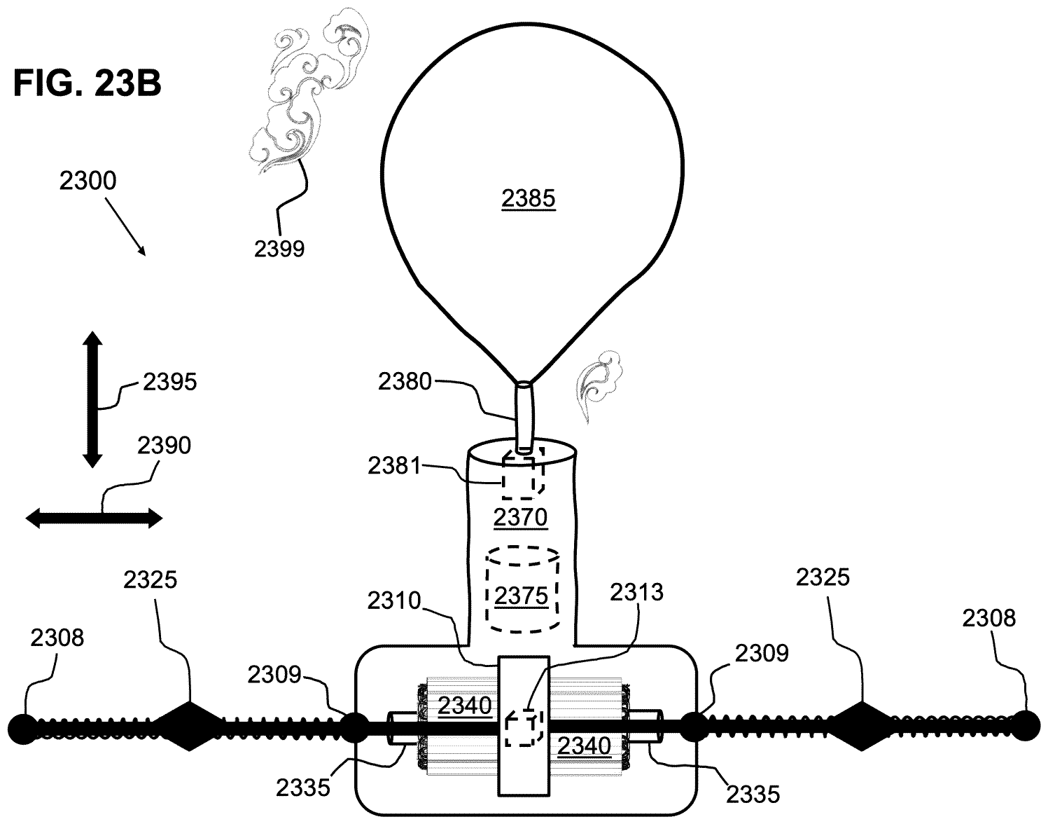

Referring now to FIG. 23A and FIG. 23B, an exemplary energy generating device 2300 is depicted. Most exemplary embodiments described herein are depicted as having a rotary electrical generator. One of ordinary skill in the art will recognize that a linear generator could be used in any of the exemplary embodiments depicted herein. For example, an exemplary embodiment of an energy generating device 2300 may include a linear generator 2350 which may be driven by transverse galloping and vortex shedding. Linear generator 2350 may include a frame 2304, which frame 2304 may be coupled to right lower spring right connector 2306, which may be coupled to the bottom end of right lower spring 2315. The top end of right lower spring 2315, may be coupled to right lower spring left connector 2312, which may be coupled to force input member 2325. Force input member 2325 may be coupled to left lower spring right connector 2301, which may be coupled to the bottom end of left lower spring 2345. The top end of left lower spring 2345, may be coupled to left lower spring left connector 2307, which may be coupled to frame 2304. Frame 2304 may be coupled to right upper spring right connector 2309, which may be coupled to the bottom end of right upper spring 2320. The top end of right upper spring 2320, may be coupled to right upper spring left connector 2311, which may be coupled to force input member 2325. Force input member 2325 may be coupled to left upper spring right connector 2305, which may be coupled to the bottom end of left upper spring 2355. The top end of left upper spring 2355, may be coupled to left upper spring left connector 2308, which may be coupled to frame 2304. Force input member 2325 may be coupled to shaft 2330, which may be coupled to magnet 2335. Magnet 2335 may be configured to enter a pass through in conductive coil assembly 2340, which may be coupled to frame 2304.

Device 2300 may include a body 2370, which may include a compressed air pump and tank 2381 connected and able to provide fluid to and receive fluid from balloon 2385 via fluid channel 2380. When balloon 2385 is filled with a fluid such as lighter than air gas, device 2300 may be more buoyant than the medium in which it is contained, such as air 2399, and therefore device 2300 may ascend. When compressed air pump and tank 2381 compresses enough of the lighter than air gas, device 2300 may be less buoyant than air 2399, and therefore device 2300 may descend. When device 2300 ascends or descends in a substantially upward or downward direction 2395, air 2399 may impinge upon force input member 2325, causing force input member 2325 to oscillate in directions 2390 due to the phenomena of transverse galloping and vortex shedding. As force input member 2325 oscillates in directions 2390, one or more magnet 2335 may move up and down within conductive coil assembly 2340, generating alternating current in the coils, which alternating current may be converted into direct current through a rectifier 2313 or by several other electronic or mechanical methods. Rectifier 2313 may be contained within electronic housing 2310 before being stored in battery 2375. Exemplary embodiment 2300, having a linear generator, may have the advantage over an embodiment containing a rotary generator that embodiment 2300 may begin to generate electricity at lower speeds than an embodiment having a rotary generator.

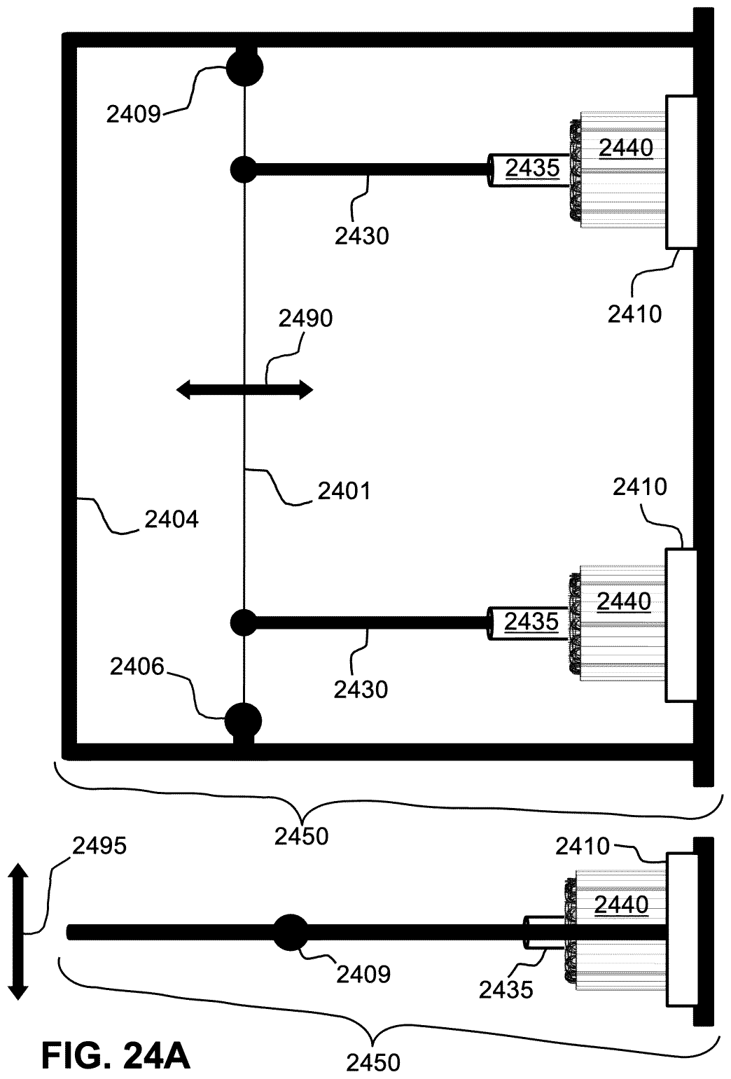

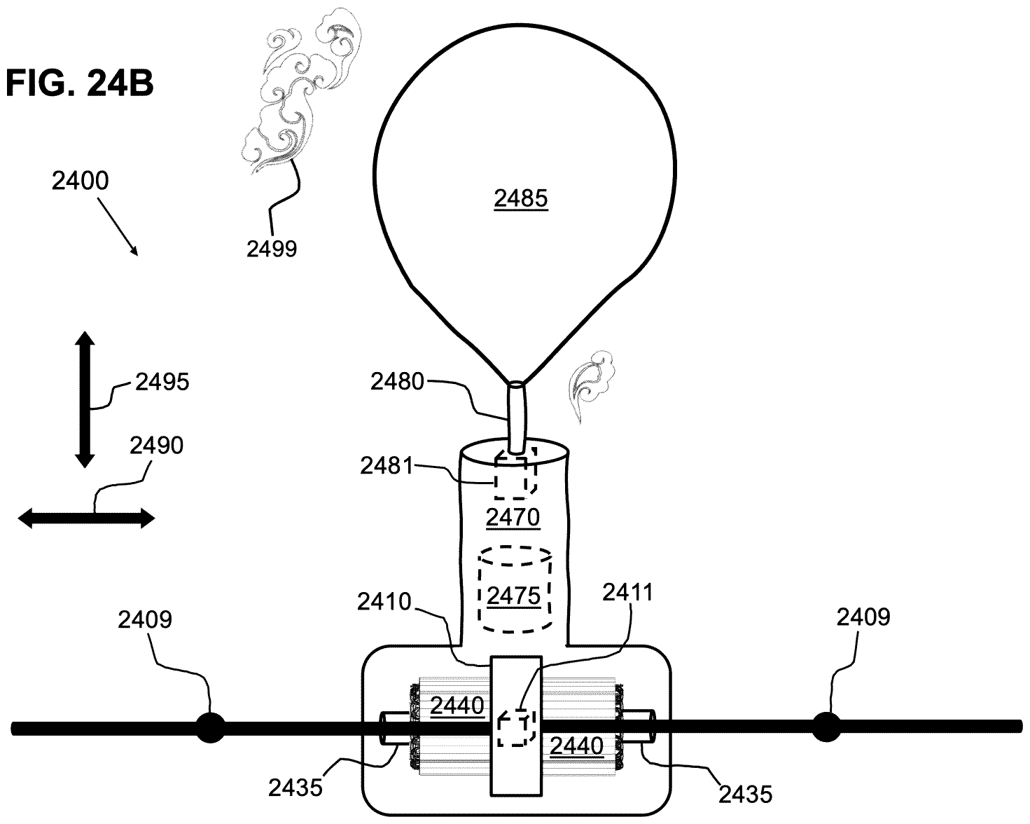

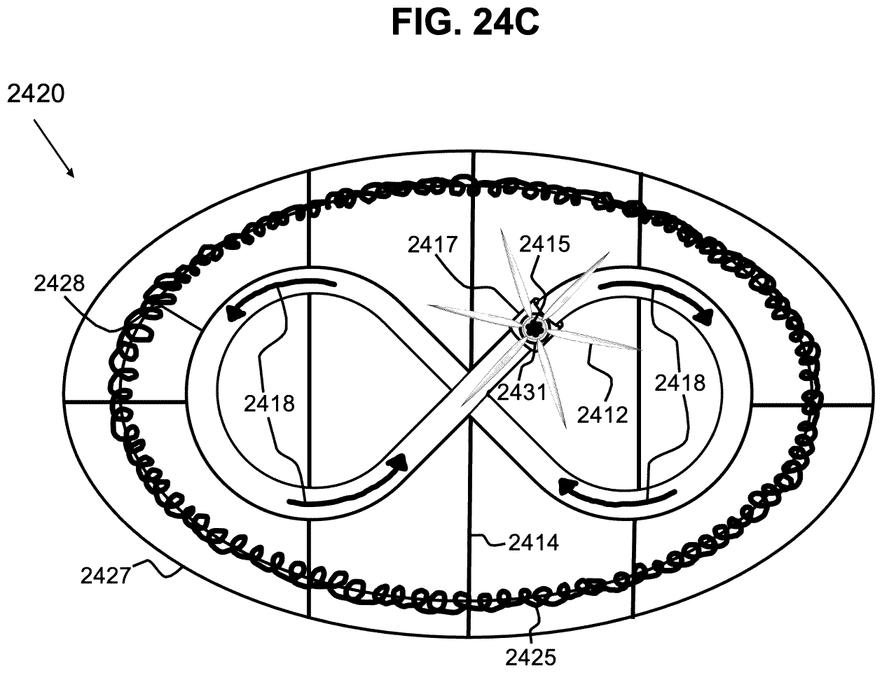

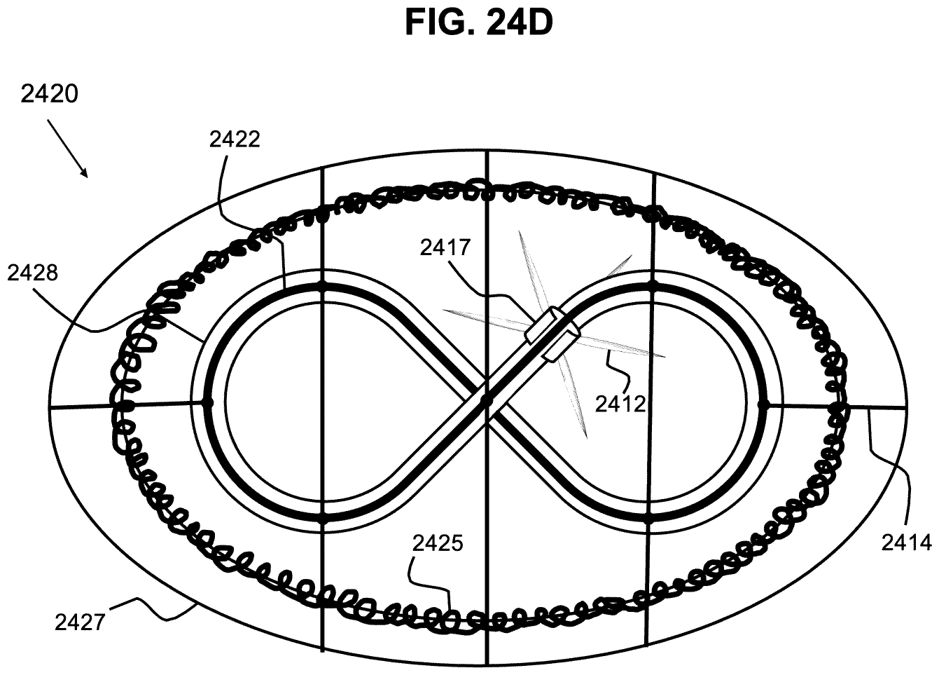

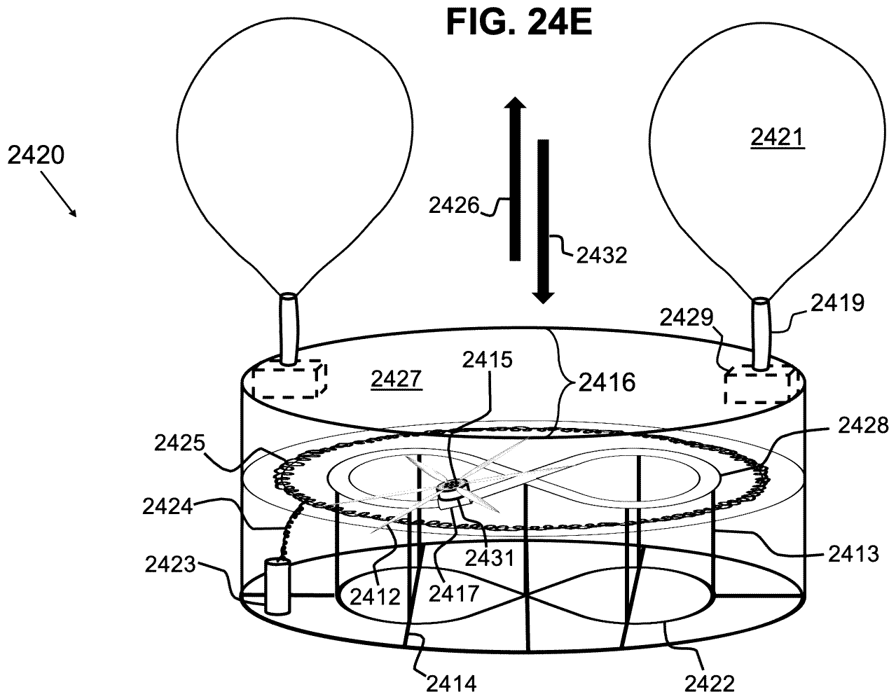

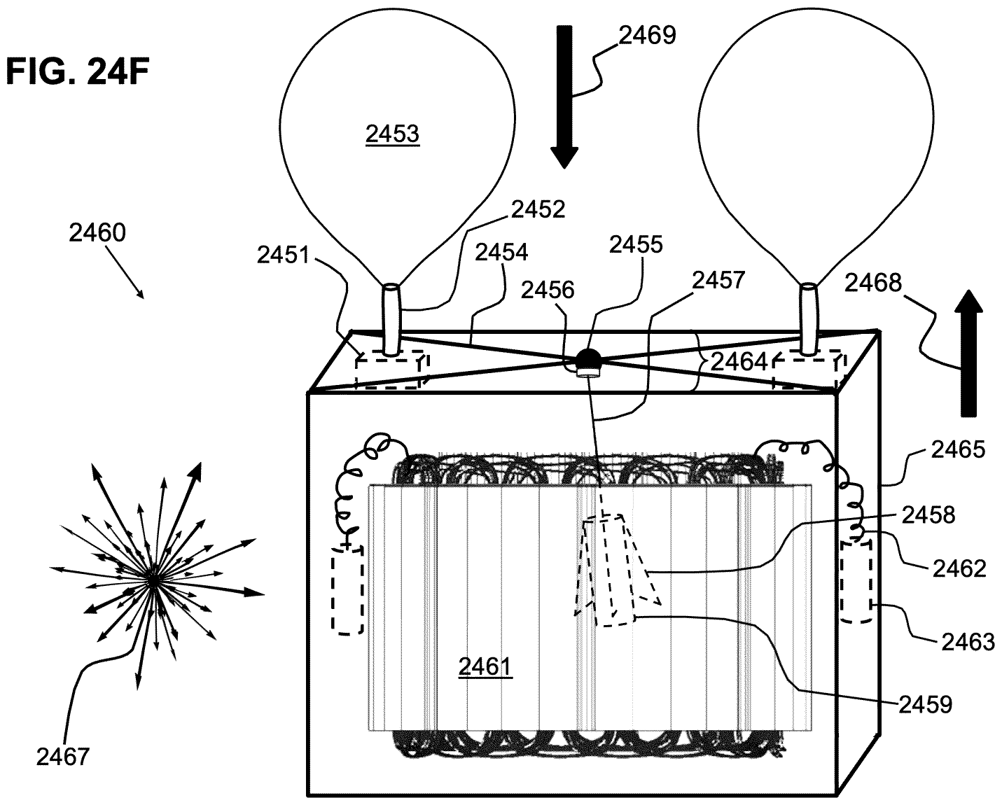

Referring now to FIG. 24A and FIG. 24B, an exemplary energy generating device 2400 is depicted. An exemplary embodiment of an energy generating device 2400 may include a linear generator 2450 which may be driven by aeroelastic fluttering. Linear generator 2450 may include a frame 2404, which frame 2404 may be coupled to lower band connector 2406 and upper band connector 2409. lower band connector 2406 and upper band connector 2409 may be coupled to either end of force input member 2401, which may be a wire, band or other component that may be subject to the phenomenon of aeroelastic fluttering. Force input member 2401 may be coupled to one or more shaft 2430, which may be coupled to one or more magnet 2435. Magnet 2435 may be configured to enter a pass through in conductive coil assembly 2440, which may be coupled to frame 2404.

Device 2400 may include a body 2470, which may include a compressed air pump and tank 2481 connected and able to provide fluid to and receive fluid from balloon 2485 via fluid channel 2480. When balloon 2485 is filled with a fluid such as lighter than air gas, device 2400 may be more buoyant than the medium in which it is contained, such as air 2499, and therefore device 2400 may ascend. When compressed air pump and tank 2481 compresses enough of the lighter than air gas, device 2400 may be less buoyant than air 2499, and therefore device 2400 may descend. When device 2400 ascends or descends in a substantially upward or downward direction 2495, air 3499 may impinge upon force input member 2401, causing force input member 2401 to oscillate in directions 2490 due to the phenomena of aeroelastic fluttering. As force input member 2401 oscillates in directions 2490, one or more magnet 2435 may move up and down within conductive coil assembly 2440, generating alternating current in the coils, which alternating current may be converted into direct current through a rectifier 2411 or by several other electronic and mechanical methods. Rectifier 2411 may be contained within electronic housing 2410 before being stored in battery 2475. Exemplary embodiment 2400, having a linear generator, may have the advantage over an embodiment containing a rotary generator that embodiment 2400 may begin to generate electricity at lower speeds than an embodiment having a rotary generator.

Devices 2300 and 2400 exemplify a general principle of movement of conductive coils relative to a magnetic field. Magnets can move in any combination of one or more linear motions relative to conductive coils, or conductive coils can move in any combination of one or more linear motions relative to magnets to generate an electric current in the conductive coils. The electric current can be stored in a battery by including in the configuration of the energy generating device a rectifier or any other system capable of converting changes in the direction of the electric current into direct current whether the linear motions are one dimensional or oscillating motions or any combination of two or three dimensional linear motions.

Referring now to FIGS. 24C, 24D and 24E, an exemplary embodiment of an energy generating device is depicted. Exemplary device 2420 may include a first body portion which may be one or more bearing 2431 and a second body portion such as housing unit 2427, which may be coupled to one or more horizontal support member 2414, each of which may be coupled to one or more coupling rail 2422, which may be coupled to one or more vertical support member 2413, each of which may be coupled to curvilinear track 2428. Curvilinear track 2428 may be movably coupled to slide unit 2417, which may be rotatably coupled to one or more bearing 2431, which may be coupled to magnet assembly 2415. One or more bearing 2431 may be coupled to a first force input member such as one or more rotor 2412. Housing unit 2427 may be coupled to one or more conductive coil assembly 2425, which may be electrically connected to battery 2423 by battery connector 2424. Housing unit 2427 may be connected to one or more buoyancy modulator 2429, which may be connected to and capable of providing a fluid to and receiving a fluid from one or more balloon 2421 via one or more fluid channel 2419. Note that some components have been removed in FIGS. 24C and 24D, such as one or more balloon 2421, for clarity of illustration.

Buoyancy modulator 2429 may include a gas compressor and a compressed gas tank. Buoyancy modulator 2429 may receive lighter than air gas from one or more balloon 2421 and compress the gas it receives from one or more balloon 2421, thereby decreasing the buoyancy of device 2420 and causing device 2420 to descend, or buoyancy modulator 2429 may provide lighter than air gas to one or more balloon 2421, thereby increasing the buoyancy of device 2420 and causing device 2420 to ascend. As device 2420 travels in direction 2426 in a fluid medium such as air, air may travel in direction 2432 relative to device 2420. Air may travel into pass through 2416 to impinge upon one or more rotor 2412, thereby causing rotation of magnet assembly 2415. Device 2420 may be buffeted by winds causing it to pitch, yaw or roll, thereby causing slide unit 2417 to travel around curvilinear track 2428 in a curvilinear route 2418 or in the opposite direction of curvilinear route 2418. The movement of magnet assembly 2415 relative to conductive coil assembly 2425 causes generation of current within conductive coil assembly 2425.

Device 2420 exemplifies a general principle of movement of conductive coils relative to a magnetic field. Magnets can move in any combination of one or more rotational or curved motions relative to conductive coils, or conductive coils can move in any combination of one or more rotational or curved motions relative to magnets to generate an electric current in the conductive coils. The electric current can be stored in a battery by including in the configuration of the energy generating device a rectifier or any other system capable of converting changes in the direction of the electric current into a single direction (direct current) whether the rotational or curved motions are regular rotational motions or any combination of curved motions.

Referring now to FIG. 24F, an exemplary embodiment of an energy generating device 2460 is depicted. Device 2460 may include one or more first body portion such as magnet assembly 2459 and one or more second body portion 2465. Second body portion 2465 may be coupled to one or more support member 2454, which may be coupled to one or more bearing coupler 2455, which may be coupled to bearing 2456, which may be rotatably coupled to rigid or flexible hanging member 2457, which may be coupled to one or more magnet assembly 2459, which may be coupled to one or more air-catching fin 2458. Second body portion 2465 may include one or more buoyancy modulator 2451, which may be coupled to and may provide gas to and receive gas from balloon 2453 via fluid channel 2452. Second body portion 2465 may include conductive coil assembly 2461.

Buoyancy modulator 2451 may include a gas compressor and a compressed gas tank. Buoyancy modulator 2451 may receive lighter than air gas from one or more balloon 2453 and compress the gas it receives from one or more balloon 2453, thereby decreasing the buoyancy of device 2460 and causing device 2460 to descend, or buoyancy modulator 2451 may provide lighter than air gas to one or more balloon 2453, thereby increasing the buoyancy of device 2460 and causing device 2460 to ascend. As device 2460 ascends substantially in direction 2468 in a fluid medium such as air, air may travel in direction 2469 relative to device 2460. Air may travel into pass through 2464 to impinge upon magnet assembly 2459 and one or more air-catching fin 2458, thereby causing movement of magnet assembly 2459 in one or more of directions 2467 or any other direction. Magnet assembly 2459 and conductive coil assembly 2461 may be included in an electrical generator such as a chaotic generator. The movement of magnet assembly 2459 relative to conductive coil assembly 2461 causes generation of electric current within conductive coil assembly 2461. Electric current may be transmitted across battery connector 2462 to be stored in battery 2475 or may be used for any purpose.

Unlike rotational generators which may continuously output direct current and unlike oscillating or linear generators which may output alternating current at a regular periodicity, the chaotic generators of devices 2420 and 2460, which output current of unpredictable polarity, might be advantageous in highly variable weather conditions such as gusty wind environments or turbulent waters by enabling the magnet a greater range of movement and thereby generating more electricity than if the movement of the magnet were constrained to a single linear or rotational direction. The generators depicted in FIGS. 24C through 24F exemplify chaotic generators class of electrical generators, which comprises all generators that neither output current with a regular periodic altering polarity like oscillating generators, nor output current of a continuous polarity like rotational generators. Chaotic generators are intended to capture as much movement as possible in chaotic conditions unlike oscillating and rotational generators which typically require relatively stable conditions.

Device 2460 exemplifies a general principle of movement of conductive coils relative to a magnetic field. Magnets can move in any combination of one or more linear or curved motions relative to conductive coils, or conductive coils can move in any combination of one or more linear or curved motions relative to magnets, regardless of how apparently chaotic the motions may be, to generate an electric current in the conductive coils. The electric current can be stored in a battery by including in the configuration of the energy generating device a rectifier or any other system capable of converting changes in the direction of the electric current into a single direction (direct current). Any path of travel, whether rotational, consisting of curved movement, oscillating, consisting of a linear movement, or chaotic, consisting of any combination of curved and linear movement, can generate usable and storable electricity in an energy generating device.

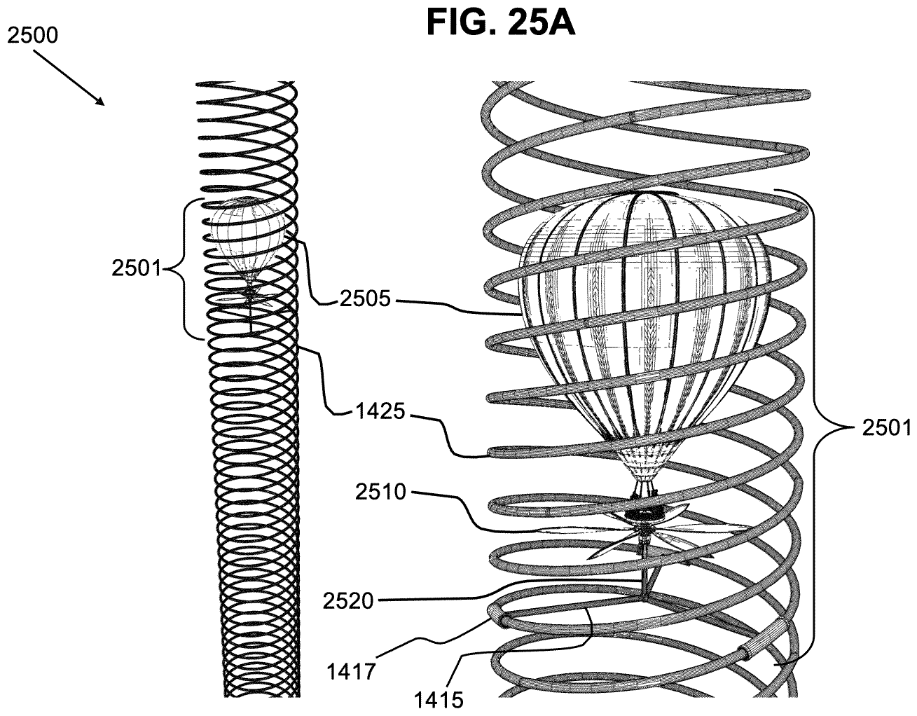

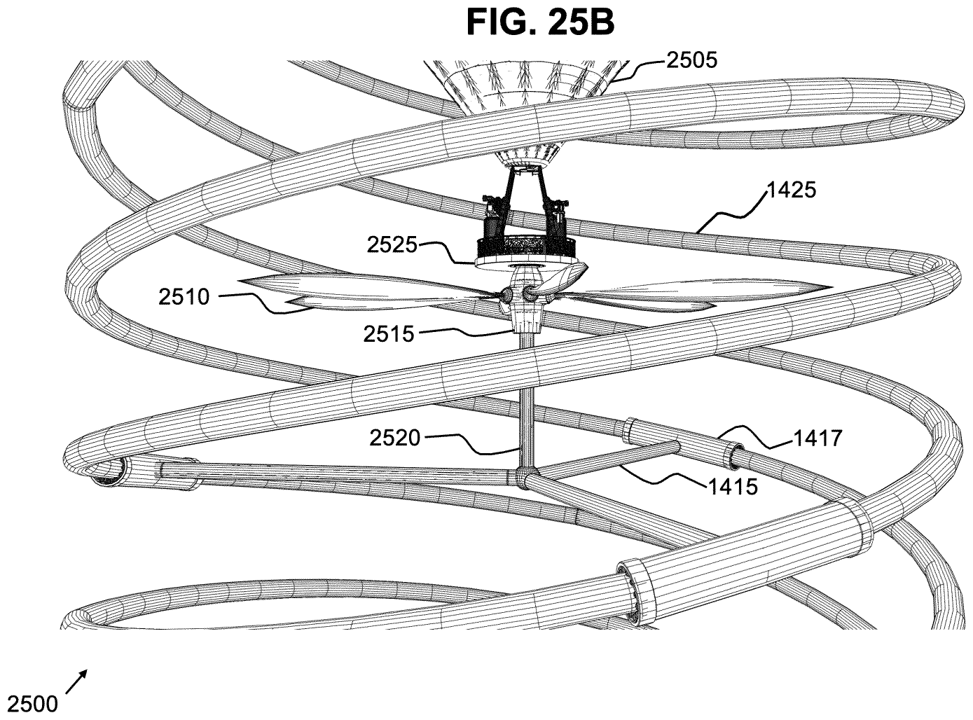

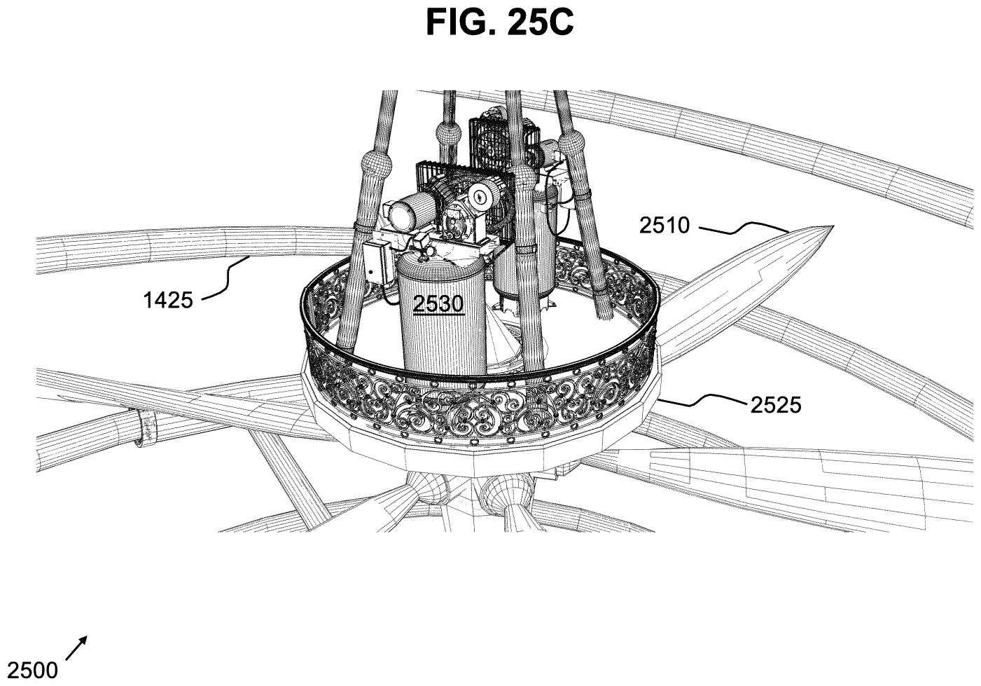

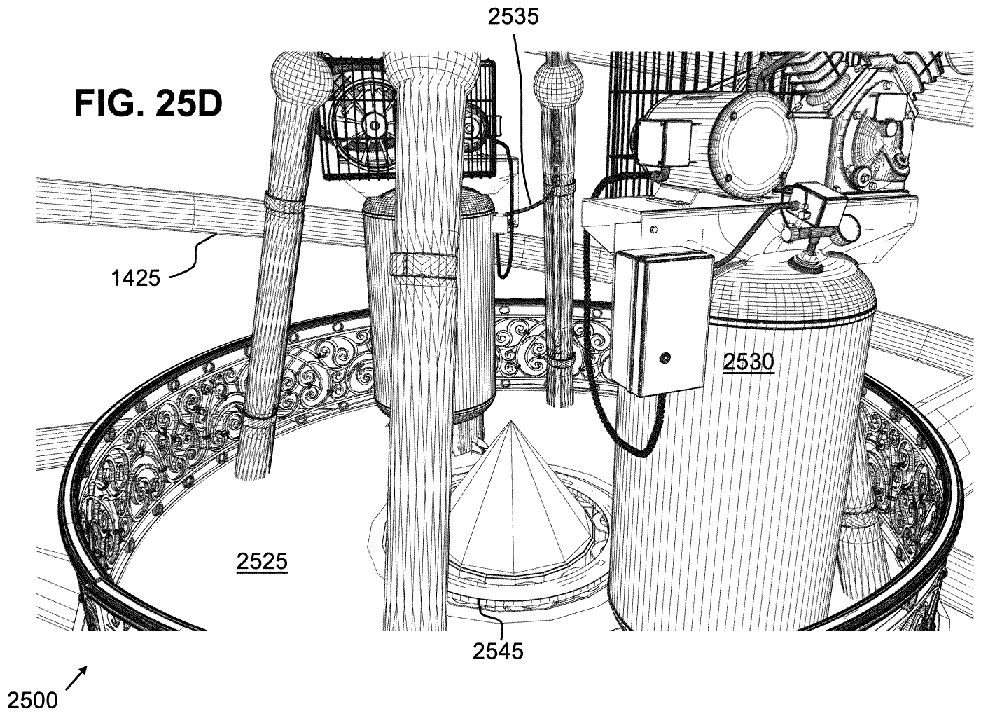

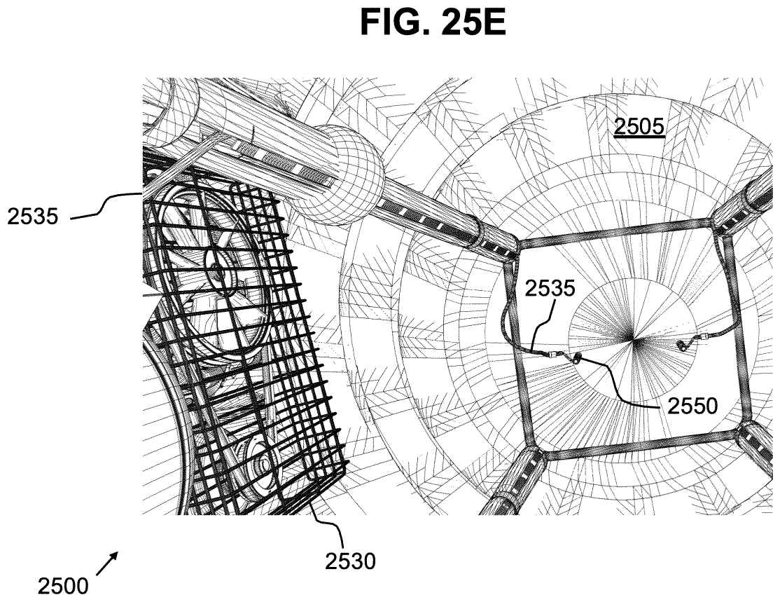

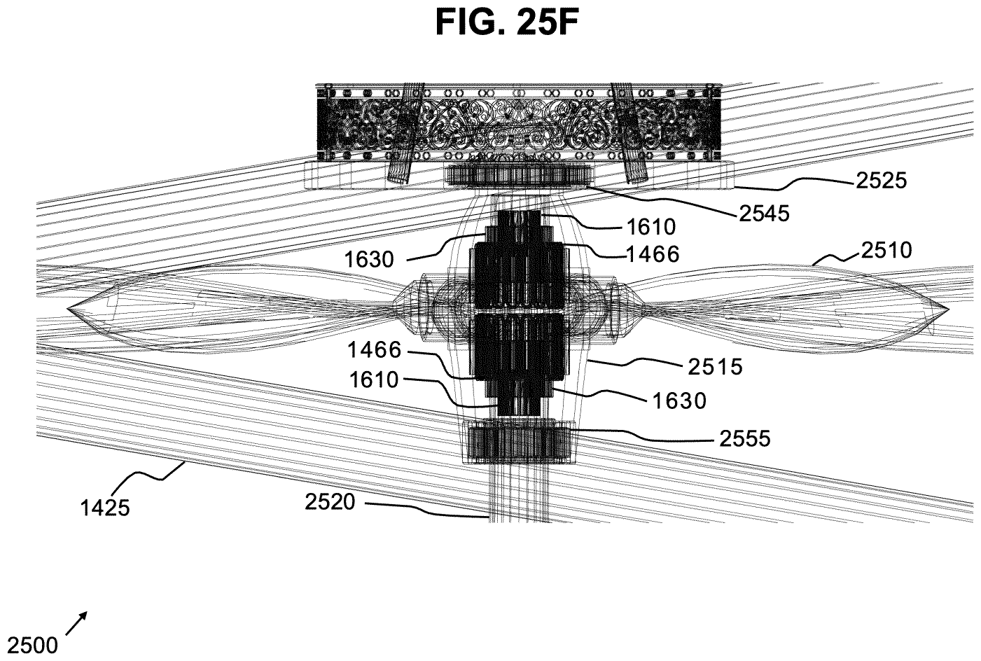

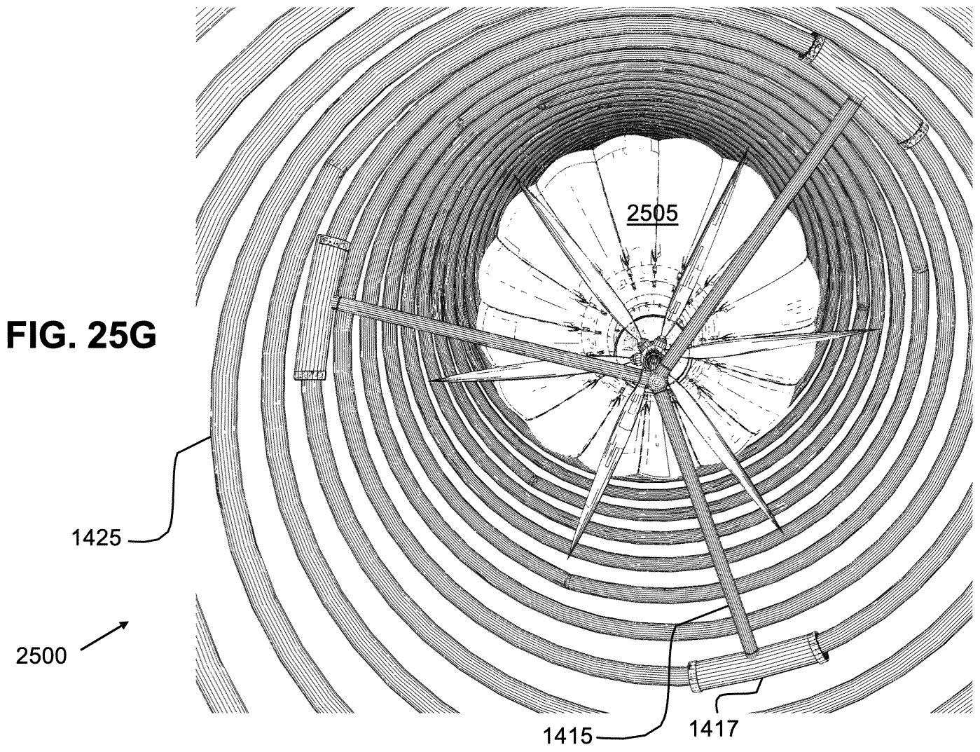

Referring now to FIGS. 25A, 25B, 25C, 25D, 25E, 25F and 25G, another exemplary embodiment of an energy generating device 2500 is depicted. Energy generating device 2500 may include one or more rotors 2510 and one or more outer track 1425. One or more rotors 2510 may be coupled to outer first body portion 2515, which may be coupled to one or more conductive coils 1466, which one or more conductive coils 1466 may be rotatably coupled to one or more one or more magnet 1610 by one or more bearing 1630. Outer first body portion 2515 may be rotatably coupled by bearing 2555 to one or more second body portion 2520, which may be coupled to one or more one or more magnet 1610. Second body portion 2520 may be coupled to guide arm 1415 which may be coupled to slide unit 1417, which may slide along one or more outer track 1425. Outer first body portion 2515 may be rotatably coupled to body portion 2525 by bearing 2545. In an exemplary embodiment of an energy generating device 2500 a buoyancy modulator may include one or more chemical converter or gas compressor and tank 2530, which may be connected by fluid channel 2535 to fluid portal 2550, which fluid portal 2550 may inject gas into balloon 2505 and may receive gas from balloon 2505.

As energy generating device 2500 kinetic member 2501 approaches a point closer to the source of gravity, or approximately around the time a device reaches the end of its descent, or around the time a device prepares to reverse its direction of travel, a buoyancy modulator such as a chemical converter or gas compressor and tank 2530 may release compressed gas into balloon 2505, which may increase the buoyancy of kinetic member 2501. As kinetic member 2501 approaches a higher point along outer track 1425, or when kinetic member 2501 recedes from the source of gravity or approaches the end of its ascent or prepares to reverse its direction of travel, a chemical converter or gas compressor and tank 2530 may compress gas received from balloon 2505, which may decrease the buoyancy of kinetic member 2501. Energy generating device 2500 is configured to operate with several similar principles to the exemplary selection of devices depicted herein, for example, the relative rotation between a first body portion and a second body portion enables the generation of electrical energy by an electrical generator that may include magnets and conductive coils and the ability for the device or for. One or more members of the device to descend through a fluid at least partly under the influence of gravity and ascend through a fluid at least partly by changes in buoyancy caused by a buoyancy modulator. The exemplary selection of devices depicted herein are configured to operate with several similar principles to energy generating device 2500, which uses a configuration including an outer track and inner rotor to harvest potential energy by the same principles by which energy generating device 1200 is able to harvest potential energy using an inner track and an outer rotor.

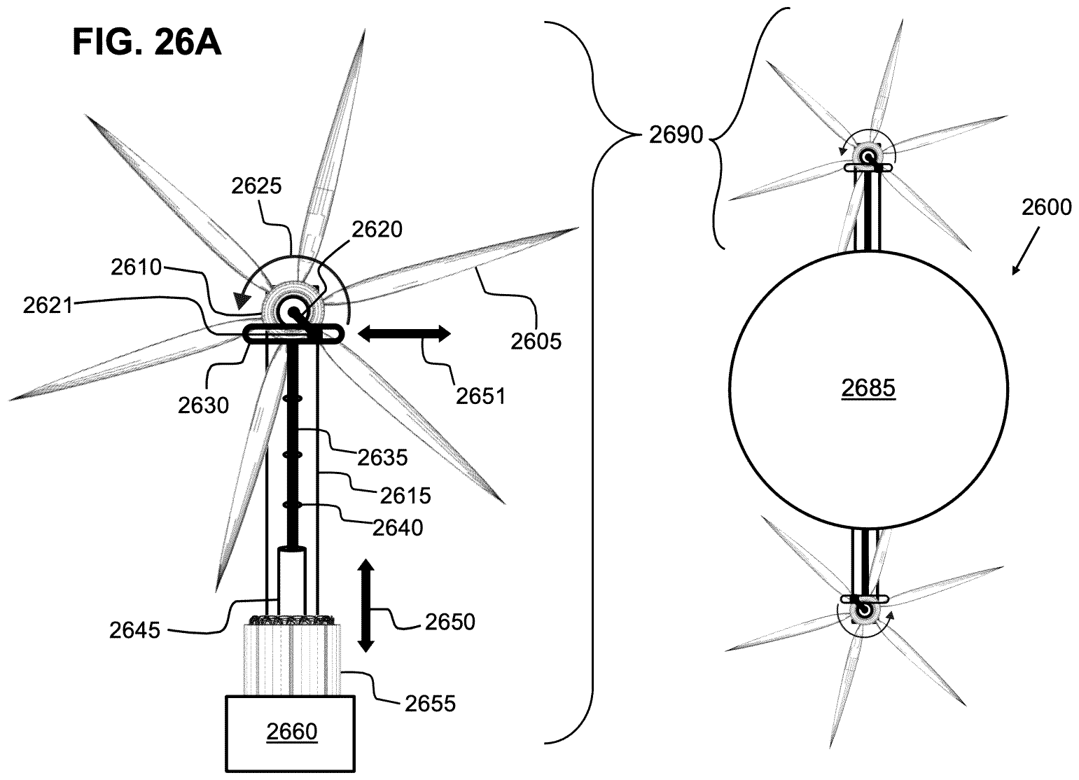

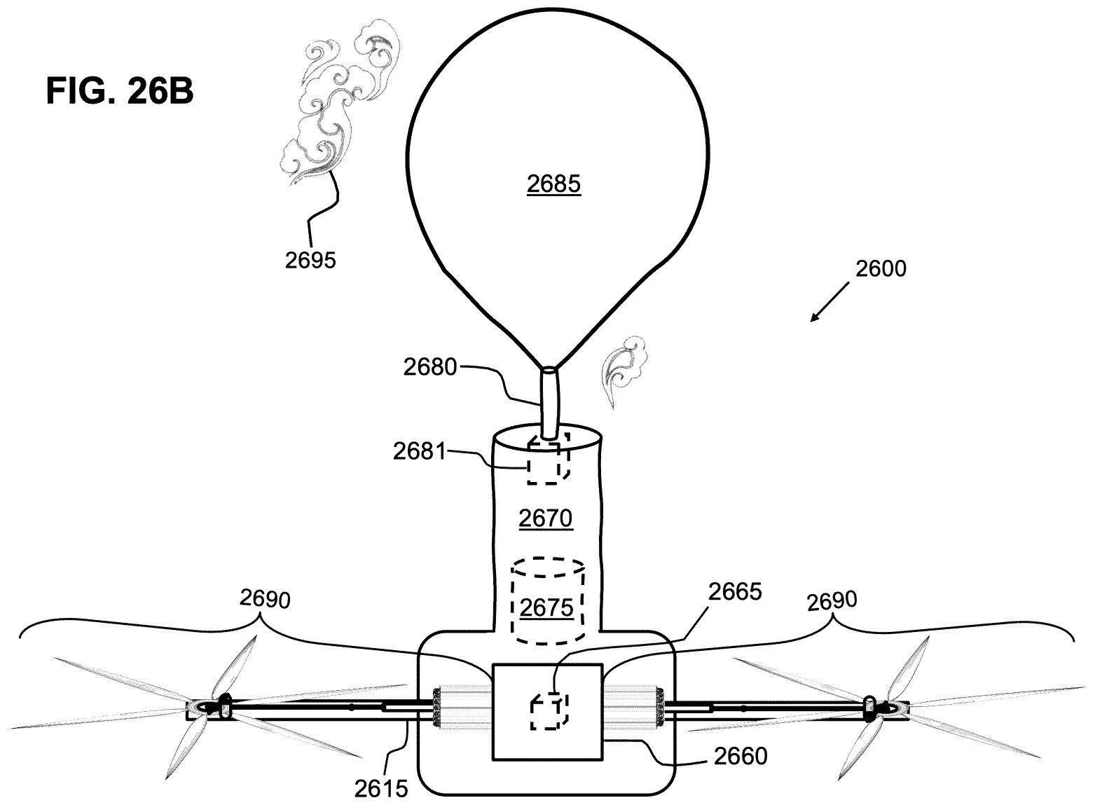

Referring now to FIGS. 26A and 26B, an exemplary embodiment of an energy generating device is depicted. An exemplary energy generating device 2600 may include a rotor-driven linear electrical generator 2690. Rotor-driven linear electrical generator 2690 may include one of more rotor 2605, which may be coupled to a first body portion 2610, which may be rotatably coupled to second body portion 2615 by a bearing. First body portion 2610 may be coupled to a scotch yoke which may include a crank 2620, which may be movably coupled to a sliding pin 2621, which may be movably coupled to a sliding yoke 2630, which may be coupled to a connecting rod 2635. Connecting rod 2635 may be oscillatably supported in a pass through of one or more support ring 2640, which one or more support ring 2640 may be coupled to second body portion 2615 and which one or more support ring 2640 may support, constrain or guide the movement of connecting rod 2635. Connecting rod 2635 may be coupled to one or more magnet 2645, which may be partially or fully included in a pass through of one or more conductive coils 2655. Second body portion 2615 and may be coupled to main body 2670, which may include one or more conductive coils 2655 and electronics housing 2660, which electronics housing 2660 may include a rectifier 2665 or other system to convert alternating current into direct current.

As a buoyancy modulator such as a compressed air system 2681 increases the buoyancy of device 2600 by releasing lighter than air gas through fluid channel 2680 and into balloon 2685, device 2600 may begin to ascend. As device 2600 ascends in a medium such as air 2695, torque is generated one or more first body portion 2610 as air 2695 impinges on one or more rotor 2605, causing first body portion 2610 and crank 2620 to rotate in a direction such as direction 2625. The rotation of crank 2620 causes sliding pin 2621 to oscillate in oscillatory left and right directions 2651 relative to sliding yoke 2630, which sliding yoke 2630 causes connecting rod 2635 and one or more magnet 2645 to oscillate in oscillatory up and down directions 2650. The movement of one or more magnet 2645 within a pass through of one or more conductive coils 2655 generates alternating current in conductive coils 2655, which alternating current is converted into direct current by rectifier 2665 or other system to convert alternating current into direct current. Direct current is stored in battery 2675 or used by device 2600 or for any other purpose. As a buoyancy modulator such as a compressed air system 2681 decreases the buoyancy of device 2600 by compressing lighter than air gas received from balloon 2685 via fluid channel 2680, device 2600 may begin to descend. Like during the ascent process described above, as device 2600 ascends in a medium such as air 2695, torque is generated one or more first body portion 2610 as air 2695 impinges on one or more rotor 2605, causing first body portion 2610 and crank 2620 to rotate, thereby generating and storing or using energy through an analogous process to the generation of energy during the ascent of device 2600 as described above.

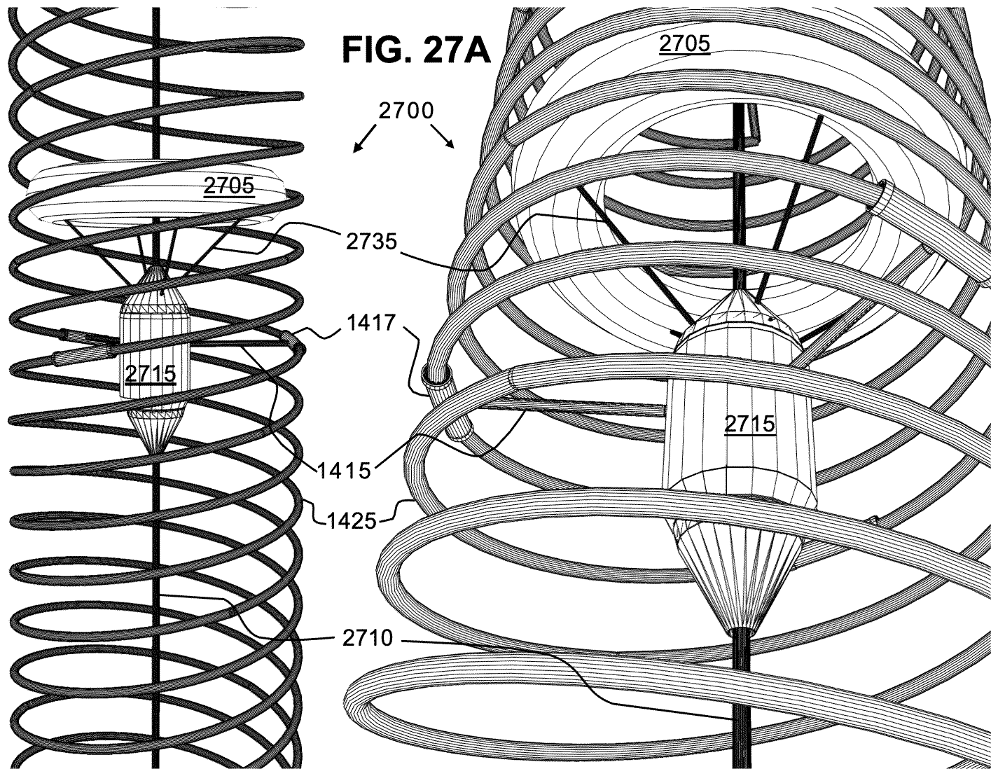

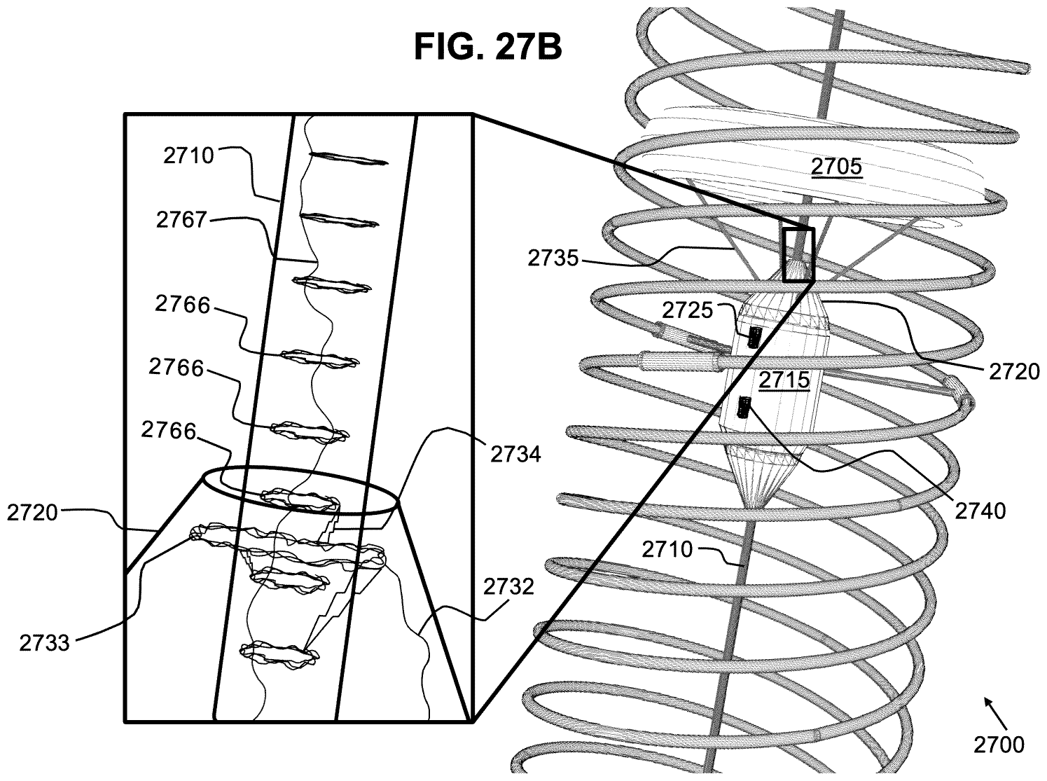

Referring now to FIGS. 27A and 27B, an exemplary embodiment of an energy generating device is depicted. An exemplary energy generating device 2700 may include an outer track 1425, which may be movably coupled to slide unit 1417 which may be coupled to guide arm 1415, which may be coupled to body portion 2715, which may be movably or rotatably coupled to an inner track and cable 2710, which may include one or more electrical transmitter or receiver 2766, which may send electricity through electrical wire 2767 or receive electricity from electrical wire 2767. Energy generating device 2700 may include one or more electrical transmitter or receiver 2733, which may be coupled to body portion 2720, which may be coupled to body portion 2715. As an energy generating device generates electricity, it may store energy in one or more battery 2725 or it may send electricity through electrical wire 2732 into one or more electrical transmitter or receiver 2733 which may wirelessly transmit electrical energy 2734 to one or more electrical transmitter or receiver 2766, which may transmit electrical energy to wire 2767 which may transmit electrical energy to any electrical load or locus or battery. When an energy generating device needs to consume energy a device may use energy stored in a battery 2725 coupled to body portion 2715, or a device may receive electrical energy 2734 that may be transferred from any source to electrical wire 2767 to one or more electrical transmitter or receiver 2766 to one or more electrical transmitter or receiver 2733 to electrical wire 2732, to wherever it is needed by an exemplary embodiment, for example, to power the operations of buoyancy modulator 2740, which may transmit a fluid through fluid channel 2735 to an inflatable member 2705. Energy generating device 2700 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

Referring now to FIGS. 28A, 28B, 28C, 28D and 28E, an exemplary embodiment of an energy generating device 2800 is depicted. Exemplary device 2800 may include an inner track 2863, which may be rotatably coupled to first body portion 2810. Device 2800 may include inflatable member 2805, which may be coupled or rotatably coupled to first body portion 2810, which may be coupled to one or more rotors 2815. When first body portion 2810 moves in a substantially upward direction 2899 or a substantially downward direction 2898 contact between rotors 2815 and the surrounding fluid medium 2897 may cause body portion 2801, which may be included in first body portion 2810 and which may be coupled to conductive coils 2860 on its inner surface, to rotate in direction 2861 or direction 2862 relative to a track, for example, relative to track 2863. Track 2863 may be rotatably coupled to first body portion 2810 which may be rotatably coupled to inflatable member 2805, for example to reduce drag, by one or more bearings or other rotatable member such as for example roller bearings or any other kind of bearing 2820. Track 2863 may include one or more magnet 2864. The relative rotation of conductive coils 2860 around one or more magnet 2864 may cause electricity to be generated in conductive coils 2860.

Track 2863 may include one or more electrical transmitter or receiver 2866, which may send electricity through electrical wire 2867 or receive electricity from electrical wire 2867. An energy generating device may include one or more electrical transmitter or receiver 2833, which may be coupled to body portion 2801, which may be coupled to first body portion 2810. As the energy generating device generates electricity, it may store energy in one or more battery 2825, or it may send electricity through electrical wire 2832 into one or more electrical transmitter or receiver 2833 which may wirelessly transmit electrical energy 2834 to one or more electrical transmitter or receiver 2866, which may transmit electrical energy to electrical wire 2867 which may transmit electrical energy to any electrical load or locus or battery. When an energy generating device needs to consume energy a device may use energy stored in a battery 2825, which may be coupled to first body portion 2810, or a device may receive electrical energy 2834 that may be transferred from any external source to electrical wire 2867 to one or more electrical transmitter or receiver 2866 to one or more electrical transmitter or receiver 2833 to wire 2832 to anywhere it may be needed by a device. Energy generating device 2800 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

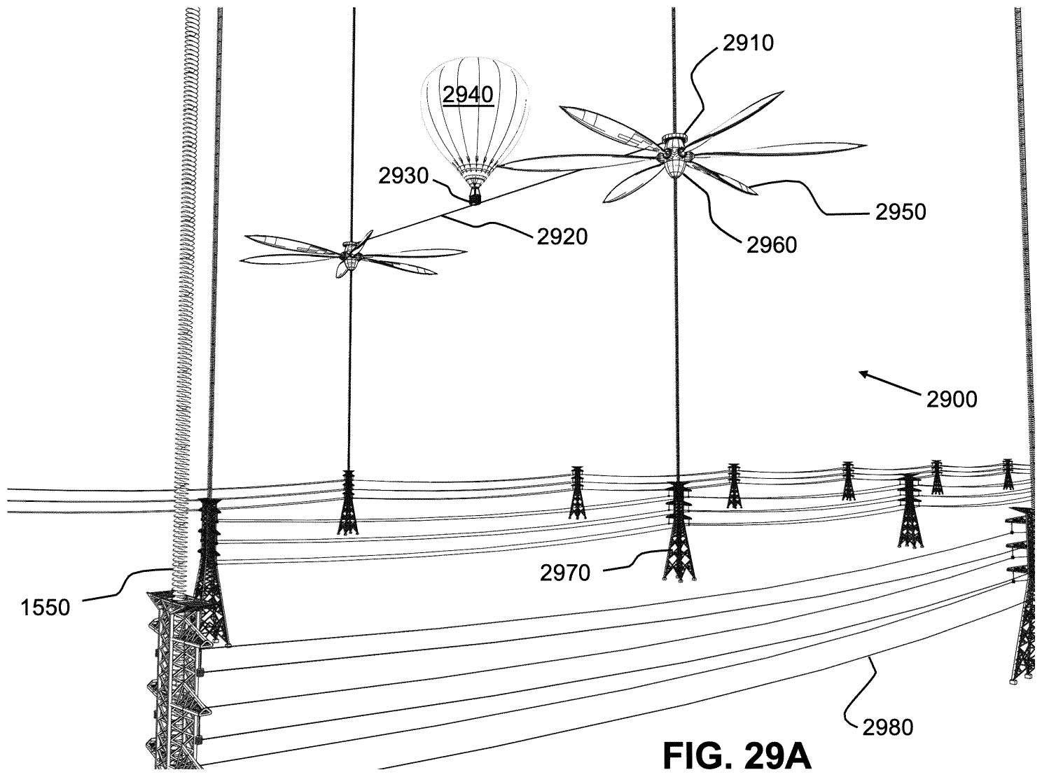

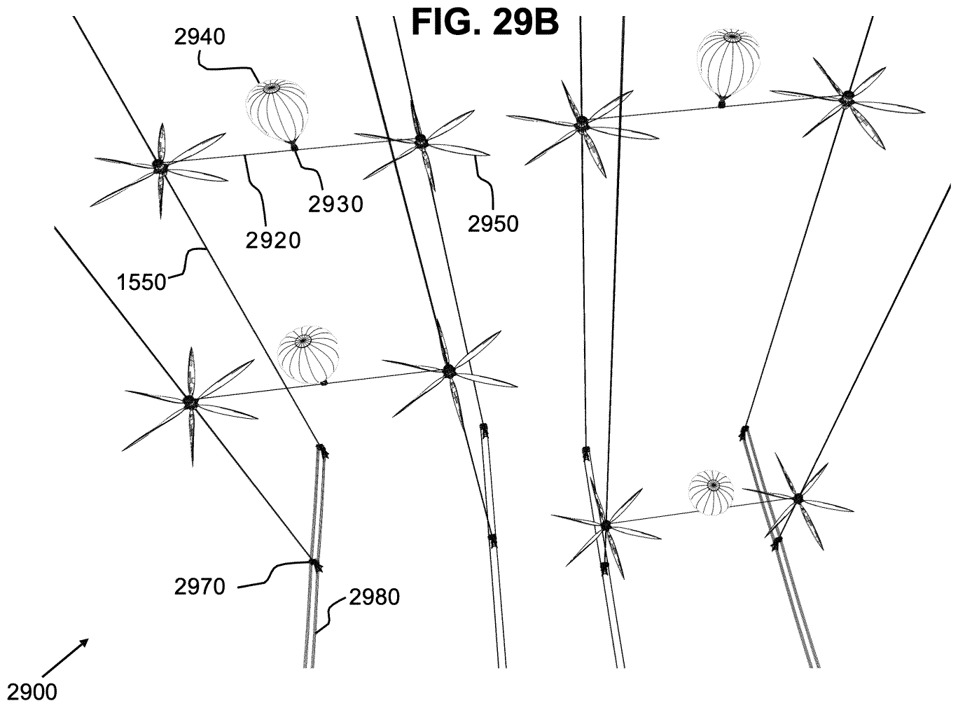

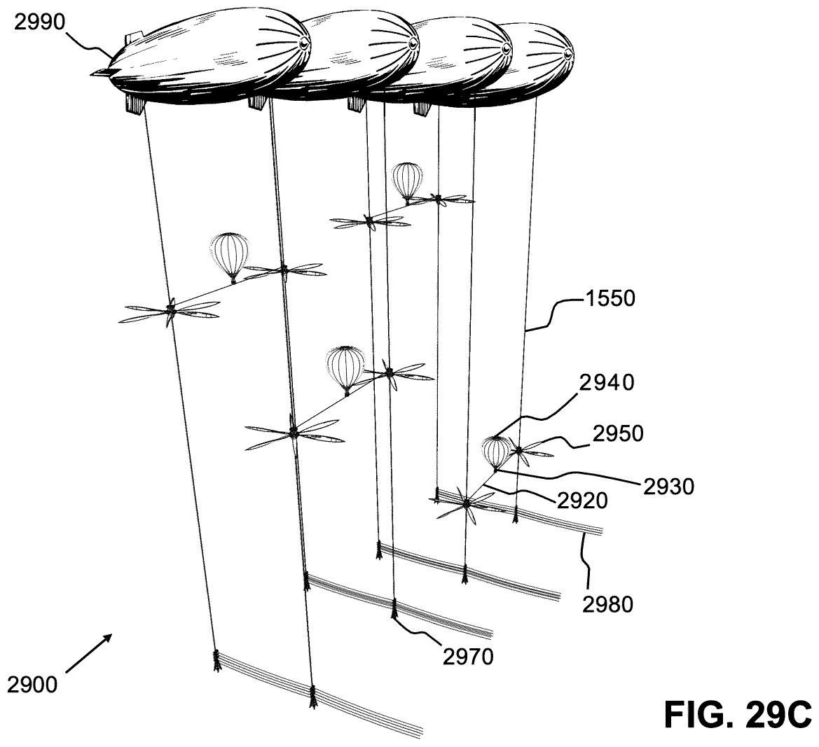

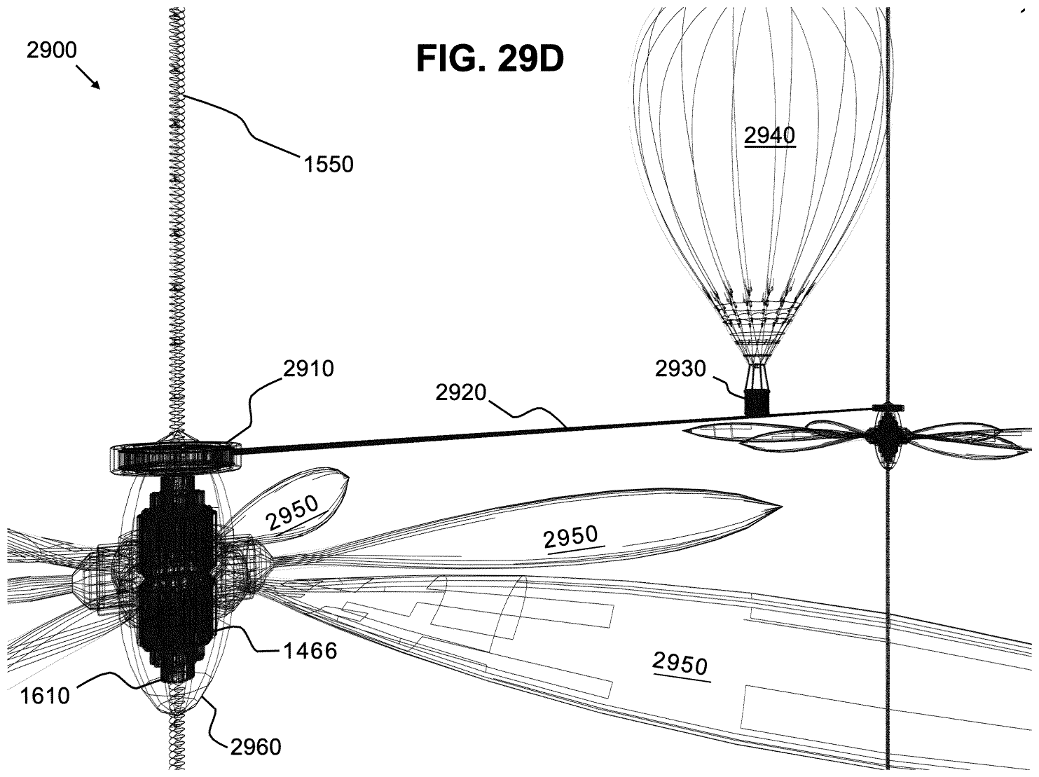

Referring now to FIGS. 29A, 29B, 29C and 29D, another embodiment of an energy generating device 2900 is depicted. Balloon 2940 may be coupled to buoyancy modulation assembly 2930, which may be coupled to body portion 2920, which may be rotatably coupled to first body portion 2960 by one or more bearing 2910. One or more conductive coils 1466 may be coupled to first body portion 2960, which may be coupled to one or more rotor 2950. One or more magnet 1610 may be rotatably coupled to one or more twisted screw-like track 1550 which may be held in a vertical orientation by one or more buoyant member such as airship 2990. An energy generating device may be configured such that one or more conductive coils 1466 rotate in the opposite direction of one or more one or more magnet 1610, thereby inducing a current in one or more conductive coils 1466 and generating electricity. An energy generating device 2900 may send electricity into one or more power line 2980, which may be coupled to one or more tower 2970, which may be coupled to one or more twisted screw-like track 1550.

Energy generating device 2900 is configured to operate with several similar principles to the exemplary selection of devices depicted herein, for example, the relative rotation between a first body portion and a second body portion enables the generation of electrical energy by an electrical generator that may include magnets and conductive coils and the ability to descend through a fluid medium at least partly under the influence of gravity and ascend through a fluid at least partly by changes in buoyancy caused by a buoyancy modulator. The exemplary selection of devices depicted herein are configured to operate with several similar principles to energy generating device 2900, which uses a configuration including an inner track and outer rotors to harvest potential energy within a gas medium, for example, air, by the same principles by which several exemplary devices depicted herein harvest potential energy within a liquid medium. By these principles, an energy generating device can harvest both gravitational potential energy and buoyancy potential energy in any fluid medium.

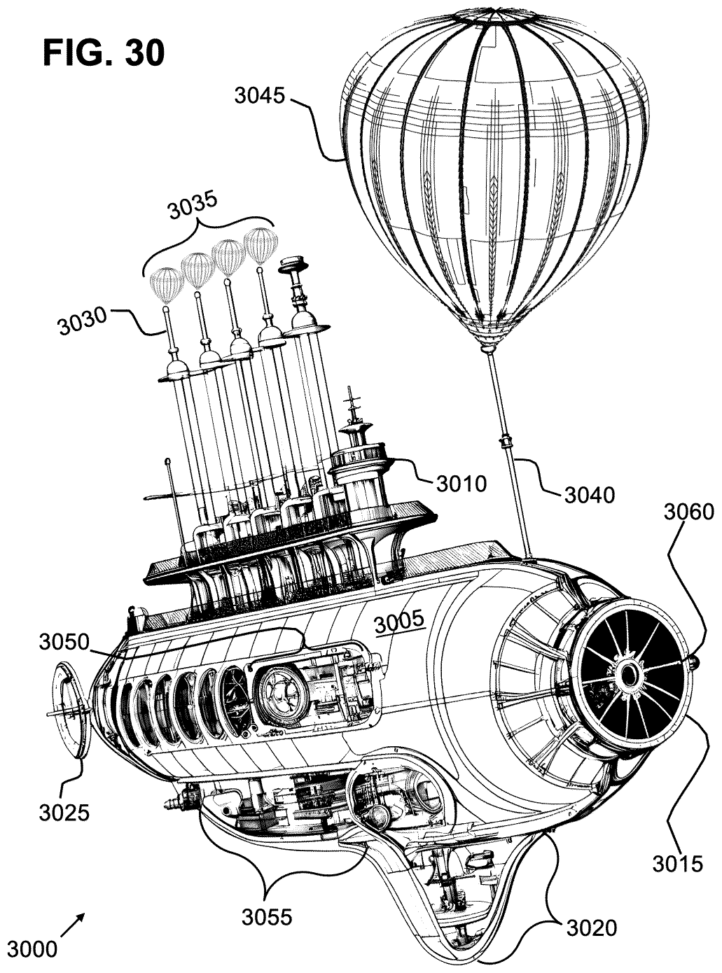

Referring now to FIG. 30, an exemplary embodiment of an energy generating device 3000 is depicted. An energy generating device may include a transport system such as a vehicle capable of transporting goods and passengers in a fluid such as air or water, for example, a car, a train, a boat, a plane, a spaceship (for example, a spaceship designed to be capable of traveling through ion clouds or hydrogen clouds or other clouds of particles in space), a helicopter, a dirigible or a submarine. For example, energy generating device 3000 is configured to transport goods as well as human, plant and animal passengers in a fluid such as water such as the ocean or in a gas such as atmospheric air. When traveling from one location to another, device 3000 may take the shortest path (or any path) latitudinally, or in the x dimension, and longitudinally, or in the y dimension, for the purpose of moving towards its destination. Device 3000 may additionally travel up and down in depth, or in the z dimension, not for the purpose of moving towards its destination but for the purpose of harvesting potential energy to generate as much electricity as is needed for its operations and passengers. The amount device 3000 must travel upward and downward on its journey is determined by the amount of energy it needs to consume on its journey to reach its destination and for any other purpose.

Device 3000 may include body 3005, which may be coupled to one or more steering unit 3025, and may also be coupled to rear balloon array 3035 by fluid channel array 3030, and may also be coupled to one or more nose balloon 3045 by fluid channel 3040. The interior of body 3005 may include a buoyancy modulation facility 3020, an electrical generator 3055 a rotation translation facility 3050. Buoyancy modulation facility 3020 may include an air compressor and compressed gas tank that provide gas to and receive gas from one or more fluid channel array 3030 and one or more fluid channel 3040 the purpose of modulating the buoyancy of device 3000 to cause it to travel upward or downward in a medium. Body 3005 may include one or more pass-through 3015, which may allow water or air or any other fluid to travel through. Pass-through 3015 may include one or more rotor 3060, which, when impinged upon by a fluid medium such as air or water, may rotate and generate torque. Depending on the needs of the people or systems piloting device 3000, the rotation generated by rotor 3060 may be used to generate electricity by electrical generator 3055, or the rotation generated by rotor 3060 might be translated by some number of degrees, such as 90° or 180° via rotation translation facility 3050, which may transfer the rotation to steering unit 3025 in order to steer device 3000 from captains quarters 3010 or autonomously.

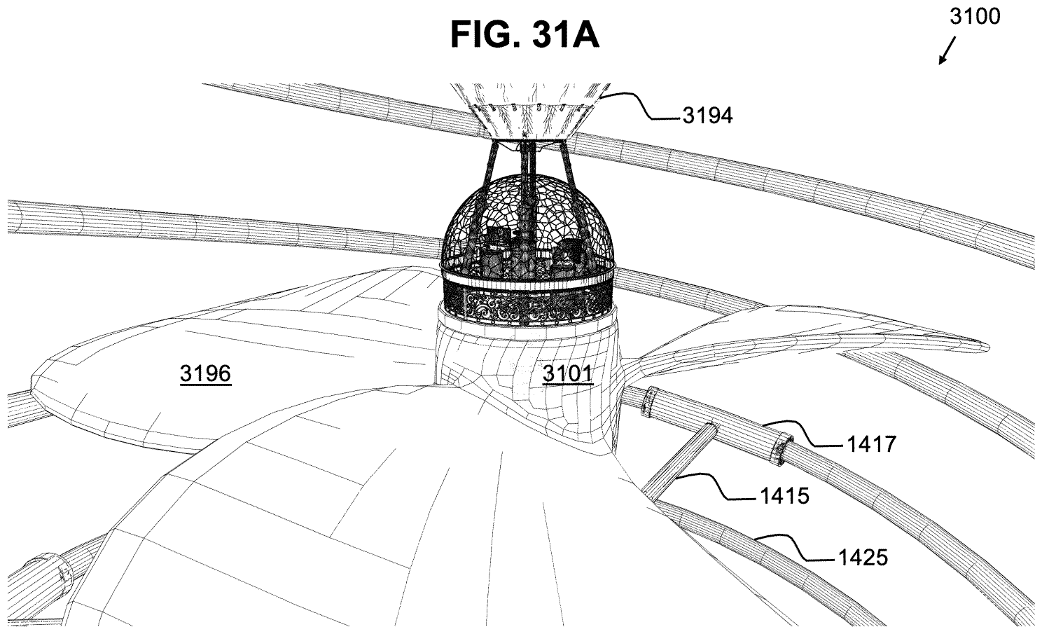

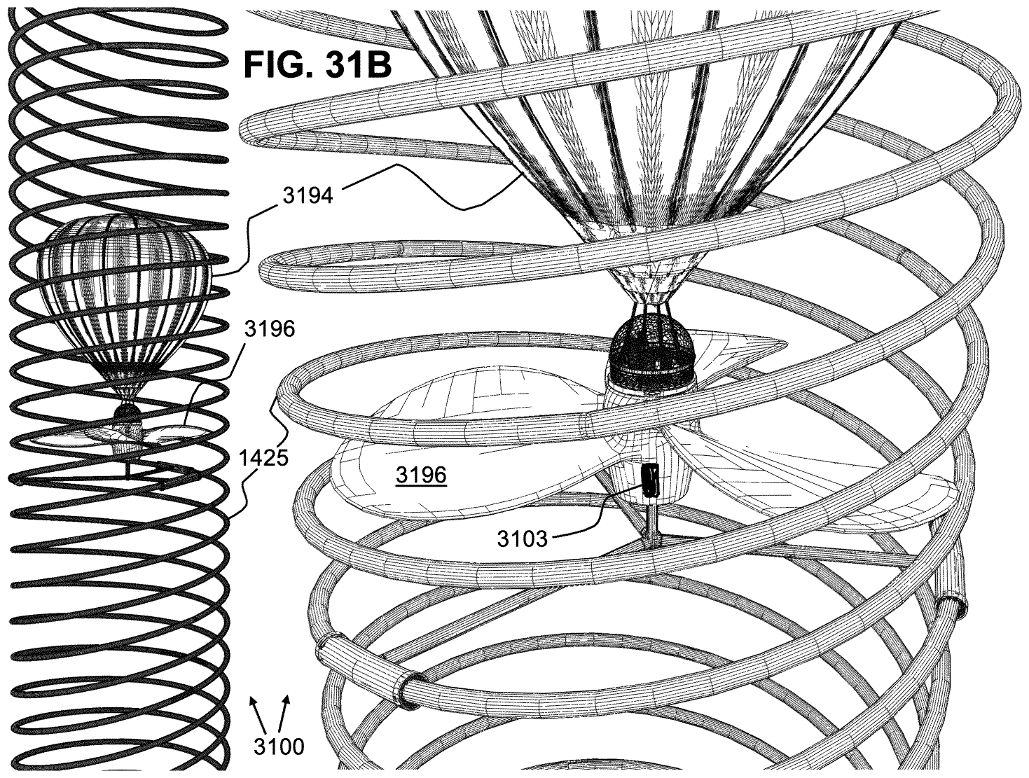

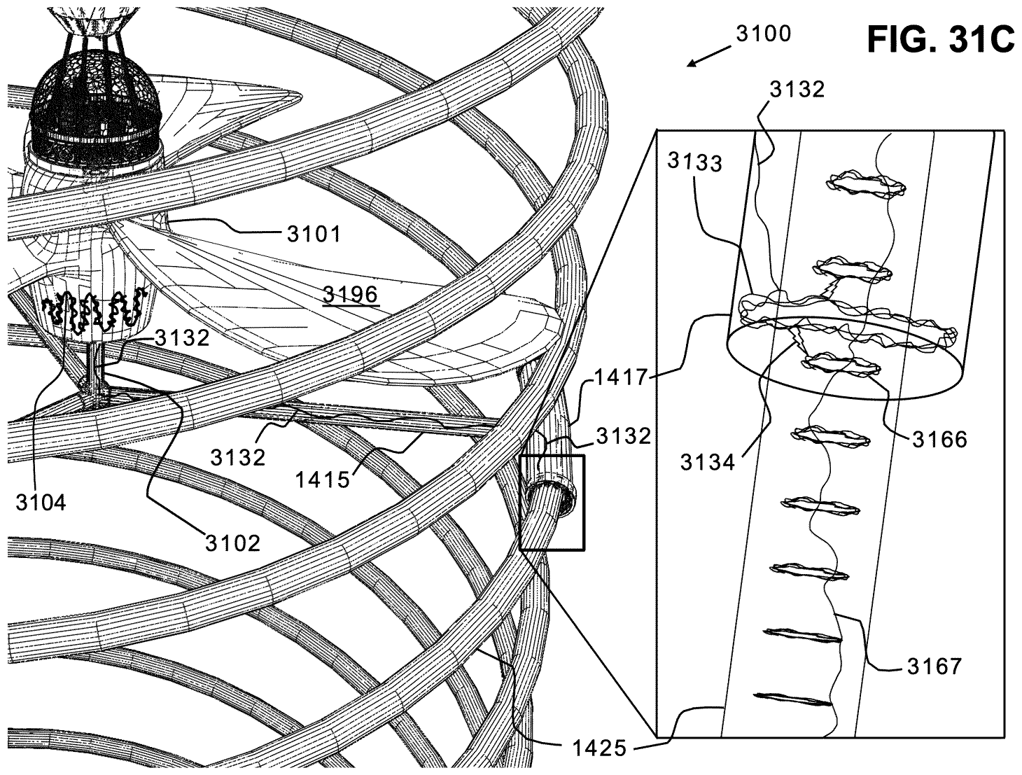

Referring now to FIGS. 31A, 31B and 31C, an exemplary embodiment of an energy generating device is depicted. An exemplary energy generating device 3100 may include an outer track 1425, which may be movably coupled to slide unit 1417 which may be coupled to guide arm 1415, which may be coupled to body portion 3102, which may be coupled to one or more magnet 3103 on the outer or inner surface of a segment of body portion 3102 that is enclosed within a pass through of body portion 3101. The location of magnet 3103 coupled to body portion 3102 is represented in FIG. 31B. For the sake of clarity, note that in several depictions of exemplary devices herein, an internal member is represented within an enclosing member as if a small segment of the enclosing member were transparent or translucent. For example, magnet 3103 and conductive coils 3104 are both represented enclosed within a segment of outer body portion 3101, which segment is depicted as being translucent or transparent precisely where the members are present. In such cases, such members (such as one or more magnet 3103 and conductive coils 3104), having been described as being enclosed within another member (such as outer body portion 3101) should not be confused as being external to the enclosing member. For example, one or more magnet 3103 and conductive coils 3104 have been described as being located within outer body portion 3101.

One or more rotor 3196 may be coupled to body portion 3101 which may be coupled to one or more conductive coils 3104 on its inner surface. Body portion 3101 may be rotatably coupled to body portion 3102 by a bearing or other rotational member. When conductive coils 3104 rotate around one or more magnet 3103, current is induced in conductive coils 3104. Conductive coils 3104 may transmit electricity, for example, through a wireless electricity transfer system, to a wire 3132. Wire 3132 may begin in body portion 3102 and extend down guide arm 1415 into slide unit 1417. Wire 3132 may transmit electricity to one or more electrical transmitter or receiver 3133, which may wirelessly transmit electricity 3134 to one or more electrical transmitter or receiver 3166, which may transmit electricity 3134 to electrical wire 3167, which may transmit electricity to any electrical load or locus or battery. When an energy generating device needs to consume energy a device may receive electricity 3134 that may be transferred from any external source to electrical wire 3167 to one or more electrical transmitter or receiver 3166 to one or more electrical transmitter or receiver 3133 to wire 3132 to wherever within the device the electricity is needed. Energy generating device 3100 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy, for example, via a buoyancy modulator 3194.

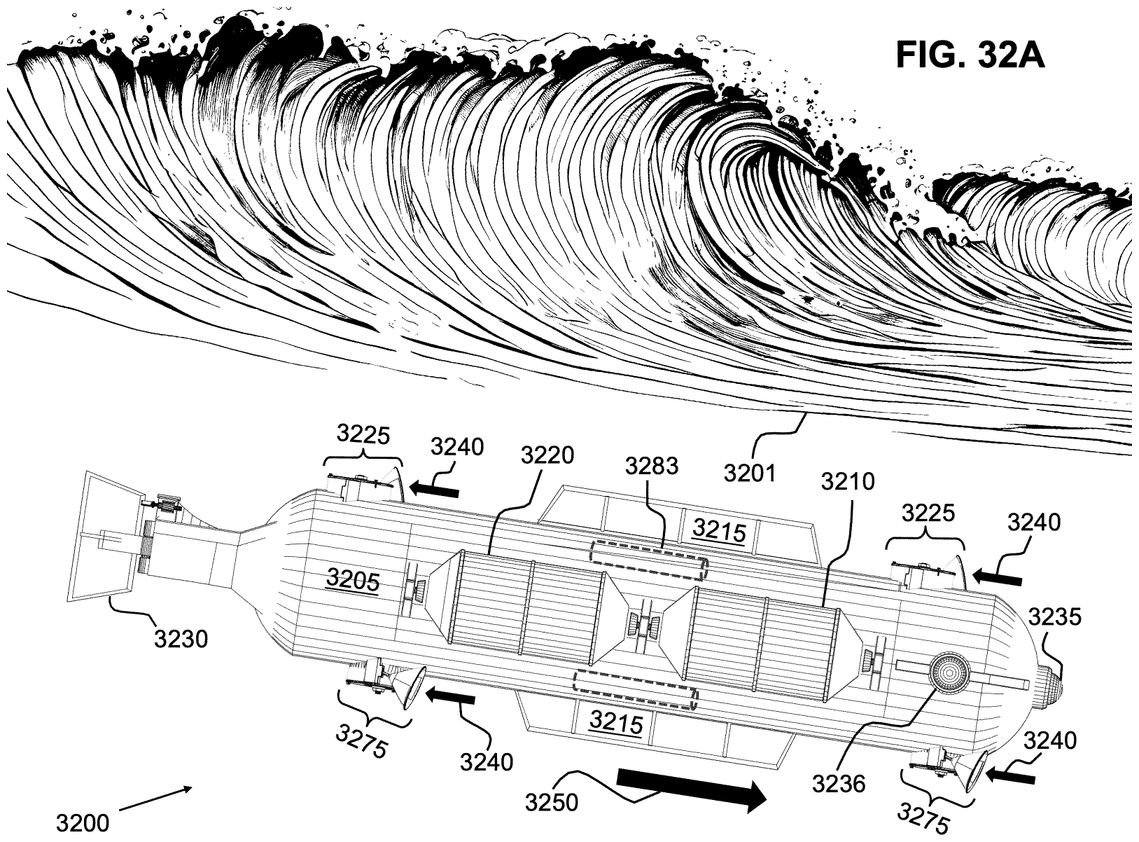

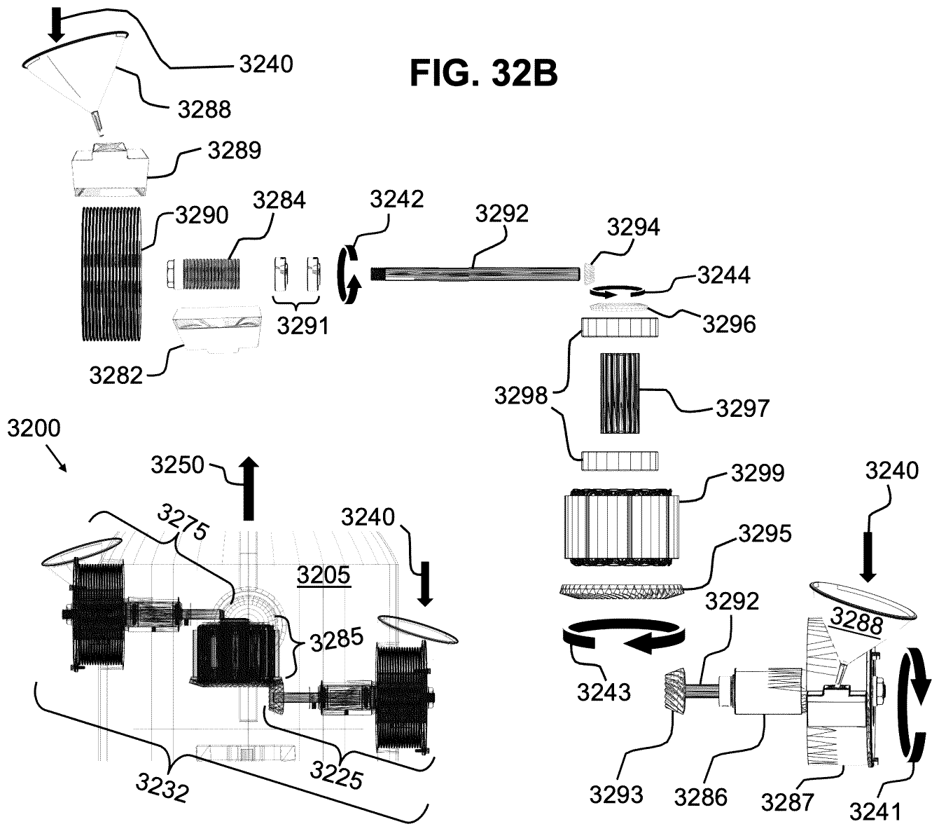

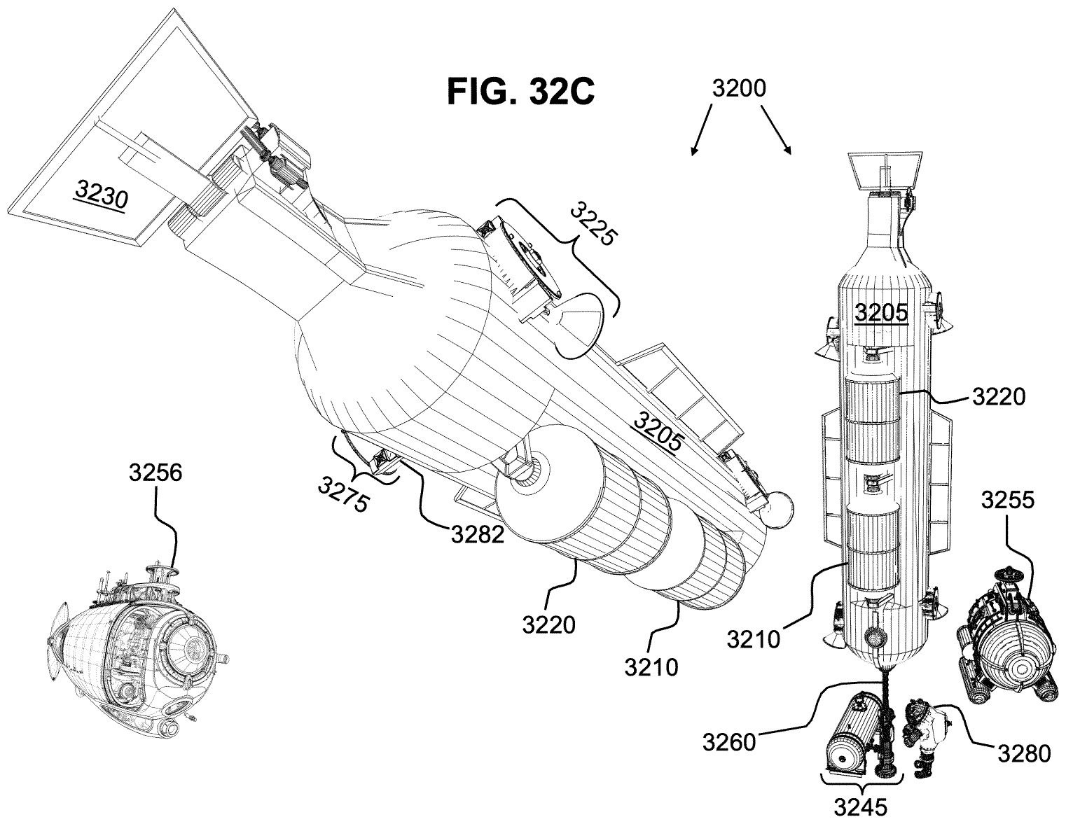

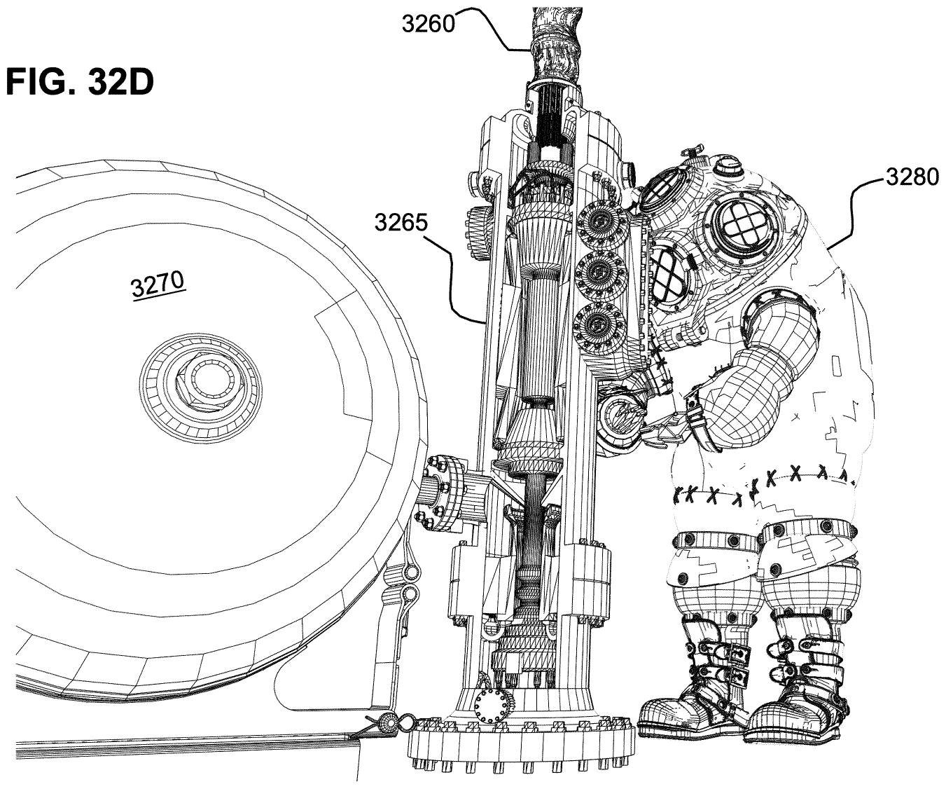

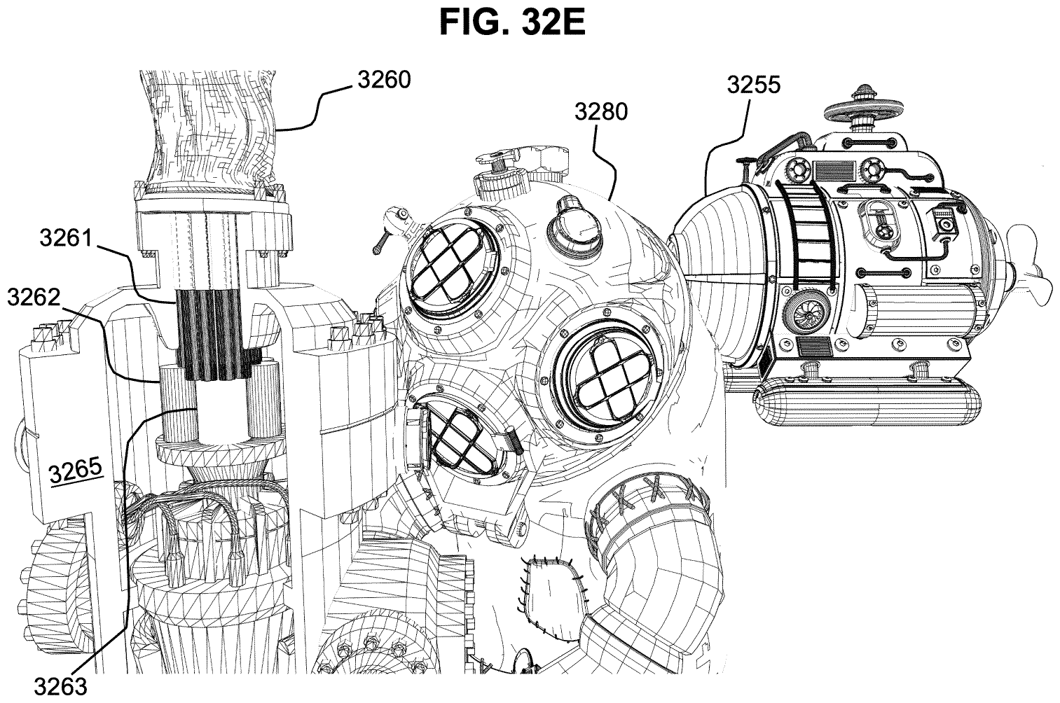

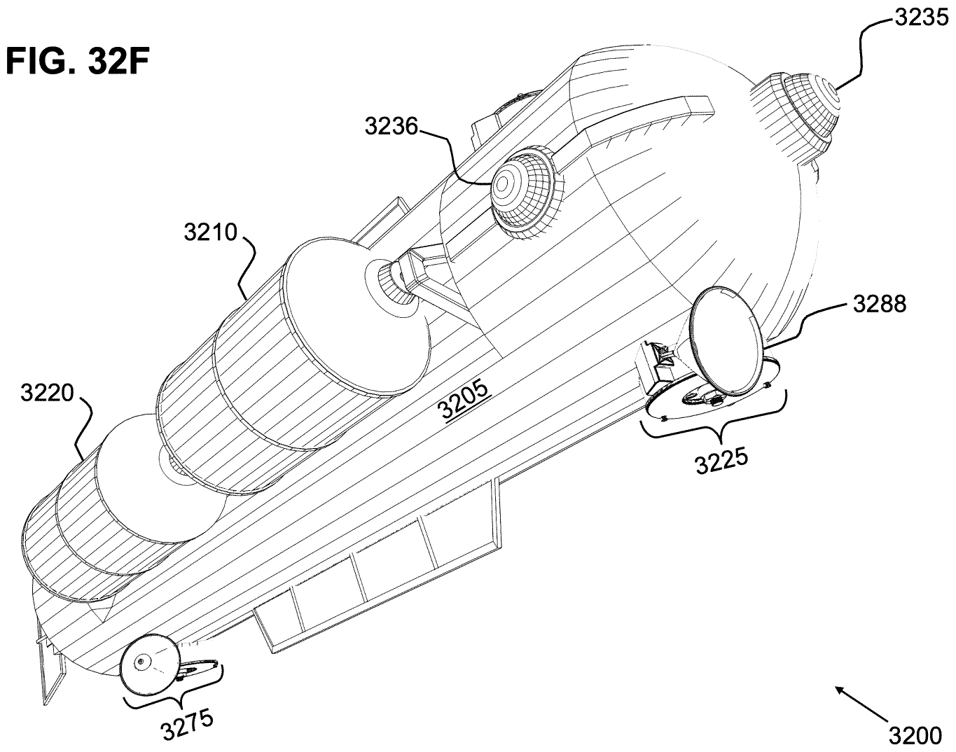

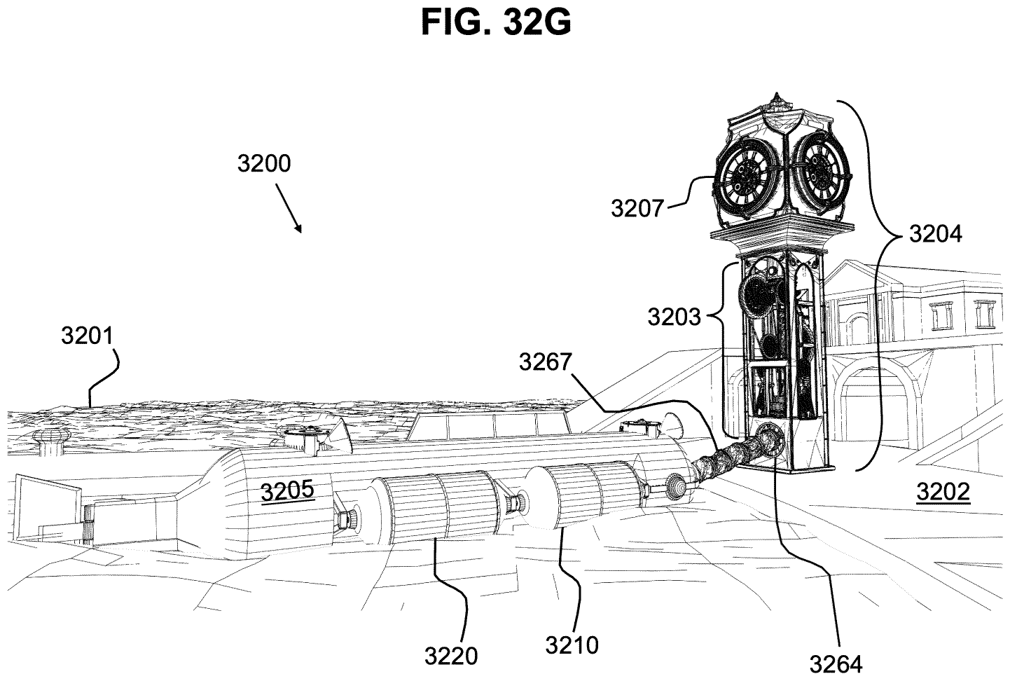

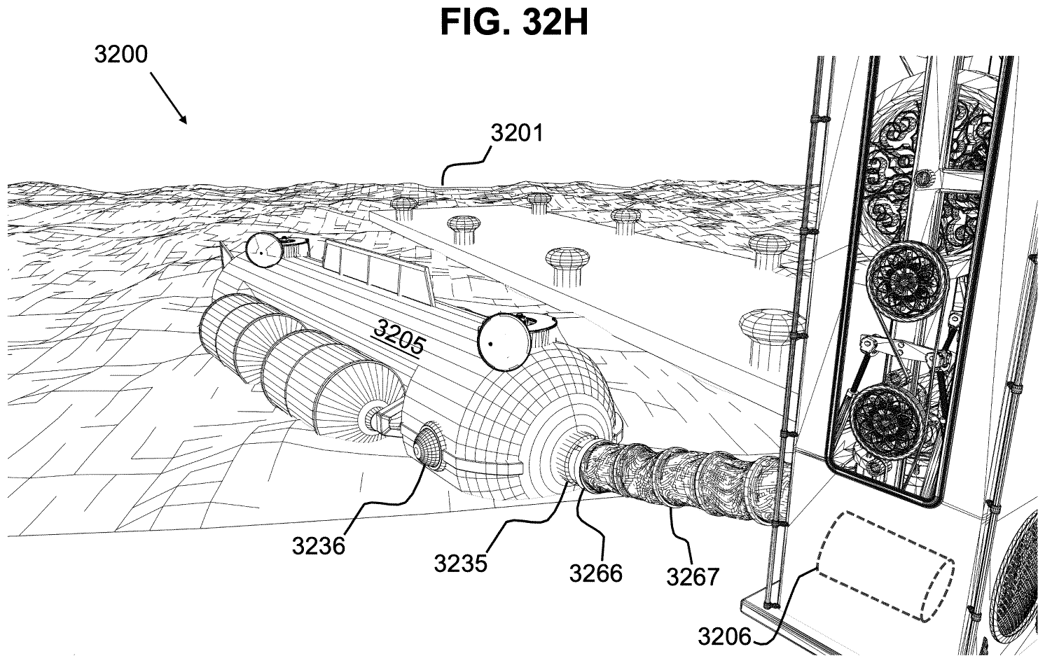

Referring now to FIGS. 32A, 32B, 32C, 32D, 32E, 32F, 32G and 32H, an exemplary embodiment of an energy generating device is depicted. Energy generating device 3200 may include a hull 3205, which may be coupled to one or more stabilization fin 3215. Hull 3205 may be coupled to one or more front multifluid tank 3210 and one or more back multifluid tank 3220, each of which ballast tank which may be configured to hold a combination of gas such as air and liquid such as water. Hull 3205 may be coupled to one or more magnet-coupled Tesla turbine 3275 and one or more conductive coil-coupled Tesla turbine 3225. Hull 3205 may contain one or more internal battery 3283. Towards the front of device 3200, hull 3205 may be coupled to one or more energy and fluid transfer port 3235. Towards the rear of device 3200, hull 3205 may be coupled to steering unit 3230. As device 3200 travels through a fluid such as the ocean in a direction such as direction 3250, the fluid moves in the opposite direction 3240 of the direction of travel of device 3200, some of which fluid enters one or more magnet-coupled Tesla turbine 3275 and one or more conductive coil-coupled Tesla turbine 3225.

Referring now to FIG. 32B, energy generating device 3200 may contain one or more Tesla turbine-driven electrical generator 3232 coupled to and partly included within hull 3205. FIG. 32B includes a transparent Tesla turbine-driven electrical generator 3232 coupled to hull 3205. A Tesla turbine-driven electrical generator 3232 may contain one or more Tesla turbine and one or more electrical generator, which one or more Tesla turbine may be configured to provide rotational force to one or more electrical generator. For example, a Tesla turbine-driven electrical generator 3232 may contain one electrical generator 3285, one magnet-coupled Tesla turbine 3275 and one conductive coil-coupled Tesla turbine 3225. FIG. 32B also includes an exploded view of magnet-coupled Tesla turbine 3275 with its outer casings removed. The exploded view of magnet-coupled Tesla turbine 3275 is coupled to the vertical half of a bevel gear 3294 which is rotatably coupled to the horizontal half of a bevel gear 3296 which is coupled to an exploded view of electrical generator 3285. The exploded view of electrical generator 3285 is coupled to the horizontal half of a bevel gear 3295, which is rotatably coupled to the vertical half of a bevel gear 3293, which is coupled to the central shaft 3292 of conductive coil-coupled Tesla turbine 3225. Note that the outer casings of conductive coil-coupled Tesla turbine 3225 have not been removed, including first outer casing 3286 and second outer casing 3287. Also note that conductive coil-coupled Tesla turbine 3225 contains the same components as magnet-coupled Tesla turbine 3275 and is not depicted exploded.

Device 3200 may be placed into a body of water at ocean surface 3201. As device 3200 travels through a fluid medium such as water in direction 3250, water moves in direction 3240 relative to device 3200 and some water passes into one or more fluid accelerator 3288 of conductive coil-coupled Tesla turbine 3225 and magnet-coupled Tesla turbine 3275. Now describing magnet-coupled Tesla turbine 3275, fluid accelerator 3288 increases the speed at which water flows into fluid spreading unit 3289. After passing through fluid spreading unit 3289, water passes through the spaces in between force input disks 3290, which spaces are maintained by small spacer discs 3284. As the water passes through the disks, the boundary layer effect causes force input disks 3290 to rotate in direction 3242. Force input disks 3290 are coupled to a central shaft 3292, which rotates as force input disks 3290 rotate. As device 3200 continues to travel, water continues to enter fluid accelerator 3288, through fluid spreading unit 3289, through the spaces between force input disks 3290 and finally exits the device after passing through fluid exit channel 3282. Central shaft 3292 is coupled to the vertical half of a bevel gear 3294, which is rotationally coupled to the horizontal half of a bevel gear 3296 at a 90° angle, thereby translating the rotational force by 90° and causing the horizontal half of a bevel gear 3296 to rotate in direction 3244. The horizontal half of a bevel gear 3296 is coupled to the inner portion of a bearing 3298. The inner surface of the inner portion of one or more bearing 3298 is coupled to one or more magnet 3297. The rotational force of the horizontal half of a bevel gear 3296 causes one or more magnet 3297 to rotate in direction 3244.

Now describing conductive coil-coupled Tesla turbine 3225, by a similar mechanism as occurs in magnet-coupled Tesla turbine 3275, water that enters fluid accelerator 3288 causes a central shaft 3292 to rotate in direction 3241. Central shaft 3292 is coupled to the vertical half of a bevel gear 3293, which is rotationally coupled to the horizontal half of a bevel gear 3295 at a 90° angle, thereby translating the rotational force by 90° and causing the horizontal half of a bevel gear 3295 to rotate in direction 3243. The horizontal half of a bevel gear 3295 is coupled to conductive coil assembly 3299, where therefore also rotate in direction 3243. The inner surface of conductive coil assembly 3299 is coupled to the outer portion of one or more bearing 3298. Note that in both conductive coil-coupled Tesla turbine 3225 and magnet-coupled Tesla turbine 3275, the rotational coupling of first outer casing 3286 to central shaft 3292 by one or more bearings 3291 prevents the rotation of force input disks 3290 from causing rotation of first outer casing 3286. First outer casing is coupled to second outer casing 3287, which therefore also does not rotate. As device 3200 travels through a fluid medium such as water in direction 3250, the counter rotation of conductive coil assembly 3299 and one or more magnet 3297 may cause the generation of electricity in conductive coil assembly 3299, which electricity may be used by device 3200 or may be stored in in one or more energy storage device such as one or more internal battery 3283.

Referring now to FIGS. 32C, 32D and 32E, exemplary energy generating device 3200 is depicted descending toward seafloor unit 3245, which may include seafloor air compression member 3265 and compressed gas tank 3270. Note that seafloor air compression member 3265 is depicted in a cutaway view to reveal internal components. Device 3200 steers itself to locations by using steering unit 3230 in combination with the transfer of fluids between one or more front multifluid tank 3210 and one or more back multifluid tank 3220. One or more front multifluid tank 3210 and one or more back multifluid tank 3220 contain several internal tanks that may contain some amount of a compressed gas such as compressed air, as well as some amount of an uncompressed gas such as air, as well as some amount of liquid such as water. When device 3200 reaches seafloor unit 3245 it connects energy and fluid transfer port 3235 or energy and fluid transfer port 3236 or another energy and fluid transfer port to seafloor unit 3245 through seafloor unit connecting cable 3260. Seafloor unit connecting cable 3260 may be similar in structure and function to cable bundle 1599, containing one or more electrical cable 3261, one or more fluid transmission pipe contained within fluid transmission pipe assembly 3263. Device 3200 may transfer energy stored in one or more internal battery 3283 through one or more electrical cable 1598 into one or more battery 3262 that may be included in seafloor air compression member 3265 of seafloor unit 3245. A person seeking electricity such as bosuns mate Edward Siecienski 3280 may stop at seafloor unit 3245 to recharge any electric load such as an electric submersible 3255 using the energy stored in one or more battery 3262, or an autonomous agent such as autonomous electric submersible 3256 may stop at seafloor unit 3245 to recharge.

Device 3200 may transfer compressed gas from one or more front multifluid tank 3210 and from one or more back multifluid tank 3220 through one or more fluid transmission pipes included in fluid transmission pipe assembly 3263, through seafloor air compression member into compressed gas tank 3270. Device 3200 may transfer a gas such as air from one or more front multifluid tank 3210 and from one or more back multifluid tank 3220 through one or more fluid transmission pipes included in fluid transmission pipe assembly 3263 into seafloor air compression member 3265, which seafloor air compression member 3265 may compress the gas and then transfer it into compressed gas tank 3270. Compressed gas tank 3270 may transfer a compressed gas such as air through seafloor air compression member 3265 into one or more fluid transmission pipes included in fluid transmission pipe assembly 3263 into one or more front multifluid tank 3210 and into one or more back multifluid tank 3220 into. Some of the compressed gas transferred from compressed gas tank 3270 may be transferred into a compressed gas tank of one or more front multifluid tank 3210 or one or more back multifluid tank 3220, and some of the compressed gas transferred from compressed gas tank 3270 may be decompressed as it is transferred into a ballast tank of one or more front multifluid tank 3210 or one or more back multifluid tank 3220, which may expel water from the ballast tank of one or more front multifluid tank 3210 or one or more back multifluid tank 3220, thereby causing device 3200 to rise. The combined density of the gasses and fluids in one or more front multifluid tank 3210 may be lower than the combined density of the gasses and fluids in one or more back multifluid tank 3220, causing device 3200 to reorient 180° or some other number of degrees such that one or more front multifluid tank 3210 becomes substantially higher than one or more back multifluid tank 3220 as device 3200 rises through the water.

Now referring to FIGS. 32F, 32G and 32H, as device 3200 departs the seafloor and ascends toward the ocean surface 3201, by the same processes described above, electricity is generated, which electricity may be used by device 3200 or may be stored in in one or more energy storage device such as one or more internal battery 3283. When device 3200 reaches the ocean surface 3201 at it's destination such as a port city 3202, it may connect energy and fluid transfer port 3235 or energy and fluid transfer port 3236 or another energy and fluid transfer port to connecting cable port 3266, which connecting cable port 3266 may be coupled to or included in land-based connecting cable 3267. Land-based connecting cable 3267, which may function similarly to seafloor unit connecting cable 3260, may connect to land unit 3204 via energy and fluid transfer port 3264, which land unit 3204 may contain an air compression system 3203 as well as a battery 3206. Land unit 3204 may also contain one or more components powered by electricity such as electric clock 3207. Electricity transferred from device 3200 to land unit 3204 may be stored in battery 3206 or used to power one or more components powered by electricity such as electric clock 3207 or used for any other purpose. Land unit 3204 may transfer some amount of air or compressed air through energy and fluid transfer port 3264, through land-based connecting cable 3267, through connecting cable port 3266, through energy and fluid transfer port 3235 or energy and fluid transfer port 3236 or another energy and fluid transfer port, and into device 3200. Land unit 3204 may draw air from device 3200 and compress the air and send it back into device 3200, or land unit 3204 may draw air from the open air around it. Then device 3200 may add water to one or more front multifluid tank 3210 and one or more back multifluid tank 3220 in order to dive back down to the ocean floor and repeat the cycle.

An energy generating device may transmit electricity directly to facilities without power lines. Referring now to FIGS. 33A, 33B, 33C, 33D, 33E, 33F, 33G, 33H, 33I, 33J, 33K, 33L, 33M, 33N, 33O, 33P, 33Q and 33R several embodiments of an exemplary energy generating device 3300 are depicted, each having two counter-rotational sets of one or more rotor 3315 and one or more rotor 3335. As depicted in FIGS. 33A and 33B. an exemplary embodiment of an energy generating device 3300 may include one or more balloon 3305 coupled to platform 3339 by one or more body member 3306. A buoyancy modulator 3310 may be coupled to platform 3339. Outer first body portion 3320 may be rotatably coupled to platform 3339 by a rotatable member such as one or more bearing 3355. Any waste heat or thermal energy generated by one or more bearing 3355 or generated by any other member of an energy generating device can be used to for the purpose of warming the same or other components or members of an energy generating device such as platform 3339 or can be used for any other purpose. The outer surface of outer first body portion 3320 may be coupled to one or more top rotor 3315. The inner surface of outer first body portion 3320 may be coupled to one or more conductive coils 1466. Inner second body portion 3330, which extends upward to inner second body portion top cap 3331, may be rotatably coupled to outer first body portion 3320 via a bearing or other rotatable member 3325. Inner second body portion 3330 may be coupled to one or more one or more magnet 1610. Inner second body portion 3330 may be coupled to one or more body portion 3340, which may be coupled to one or more bottom rotor 3335. Body portion 3340 may be rotatably coupled to cordage or rope 3301 or to a cable bundle such as cable bundle 1599 via bearing or other rotatable member 3345. One or more conductive coils 1466 may be rotatably coupled to one or more one or more magnet 1610 by a bearing such as for example bearing 1630. The relative rotation of one or more conductive coils 1466 with one or more one or more magnet 1610 causes the generation of electrical current or produces electricity in the one or more conductive coils 1466.

An exemplary embodiment of an energy generating device can be configured to output energy in several different ways. As depicted in other devices, device 3300 may output to a power line or other electricity transportation medium. For example, as depicted in FIG. 33C, a device might be configured to transmit energy through cable bundle 1599 through cable bundle storage and retraction unit 3365 and into a power grid via one or more electrical transmission line 3379. A device might be configured to store energy onboard for example, as depicted in FIG. 33C, in an aerial battery 3378 or in a ground-based battery such as battery 3381 via electrical connector 3368 or in any other battery configuration such as a DIY battery unit 3382. An energy generating device may be large or mid-sized as depicted in some of the drawings herein, or an energy generating device may be small, for example, as depicted in FIG. 33D, an exemplary embodiment of an energy generating device 3366 might output electricity via a power strip 3386 and an exemplary embodiment of an energy generating device 3344 might output electricity via any other device such as a single USB connector 3388.

As depicted in FIG. 33E, while the aerial unit 3369 of an exemplary embodiment of an energy generating device 3300 ascends through a medium substantially in direction 3321, for example, from height 3323 to height 3326 to height 3329 a bottom torque generator may rotate substantially in a rotational direction and a top torque generator may rotate substantially in the opposite rotational direction, for example, a bottom torque generator 3341 may rotate substantially in direction 3328 and a top torque generator 3342 may rotate substantially in direction 3324, causing relative rotation between magnets and conductive coils to generate electricity.

When or around the time that the aerial unit 3369 of an exemplary embodiment of an energy generating device 3300 reaches a height, for example, its zenith height 3329, the direction of rotation of bottom torque generator 3341 may switch from substantially direction 3328 to substantially direction 3324 and the direction of rotation of top torque generator 3342 may switch from substantially direction 3324 to substantially direction 3328. While the aerial unit 3369 of an exemplary embodiment of an energy generating device 3300 descends through a medium substantially in direction 3395, for example from a height such as height 3329 to height 3326 to height 3323 a bottom torque generator 3341 may rotate substantially in direction 3324 and a top torque generator 3342 may rotate substantially in direction 3328, causing relative rotation between magnets and conductive coils to generate electricity.

When or around the time that the aerial unit 3369 of an exemplary embodiment of an energy generating device 3300 reaches a height, for example, its lowest height 3323, the direction of rotation of bottom torque generator 3341 may switch from substantially direction 3324 back to substantially direction 3328 and the direction of rotation of top torque generator 3342 may switch from substantially direction 3328 back to substantially direction 3324. When the aerial unit 3369 of an exemplary embodiment of an energy generating device 3300 reaches a height such as its zenith height 3329 or its lowest height 3323 a switching unit 3327, which may function similarly to switching unit 1330, may cause the polarity of the output to reverse, so that electrical energy generated while ascending is stored with the same polarity as electrical energy generated while descending. A configuration of four diodes or a rectifier can be used so that the direction of current flow of the electrical generator remains the same as in the downward direction.

Device 3300 and many of the other exemplary devices depicted herein may output electricity into an energy storage device. For example, as depicted in FIG. 33F and FIG. 33G, an aerial unit 3369 of an energy generating device 3300 might be configured to transmit energy through cable bundle 1599 through cable bundle storage and retraction unit 3365, and into battery 3362 and then into electrical hose 3361 and through electric connector 3334 into a device such as, for example, an electric vehicle such as cybertruck 3377. Energy generating devices 3300, 3366 and 3344 are configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

As depicted in FIG. 33G an exemplary energy generating device 3350 may include an aerial unit 3369 connected to a ground unit 3399 via cable bundle 1599, or may include a freely traveling aerial unit 3393 that is steered and horizontally propelled by engine 3354. As depicted in FIG. 33G, as aerial unit 3369 travels vertically through the air in substantially upward direction 3303 or in substantially downward direction 3304, it generates electricity using a torque generator that may include two counterrotating rotors. Aerial unit 3369 may land in docking station 694 where it may transmit electricity from its onboard battery into any source of electrical load such as an EV charging station. Electricity may be transmitted from connecting port 680 to the docking station 694 or from the docking station 694 to the connecting port 680 through a wired electrical connection, or it may be transmitted wirelessly, such that, for example, electricity 691 generated by device 3350 is transmitted through wireless electrical transmitter or receiver 690 to wireless electrical transmitter or receiver 692 then to wire 693 then to any electrical load or locus or battery. Electricity 699 may be transmitted in the opposite direction, from electrical transmitter or receiver 692 to electrical transmitter or receiver 690. Energy generating device 3350 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

As depicted in FIG. 33H and FIG. 33I, the aerial unit 3369 of an exemplary embodiment of an energy generating device 3300 might transmit electricity through cable bundle 1599 through cable bundle storage and retraction unit 3365 into electricity distribution assembly 3332. Electricity distribution assembly 3332 might then transmit electricity to one or more dwelling 3336 via a power line branch 3338. Alternatively, like in many exemplary embodiments of an energy generating device, an energy generating device 3350 may include a freely traveling aerial unit 3393 tethered to nothing at all, which may transmit energy that it generates to a docking member such as docking station 694.

As depicted in FIG. 33J. through FIG. 33N, an exemplary embodiment of an energy generating device 3311 may have an aerial unit 3369 that may be tethered to any object using, by way of example, cordage or rope 3301, which may be reeled in or released or unwound by cable bundle storage and retraction unit 3365. An energy generating device can operate even in the most remote locations to enable inhabitants 3389 to spend electrical energy that they have cleanly harvested from potential energy rather than spending human energy, and to use automated electrical devices such as robotic tractor 3387 rather than manual tools such as tool 3367. When using a rope or when using no tethering device at all, device 3311 may store the energy it generates, for example, in an electric or electrochemical battery 3309. Rather than or in addition to using cordage or rope 3301, an exemplary embodiment of an energy generating device might use a cable bundle 1599 that may include one or more electrical cable 1598 for transmission of electricity. Referring now to FIG. N, an energy generating device 3011 may include a gravity battery rather than an electric or electrochemical battery. A gravity battery may directly use the energy generated by device 3000 or any other energy generating device to lift heavy object like stones using stone lifting and lowering member 3307, which stones can be piled up or built into one or more usable such as structure and energy storage deposit 3317. Lifting and lowering member 3307 may be connected to generator driving cable 3314, which may be windably or movably connected to electrical generator 3302. When a stone is lifted in upward direction 3316 and placed on to a structure and energy storage deposit 3317, potential energy is stored. Structure and energy storage deposit 3317 can be used for any purpose until there is a shortage of electricity, at which point structure and energy storage deposit 3317 may be disassembled by a gravity battery crane 3308 to drive electrical generator 3302 as a stone is lowered in downward direction 3318 by lifting and lowering member 3307. A substantial advantage of using gravity batteries is that they do not require the production, refinement, use and disposal of toxic chemicals like traditional batteries. Moreover, they can serve as useful structures for long periods of time when energy is abundant and do not lose the energy stored in them even if they don't need to be used for millions of years. Energy generating device 3311 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

As depicted in FIGS. 33J, 33K and 33O, an exemplary embodiment of an energy generating device 3322 may provide electricity to a lighting unit or other public utility or any other system that can be powered by electrical energy in order to, for example, provide the system with clean electricity that can be generated day and night. A device 3322 might use one or more aerial-located buoyancy modulator 3310. Alternatively, device 3322 might use a ground-based buoyancy modulator such as a chemical converter or air compressor 3360 and gas tank 3375. Cable bundle 1599 may have several sections which may include cable bundle section 3390 and cable bundle section 3385. A ground based buoyancy modulator such as a chemical converter or air compressor 3360 and gas tank 3375 may be coupled to cable bundle storage and retraction unit 3365 by cable bundle section 3390. Cable bundle storage and retraction unit 3365 may be coupled to lighting unit 3380 by cable bundle section 3385. A ground based buoyancy modulator including gas tank 3375 and chemical converter or air compressor 3360 may provide gas to and receive gas from cable bundle storage and retraction unit 3365 by cable bundle section 3390. Cable bundle storage and retraction unit 3365 may provide gas to and receive gas from balloon 3305 via cable bundle 1599 which provides gas to and receives gas from cable bundle section 3385, which extends through lighting unit 3380 to connect to cable bundle 1599.

Upon or shortly after a balloon 3305 or an aerial unit 3369 of an energy generating device reaches the highest zenith height 3329, cable bundle storage and retraction unit 3365 may reel in cable bundle 1599 and may thereby cause or increase the rate at which the energy generating device travels substantially in direction 3395 in addition to the primary decrease in buoyancy caused by a buoyancy modulator. Alternatively, cable bundle storage and retraction unit 3365 may not have any impact on the rate at which an energy generating device travels. The cable bundle storage and retraction unit 3365 may serve to keep and organize the portion of cable bundle 1599 that is at ground level at any point in time.

An energy generating device may be configured to operate in a set location, as depicted in some of the drawings herein or an energy generating device may be portable. As depicted in FIGS. 33J, 33K, 33P, 33Q and 33R, an energy generating device may be mobile, for example a device may be worn by a user. For example, an exemplary embodiment of an energy generating device 3333 might be worn using one or more harness 3363 and one or more support member 3364 by, for example, a wandering merchant of boiled goods or a purveyor of bespoke on-location boiling services or other user 3376. A buoyancy modulator such as one or more chemical converter or air compressor 3360 and one or more gas tank 3375 may provide gas to and receive gas from balloon 3305 or aerial unit 3369 via cable bundle 1599 to modulate the buoyancy of energy generating device 3333. Cable bundle storage and retraction unit 3365 may unwind or release length of cable bundle 1599 while aerial unit 3369 ascends. Cable bundle storage and retraction unit 3365 may wind or spool the cable bundle 1599 while aerial unit 3369 descends, for example, from height 3326 to height 3323. User 3376 may use a robotic exoskeleton or other lifting aid 3349 to bear some or all of the weight of an energy generating device rather than or in addition to harness 3363 and support member 3364. As depicted in FIG. 33Q, when energy generating device 3333 generates electricity it may store the electricity in on board battery 3370, or electricity may be used immediately upon or just after energy generation for an electrical load of an exemplary energy generating device or one or more member of a device or other electricity-consuming system such as industrial packsaddle-mountable steam kettle 3319.

As depicted in FIGS. 33P and 33R, safety unit 3397 may provide a protective barrier between user 3376 and an energy generating device. Safety unit 3397 may include controls 3398 to operate, turn on, shut down and modulate the parameters of an energy generating device such as the level of energy output of the device as controlled by the difference in speed of rotations of the device as controlled by the difference in buoyancy between the aerial unit of the device and the surrounding medium. Safety unit 3397 may include a GPS positioning device 3392 to broadcast the positioning information of one or more user 3376 to one or more other user 3376. Safety unit 3397 may include proximity sensor 3394 which may be configured to provide a warning to user 3376 in the form of a vibration or sound from a warning system such as one or more vibrating gear and speaker system 3396 when another user 3376 is approaching a distance 3312 as detected by the proximity sensor 3394 or GPS positioning device 3392 so that all users 3376 stay a safe distance 3312 apart as not to cause their wearable energy generating devices to collide. Like device 3333, an energy generating device may include one or several safety units of many varieties, each configured to protect users and operators of a device as well as all others from danger or harm. The precise configuration of a safety unit may vary widely depending on the nature of the application and configuration of the energy generating device.

Energy generating devices 3300, 3311, 3322 and 3333 are configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator. The exemplary selection of devices depicted herein are configured to operate with several similar principles to energy generating device 3300, 3311, 3322, 3333, 3344 and 3366, for example, an energy generating device can harvest gravitational potential energy and flotational potential energy in any fluid medium. Further, an energy generating device can harvest potential energy regardless of whether the torque generator of an energy generating device includes two counterrotating rotors as depicted in energy generating device 3300, or alternatively includes some other configuration of tracks and rotors.

As previously taught, some of the members of an energy generating device may be included in an aerial unit 3369. Referring now to FIGS. 34A and 34B, other members of an energy generating device may not be included in an aerial unit 3369 or may be included outside an aerial unit 3369. For example, while in some embodiments cable bundle storage and retraction unit 3365 may be included in an arial member, on other embodiments, such as in exemplary energy generating device 3483 depicted in FIGS. 34A and 34B, cable bundle storage and retraction unit 3365 may not be included in an aerial member, but instead may be included in ground unit 3472 and coupled to cable bundle 1599 which may be coupled or movably coupled or retractably coupled or rotationally coupled to aerial unit 3369. An exemplarily embodiment of energy generating device 3484, may include only a single member in its aerial unit 3369, for example, a balloon 3471, while including all other members in ground unit 3473. Some exemplary embodiments of an energy generating device may have both an aerial member such as freely traveling aerial unit 3393 or aerial unit 3369 and a ground unit such as cordage or rope 3301 or ground unit 3473, while other devices may only have either a ground unit or an aerial member. Further, while many exemplary embodiments may include some members in an aerial member and may include other members outside of an aerial member, some exemplary embodiments of an energy generating device, for example, device 3311, may include all or nearly all members in an aerial unit 3369. In some embodiments, a ground unit 3473 may include cable bundle storage and retraction unit 3365.

In some exemplary embodiments of an energy generating device such as devices 3483 and 3484, cable bundle storage and retraction unit 3365 may reel in, release and store cable bundle 1599. Reeling in can be powered by traditional methods using a torsion spring, for example, during descent of the aerial unit 3369, or reeling in may occur by any other method. Alternatively, no reeling need occur. As depicted in FIGS. 34A and 34B, cable bundle 1599 may transmit air or other gas and electricity between aerial unit 3369 and ground unit 3473, which ground unit 3473 may include a buoyancy modulator 3410. As an alternative to converting potential energy into electricity inside the aerial unit as depicted in several exemplary embodiments, a device, such as, for example, an exemplary embodiment of an energy generating device 3484 may generate electricity on the ground, such as by coupling a cable bundle storage and retraction unit 3365 to shaft 3474 which provides rotational force to an electrical generator 3391. Like in other exemplary embodiments of an energy generating device, electricity can be generated by the relative rotation of magnets and conductive coils or by any other method using rotation to generate electricity. One of ordinary skill in the art will recognize that the electrical generator included in an energy generating device can be any kind of electrical generator that uses rotational force or any other force translated or translatable into a rotational force to generate electricity. In an exemplary embodiment, a cable bundle might be included in the aerial unit 3369. Energy generating devices 3483 and 3484 are configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator.

Referring now to FIG. 34C, two exemplary embodiments of an energy generating device are depicted. An exemplary embodiment of an energy generating device 3452 includes a surface unit 3407, which includes a buoy 3437 which may be coupled to a cable bundle storage and retraction unit 3365, or buoy 3437 may be coupled directly to a rode line 3448 without a cable bundle storage and retraction unit 3365. Buoy 3437 is configured such that it maintains surface unit 3407 on or near the surface of a fluid such as ocean surface 3443. Cable bundle storage and retraction unit 3365 may be coupled to and can reel and unreel rode line 3448, which rode line 3448 is coupled to a marine unit 3456. Marine unit 3456 may include a buoyancy modulator 3458, which may be configured to compress and expand a gas and provide gas to and receive gas from a weighted swim bladder 3402. Weighted swim bladder 3402 may be configured to expand and contract depending on how much gas it contains. Weighted swim bladder 3402 may be configured to weigh enough to pull marine unit 3456 in downward descending direction 3418 when weighted swim bladder 3402 is contracted. Weighted swim bladder 3402 may be configured to cause marine unit 3456 to ascend in direction 3417 when weighted swim bladder 3402 is expanded with a gas, thereby turning the orientation of marine unit 3456 by 180° prior to or at the beginning of its ascent. Marine unit 3456 may include a torque generation and electricity generation system 3459 configured to operate with several similar principles to the exemplary selection of devices depicted herein, for example, the relative rotation between a first body portion containing rotors and a second body portion containing counter directional rotors enables the generation of electrical energy by an electrical generator that may include magnets and conductive coils and the ability for a device or one or more member of a device to descend through a fluid at least partly under the influence of gravity and ascend through a fluid at least partly by changes in buoyancy, thus torque generation and electricity generation system 3459 does not require further explanation of how it operates to generate electricity.

An exemplary embodiment of an energy generating device 3453 includes a surface unit 3408, which includes a buoy 3437 which may be coupled to a pole 3451, which may be coupled to a system 3416. System 3416 may include many of the same components as ground unit 3473 depicted in FIG. 34B, including a buoyancy modulator 3410 as well as an electrical generator 3491, which may be coupled to a shaft 3474, which may be coupled to a cable bundle storage and retraction unit 3365, as depicted in FIG. 34B. Refer to the discussion of FIG. 34B above to review components and functions of ground unit 3473 which many include several of the same components as system 3416. Buoy 3437 is configured such that it maintains surface unit 3408 on or near the surface of a fluid such as ocean surface 3443. Cable bundle storage and retraction unit 3365 may be coupled to and can reel and cable bundle 1599, which cable bundle 1599 may be coupled to a swim bladder 3457. Buoyancy modulator 3410 may receive fluid from and send a fluid such as a gas or liquid to weighted swim bladder 3457 via cable bundle 1599. Alternatively, cable bundle 1599 might not provide a gas to swim bladder 3457, rather, a buoyancy modulator 3410 may be directly coupled to and provide gas to and receive gas from swim bladder 3457. A swim bladder 3457 may be configured to expand and contract depending on how much fluid it contains. Swim bladder 3457 may be denser than the surrounding medium when contracted, or swim bladder may be less dense than the surrounding medium when contracted. If swim bladder is denser then the surrounding medium when contracted, swim bladder 3457 may descend in direction 3418 when it is contracted and may ascend in direction 3417 when it is expanded with a fluid such as a gas. If swim bladder is less dense then the surrounding medium when contracted, swim bladder 3457 may ascend in direction 3417 when it is contracted and may descend in direction 3418 when it is expanded with a fluid such as a liquid that is more dense then water. Alternatively, swim bladder 3457 may include a ballast system 3446 that functions to modulate its buoyancy like in other exemplary embodiments previously discussed such as exemplary embodiment 100. Energy generating device 3452 and 3453 are configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator.

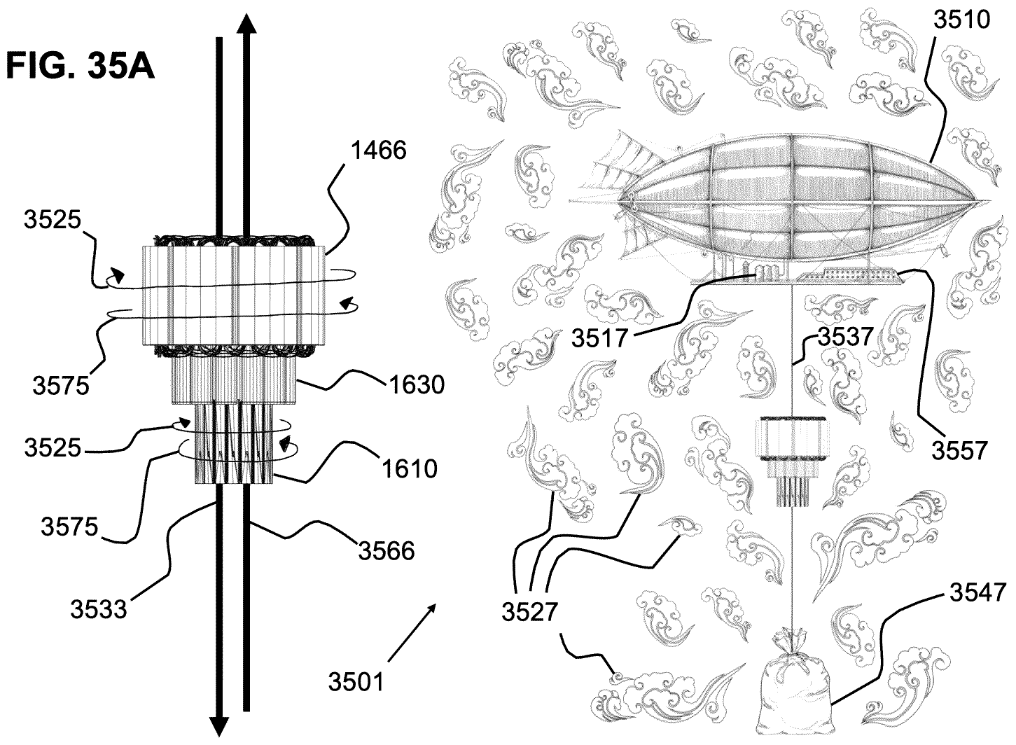

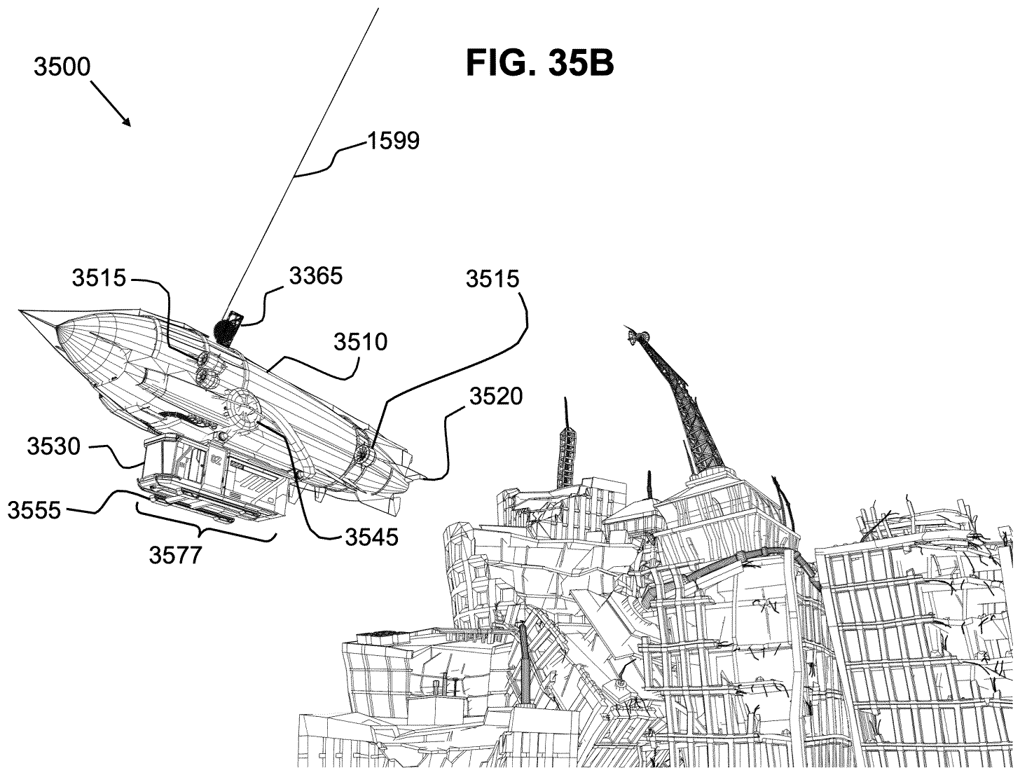

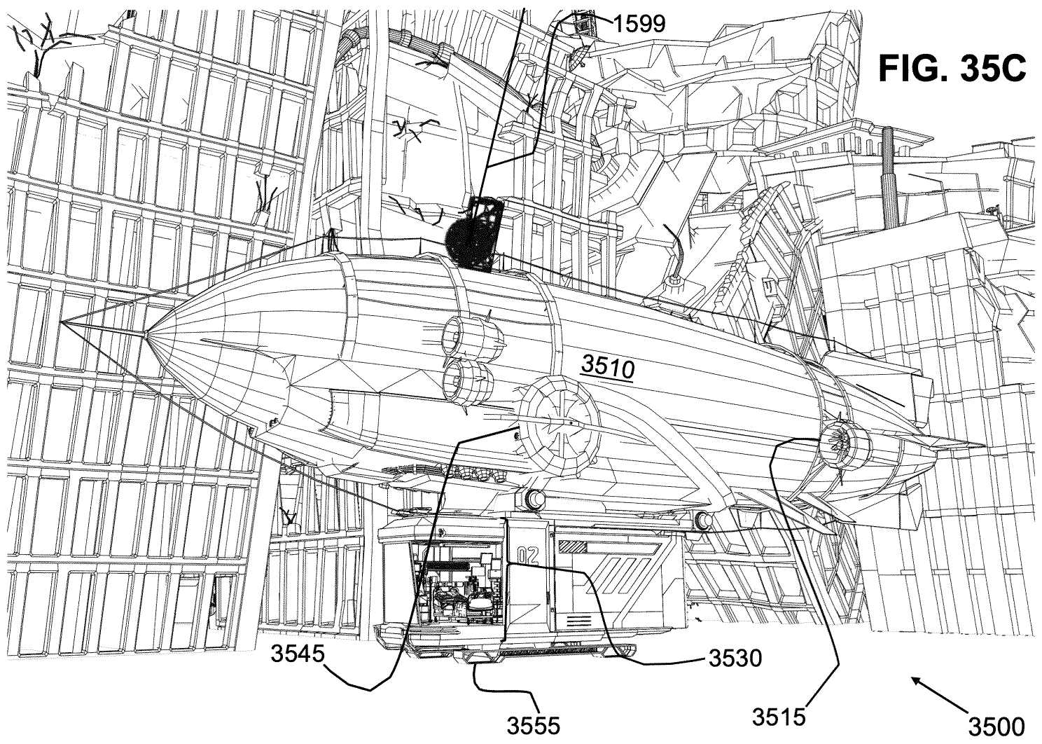

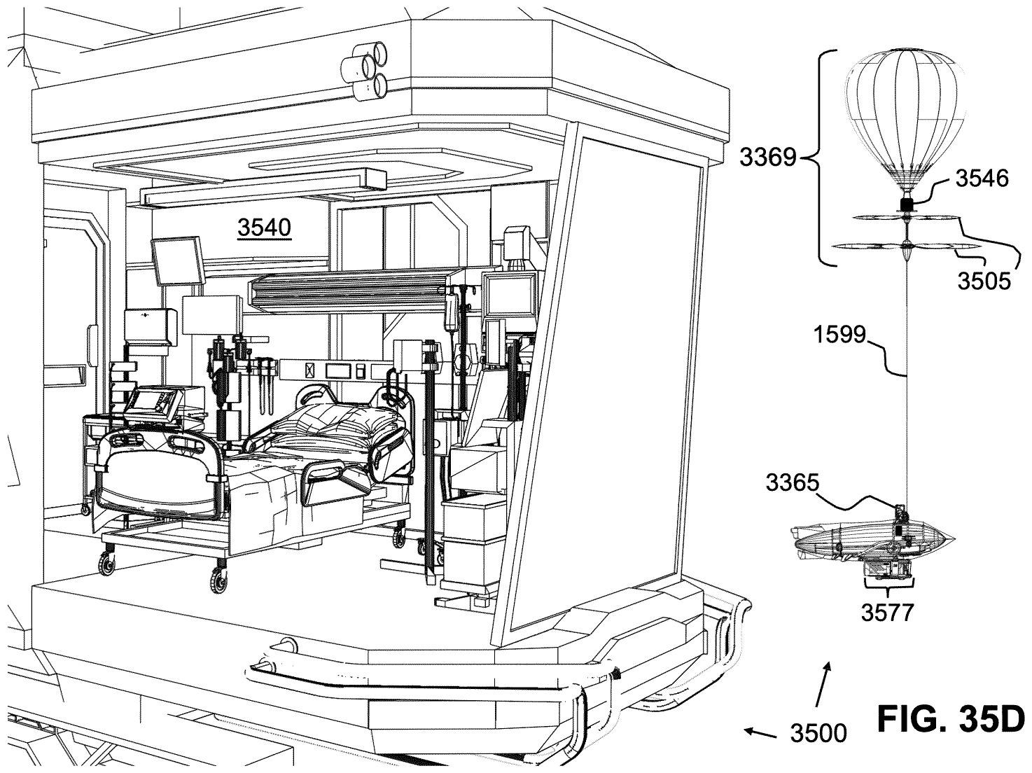

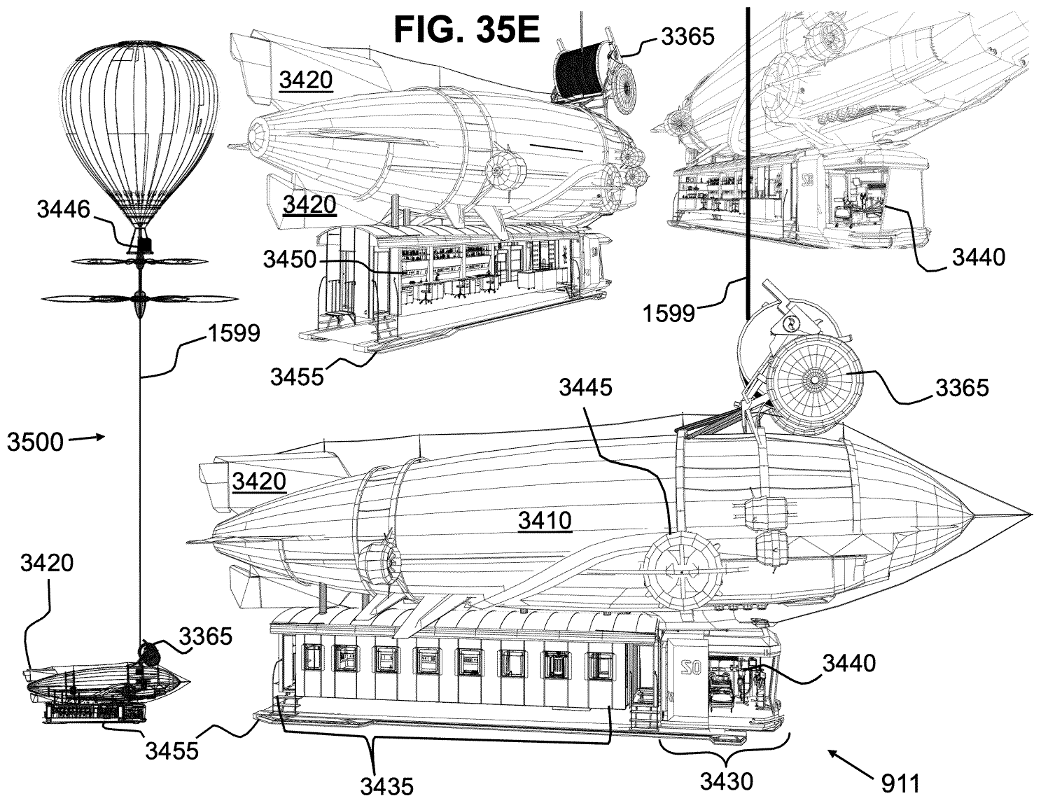

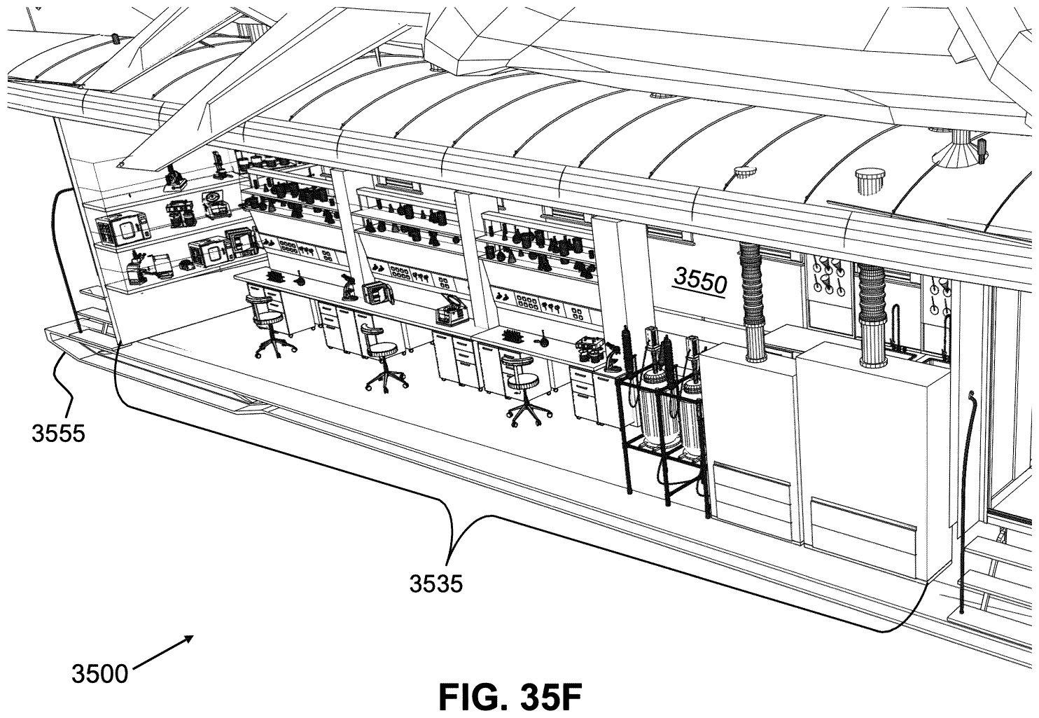

Referring now to FIG. 35A, an exemplary embodiment of an energy generating device is depicted. An exemplary energy generating device 3501 may include a top airship 3510, which may be configured to receive and send a fluid from and to a buoyancy modulator such as air compressor and gas tank 3517. An exemplary device might include a weight such as one or more sandbag 3547, which may be coupled to airship 3511 by cable bundle 3537. An exemplary embodiment of an energy generating device may be configured to use any kind of torque generator such as using rotors and tracks as previously taught to cause conductive coils 1466 to rotate in direction 3525 or direction 3575 when the torque generator travels through a medium 3527 in a direction 3533 or direction 3566, or conductive coils 1466 might not rotate. An exemplary embodiment of an energy generating device may be configured to use any kind of torque generator to cause magnet 1610 to rotate in direction 3575 or direction 3525 when the torque generator travels through a medium 3527 in a direction 3533 or direction 3566, or magnet 1610 might not rotate. As long as one or the other of the one or more magnet 1610 and the conductive coils 1466 rotate relative to the other, they need not both rotate The relative rotation of conductive coils 1466 and magnet 1610, for example, around a rotational member such as a bearing 1630, may generate electricity in conductive coils 1466, which may be transferred to battery bank 3557 via cable bundle 3537 or may be routed to other members of exemplary energy generating device 3501 or to any other electrical load or locus. Energy generating device 3501 is configured to operate with several similar principles to the exemplary selection of devices depicted herein, for example, the relative rotation between a first body portion and a second body portion enables the generation of electrical energy by an electrical generator that may include magnets and conductive coils and the ability for device 3501 or one or more members of device 3501 to descend through a fluid at least partly under the influence of gravity and ascend through a fluid at least partly by changes in buoyancy caused by a buoyancy modulator.

Referring now to FIGS. 35B, 35C, 35D, 35E, and 35F, several exemplary embodiments of an energy generating device are depicted. An exemplary energy generating device 3500 is similar in operation and function to exemplary energy generating device 3300 depicted in in FIG. 33 and may include an aerial unit 3369. An exemplary device may include two counterrotating rotors 3505 coupled to an electrical generator similar to that depicted in device 3300. Energy generated by exemplary device 3500 may be transferred through cable bundle 1599 or any other method into cable bundle storage and retraction unit 3365, which may be coupled to a airship 3511, which may include one or more propulsion unit 3515 and steering unit 3520. Airship 3511 may include a gondola 3577, that may land using landing gear 3555. Gondola 3577 may include a front section 3530 and a back section 3535. Airship 3511 may be coupled to cable bundle storage and retraction unit 3365 which may be coupled to cable bundle 1599 which may be coupled to aerial unit 3369. Airship 3511 may include a buoyancy modulator 3545, which may provide fluids to and receive fluids from aerial unit 3369. Energy generating device 3500 may include a battery 3546, which may provide electricity to and receive electricity from aerial unit 3369. Front section 3530 may include fully powered facilities such a fully powered emergency facilities such as an intensive care unit 3540. Back section 3535 may include fully powered facilities such a fully powered emergency facilities such as a medical testing laboratory 3550. Energy generating device 3500 is configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator.

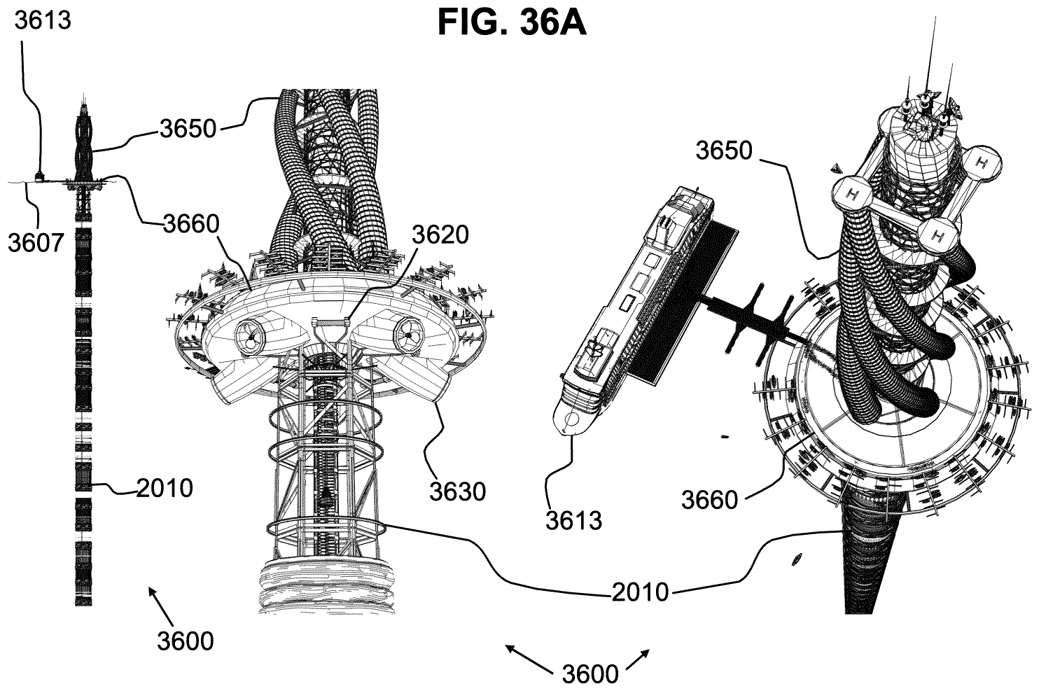

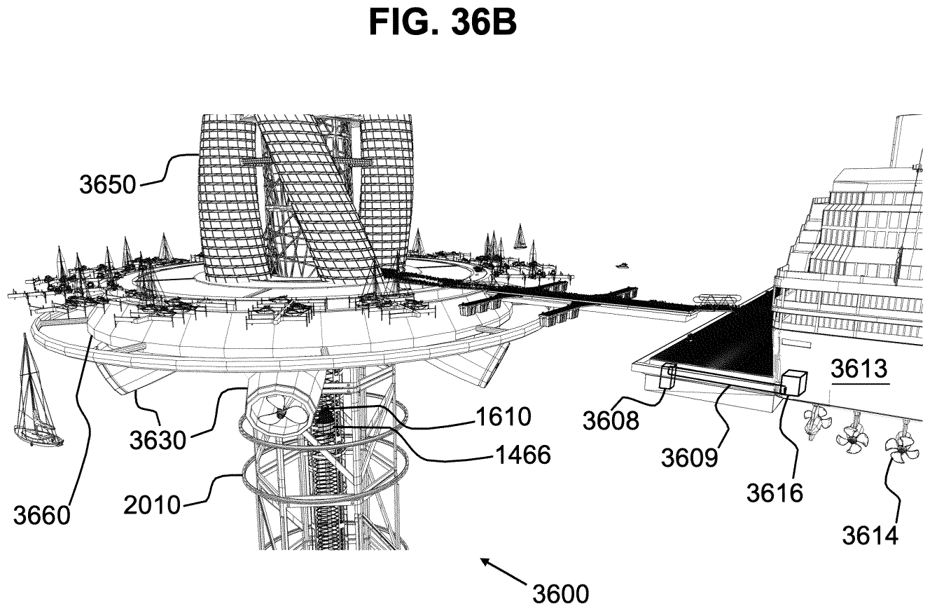

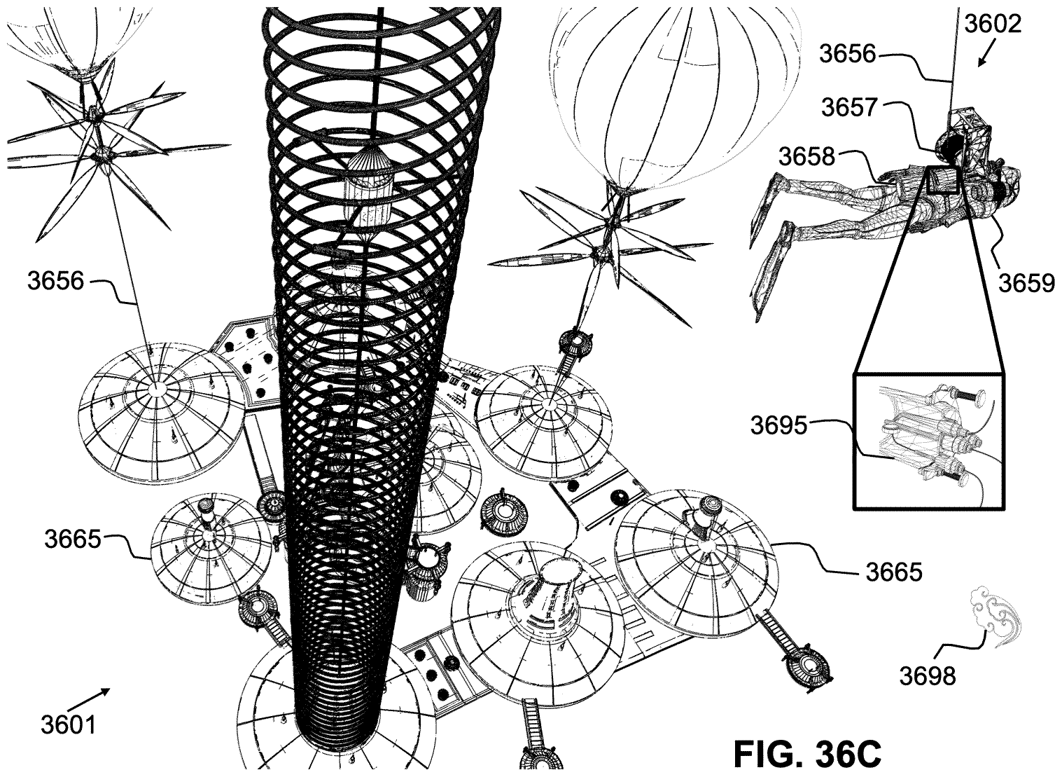

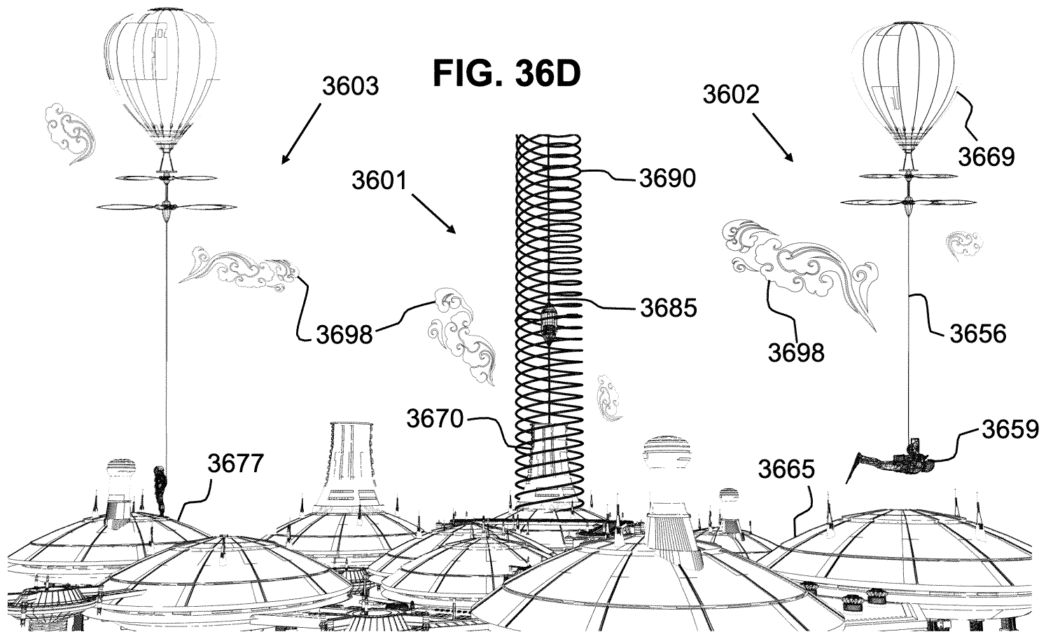

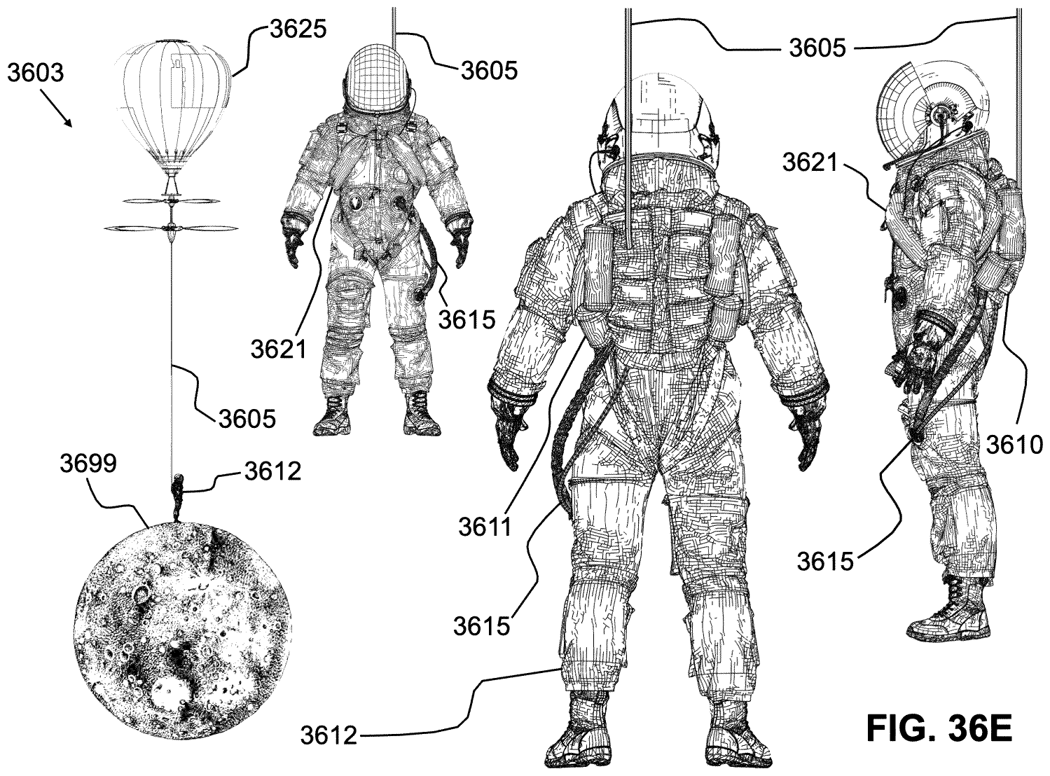

Referring now to FIGS. 36A and 36B, an exemplary embodiment of an energy generating device is depicted. An exemplary energy generating device 3600 may include one or more one or more magnet 1610 rotatably coupled to one or more conductive coils 1466 housed by a vessel, for example, linear vessel 2110. An energy generating device 3600 may be submersed below the water line 3607 to provide power to any electrical system or battery or electrical load such as a marine facility, for example a deep ocean facility such as a light house residence and resort 3650. A light house residence and resort 3650 may remain substantially vertical and balanced and relatively still by selectively activating counter directional engines or motors such as counter directional electric motor 3630, when sensors 3620 detect that platform 3660 is not sufficiently parallel with water line 3607, such that selective activation of one or more counter directional electric motor 3630 may cause platform 3660 to become more parallel to water line 3607.

A typical cruise ship 3613 may consume substantial amounts of fossil fuels to power their facilities and their engines 3614. An exemplary embodiment of an energy generating device 3600 may generate and be powered by 100% clean electricity harvested from potential energy and can therefore provide energy to cruise ships to supplement and reduce their fossil fuel consumption, for example, by sending electricity from battery 3608 through electrical cable 3609 to cruise ship battery or electrical load 3616. Energy generating device 3600 is configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator. The exemplary selection of devices depicted herein is configured to operate with several similar principles to energy generating device 3600, which uses a configuration including two counter rotational tracks to harvest potential energy by the same principles by which energy generating device 2900 is able to harvest potential energy using both track and rotor.

Referring now to FIGS. 36C and 36D, several exemplary embodiments of an energy generating device are depicted. Three exemplary embodiments of energy generating devices 3601, 3602 and 3603 function similarly to other exemplary embodiments. An exemplary device 3601 may have counter rotational tracks which may include one or more inner track 3685 and an outer track 3690. Device 3601 may function similarly to other exemplary energy generating devices previously taught, for example, device 3601 may generate electricity similarly to device 2700 and device 1400. Device 3601 may feed electricity into an electrolysis unit 3670 to convert a medium 3698, for example, water, into hydrogen and oxygen for use by dwellers in underwater community 3665. Similarly, wearable energy generating device 3602 may feed electricity into an electrolysis unit, for example, electrolysis unit 3695, to convert a medium 3698, for example, water, into hydrogen and oxygen for a diver 3659. Wearable device 3602 may contain a cable bundle storage and retraction unit 3657, which may be coupled to cable bundle 3656, which may transfer one or more fluids between inflatable member 3669 and buoyancy modulator 3658.

The problems that an exemplary device may solve for underwater communities are similar to the problems that an exemplary device may solve for communities with an unbreathable atmosphere, such as a community on Mars, or such as a community on Earth if by fate or by folly Earth's air becomes unbreathable. Device 3601 may feed electricity into an electrolysis unit 3670 to convert a medium 3698, for example, air, such as air containing high amounts of CO₂, into carbon and oxygen for dwellers in a space community, for example, a Martian community of Earth plants, animals and people 3677. Energy generating devices 3601, 3602 and 3603 are configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator.

Referring now to FIG. 36E, an exemplary embodiment of a wearable energy generating device is depicted. Device 3603 may include a cable bundle 3605, coupled to wearable member 3610 via strap coupler 3621 to a wearer 3612 of the device. Wearable member 3610 may contain oxygen harvesting unit 3611, which may harvest oxygen, for example, O₂, from CO₂. Oxygen might then be delivered to the wearer of the device via tube 3615, and carbon dioxide might be taken in from the environment, for example from the atmosphere of an astronomical body 3699 or might be harvested from the exhaled air of wearer 3612 and transferred to oxygen harvesting unit 3611 via tube 3615. Cable bundle 3605 may transfer fluids such as gasses such as oxygen or a lighter than air gas such as hydrogen or helium between balloon 3625 and wearable member 3610 via cable bundle 3605. Energy generating device 3603 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members of the device to descend through a fluid at least partly under the influence of gravity and ascend through a fluid at least partly by changes in buoyancy caused by a buoyancy modulator.

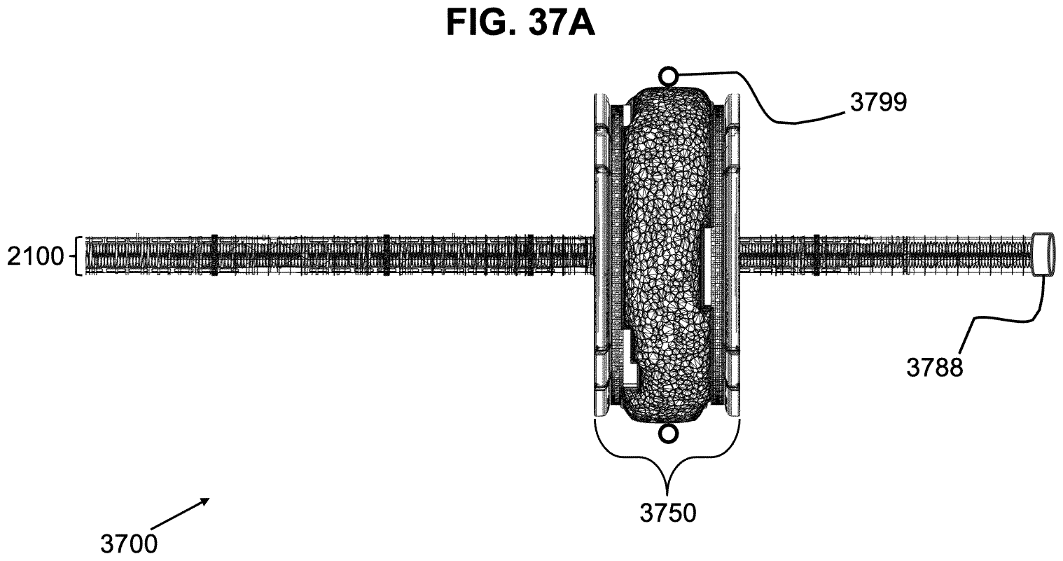

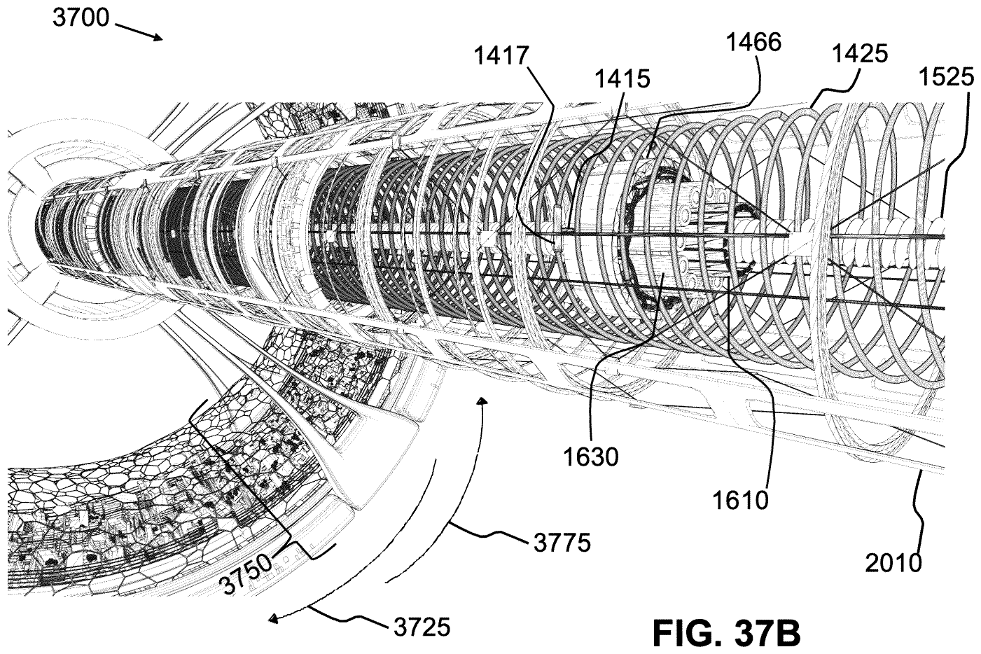

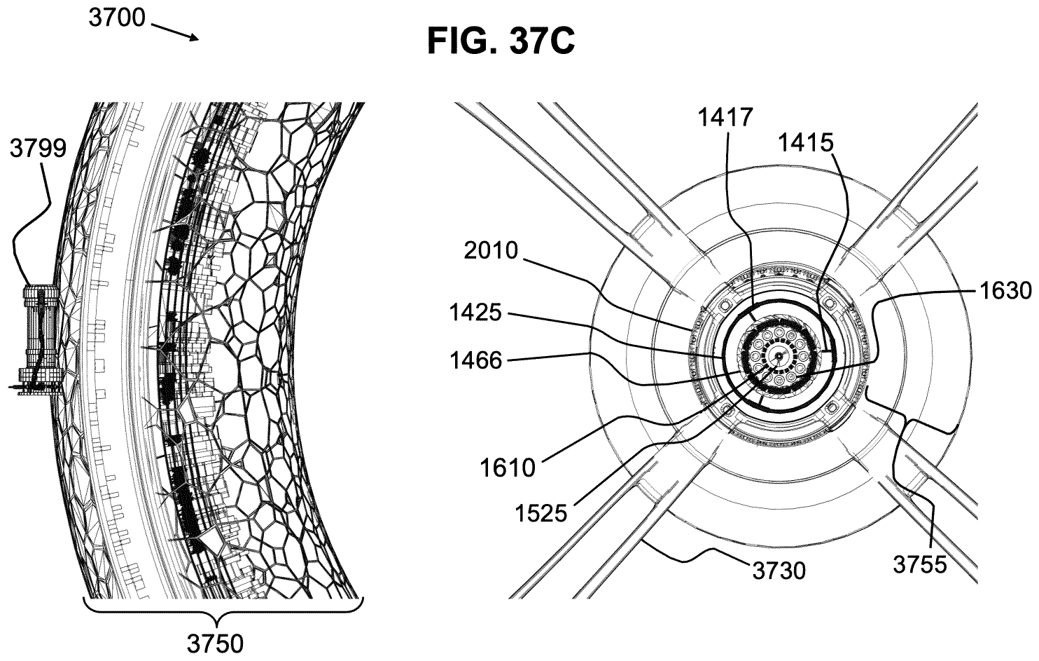

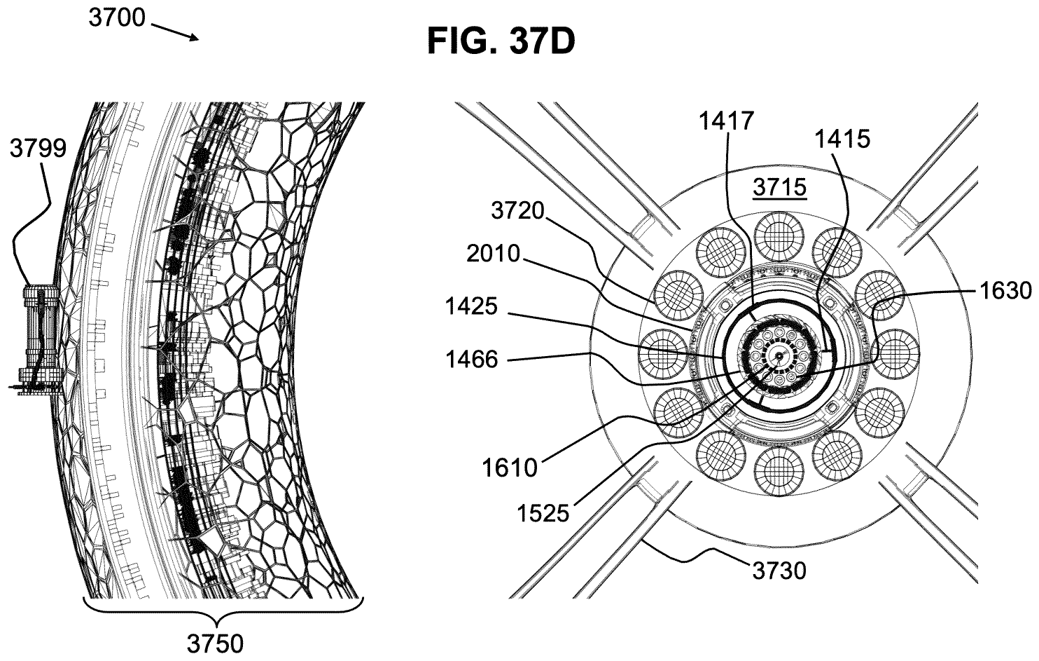

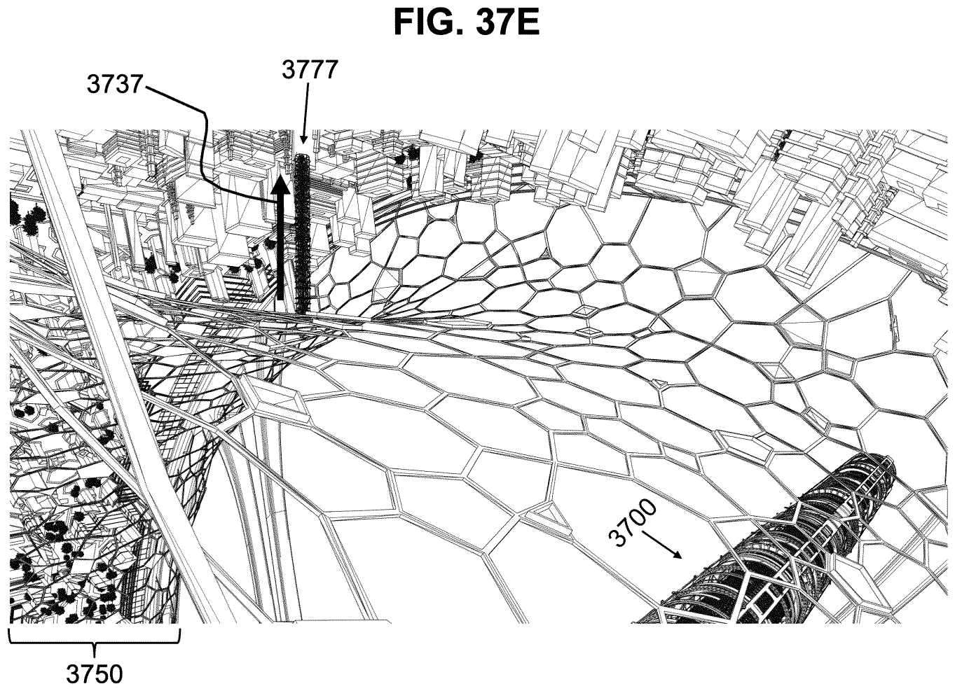

Referring now to FIGS. 37A, 37B, 37C, 37D and 37E, two exemplary embodiments of energy generating devices, 3700 and 3777, are depicted. An energy generating device may harvest or convert the gravitational potential energy and buoyancy potential energy of an astronomical body or other natural gravity generator into electrical energy, as well as thermal energy, and several other forms of energy, as has been depicted in some of the exemplary embodiments taught above. An energy generating device may also harvest or convert the gravitational potential energy and buoyancy potential energy created by an artificial gravity generator into electrical energy, thermal energy, and several other forms of energy. An artificial gravity generator may create artificial gravity by, for example, creating an inertial force, such as a linear inertial force, or, as illustrated in FIGS. 37, a rotational inertial force created using, for example, one or more ion thruster 3799, thereby producing conditions by which an energy generating device might harvest potential energy in the form of electricity. Depicted from a distance in FIG. 37A, an energy generating device 3700 may include an energy generating device 2100 and an artificial gravity generator 3750.

In accordance with various exemplary embodiments, energy generating devices 3700 and 3777 may be configured to generate electricity similar to devices depicted in previous figures, for example, devices 1400 and 1600. An energy generating device 3700 may include a vessel such as linear vessel 2110 rotatably coupled by one or more bearing 3720 to body portion 3715. Body portion 3715 may be coupled to artificial gravity generator 3750 by one or more body connector portion 3730. Alternatively in some embodiments, body portion 3755 may be coupled to a vessel such as linear vessel 2110 on its inner surface and body connector portion 3730 on its outer surface. Embodiment 3700 may include an artificial gravity generator 3750, which may rotate substantially in direction 3725 or direction 3775. Embodiment 3700 may include one or more conductive coils 1466 rotatably coupled to one or more one or more magnet 1610, for example, by one or more rotational member such as a bearing such as roller bearing 1630. Embodiment 3700 may include an outer track 1425 movably coupled to conductive coils 1466, for example, by guide arm 1415 coupled to slide unit 1417. Exemplary device 3700 may include an inner track 1525 movably coupled to one or more magnet 1610 such that one or more magnet 1610 rotate as the move up or down track 1525. Alternatively, embodiment 3700 may use one or more rotors in place of one or more outer track 1425 or 1525. One or more terminus of an energy generating device 2100 may include a top cap 3788 coupled to or supporting or binding one or more members of an energy generating device such as linear vessel 2110, outer track 1425, track 1525 and other members. Embodiment 3700 may include linear vessel 2110, which may contain a fluid medium. Linear vessel 2110 is depicted in cut away view from several angles in FIG. 37.

An exemplary embodiment of an energy generating device 3777 may be coupled to the outer surface of an artificial gravity generator 3750, or as depicted in FIG. 37E, an exemplary energy generating device 3777 may be coupled to the inner surface of or included within an artificial gravity generator 3750 and may be substantially parallel to the direction of the force of gravity 3737. Device 3777 may harvest the potential energy of the gravity, including the gravitational potential energy and the buoyancy potential energy. An energy generating device 3777 may convert the gravitational potential energy and buoyancy potential energy created by an artificial gravity generator 3750 into electrical energy, thermal energy, and several other forms of energy. Energy generating devices 3700 and 3777 are configured to operate with several similar principles to the exemplary selection of devices depicted herein, for example, the relative rotation between a first body portion and a second body portion enables the generation of electrical energy by an electrical generator that may include magnets and conductive coils and the ability for the device or one or more members to descend through a fluid at least partly under the influence of gravity and ascend through a fluid at least partly by changes in buoyancy caused by a buoyancy modulator. The exemplary selection of devices depicted herein are configured to operate with several similar principles to energy generating device 3700 and 3777, which use a configuration including two counter rotational tracks to harvest potential energy by the same principles in orbit or in deeps space by which energy generating device 1400 uses a configuration including two counter rotational tracks to harvest potential energy in atmosphere, deep ocean water, or any fluid medium.

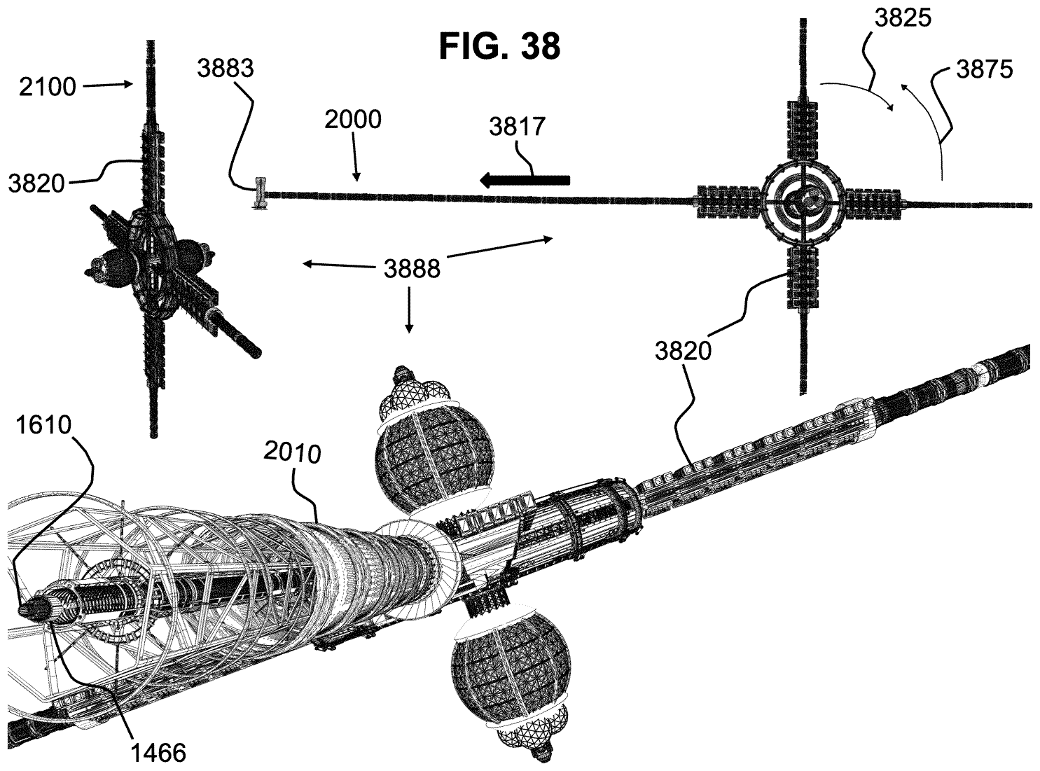

Referring now to FIG. 38, an exemplary embodiment of an energy generating device is depicted. Device 3888 functions similarly to device 3777. An exemplary embodiment 3888 might include one or more energy generating devices 2100, each of which may include a fluid filled vessel such as linear vessel 2110 depicted partially cut away to show that it contains one or more magnet 1610 and conductive coils 1466. An exemplary embodiment 3700 may include a propulsion system such as for example one or more ion thruster 3883, that may cause the device to rotate substantially in direction 3825 or direction 3875 to generate artificial gravity, with the direction of the force of gravity in substantially outward direction 3817 regardless of whether exemplary embodiment 3700 is caused to rotate in direction 3825 or direction 3875. An exemplary energy generating device 3888 may include one or more battery 3820 to store electricity generated by one or more energy generating devices 2100 or any other one or more energy generating devices included in exemplary device 3888. Energy generating device 3888 is configured to operate with several similar principles to the exemplary selection of devices depicted herein, for example, the relative rotation between a first body portion and a second body portion enables the generation of electrical energy by an electrical generator that may include magnets and conductive coils and the ability for the device or one of its members to descend through a fluid at least partly under the influence of gravity and ascend through a fluid at least partly by changes in buoyancy caused by a buoyancy modulator. The exemplary selection of devices depicted herein are configured to operate with several similar principles to energy generating device 3888, for example, an energy generating device can harvest gravitational potential energy and buoyancy potential energy in the air, on the ground, under water, in orbit, in deep space far from any substantial natural gravitational influences, in a fluid body such as an atmosphere or ocean or in a closed vessel containing a fluid medium, while its members can be located near or far from the moving locus of harvesting potential energy.

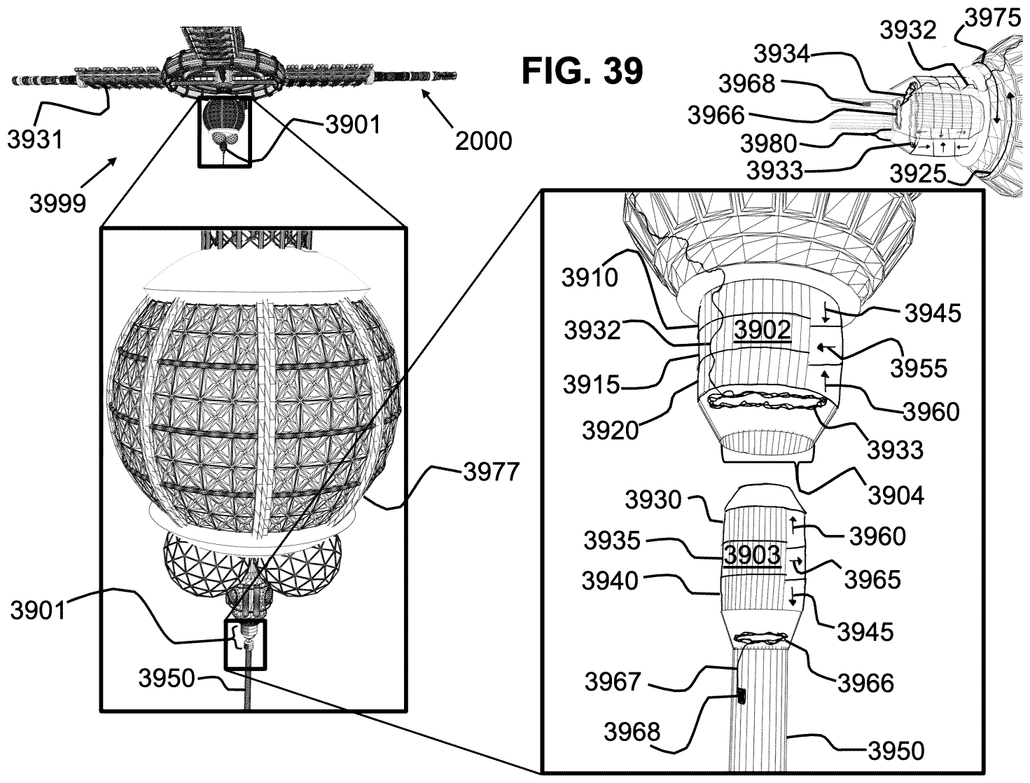

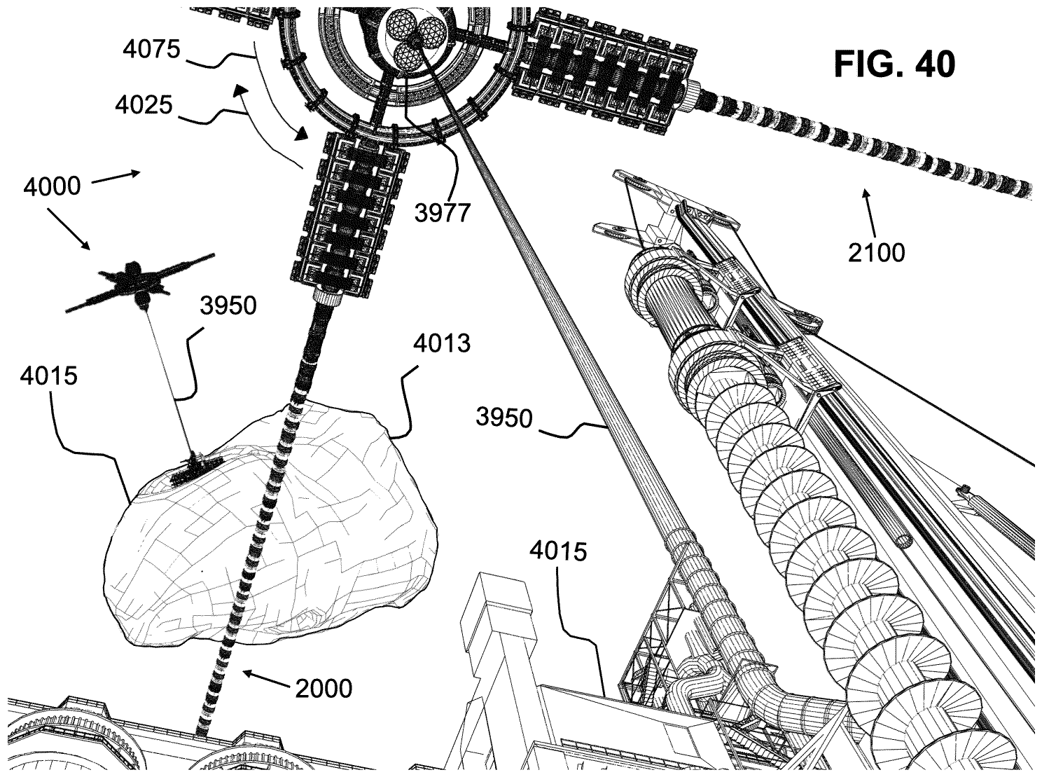

Referring now to FIGS. 39 and 40, two exemplary embodiments of an energy generating device are depicted. An exemplary embodiment of an energy generating device 3999 functions similarly to exemplary embodiments 3777 and 3888. An exemplary device may include any kind of bearing, for example, a magnetic bearing such as magnetic bearing 3901, which may be located anywhere along cable bundle 3950 or at another appropriate location within exemplary energy generating device 3999. Magnetic bearing 3901 may include an outer magnet set 3902 and an inner magnet set 3903. Magnetic bearing 3901 may be configured in a variety of ways known to skilled practitioners of the art. By way of example, outer magnet set 3902 may include three sections: upper section 3910 which may generate a magnetic field in direction 3945, middle section 3915 which may generate a magnetic field in direction 3955, and lower section 3920 which may generate a magnetic field in direction 3960. Inner magnet set 3903 may include three sections: upper section 3930 which may generate a magnetic field in direction 3960, middle section 3935 which may generate a magnetic field in direction 3965, and lower section 3940 which may generate a magnetic field in direction 3945. Outer magnet set 3902 may include a pass through 3904. Inner magnet set 3903 may be included within pass through 3904. Magnetic bearing 3901 may be configured to retain or receive inner magnet set 3903 in the pass through of outer magnet set 3902 such that there is always or usually an air gap 3980 between outer magnet set 3902 and inner magnet set 3903. Note that the term air gap has been used herein because it is a common term that conveys the idea of spatial separation, however in some environments such as deep space the air gap may not contain any air or gas or matter of any kind. Outer magnet set 3902 may rotate in direction 3925 or direction 3975. Inner magnet set 3903 may rotate in direction 3925 or direction 3975. Alternatively, outer magnet set 3902 and inner magnet set 3903 may not rotate at all relative to each other, for example, if exemplary device 3999 is rotating at the same speed as the body to which inner magnet set 3903 is coupled. Note that the location of outer magnet set 3902 could be switched with the location of the inner magnet set 3903, or a different configuration or kind of magnetic bearing could be used, or a bearing that is not magnetic could be used. The depiction of the configuration and type of bearing included in FIG. 39 for exemplary purposes to aid in comprehension of these teachings and like all exemplary devices, members and components herein is not intended to be restrictive or limiting.

An exemplary embodiment of an energy generating device may include an electrical generator or other energy generator or energy source like one or more battery 3931. For example, an energy generating device 3999 may include an energy generating device 2100 or other energy generator. An exemplary device may include a wired energy transmission line, in addition to or in place of a wireless energy transmission system. An energy generating device 2100 or an electrical generator or other energy generator or energy source like a battery 3931 may provide energy to a space manufacturing facility 3977, or may transmit electricity 3934 through wire or other energy transfer member 3932 into wireless energy transmitter or receiver 3933, which may transfer the energy to wireless energy transmitter or receiver 3966, which may transfer the energy through wire or other energy transfer member 3967, which may transfer electricity through electrical port 3968 into cable bundle 3950, to any source of electrical load, for example, a facility, for example, an asteroid mining facility and materials processing facility and manufacturing facility 4015, as depicted in FIG. 40.

Asteroid mining facility and materials processing facility and manufacturing facility 4015 may produce energy generating devices and may produce parts for energy generating devices or may process or produce any other good or material, and is especially well suited to produce goods and materials comprised of the stones, ores and other matter mined or obtained from an asteroid 4013 or any astronomical body. An energy generating device may include several energy generating devices, for example, an exemplary energy generating device 4000 may include several energy generating devices 2100. Exemplary energy generating device 4000 may rotate substantially in direction 4025 or direction 4075 in order to create artificial gravity, which artificial gravity may include gravitational and buoyancy potential energy, which potential energy may be harvested as electrical energy or any form of energy, for example, by the several energy generating devices 2100 that may be included in energy generating device 4000. Energy generating devices 3999 and 4000 are configured to operate with several similar principles to the exemplary selection of devices depicted herein, for example, the relative rotation between a first body portion and a second body portion enables the generation of electrical energy by an electrical generator that may include magnets and conductive coils and the ability for a device or one or more member of a device to descend through a fluid at least partly under the influence of gravity and ascend through a fluid at least partly by changes in buoyancy caused by a buoyancy modulator. The exemplary selection of devices depicted herein are configured to operate with several similar principles to energy generating devices 3999 and 4000, and by these principles may harvest potential energy in the form of electrical energy from a source of gravity created by a natural source such as a planet or from artificially created gravity. Like other exemplary energy generating devices previously taught, exemplary embodiments 3999 or 4000 do not require a natural source of gravity in order to harvest gravitational potential energy and buoyancy potential energy, which can be harvested in the absence of astronomical bodies and in the absence of any matter by generating artificial gravity.

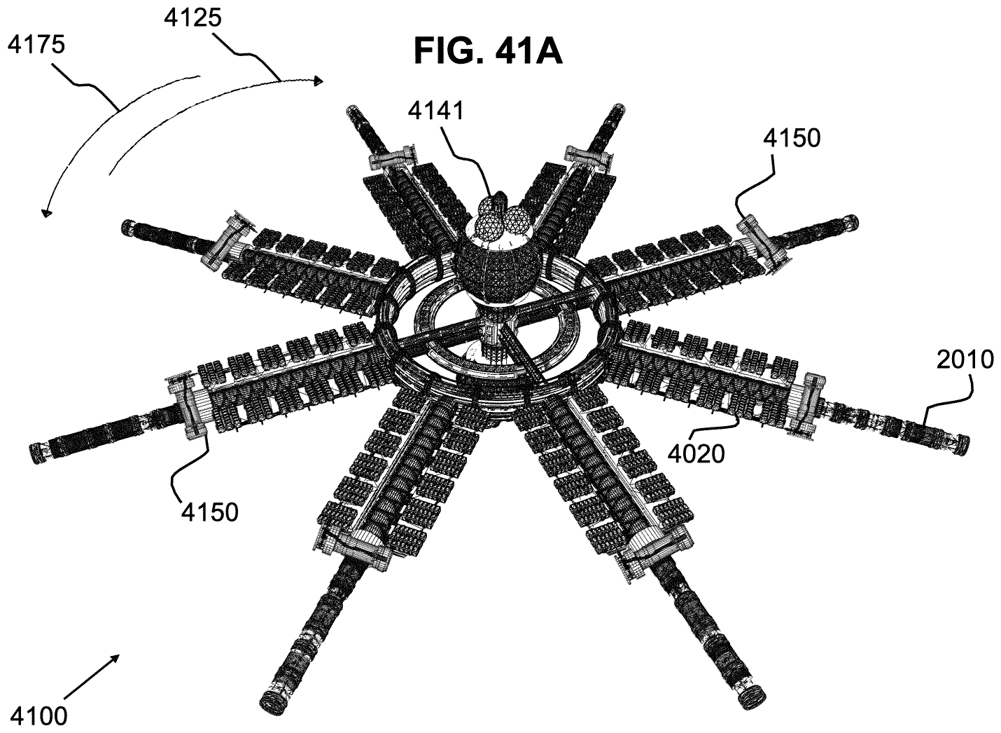

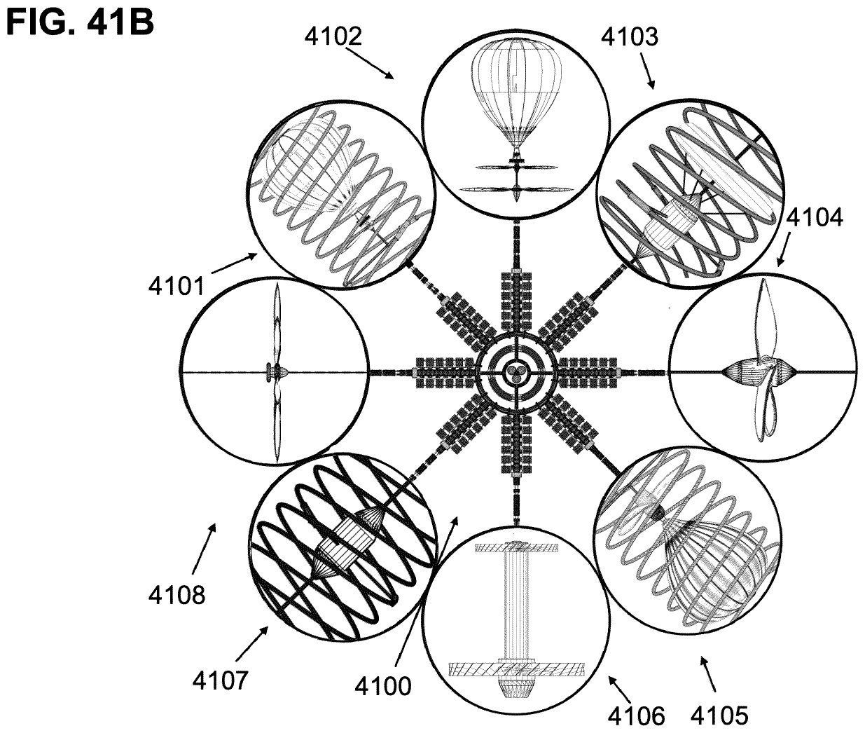

Referring now to FIGS. 41A and 41B, an exemplary embodiment of an energy generating device is depicted. An exemplary embodiment of an energy generating device 4100 may create artificial gravity by using one or more propulsion implement such as, for example, ion thrusters 4150 that causes device 4100 to rotate substantially in direction 4125 or direction 4175. Device 4100 may include one or more battery 4020 and may include an electrical load inducing facility such as a non-gravity or low gravity manufacturing facility 4141 and may include several energy generating devices of varying configurations, each of which may include: a vessel such as linear vessel 2110 that may hold or receive a fluid medium, a first force input structure such as a torque generator, an electrical generator and a buoyancy modulator, each of which may be configured in a variety of ways, for example: device 4101 may include a gas medium, a torque generator including an outer track and inner rotor and a buoyancy modulator including an air compression system and an inflatable member; device 4102 may include a gas medium, a torque generator including counter rotational rotors such as one or more clockwise rotating rotor and one or more counterclockwise rotating rotor, and a buoyancy modulator including an air compressor and inflatable member; device 4103 may include a gas medium, a torque generator including one or more outer track and one or more inner track and a buoyancy modulator including a methane production system and one or more inflatable member; device 4104 may include a liquid medium, a torque generator including one or more outer rotors and one or more inner tracks and a buoyancy modulator including a traditional submarine ballast system; device 4105 may include a liquid medium, a torque generator including one or more outer tracks and one or more inner rotors and a buoyancy modulator including a hydrogen production system and inflatable member; device 4106 may include a liquid medium, a torque generator including one or more outer rotors and one or more inner rotor and a buoyancy modulator including a submarine ballast system; device 4107 may include a liquid medium, a torque generator including one or more outer tracks and one or more inner tracks and a buoyancy modulator including a submarine ballast system; device 4108 may include a gas medium, a torque generator including one or more outer rotors and one or more inner tracks and a buoyancy modulator including a hydrogen production system and an inflatable member.

An energy generating device such as an energy generating device included in device 4100 operates on the principle by which potential energy can be harvested as electrical energy. To realize this principle an energy generating device such as an energy generating device included within device 4100 may be configured as described and depicted herein or may include any configuration of: fluid medium, torque generator, buoyancy modulator and electrical generator. While energy generating device 4100 is depicted including eight different configurations of an energy generating device for illustration and exemplary purposes, a device 4100 may instead include energy generating devices that all share the same configuration in order to balance the device and facilitate smooth rotation. Energy generating device 4100 and energy generating devices included within energy generating device 4100 are configured to operate with several similar principles to the exemplary selection of devices depicted herein, for example, the relative rotation between a first body portion and a second body portion enables the generation of electrical energy by an electrical generator that may include magnets and conductive coils and the ability for a member to descend through a fluid at least partly under the influence of gravity and ascend through a fluid at least partly by changes in buoyancy caused by a buoyancy modulator.

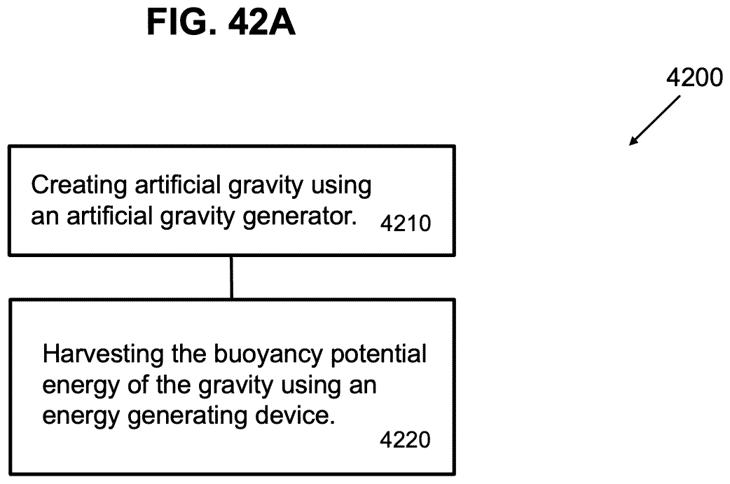

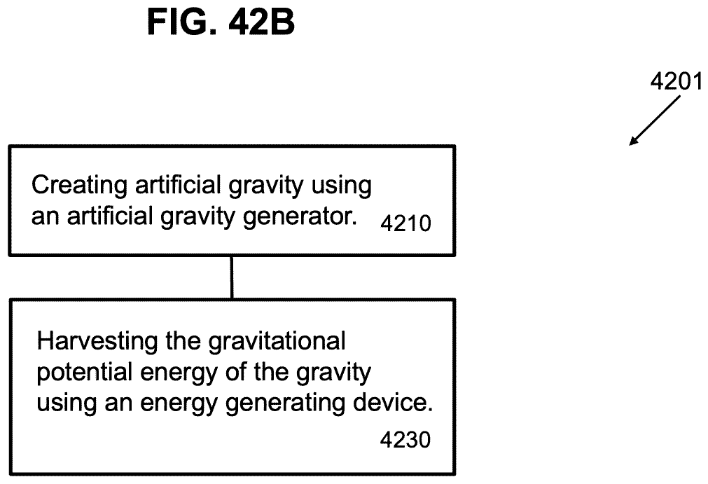

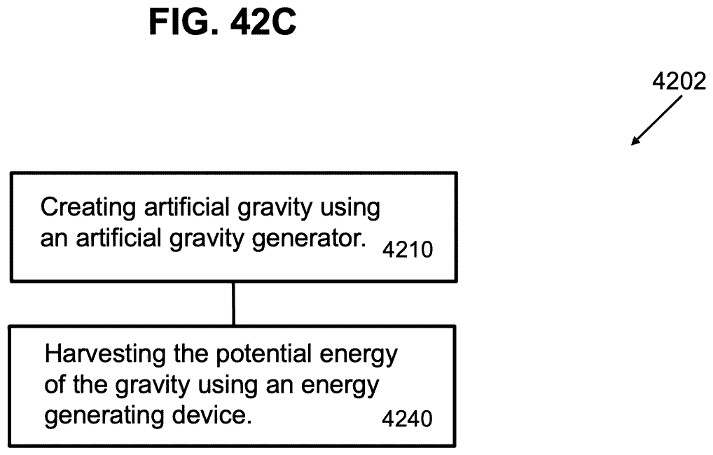

Referring now to FIG. 42A, a flow diagram containing a method for creating energy 4200 may include creating artificial gravity using an artificial gravity generator 4210 and harvesting the buoyancy potential energy of the gravity using an energy generating device 4220. Referring now to FIG. 42B, a flow diagram containing a method for creating energy 4201 may include creating artificial gravity using an artificial gravity generator 4210 and harvesting the gravitational potential energy of the gravity using an energy generating device 4230. Referring now to FIG. 42C, a flow diagram containing a method for creating energy 4202, may include creating artificial gravity using an artificial gravity generator 4210, and harvesting the potential energy of the gravity using an energy generating device 4240.

As depicted in several of the preceding figures, the ideal size, components or members, and configuration, of an energy generating device may be determined by the specific use, application, or purpose for which the energy generating device is being configured. All energy generating devices such as those exemplary devices depicted herein operate on similar principles, therefore an energy generating device might interchangeably use any configuration of counter rotational torque generator including any combination of clockwise and counterclockwise torque generators, or any other combination of torque generators or force input members, or any single torque generator or force input member, included dual torque generators that rotate in the same direction such as the example depicted in FIG. 8, as well as bladeless rotors, bladeless torque generators, and bladeless force input members, for example, a rolling fluid turbine such as the example depicted in FIG. 44, as well as linear generators and chaotic generators such as depicted in FIG. 23 and FIG. 24. Furthermore, because all energy generating devices operate on similar principles, an energy generating device may interchangeably use any buoyancy modulator. The schematics included herein may depict one or another bearing, such as roller bearing 1630, however wherever a roller bearing is used any kind of bearing may be used, for example, a magnetic bearing may be the most efficient type of bearing to use in an energy generating device.

Further, it should be noted that the type of energy generator may be varied without departing from the spirit or scope of the matter of this disclosure. For example, the type of generator that may be used includes but is not limited to the types shown and described above but may be any type of electric or electromagnetic generator, which may be any of direct current generators (dynamos) or alternating current generators (alternators). Further other types of generators may also be used, including but not limited to electrostatic generators, thermoelectrical generators, etc. alone or in conjunction with a dynamo or alternator.

Further still, it should be noted that the type of buoyancy modulator may be varied without departing from the spirit or scope of this disclosure. For example, the type of buoyancy modulator that may be used includes but is not limited to the types shown and described above and may be any type of buoyancy modulator such as use of a lighter than air gas, use of heated gas or heated particles similar to that used in hot air balloons and airships, use of a flapping system similar to that used in ornithopters, rotary lift similar to that used in helicopters, jet propulsion, ionic wind or electrodynamic thrust, magnetism, ballast systems as used in submarines, pneumatic systems such as those that use air to fill cavities or compartments, use of a vacuum, buoyant materials, propulsion and swim bladders similar to those used in aquatic robots.

Furthermore, it should be noted that the type of force input member or torque generator may be varied without departing from the spirit or scope of this disclosure. For example, the type of force input member or torque generator that may be used includes but is not limited to the types shown and described above and may be any type of force input member or torque generator such as toroidal rotors, any kind of rotors, horizontal axis turbines, vertical axis turbines, Savonius turbines, force input members used in linear generators, any kind of turbines, Archimedes screw, force input members that use vortex induced vibration or other systems using vortex shedding, electrostatic wind energy converters, rolling fluid turbines, force input members that rely upon electrohydrodynamic phenomena such as systems similar to solid state wind energy transformers, and any other force input member or torque generator.

Many exemplary embodiments of an energy generating device taught herein have been configured to use a single rotor or two rotors. Embodiments configured with two rotors have primarily been described to use two counter rotating rotors. However, as will be obvious to anyone of ordinary skill in the art, the two rotors could rotate in the same direction, as exemplified in exemplary energy generating device 800. Without departing from the spirit or scope of this disclosure, one of ordinary skill in the art could configure two rotors of an energy generating device to rotate in the same direction, or in any two directions which are neither the same nor opposite, simply by coupling at least one of the rotors to a mechanical system that translates one rotational direction to another. For example, one could use a mechanical system of gears, belt and pulley systems, bevel gears, worm and worm gears, cam and follower, linkages, ratchets, etc., to convert the rotational direction of one rotor into a different rotational direction so that although the rotors are not configured to rotate in opposite directions, the magnet and conductive coils of the electrical generator rotate in opposite directions.

Many structures and designs may be used without departing from the spirit or scope of the disclosure. Various materials may also be used without departing from the spirit or scope of the disclosure.

The term “the exemplary selection of devices depicted herein” is used several times herein to describe the select subset of energy generating devices that have been included in these teachings for the purposes of providing a select few example configurations of the many possible configurations of an energy generating device, in particular, devices: 100, 200, 300, 500, 600, 700, 800, 1200, 1400, 1600, 1650, 2000, 2100, 2150, 2200, 2250, 2300, 2400, 2420, 2460, 2500, 2600, 2700, 2800, 2900, 3100, 3200, 3300, 3311, 3322, 3333, 3344, 3350, 3366, 3452, 3453, 3483, 3484, 3500, 3501, 3600, 3601, 3602, 3603, 3700, 3777, 3888, 3999, 4000 and 4100, 4101, 4102, 4103, 4104, 4105, 4106, 4107 and 4108.

Further, it should be noted that each exemplary energy generating device depicted herein, may be configured to include a first body portion, at least one first force input structure coupled to the first body portion and configured to receive an external force, a second body portion, the first body portion rotatable, oscillatable, or movable relative to the second body portion; and an electrical generator configured to use the relative motion between the first body portion and the second body portion to generate electricity, wherein the first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation, oscillation or movement between the first body portion and the second body portion. Each exemplary energy generating device depicted herein may be configured such that the first body portion is substantially concentric with the second body portion. Each exemplary energy generating device depicted herein may be configured such that the first body portion includes a pass through configured to receive the second body portion. Each exemplary energy generating device depicted herein may be configured such that the second body portion is rotatably, oscillatably, or movably supported by at least one bearing, scotch yoke, slider-crank mechanism, cam and follower mechanism, rack and pinion mechanism, screw thread mechanism, flexible or inflexible hanging member such as a rope or string, or any other movable mechanism. Each exemplary energy generating device depicted herein may be configured such that the at least one bearing includes at least one of a mechanical bearing, an air bearing, a fluid bearing, and a magnetic bearing. Each exemplary energy generating device depicted herein may be configured such that at least one second force input structure is coupled to the second body portion. Each exemplary energy generating device depicted herein may be configured such that the at least one second force input structure is configured to cause increased relative rotation, oscillation or movement between the first body portion and the second body portion when the at least one second force input structure receives a force from the impinging medium. Each exemplary energy generating device depicted herein may be configured such that the at least one first force input structure includes a rotor, oscillator, or is configured to receive chaotic forces and the at least one second force input structure includes a rotor, oscillator, or is configured to receive chaotic forces. Each exemplary energy generating device depicted herein may be configured such that the at least one first force input structure includes a rotor, oscillator, or is configured to receive chaotic forces. Each exemplary energy generating device depicted herein may be configured such that the second body portion includes at least one magnet or coil and the first body portion includes at least magnet or one coil, the at least one magnet and the at least one coil being a portion of the electrical generator. Each exemplary energy generating device depicted herein may be configured such that at least one buoyancy modulator selectively changes the buoyancy of the energy generating device. Each exemplary energy generating device depicted herein may be configured such that the at least one buoyancy modulator includes at least one ballast tank. Each exemplary energy generating device depicted herein may be configured such that the at least one buoyancy modulator includes at least one inflatable member. Each exemplary energy generating device depicted herein may be configured such that at least one pump or other gas compression member configured to fill at least one compressed gas tank. Each exemplary energy generating device depicted herein may be configured such that at least one compressor pump configured to fill at least one compressed gas tank. Each exemplary energy generating device depicted herein may be configured such that the at least one second force input structure includes a helix. Each exemplary energy generating device depicted herein may be configured such that the at least one first force input structure includes a helix. Each exemplary energy generating device depicted herein may be configured such that the at least one second force input structure includes a helix. Each exemplary energy generating device depicted herein may be configured to include a first body portion having a pass-through, at least one rotor or oscillator or a torque generating structure configured to receive chaotic forces or other torque generating structure coupled to the first body portion and configured to receive an external force, a second body portion, the second body portion concentrically located at least partially within the pass-through of the first body portion, the first body portion rotatable or oscillatable or movable relative to the second body portion, at least one rotor or other torque generating structure coupled to the second body portion and configured to receive an external force and an electrical generator configured to use the relative motion between the first body portion, having one or more conductive coils, and the second body portion, having one or more magnets, to generate electricity, wherein the first body portion and the second body portion are configured to descend through a medium at least partially under the force of gravity or ascend through the medium at least partially by buoyant forces in such a way that the medium causes a force on the at least one rotor or oscillator or a torque generating structure configured to receive chaotic forces or other torque generating structure by impinging on the at least one rotor or oscillator or a torque generating structure configured to receive chaotic forces or other torque generating structure causing relative rotation, oscillation or movement between the first body portion and the second body portion. Each exemplary energy generating device depicted herein may be configured to perform a method of generating electricity, comprising: causing an energy generating device, having a first body portion and a second body portion configured to counter rotate with each other or to counter oscillate with each other or to move relative to each other, to descend in a medium under the force of gravity, causing relative rotation between the first body portion and the second body portion by providing contact between the medium and a torque generator configured on one or both of the first body portion and the second body portion, generating electricity by providing magnets and conductive coils on the first body portion and the second body portion, the magnets causing an electrical current in the conductive coils as they bypass one another and increasing the buoyancy of the energy generating device causing the energy generating device to ascend.

### Features Related to Various Embodiments

Disclosed below are various embodiments and related features which may entirely form or form features of the disclosed embodiments alone or in various combinations. These embodiments and clauses detailing potential elements are provided as disclosure and support for possible alternative claims and claim limitations in accordance with various embodiments of the inventions discussed in this document and the family of which this document is a member.

An energy generating device disclosed includes a first body portion, at least one first force input structure coupled to the first body portion and configured to receive an external force and a second body portion, the first body portion rotatable relative to the second body portion. The device also includes an electrical generator configured to use the relative motion between the first body portion and the second body portion to generate electricity. The first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

The energy generating device may include the second body portion having at least one coil and the first body portion having at least one magnet, the at least one coil and the at least one magnet being a portion of the electrical generator.

The energy generating device may include the at least one second force input structure having at least one torque generator.

The energy generating device may include the at least one first force input structure having at least one torque generator.

The energy generating device may include the at least one second force input structure having at least one torque generator.

A method of manufacturing an energy generating device may include producing, from suitable materials, a first body portion and producing, from suitable materials, at least one first force input structure. The method may also include coupling the at least one first force input structure to the first body portion in a configuration to receive an external force and producing, from suitable materials, a second body portion. The method may further include assembling the first body portion with the second body portion in a configuration to be rotatable relative to the second body portion and assembling an electrical generator in a configuration to use the relative motion between the first body portion and the second body portion to generate electricity. The first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

An energy generating device includes at least one first body portion, at least one second body portion, at least one torque generator, and at least one electrical generator configured to use the relative motion between the first body portion and the second body portion to generate electricity. The first body portion and the second body portion are configured to descend through a medium at least partially under the force of gravity or ascend through the medium at least partially by buoyant forces in such a way that the torque generator causes relative rotation between the first body portion and the second body portion.

The energy generating device may include the first body portion is substantially concentric with the second body portion.

The energy generating device may include the first body portion having a pass through configured to receive the second body portion.

The energy generating device may include the second body portion is rotatably supported by at least one bearing.

The energy generating device may include the at least one bearing having at least one of a mechanical bearing, an air bearing, a fluid bearing, and a magnetic bearing.

The energy generating device may include the torque generator having at least one first force input structure configured to receive an external force as the energy generating device descends or ascends through a medium causing relative rotation between the first body portion and the second body portion.

The energy generating device may include the at least one first track being configured to prevent the rotation of the first body portion as the energy generating device descends or ascends through a medium.

The energy generating device may include the at least one first track being configured to steer or constrain the motion of the first body portion causing relative rotation between the first body portion and the second body portion as the energy generating device descends or ascends through a medium.

The energy generating device may include at least one second force input structure coupled to the second body portion.

The energy generating device may include the at least one second track being configured to prevent the rotation of the second body portion as the energy generating device descends or ascends through a medium.

The energy generating device may include the at least one second track being configured to steer or constrain the motion of the second body portion causing increased relative rotation between the first body portion and the second body portion as the energy generating device descends or ascends through a medium.

The energy generating device may include the at least one second force input structure being configured to cause increased relative rotation between the first body portion and the second body portion when the at least one second force input structure receives a force from the impinging medium.

The energy generating device may include the at least one first force input structure having a rotor and the at least one second force input structure includes a rotor.

The energy generating device may include the at least one first force input structure having a rotor.

The energy generating device may include the second body portion having at least one magnet and the first body portion having at least one coil, the at least one magnet and the at least one coil being a portion of the electrical generator.

The energy generating device may include the second body portion having at least one coil and the first body portion having at least one magnet, the at least one coil and the at least one magnet being a portion of the electrical generator.

The energy generating device may include at least one buoyancy modulator configured to selectively change the buoyancy of the energy generating device.

The energy generating device may include the at least one buoyancy modulator having at least one ballast tank.

The energy generating device may include the at least one buoyancy modulator having at least one inflatable member.

The energy generating device may include at least one pump or other gas compression member configured to fill at least one compressed gas tank.

The energy generating device may include at least one compressor pump configured to fill at least one compressed gas tank.

The energy generating device may include at least one pump or other gas compression member configured to fill at least one compressed gas tank.

The energy generating device may include at least one compressor pump configured to fill at least one compressed gas tank.

The energy generating device may include the at least one second force input structure being a helix or helical rotor.

The energy generating device may include the at least one first force input structure being a helix or helical rotor.

The energy generating device may include the at least one second force input structure being a helix or helical rotor.

The energy generating device may include at least one pump or other gas compression member configured to fill at least one compressed gas tank.

The energy generating device may include at least one compressor pump configured to fill at least one compressed gas tank.

The energy generating device may include the torque generator having at least one first guide member.

The energy generating device may include the torque generator having at least one second guide member.

The energy generating device may include a vessel.

The energy generating device may include the vessel having a linear vessel.

The energy generating device may include the vessel having a nonlinear vessel.

The energy generating device of may include the first body portion having a pass through configured to receive the second body portion.

The energy generating device may include the second body portion being rotatably supported by at least one bearing.

The energy generating device may include the at least one bearing having at least one of a mechanical bearing, an air bearing, a fluid bearing, and a magnetic bearing.

The energy generating device may include the at least one first guide member having at least one first track.

The energy generating device may include the at least one first track being configured to prevent the rotation of the first body portion as the energy generating device descends or ascends through a medium.

The energy generating device may include the at least one first track being configured to steer or constrain the motion of the first body portion causing relative rotation between the first body portion and the second body portion as the energy generating device descends or ascends through a medium.

The energy generating device may include the at least one second guide member having at least one second track.

The energy generating device may include the at least one second track being configured to prevent the rotation of the second body portion as the energy generating device descends or ascends through a medium.

The energy generating device may include the at least one first force input structure including at least one first guide member.

The energy generating device may include the at least one second force input structure including at least one first guide member.

The energy generating device may include the at least one first force input structure including at least one second guide member.

The energy generating device may include the at least one second track being configured to steer or constrain the motion of the second body portion causing increased relative rotation between the first body portion and the second body portion as the energy generating device descends or ascends through a medium.

The energy generating device may include the at least one second force input structure being configured to cause increased relative rotation between the first body portion and the second body portion when the at least one second force input structure receives a force from the impinging medium.

The energy generating device may include the at least one first force input structure having a rotor and the at least one second force input structure having a rotor.

The energy generating device may include the at least one first force input structure having a rotor.

The energy generating device may include the at least one buoyancy modulator having at least one ballast tank.

The energy generating device may include the at least one buoyancy modulator having at least one inflatable member.

The energy generating device may include at least one pump or other gas compression member configured to fill at least one compressed gas tank.

The energy generating device may include at least one compressor pump configured to fill at least one compressed gas tank.

The energy generating device may include at least one pump or other gas compression member configured to fill at least one compressed gas tank.

The energy generating device may include at least one compressor pump configured to fill at least one compressed gas tank.

The energy generating device may include the at least one second force input structure being a helix or helical rotor.

The energy generating device may include the at least one first force input structure being a helix or helical rotor.

The energy generating device may include the at least one second force input structure being a helix or helical rotor.

The energy generating device may include at least one pump or other gas compression member configured to fill at least one compressed gas tank.

The energy generating device may include at least one compressor pump configured to fill at least one compressed gas tank.

The energy generating device may include the vessel being a linear vessel.

The energy generating device may include the vessel being a nonlinear vessel.

The energy generating device may include a potential energy converter.

The energy generating device may include the potential energy converter being configured to convert the potential energy of the force of gravity into electrical energy.

The energy generating device may include the potential energy converter being configured to convert the potential energy of the force of buoyancy into electrical energy.

The energy generating device may include the potential energy converter being configured to convert the potential energy of the force of gravity into thermal energy.

The energy generating device may include the potential energy converter being configured to convert the potential energy of the force of buoyancy into thermal energy.

The energy generating device may include the potential energy converter being configured to convert the potential energy of the force of gravity into sound energy.

The energy generating device may include the potential energy converter being configured to convert the potential energy of the force of buoyancy into sound energy.

The energy generating device may include the potential energy converter being configured to convert the potential energy of the force of gravity into chemical energy.

The energy generating device may include the potential energy converter being configured to convert the potential energy of the force of buoyancy into chemical energy.

The energy generating device may include the potential energy converter being configured to convert the potential energy of the force of gravity into radiant energy.

The energy generating device may include the potential energy converter being configured to convert the potential energy of the force of buoyancy into radiant energy.

The energy generating device may include the buoyancy modulator having at least one chemical converter configured to convert one or more input chemicals into one or more output chemicals.

The energy generating device may include the at least one chemical converter being configured to convert one or more chemicals to lighter than air gas.

The energy generating device may include the buoyancy modulator having at least one matter phase converter configured to convert a substance from one phase of matter to another.

The energy generating device may include the matter phase converter being configured to convert matter between a liquid phase and a gas phase.

The energy generating device may include the matter phase converter being configured to convert matter between a solid phase and a gas phase.

The energy generating device may include the matter phase converter being configured to convert matter between a liquid phase and a solid phase.

The energy generating device may include the at least one chemical converter being configured to convert one or more chemicals into one or more chemicals that are lighter than air.

The energy generating device may include the vessel being configured to contain a medium.

The energy generating device may include at least one density modulator configured to selectively change the density of the energy generating device.

The energy generating device may include at least one density modulator configured to selectively change the density of the medium in which the energy generating device is located.

The energy generating device may include the source of gravity being a massive astronomical body.

The energy generating device may include the source of gravity being an artificial gravity generator.

The energy generating device may include the at least one chemical converter being configured to convert one or more chemicals to methane.

The energy generating device may include the at least one chemical converter being configured to convert one or more chemicals to one or more chemicals less dense than the medium surrounding the energy generating device.

The energy generating device may include the at least one chemical converter being configured to convert one or more chemicals to one or more chemicals less dense than the medium in which the energy generating is located.

The energy generating device may include the at least one chemical converter being configured to convert one or more chemicals to one or more chemicals lighter than water.

A method of generating electricity may include causing an energy generating device, having a first body portion and a second body portion configured to counter rotate with each other, to descend in a medium under the force of gravity and causing relative rotation between the first body portion and the second body portion by configuring the at least one track to steer or constrain the motion of one or both of the first body portion and the second body portion. The method may also include generating electricity by providing magnets and conductive coils on the first body portion and the second body portion, the magnets causing an electrical current in the conductive coils as they bypass one another and increasing the buoyancy of the energy generating device causing the energy generating device to ascend.

A method of manufacturing an energy generating device may include producing, from suitable materials, a first body portion and producing, from suitable materials, a second body portion. The method may also include producing, from suitable materials, at least one track and movably coupling the at least one track to one or both of the first body portion and second body portion in a configuration to cause the track to steer or constrain the motion of one or both of the first body portion and second body portion. Further, the method may include assembling the first body portion with the second body portion in a configuration to enable relative rotation between the first body portion and the second body portion and assembling an electrical generator in a configuration to use the relative motion between the first body portion and the second body portion to generate electricity. The first body portion and the second body portion are configured to descend through a medium at least partially under the force of gravity or ascend through the medium at least partially by buoyant forces in such a way that the track steers or constrains the motion of the one or both of the first body portion and the second body portion causing relative rotation between the first body portion and the second body portion.

A method of generating electricity may include increasing the buoyancy of an energy generating device causing the energy generating device to ascend in a medium and causing relative rotation between the first body portion and the second body portion by providing contact between the at least one track and one or both of the first body portion and the second body portion, thereby steering or constraining the motion of one or both of the first body portion and second body portion. The method may also include reversing polarity of the outputs of an electrical generator and generating electricity by providing magnets and conductive coils on the first body portion and the second body portion, the magnets causing an electrical current in the conductive coils as they bypass one another.

A configuration of four diodes or a rectifier can be used so that the direction of current flow of the electrical generator remains the same as in the downward direction.

A method of creating energy may include creating artificial gravity using an artificial gravity generator and harvesting the buoyancy potential energy of the gravity using an energy generating device.

A method of creating energy may include creating artificial gravity using an artificial gravity generator and harvesting the gravitational potential energy of the gravity using an energy generating device.

A method of creating energy may include creating artificial gravity using an artificial gravity generator and harvesting the potential energy of the gravity using an energy generating device.

An energy generating device may include a first body portion, at least one first force input structure coupled to the first body portion and configured to receive an external force, a second body portion, the first body portion oscillatable relative to the second body portion and an electrical generator configured to use the relative motion between the first body portion and the second body portion to generate electricity, wherein the first body portion and the second body portion are configured to descend through a medium at least partially under the force of gravity or ascend through the medium at least partially by buoyant forces in such a way that the medium causes a force on the at least one first force input structure by impinging on the at least one force input structure causing relative oscillation between the first body portion and the second body portion.

The energy generating may be configured such that the at least one second force input structure is configured to cause increased relative oscillation between the first body portion and the second body portion when the at least one second force input structure receives a force from the impinging medium.

The energy generating device may be configured such that the at least one first force input structure includes an oscillator and the at least one second force input structure includes an oscillator.

The energy generating device may be configures such that the at least one first force input structure includes an oscillator.

An energy generating device may include a first body portion having a pass-through, at least one oscillator or other torque generating structure coupled to the first body portion and configured to receive an external force, a second body portion, the second body portion concentrically located at least partially within the pass-through of the first body portion, the first body portion oscillatable relative to the second body portion, at least one oscillator or other torque generating structure coupled to the second body portion and configured to receive an external force, and an electrical generator configured to use the relative motion between the first body portion, having one or more conductive coils, and the second body portion, having one or more magnets, to generate electricity, wherein the first body portion and the second body portion are configured to descend through a medium at least partially under the force of gravity or ascend through the medium at least partially by buoyant forces in such a way that the medium causes a force on the at least one oscillator or other torque generating structure by impinging on the at least one oscillator causing relative oscillation between the first body portion and the second body portion.

A method of generating electricity may include causing an energy generating device, having a first body portion and a second body portion configured to oscillate relative to each other, to descend in a medium under the force of gravity, causing relative oscillation between the first body portion and the second body portion by providing contact between the medium and a torque generator configured on one or both of the first body portion and the second body portion, generating electricity by providing magnets and conductive coils on the first body portion and the second body portion, the magnets causing an electrical current in the conductive coils as they bypass one another and increasing the buoyancy of the energy generating device causing the energy generating device to ascend.

An energy generating device may include a first body portion, at least one first force input structure coupled to the first body portion and configured to receive an external force, a second body portion, the first body portion movable relative to the second body portion and an electrical generator configured to use the relative motion between the first body portion and the second body portion to generate electricity, wherein the first body portion and the second body portion are configured to descend through a medium at least partially under the force of gravity or ascend through the medium at least partially by buoyant forces in such a way that the medium causes a force on the at least one first force input structure by impinging on the at least one force input structure causing relative movement between the first body portion and the second body portion.

The energy generating device may be configures such that the at least one second force input structure is configured to cause increased relative movement between the first body portion and the second body portion when the at least one second force input structure receives a force from the impinging medium.

The energy generating device may be configured such that the at least one first force input structure is configured to receive irregular, nonlinear, noncurvilinear or chaotic forces and the at least one second force input structure is configured to receive irregular, nonlinear, noncurvilinear or chaotic forces.

The energy generating device may be configured such that the at least one first force input structure is configured to receive irregular, nonlinear, noncurvilinear or chaotic forces.

An energy generating device may include a first body portion having a pass-through, at least one torque generating structure is configured to receive irregular, nonlinear, noncurvilinear or chaotic forces coupled to the first body portion and configured to receive an external force, a second body portion, the second body portion concentrically located at least partially within the pass-through of the first body portion, the first body portion movable relative to the second body portion, at least one torque generating structure coupled to the second body portion and configured to receive irregular, nonlinear, noncurvilinear or chaotic forces and an electrical generator configured to use the relative motion between the first body portion, having one or more conductive coils, and the second body portion, having one or more magnets, to generate electricity, wherein the first body portion and the second body portion are configured to descend through a medium at least partially under the force of gravity or ascend through the medium at least partially by buoyant forces in such a way that the medium causes a force on the at least one torque generating structure by impinging on the at least one torque generating structure causing relative movement between the first body portion and the second body portion.

A method of generating electricity may include causing an energy generating device, having a first body portion and a second body portion configured to move relative to each other, to descend in a medium under the force of gravity, causing relative movement between the first body portion and the second body portion by providing contact between the medium and a torque generator configured on one or both of the first body portion and the second body portion, generating electricity by providing magnets and conductive coils on the first body portion and the second body portion, the magnets causing an electrical current in the conductive coils as they bypass one another and increasing the buoyancy of the energy generating device causing the energy generating device to ascend.

In some instances, one or more components or members may be referred to herein as “configured to,” “configured by,” “configurable to,” “operable/operative to,” “adapted/adaptable,” “able to,” “conformable/conformed to,” etc. Those of ordinary skill in the art will recognize that such terms (e.g. “configured to”) generally encompass active-state components or members and/or inactive-state components or members and/or standby-state components or members, unless context requires otherwise.

In some instances, an energy generating device or one of the components or members comprising an energy generating device may be said to “comprise” or “include” components or members. Those of ordinary skill in the art will recognize that the terms “comprise” and “include” are synonyms used interchangeably unless context requires otherwise. In some instances, an energy generating device or one of the components or members comprising an energy generating device may be said to be “attached to” or “coupled to” or “included in” or comprised of or may be said to “have” components or members. Those of ordinary skill in the art will recognize that these terms are synonyms used interchangeably unless context requires otherwise.

In some instances, an energy generating device or one or more members of an energy generating device may be described in the singular or may be described in the plural. Those of ordinary skill in the art will recognize that a device or member that included in the singular could also be included in the plural and a device or member that is included in the plural could also be included in the singular without departing from the spirit or scope of this disclosure. For example, a member described as “a bearing” could also be “one or more bearings”, while a member described as “one or more bearing” could also be “one bearing”.

While many exemplary energy generating devices are described as having or including components that are explicitly named using the word “member”, for example, “outer first body portion 3320”, a skilled practitioner will recognize that included components that are not explicitly named using the word “member” are members despite not being explicitly named as such. For example, “conductive coils 1466” are not explicitly named using the word “member” but are nonetheless a member of an exemplary energy generating device. An energy generating device or a member of an energy generating device may be described as having a property, state or function. A skilled practitioner will recognize that the device or member may have substantially that property, state or function without departing from the spirit or scope of this disclosure. For example, in some instances, an energy generating device or one or more members of an energy generating device may be said to be oriented in a direction, such as a vertical orientation, or may be said to be oriented in relation to a second member such as oriented concentrically to a second member. Those of ordinary skill in the art will recognize that a device or member that is said to be oriented in relation to a second member such as oriented concentrically to a second member could also be oriented substantially concentrically to a second member without departing from the spirit or scope of this disclosure. Those of ordinary skill in the art will recognize that a device or member that is said to said to be oriented in a direction could also be oriented in a substantially similar direction without departing from the spirit or scope of this disclosure. For example, a device said to be vertically oriented could also be substantially vertically oriented.

In some instances, an energy generating device or one or more members of an energy generating device may be said to be rotating or moving or traveling in a direction. Those of ordinary skill in the art will recognize that a device or member that is said to be rotating or moving or traveling in a direction could be moving in a substantially similar direction to the written or depicted direction without departing from the spirit or scope of this disclosure. For example, an exemplary energy generating device traveling in a downward direction may not be traveling straight downward, but may be traveling at a downward angle. As a second example, a member that is said to travel or rotate in the opposite direction of a second member may not be traveling or rotating in exactly the opposite direction of a second member, but may be traveling or rotating in a substantially opposite direction of a second member.

In some instances, an energy generating device or one or more members of an energy generating device may be said to turn or reorient by some number of degrees, such as 180°. Those of ordinary skill in the art will recognize that a device or member that is said to said to turn or reorient by some number of degrees could turn or reorient a substantially similar number of degrees to the written or depicted number of degrees without departing from the spirit or scope of this disclosure. For example, an exemplary energy generating device traveling in a downward direction may not be traveling straight downward, but may be traveling at an angle. When the device turns around, it may be said to turn 180° in order travel in an upward direction, but the device might not turn a full 180°, or it might turn more than 180°.

In some instances, an energy generating device or one or more members of an energy generating device may be said to reach a height such as a top height or zenith height or bottom height. Those of ordinary skill in the art will recognize that a device or member that is said to reach a height such as a top or bottom height could reach a substantially high or low height without departing from the spirit or scope of this disclosure. For example, an exemplary energy generating device or member said to reach a top height may reach any height higher than its prior height. Another example, an exemplary energy generating device or member said to reach a bottom height may reach any height lower than its prior height.

In some instances, an energy generating device or one or more members of an energy generating device may be said to reach a height relative to another device or member, such as a height “just below buoy 1240”. Those of ordinary skill in the art will recognize that a device or member that is said to reach a height relative to the height of another device or member could reach a substantially higher or lower height without departing from the spirit or scope of this disclosure. For example, an exemplary energy generating device or member said to reach a height just below buoy 1240 may reach any height lower than buoy 1240.

While particular aspects of the present subject matter described herein have been shown and described, it will be apparent to those of ordinary skill in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those of ordinary skill in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those of ordinary skill in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those of ordinary skill in the art that various modifications can be made thereto without departing from the spirit or scope of the claimed subject matter as set forth in the claims and all illustrative embodiments are exemplary in nature.

1. An energy generating device, comprising:
a first body portion;
at least one first force input structure coupled to the first body portion and configured to receive an external force;
a second body portion, the first body portion rotatable relative to the second body portion; and
an electrical generator configured to use the relative motion between the first body portion and the second body portion to generate electricity,
wherein the first body portion and the second body portion are configured to descend through a medium at least partially under the force of gravity or ascend through the medium at least partially by buoyant forces in such a way that the medium causes a force on the at least one first force input structure by impinging on the at least one force input structure causing relative rotation between the first body portion and the second body portion.

2. The energy generating device of claim 1, wherein the first body portion is substantially concentric with the second body portion.

3. The energy generating device of claim 2, wherein the first body portion includes a pass through configured to receive the second body portion.

4. The energy generating device of claim 3, wherein the second body portion is rotatably supported by at least one bearing.

5. The energy generating device of claim 4, wherein the at least one bearing includes at least one of a mechanical bearing, an air bearing, a fluid bearing, and a magnetic bearing.

6. The energy generating device of claim 2, further comprising:
at least one second force input structure coupled to the second body portion.

7. The energy generating device of claim 6, wherein the at least one second force input structure is configured to cause increased relative rotation between the first body portion and the second body portion when the at least one second force input structure receives a force from the impinging medium.

8. The energy generating device of claim 6, wherein the at least one first force input structure includes a rotor and the at least one second force input structure includes a rotor.

9. The energy generating device of claim 1, wherein the at least one first force input structure includes a rotor.

10. The energy generating device of claim 1, wherein the second body portion includes at least one magnet or coil and the first body portion includes at least one magnet or one coil, the at least one magnet and the at least one coil being a portion of the electrical generator.

11. The energy generating device of claim 1, further comprising:
at least one buoyancy modulator configured to selectively change the buoyancy of the energy generating device.

12. The energy generating device of claim 11, wherein the at least one buoyancy modulator includes at least one ballast tank.

13. The energy generating device of claim 11, wherein the at least one buoyancy modulator includes at least one inflatable member.

14. The energy generating device of claim 12, further comprising:
at least one pump or gas compression member configured to fill at least one compressed gas tank.

15. The energy generating device of claim 14, further comprising:
at least one compressor pump configured to fill at least one compressed gas tank.

16. The energy generating device of claim 9, wherein the at least one second force input structure includes a helix.

17. The energy generating device of claim 1, wherein the at least one first force input structure includes a helix.

18. The energy generating device of claim 17, wherein the at least one second force input structure includes a helix.

19. An energy generating device, comprising:
a first body portion having a pass-through;
at least one rotor or torque generating structure coupled to the first body portion and configured to receive an external force;
a second body portion, the second body portion concentrically located at least partially within the pass-through of the first body portion, the first body portion rotatable relative to the second body portion;
at least one rotor or torque generating structure coupled to the second body portion and configured to receive an external force; and
an electrical generator configured to use the relative motion between the first body portion, having one or more conductive coils, and the second body portion, having one or more magnets, to generate electricity,
wherein the first body portion and the second body portion are configured to descend through a medium at least partially under the force of gravity or ascend through the medium at least partially by buoyant forces in such a way that the medium causes a force on the at least one rotor or torque generating structure by impinging on the at least one rotor or torque generating structure causing relative rotation between the first body portion and the second body portion.

20. A method of generating electricity, comprising:
causing an energy generating device, having a first body portion and a second body portion configured to counter rotate with each other, to descend in a medium under the force of gravity;
causing relative rotation between the first body portion and the second body portion by providing contact between the medium and a torque generator configured on one or both of the first body portion and the second body portion;
generating electricity by providing magnets and coils on the first body portion and the second body portion, the magnets causing an electrical current in the coils as they bypass one another; and
increasing the buoyancy of the energy generating device causing the energy generating device to ascend.

21. The energy generating device of claim 13, further comprising:
at least one pump or gas compression member configured to fill at least one compressed gas tank.

22. The energy generating device of claim 21, further comprising:
at least one compressor pump configured to fill at least one compressed gas tank.
